(19) United States
(12) Patent Application Publication
(10) Pub. No.: US 2025/0296942 A1
(43) Pub. Date: Sep. 25, 2025

(54) Phosphonate-Based Coordination Complexes and Methods of Preparation and Use Thereof

(71) Applicants: Vilmali LOPEZ-MEJIAS, San Juan, PR (US); Gabriel E. QUIÑONES VELEZ, San Juan, PR (US); Alondra A. RIVERA RAICES, San Juan, PR (US); Alexandra Paris SANTIAGO, San Juan, PR (US); Angelica F. FIGUEROA GUZMAN, San Juan, PR (US); Lesly Y. CARMONA-SARABIA, San Juan, PR (US); Andrea M. ESCALERA JOY, San Juan, PR (US); Darilys Mojica VAZQUEZ, San Juan, PR (US); Solimar Esteves VEGA, San Juan, PR (US); University of Puerto Rico, San Juan, PR (US)

(72) Inventors: Vilmali Lopez-Mejias, San Juan, PR (US); Gabriel E. Quiñones Velez, San Juan, PR (US); Alexandra Paris Santiago, San Juan, PR (US); Alondra A. Rivera Raices, San Juan, PR (US); Angelica F. Figueroa Guzman, San Juan, PR (US); Lesly Y. Carmona-Sarabia, San Juan, PR (US); Andrea M. Escalera Joy, San Juan, PR (US); Darilys Mojica Vazquez, San Juan, PR (US); Solimar Esteves Vega, San Juan, PR (US)

(21) Appl. No.: 18/707,313

(22) PCT Filed: Nov. 7, 2022
(86) PCT No.: PCT/US2022/049148

§ 371 Date: May 3, 2024

Related U.S. Application Data
(60) Provisional application No. 63/276,513, filed on Nov. 5, 2021.
(60) Provisional application No. 63/310,455, filed on Feb. 15, 2022.

(51) Int. Cl. C07F 3/04

(52) U.S. Cl. CPC C07F 3/04

(57) ABSTRACT

A coordination complex comprising a phosphonate-containing ligand molecule and a bioactive metal is provided. In one aspect, the present disclosure provides a compound comprising one or more phosphonate-containing ligand molecules and a bioactive metal, wherein each ligand is coordinated to the bioactive metal through at least one phosphonate, wherein the bioactive metal is Mg²⁺, Ca²⁺, or Zn²⁺.

### CROSS-REFERENCE TO RELATED APPLICATIONS

This application is a U.S. National Stage Entry of International Patent Application no. PCT/US2022/049148, filed Nov. 7, 2022, which claims the benefit of priority of U.S. Provisional Application No. 63/276,513, filed Nov. 5, 2021, and U.S. Provisional Application No. 63/310,455, filed Feb. 15, 2022, each of which is incorporated herein by reference in its entirety.

### FIELD

The present disclosure relates to phosphonate-based coordination complexes incorporating Ca²⁺, Mg²⁺, and Zn²⁺. The present disclosure also provides methods for preparation and use thereof.

### BACKGROUND

Cancer remains a major public health concern, being one of the leading causes of death worldwide. Among all new cancer cases recently diagnosed (18.1 M), the three most common cancers in women are breast, lung and colorectal. Of these, breast cancer alone accounts for 30% of all estimates. The highest mortality rate observed in women is primarily due to breast cancer due to its high potential to metastasize once in an advanced stage. Over 80% of patients with advanced breast cancer develop osteolytic metastases, representing a debilitating stage of the disease with very low prognoses. Clinically, osteolytic metastasis is challenging due to the rapid microarchitectural deterioration of affected site at the bone marrow, based on the altered coupling between osteoblasts and osteoclasts, all mediated by tumor-driven dysregulation. Therefore, progression of the disease relies on the dysregulation promoted by metastatic cells at the bone microenvironment, making these prominent therapeutic targets to treat osteolytic metastasis. Antiresorptive medications, such as bisphosphonates, are commonly prescribed to treat and delay the progression of breast cancer-induced osteolytic metastasis. These compounds resist enzymatic hydrolysis due to the presence of a P—C—P bond, in contrast to pyrophosphates which have a P—O—P backbone. Preclinical research has demonstrated the bisphosphonates promote anti-tumor effects via direct mechanisms, such as tumor cell apoptosis, and indirect mechanisms, such as angiogenesis and 76 T cells). However, due to the several pharmacological deficiencies that bisphosphonates present, such as poor bioavailability and low intestinal adsorption (<10%), their direct anti-tumor effects remain unclear because of the high doses required to provide the desired therapeutic effect.

Accordingly, there remains a need to develop new bisphosphonate compounds for use as therapeutic agents.

### SUMMARY

The present disclosure concerns compounds comprised of phosphonate-based coordination complexes. These complexes have the potential to be potent anticancer agents, especially with regard to osteolytic metastases, while overcoming the shortcomings of phosphonate-based compounds (e.g., zoledronic acid or risedronic acid) alone.

Accordingly, one aspect of the present disclosure is a compound comprising one or more ligand molecules bound to one or more bioactive metal ions, wherein the one or more ligand molecules is zoledronate, risedronate, or

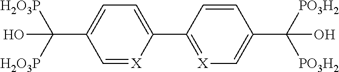

or an anionic derivative thereof, wherein X is N or C(H), and, wherein the bioactive metal is one of Mg²⁺, Ca²⁺, Zn²⁺

In another aspect, the present disclosure provides for a drug-loaded composition, comprising the compound as otherwise described herein and a drug composition, wherein the compound is provided in a crystal with a plurality of channels, and wherein the drug composition is disposed within the plurality of channels.

In another aspect, the present disclosure provides for a method for the preparation of a nanocrystalline compound, the method comprising:
admixing a solution of a ligand as otherwise described herein with a hydrophobic reagent and an emulsifier;
homogenizing the mixture;
heating the mixture to a temperature above a pre-determined phase inversion temperature; and
adding an aqueous solution of a bioactive metal to form a nanocrystalline compound with an average diameter of no more than 1000 nm.

In another aspect, the present disclosure provides for a drug-loaded composition, comprising the compound as otherwise described herein and a drug composition, wherein the compound is provided in a crystal with a plurality of channels, and wherein the drug composition is disposed within the plurality of channels.

In another aspect, the present disclosure provides for a method for treating cancer in a subject in need thereof, the method comprising administering a therapeutically effective amount of a compound or drug-loaded composition as otherwise described herein.

Other aspects of the disclosure will be apparent to those skilled in the art in view of the description that follows.

### BRIEF DESCRIPTION OF THE DRAWINGS

FIGS. 1A-1F: Polarized optical micrographs of ZOLE-based BPCCs presenting the highest quality single crystals; ZOLE-Ca form I as shown in FIG. 1A, ZOLE-Mg form I as shown in FIG. 1B, ZOLE-Zn form I as shown in FIG. 1C, ZOLE-Ca form II as shown in FIG. 1D, ZOLE-Mg form II as shown in FIG. 1E, and ZOLE-Zn form II as shown in FIG. iF.

FIG. 2: Raman spectra overlay of certain embodiments: (a) zoledronate (ZOLE) and ZOLE-based BPCCs; (b) ZOLE-Ca form I, (c) ZOLE-Ca form II, (d) ZOLE-Mg form I, (e) ZOLE-Mg form II, (f) ZOLE-Zn form I, and (g) ZOLE-Zn form II.

FIGS. 3A-3F: Representative scanning electron micrographs of single crystals and cluster for the ZOLE-based BPCCs; ZOLE-Ca form I, as shown in FIG. 3A; ZOLE-Ca form II as shown in FIG. 3B; ZOLE-Mg form I as shown in FIG. 3C; ZOLE-Mg form II as shown in FIG. 3D; ZOLE-Zn form I as shown in FIG. 3E; and ZOLE-Zn form II as shown in FIG. 3F.

FIGS. 4A-4F: Representative energy dispersive spectra for the ZOLE-based BPCCs; ZOLE-Ca form I, as shown in FIG. 4A, ZOLE-Ca form II as shown in FIG. 4B, ZOLE-Mg form I as shown in FIG. 4C, ZOLE-Mg form II as shown in FIG. 4D, ZOLE-Zn form I as shown in FIG. 4E, and ZOLE-Zn form II as shown in FIG. 4F.

FIG. 5: PXRD overlay of (a) zoledronate (ZOLE) and ZOLE-based BPCCs; (b) ZOLE-Ca form I, (c) ZOLE-Ca form II, (d) ZOLE-Mg form I, (e) ZOLE-Mg form II, (f) ZOLE-Zn form I, and (g) ZOLE-Zn form II.

FIGS. 6A-6F: Packing motifs of ZOLE-Ca form I along the b-axis as shown in FIG. 6A, ZOLE-Ca form II along the a-axis as shown in FIG. 6B, ZOLE-Mg form I along the b-axis as shown in FIG. 6C, ZOLE-Mg form II along the a-axis as shown in FIG. 6D, ZOLE-Zn form I along the b-axis as shown in FIG. 6E, and ZOLE-Zn form II along the a-axis as shown in FIG. 6F.

FIG. 7: TGA thermographs of ZOLE, ZOLE-Ca form I, ZOLE-Ca form II, ZOLE-Mg form I, ZOLE-Mg form II, ZOLE-Zn form I, and ZOLE-Zn form II coordination complexes. All thermographs were collected under the same temperature range (10-700° C.) at a heating rate of 5° C./min under N₂.

FIG. 8: Complete dissolution profile for ZOLE, ZOLE-Ca form I, ZOLE-Ca form II, ZOLE-Mg form I, ZOLE-Mg form II, ZOLE-Zn form I, and ZOLE-Zn form II in PBS for 48 h (dashed line). Extended dissolution profile for ZOLE-Zn form I up to 192 h, showing complete release of the ZOLE content.

FIG. 9: Comparison of the complete dissolution profiles in two different physiological media for ZOLE in PBS and FaSSGF, as well for ZOLE-Ca form II in PBS and FaSSGF for 36 h (dashed line).

FIGS. 10A-10C: FIG. 10A shows schematic diagram of the PIT-nano-emulsion synthesis of nano-Ca@ZOLE, showing the phase inversion at a temperature of approximately ˜12° C. (dashed line). Phase inversion starts at ˜9° C. and ends at ˜15° C. FIG. 10B shows dynamic light scattering (DLS) spectra showing average size distribution (˜150 d.nm) of nano-Ca@ZOLE nanoparticles for the three replicate syntheses. FIG. 10C shows PXRD overlay of ZOLE, ZOLE-Ca form II simulated powder pattern, ZOLE-Ca form II bulk crystals, and agglomerated nanocrystals of nano-Ca@ZOLE.

FIG. 11: DLS spectra showing the particle size distribution of nano-Ca@ZOLE after 0 h, 24 h, and 48 h in 10% FBS:PBS at 37° C.

FIG. 12: Binding curves of ZOLE (control, black) and nano-Ca@ZOLE (experimental, light blue) to HA in PBS, showing their maximum binding of 82% and 36%, respectively.

Measurements were performed in duplicate and 5% error bars were integrated.

FIGS. 13A-13C: EDS analysis of HA (control) as shown in FIG. 13A, HA-ZOLE (control) as shown in FIG. 13B, and HA-nano-Ca@ZOLE (experimental) after the binding assay completed as shown in FIG. 13C. EDS spectra includes the insertion of a schematic diagram for the proposed binding mechanism of these materials to the HA surface. The magnification used for elemental composition analysis was 10,000x in all surface measurements.

FIGS. 14A-14H: Percentage of relative cell live (% RCL) for the human breast cancer MDA-MB-231 and normal osteoblast-like hFOB 1.19 cell lines (left bar), ZOLE (middle bar), and nano-Ca@ZOLE (right bar) at concentrations of (FIGS. 14A and 14 E) 1.9, (FIGS. 14B and 14F) 3.8, (FIGS. 14C and 14G) 7.5, and (FIGS. 14D and 14F) 15 μM after 24, 48, and 72 h of treatment.

FIG. 15: Molecular structure of RISE (Actonel@, left), and acidic form of the pyridinyl BP (risedronic acid, right) employed for the design of RISE-based BPCCs.

FIG. 16: Schematic diagram of (right) the synthetic pathways leading to three crystalline phases of RISE-based BPCCs, showing coordination of risedronate (RISE) with three different bioactive metals (M²⁺=Ca²⁺Mg²⁺, and Zn²⁺) at several synthesis conditions, and (left) crystallization of the protonated form of the ligand (H-RISE). Unit cell and polarized optical micrographs of each RISE-based BPCC and H-RISE are shown in the product side of each reaction. The variables explored were pH, metal salt anion (NO₃⁻ vs Cl⁻), and addition of HEDP as auxiliary ligand.

FIG. 17: Raman spectra overlay of (a) RISE, (b) H-RISE and the RISE-based BPCCs; (c) RISE-Ca, (d) RISE-Mg, and (e) RISE-Zn.

FIGS. 18A-18D: Representative scanning electron micrographs and energy dispersive spectra for H-RISE, blue, as shown in FIG. 18A; and the RISE-based BPCCs RISE-Ca, red, as shown in FIG. 18B; RISE-Mg, green, as shown in FIG. 18C; and RISE-Zn, purple, as shown in FIG. 18D.

FIG. 19: PXRD overlay of (a) RISE, (b) H-RISE and the RISE-based BPCCs; (c) RISE-Ca, (d) RISE-Mg, and (e) RISE-Zn.

FIGS. 20A-20D: Packing motifs of H-RISE along the a-axis as shown in FIG. 20A, RISE-Ca along the α-axis as shown in FIG. 20B, RISE-Mg along the b-axis as shown in FIG. 20C, and RISE-Zn along the α-axis as shown in FIG. 20D.

FIG. 21: TGA thermographs of (a) H-RISE, (b) RISE and the RISE-based BPCCs; (c) RISE-Mg, (d) RISE-Ca, and (e) RISE-Zn. All thermographs were collected under the same temperature range (10-700° C.) at a heating rate of 5° C./min under N₂.

FIGS. 22A-22B: Complete dissolution profile of RISE, H-RISE, RISE-Ca, RISE- Mg and RISE-Zn in PBS as shown in FIG. 22A and FaSSGF for 48 h as shown in FIG. 22B.

FIGS. 23A-23C: Synthesis of nano-Ca@RISE. FIG. 23A shows diagram of the nano-Ca@RISE PIT nano-emulsion synthesis. PIT starts at ˜11° C. and ends at ˜20° C., with a resulting inversion of phases at ˜16° C. (dashed line). FIG. 23B shows dynamic Light Scattering (DLS) analysis of the resulting nanocrystals showing an average particle size distribution of ˜342 d.nm.

FIG. 23C shows PXRD overlay of RISE (black), RISE-Ca simulated powder pattern (navy blue), RISE-Ca bulk crystals, and agglomerated nanocrystals of nano-Ca@RISE (light blue).

FIG. 24: DLS spectra showing the particle size distribution of nano-Ca@RISE after 24, 48, and 72 h in 1% FBS:H₂O.

FIG. 25: Binding curves of RISE (control, black) and nano-Ca@RISE (experimental, pink) to HA in PBS, showing their maximum binding of 76% (black dashed line) and 30% (pink dashed line), respectively. Error bars for duplicate measurements fall below five percent (<5%) error.

FIGS. 26A-26H: Percentage of relative cell live (% RCL) for the human breast cancer MDA-MB-231 and normal osteoblast-like hFOB 1.19 cell lines, in green controls, RISE, and nano-Ca@RISE at concentrations of (FIGS. 26A and 26E) 35, (FIGS. 26B and 26F) 40, (FIGS. 26C and 26G) 45, and (FIGS. 26D and 26H) 50 μM after 24, 48, and 72 h of treatment.

FIG. 27: Raman spectra overlay of “as received” RISE (bottom), and H-RISE (top).

FIG. 28: Raman spectra overlay of “as received” RISE (bottom), and the synthesized RISE-Ca BPCC (top).

FIG. 29: Raman spectra overlay of “as received” RISE (bottom), and the synthesized RISE-Mg BPCC (top).

FIG. 30: Raman spectra overlay of “as received” RISE (bottom), and the synthesized RISE-Zn BPCC (top).

FIG. 31: Powder X-ray diffractogram overlay of “as received” RISE (bottom), and H-RISE (top).

FIG. 32: Powder X-ray diffractogram overlay of “as received” RISE (bottom), and the synthetized RISE-Ca BPCC (top).

FIG. 33: Powder X-ray diffractogram overlay of “as received” RISE (bottom), and the synthetized RISE-Mg BPCC (top).

FIG. 34: Powder X-ray diffractogram overlay of “as received” RISE (bottom), and the synthetized RISE-Zn BPCC (top).

FIGS. 35A-35B: Ball-stick representation of the asymmetric unit as shown in FIG. 35A and crystalline packing of H-RISE along α-axis as shown in FIG. 35B.

FIGS. 36A-36B: Ball-stick representation of the asymmetric unit as shown in FIG. 36A and crystalline packing of RISE-Ca along α-axis as shown in FIG. 36B.

FIGS. 37A-37B: Ball-stick representation of the asymmetric unit as shown in FIG. 37A and crystalline packing of RISE-Mg along b-axis as shown in FIG. 37B.

FIGS. 38A-38B: Ball-stick representation of the asymmetric unit as shown in FIG. 38A and crystalline packing of RISE-Zn along α-axis as shown in FIG. 38B.

FIG. 39: ORTEPs (atoms labeled) showing the spatial arrangement of the RISE molecules within the crystal lattice of H-RISE.

FIG. 40: ORTEPs (atoms labeled) showing the connectivity between Ca atom and RISE to form RISE-Ca.

FIG. 41: ORTEPs (atoms labeled) showing the connectivity between Mg atom and RISE to form RISE-Mg.

FIG. 42: ORTEPs (atoms labeled) showing the connectivity between Zn atom and RISE to form RISE-Zn.

FIG. 43: Simulated (bottom) and experimental (top) powder pattern overlay of H-RISE BPCC.

FIG. 44: Simulated (bottom) and experimental (top) powder pattern overlay of RISE-Ca BPCC.

FIG. 45: Simulated (bottom) and experimental (top) powder pattern overlay of RISE-Mg BPCC.

FIG. 46: Simulated (bottom) and experimental (top) powder pattern overlay of RISE-Zn BPCC.

FIG. 47: Simulated powder pattern overlay of the crystallized H-RISE within this work, and previously reported H-RISE structure.

FIG. 48: Simulated powder pattern overlay of the synthesized BPCCs from bottom to top; RISE-Ca, RISE-Mg, and RISE-Zn, and previously reported RISE metal complexes: RISE-Cd form I (POLNEK, orange),² RISE-Cd form II (POLNIO, pink),² RISE-Cu (LUVMUL01, light blue),³ and RISE-Ni (LAKPOE, navy blue).³

FIG. 49: TGA analysis of H-RISE shows an initial thermal degradation event (exp: 5.954 wt. %), attributed to the loss of water molecules from the complex (theo: 5.98 wt. %). Additionally, TGA analysis shows a low temperature (200-300° C.) weight lost (57.46 wt. %), which was attributed to the decomposition of RISE.

FIG. 50: TGA analysis of RISE-Ca BPCC shows a low temperature (100-200° C.) weight lost (exp: 10.23 wt. %), which was attributed to the evaporation of water molecules (theo: 10.65 wt. %). Additionally, another low temperature (200-400° C.) weight lost (8.199 wt. %) was observed, which was attributed to the decomposition of RISE. Subsequently at higher temperature (400-700° C.) a weight loss of 12.52 wt. % occurred, which was attributed to the degradation of calcium/calcium oxide.

FIG. 51: TGA analysis of RISE-Mg BPCC shows an initial thermal degradation event (exp: 10.36 wt. %), attributed to the loss of water molecules from the complex (theo: 10.97 wt. %). Additionally, TGA analysis shows a low temperature (250-400° C.) weight lost (17.22 wt. %) which was attributed to the decomposition of RISE. Subsequently at higher temperature (410-700° C.) a weight lost (5.602 wt. %) occurred, which was attributed to the degradation of magnesium/magnesium oxide.

FIG. 52: TGA analysis of RISE-Zn BPCC shows a low temperature (100-200° C.) weight lost (exp: 9.796 wt. %), which was attributed to the evaporation of water molecules (theo: 10.30 wt. %). Another low temperature (210-420° C.) weight lost (12.02 wt. %), which was attributed to the decomposition of RISE was observed. Subsequently, at higher temperature (430-700° C.) a weight loss of 15.977 wt. % occurred, which was attributed to the degradation of zinc/zinc oxide.

FIG. 53: Energy dispersive spectra of H-RISE displaying the presence of atoms (carbon, nitrogen, oxygen and phosphorus) present in the molecular structure of RISE.

FIG. 54: Energy dispersive spectra of RISE-Ca BPCC displaying the presence of atoms (carbon, nitrogen, oxygen and phosphorus) present in the molecular structure of the ligand (RISE) and the metal (Calcium).

FIG. 55: Energy dispersive spectra of RISE-Mg BPCC displaying the presence of atoms (carbon, nitrogen, oxygen and phosphorus) present in the molecular structure of the ligand (RISE) and the metal (Magnesium).

FIG. 56: Energy dispersive spectra of RISE-Zn BPCC displaying the presence of atoms (carbon, nitrogen, oxygen and phosphorus) present in the molecular structure of the ligand (RISE) and the metal (Zinc).

FIGS. 57A-57C: Scanning electron micrographs of H-RISE crystal clusters and single crystals at the following magnifications, FIG. 57A: ×50 magnification, and FIGS. 57B-57C: ×200 magnification.

FIGS. 58A-58C: Scanning electron micrographs of RISE-Ca single crystals at the following magnifications, FIG. 58A: ×230 magnification, and FIGS. 58A-58C: ×350 magnification.

FIGS. 59A-59C: Scanning electron micrographs of RISE-Mg crystal clusters and single crystals at the following magnifications, FIG. 59A: ×370 magnification, FIG. 59B: ×550 magnification, and FIG. 59C: ×650 magnification.

FIGS. 60A-60C: Scanning electron micrographs of RISE-Zn crystal clusters and single crystals at the following magnifications, FIGS. 60A-60B: ×400 magnification, and FIG. 60C: ×550 magnification.

FIG. 61: Absorbance spectra of RISE presenting a )max at 260 nm in PBS in the concentration range (0.01-0.12 mg/mL) employed to construct a calibration curve.

FIG. 62: Calibration curve for the quantification of RISE in PB.

FIG. 63: Absorbance spectra of RISE presenting a )max at 260 nm in FaSSGF in the concentration range (0.01-0.12 mg/mL) employed to construct a calibration curve.

FIG. 64: Calibration curve for the quantification of RISE in FaSSGF.

FIG. 65: Nano-emulsion PIT determination of an aqueous RISE solution, showing the phase inversion occurs at approximately ˜16° C. (dashed line). Depicted by the light orange region is the range for the phase inversion which starts at 11° C. and ends at 20° C.

FIG. 66: DLS spectra showing particle size distribution for each run (red, blue and green) and an average size of 385.1 d.nm (purple).

FIG. 67: DLS spectra showing particle size distribution (d. nm) for each run (red, blue and green) and an average of 371.0 d.nm (purple).

FIG. 68: DLS spectra showing particle size distribution (d. nm) for each run (red, blue and green) and an average of 269.8 d.nm (purple).

FIG. 69: DLS spectra showing particle size distribution (d. nm) for each run (red, blue and green) and an average of 74.03 d.nm (purple).

FIG. 70: DLS spectra showing particle size distribution (d. nm) for each run (red, blue and green) and an average of 104.7 d.nm (purple).

FIG. 71: DLS spectra showing particle size distribution (d. nm) for each run (red, blue and green) and an average of 112.0 d.nm (purple).

FIG. 72: Polarized optical micrograph of nano-Ca@RISE agglomerated nanocrystals mounted in a 20 m MiTeGen micro loop, observed at 20× magnification.

FIG. 73: Powder X-ray diffractogram overlay of “as received” RISE (black), RISE-Ca simulated powder pattern (navy blue), RISE-Ca bulk crystals, and nano-Ca@RISE nanocrystals (light blue).

FIG. 74: Absorbance spectra of nano-Ca@RISE presenting a λₘₐₓ at 206 nm in PBS in the concentration range (0.0005-0.006 mg/mL) employed to construct a calibration curve.

FIG. 75: Calibration curve for nano-Ca@RISE for quantification in PBS.

FIG. 76: Binding curve of RISE to HA in PBS, reaching a maximum binding of 76% in 8 days (dashed line). Error bars for duplicate measurements fall below five percent (<5%) error.

FIG. 77: Binding curve of nano-Ca@RISE to HA in PBS, reaching a maximum binding of 36% in 1 day (dashed line). Error bars for duplicate measurements fall below five percent (<5%) error.

FIGS. 78A-78C: IC₅₀ curves for RISE employing the human breast cancer MDA-MB-231 cell line at 24 h of treatment as shown in FIG. 78A, 48 h of treatment as shown in FIG. 78B, 72 h of treatment as shown in FIG. 78C.

FIGS. 79A-79C: IC₅₀ curves for RISE employing the osteoblast-like hFOB 1.19 cell line at 24 h of treatment as shown in FIG. 79A, 48 h of treatment as shown in FIG. 79B, 72 h of treatment as shown in FIG. 79C.

FIG. 80: The relative cell live percentage (% RCL) of human breast cancer MDA-MB-231 cell line treated with RISE and nano-Ca@RISE at concentrations of 35, 40, 45, and 50 μM for 24 h.

FIG. 81: The relative cell live percentage (% RCL) of human breast cancer MDA-MB-231 cell line treated with RISE and nano-Ca@RISE at concentrations of 35, 40, 45, and 50 μM for 48 h.

FIG. 82: The relative cell live percentage (% RCL) of human breast cancer MDA-MB-231 cell line treated with RISE and nano-Ca@RISE at concentrations of 35, 40, 45, and 50 μM for 72 h.

FIG. 83: The relative cell live percentage (% RCL) of osteoblast hFOB 1.19 cell line treated with RISE and nano-Ca@RISE at concentrations of 35, 40, 45, and 50 μM for 24 h.

FIG. 84: The relative cell live percentage (% RCL) of osteoblast hFOB 1.19 cell line treated with RISE and nano-Ca@RISE at concentrations of 35, 40, 45, and 50 μM for 48 h.

FIG. 85: The relative cell live percentage (% RCL) of osteoblast hFOB 1.19 cell line treated with RISE and nano-Ca@RISE at concentrations of 35, 40, 45, and 50 μM for 72 h.

FIGS. 86A-86F: SEM micrographs for BPBPA-Ca as shown in FIG. 86A, BPBPA-Zn as shown in FIG. 86B, and BPBPA-Mg as shown in FIG. 86C. All SEM micrographs were recorded employing a 5 nm thick layer of Au. Elements such as carbon, oxygen, phosphorus, calcium, zinc, and magnesium were detected by EDS analysis. These elements are part of the crystal structure of BPBPA-Ca as shown in FIG. 86D, BPBPA-Zn as shown in FIG. 86E, and BPBPA-Mg as shown in FIG. 86F.

FIGS. 87A-87B: Raman spectra as shown in FIG. 87A, and PXRD diffractograms for BPBPA, contrasted with BPBPA-Ca, BPBPA-Zn, and BPBPA-Mg as shown in FIG. 87B. All Raman spectra were recorded from 3,500 to 250 cm⁻¹ while the PXRDs were collected at 300 K in fast phi mode using a 90 s exposure.

FIGS. 88A-88B: Dissolution curve for BPBPA, BPBPA-Ca, BPBPA-Zn, and BPBPA-Mg in PBS as shown in FIG. 88A and FaSSGF at 37° C. as shown in FIG. 88B. Each experiment was performed in duplicate. Error bars are not observed due to the small coefficient of variation (% CV<5%).

FIGS. 89A-89D: FIG. 89A shows schematic diagram of the PIT nano-emulsion synthesis of nano-Ca@BPBPA. The phase inversion temperature was determined to occur at about ˜14° C.¹⁰ FIG. 89B shows DLS spectra showing the particle size distribution (˜160 d.nm) of nano-Ca@BPBPA. FIG. 89C shows polarized optical micrographs of agglomerated nano-Ca@BPBPA mounted in a 30 μm MiTeGen micro loop. FIG. 89D shows experimental PXRD overlays of BPBPA, BPBPA-Ca contrasted with nano-Ca@BPBPA.

FIGS. 90A-90D: FIG. 90A shows binding curve for BPBPA and nano-Ca@BPBPA to HA in physiological conditions (PBS, pH=7.4) at 37° C. Error bars are not observed for small coefficients of variation (% CV<5%). EDS analysis for HA as shown in FIG. 90B, HA-BPBPA as shown in FIG. 90C, and HA-nano-Ca@BPBPA was carried out at 3000× magnification as shown in FIG. 90D.

FIGS. 91A-91C: FIG. 91A shows energy dispersive spectroscopy (EDS) analysis for (i) letrozole (LET), (ii) BPBPA-Ca, (iii) drug-loaded BPBPA-Ca, and (iv) drug-loaded nano-Ca@BPBPA. FIG. 91B shows the percent % release curve of letrozole (black, control) and drug-loaded BPBPA-Ca (green, experimental) in FaSSGF (pH=1.60) at 37° C. Error bars are not observed for data points with a coefficient of variation (% CV)<5%. FIG. 91C shows comparison of TGA thermograph of letrozole, BPBPA-Ca with the drug-loaded BPBPA-Ca, and drug-loaded nano-Ca@BPBPA.

FIGS. 92A-92L: Relative cell live (% RCL) for the MCF-7, MDA-MB-231, and hFOB 1.19 cells treated with DMEM or DMEM:F12 (control, black), nano-Ca@BPBPA (control, red), letrozole (LET, control, blue), and drug-loaded nano-Ca@BPBPA (experimental, green) in concentrations of (FIG. 92A) 0.5, (FIG. 92B) 1.6, (FIG. 92C) 3.1, (FIGS. 92D, 92E and 92I) 6.3, (FIGS. 92F and 92J) 12.5, (FIGS. 92G and 92K) 25 and (FIGS. 92H and 92L) 50 μM after 24, 48, and 72 h of treatment.

FIG. 93: ¹H-NMR spectrum for the synthesized ligand, BPBPA. The experiment was performed at room temperature in D₂O, the signal of H₂O in the D₂O solvent is detected around 4.8 ppm. Signals between 7.59-7.88 ppm correspond to the symmetric aromatic hydrogens in the molecular structure of BPBPA. The ¹H-NMR spectrum for BPBPA has not been previously reported in the literature.

FIG. 94: ³¹P-NMR spectrum for the synthesized ligand, BPBPA. The experiment was performed at room temperature in D₂O. The signal corresponding to the symmetric phosphorus in the molecular structure of BPBPA appears at 16.30 ppm. The ³¹P-NMR spectrum for BPBPA has not been previously reported in the literature.

FIG. 95: ¹³C-APT NMR spectrum for the synthesized ligand, BPBPA. The experiment was performed at room temperature in D₂O. The ¹³C-APT-NMR experiment yields methine (CH) signals positive and quaternary (C) signals negative. The signals corresponding to the symmetric aromatic carbons were detected at 125.31, 126.80, 126.89, and 129.48 ppm (s, 8CH). The symmetric quaternary carbons in the molecular structure of BPBPA appear at about 135.57, 137.34, and 138.18 ppm (s, 6C). The ¹³C-APT-NMR spectrum for BPBPA has not been reported in the literature.

FIG. 96: Raman spectra for the obtained BPBPA. The Raman spectra for BPBPA was collected from 3,250 to 250 cm⁻¹.

FIG. 97: PXRD diffractogram for the obtained BPBPA. The experiment was performed in fast phi mode for powder at 300 K and 90 s of exposure time.

FIG. 98: TGA thermograph for the obtained BPBPA. The experiment was performed employing a temperature range from 25 to 700° C. at 5° C./min.

FIG. 99: Raman spectra overlay of BPBPA and BPBPA-Ca. The Raman spectra were collected from 3,250 to 250 cm⁻¹.

FIG. 100: Raman spectra overlay of BPBPA and BPBPA-Zn. The Raman spectra were collected from 3,250 to 250 cm⁻¹.

FIG. 101: Raman spectra overlay of BPBPA and BPBPA-Mg. The Raman spectra were collected from 3,250 to 250 cm⁻¹.

FIG. 102: PXRD diffractograms overlay of BPBPA and BPBPA-Ca. The experiment was performed in fast phi mode for powders using a 90 s exposure at 5° C./min.

FIG. 103: PXRD diffractograms overlay of BPBPA and BPBPA-Zn. The experiment was performed in fast phi mode for powders using a 90 s exposure at 5° C./min.

FIG. 104: PXRD diffractograms overlay of BPBPA and BPBPA-Mg. The experiment was performed in fast phi mode for powders using a 90 s exposure at 5° C./min.

FIGS. 105A-105D: The crystalline structure of BPBPA-Ca. FIG. 105A shows the asymmetric unit and packing along the α-axis as shown in FIG. 105B, b-axis as shown in FIG. 105C, and c-axis of BPBPA-Ca as shown in FIG. 105D.

FIGS. 106A-106D: The crystalline structure of BPBPA-Zn. FIG. 106A shows the asymmetric unit and packing along the α-axis as shown in FIG. 106B, b-axis as shown in FIG. 106C, and c-axis of BPBPA-Zn as shown in FIG. 106D.

FIGS. 107A-107B: The crystalline structure of BPBPA-Zn. FIG. 107A shows the asymmetric unit and Crystal packing of BPBPA-Zn showing the coordination sphere of Zn (1) as shown in FIG. 107B. The ligand binds in a tridentate mode to the Zn (1) metal center through O6, O3, and O1; the hydroxyl group participates in the coordination sphere of Zn (1). Adjacent bellow ligand coordinate in a bidentate mode the Zn (1) metal center (O2 and O5).

FIG. 108: Simulated (top, red) and experimental (black, bottom) PXRD diffractograms of BPBPA-Ca at 100 K. The simulated PXRD from the solved crystal structure is equal to the experimental PXRD of BPBPA-Ca.

FIG. 109: Simulated (top, red) and experimental (black, bottom) PXRD diffractograms of BPBPA-Ca at 100 K. The simulated PXRD from the solved crystal structure is equal to the experimental PXRD of BPBPA-Ca.

FIG. 110: TGA thermographs of BPBPA compared with BPBPA-Ca. The experiment was performed at 5° C./min in a temperature range of 25-700° C. The TGA thermograph of BPBPA-Ca indicates a low temperature (25-200° C.) weight loss of 19.66% (calculated, 20.44%) corresponding to the loss of water molecules.

FIG. 111: TGA thermographs of BPBPA compared with BPBPA-Zn. The experiment was performed at 5° C./min in a temperature range of 25-700° C. The TGA thermograph of BPBPA-Zn indicates a low temperature (25-200° C.) weight loss of 12.36% (calculated, %) corresponding to the loss of water molecules.

FIG. 112: TGA thermographs of BPBPA compared with BPBPA-Mg. The experiment was performed at 5° C./min in a temperature range of 25-700° C. The TGA thermograph of BPBPA-Mg indicates a low temperature (25-200° C.) weight loss of % (calculated, %) corresponding to the loss of water molecules.

FIGS. 113A-113D: SEM micrographs of BPBPA-Ca at 100 magnification as shown in FIG. 113A, 100 magnification as shown in FIG. 113B, 850 magnification as shown in FIG. 113C, and 1000 magnification as shown in FIG. 113D. Samples were coated with a 5 nm layer of Au prior to SEM analysis.

FIGS. 114A-114D: SEM micrographs of BPBPA-Zn at 160 magnification as shown in FIG. 114A, 300 magnification as shown in FIG. 114B, 1000 magnification as shown in FIG. 114C, and 1300 magnification as shown in FIG. 114D. Samples were coated with a 5 nm layer of Au prior to SEM analysis.

FIGS. 115A-115D: SEM micrographs of BPBPA-Mg at 250 magnification as shown in FIG. 115A, 750 magnification as shown in FIG. 1151B, 2000 magnification as shown in FIG. 115C, and 4500 magnification as shown in FIG. 115D. Samples were coated with a 5 nm layer of Au prior to SEM analysis.

FIG. 116: Energy dispersive spectroscopy (EDS) analysis for BPBPA-Ca. The EDS analysis allowed the detection of elements (carbon, oxygen, phosphorus, and calcium) in BPBPA-Ca.

FIG. 117: Energy dispersive spectroscopy (EDS) analysis for BPBPA-Zn. The EDS analysis allowed the detection of elements (carbon, oxygen, phosphorus, and zinc) in BPBPA-Zn.

FIG. 118: Energy dispersive spectroscopy (EDS) analysis for BPBPA-Mg. The EDS analysis allowed the detection of elements (carbon, oxygen, phosphorus, and magnesium) in BPBPA-Mg.

FIG. 119: Absorption spectra (200-400 nm) for the BPBPA standard solutions. The concentration range utilized for the calibration curve was from 0.05 to 0.002 mg/mL of BPBPA in PBS.

FIG. 120: Calibration curve of BPBPA in PBS. The concentration range utilized for the calibration curve is 0.05 to 0.002 mg/mL of BPBPA in PBS.

FIG. 121: The dissolution curve of BPBPA compared with BPBPA-Ca in PBS at 37° C. About 9% of BPBPA was released from the BPBPA-Ca after 72 h. The experiment was performed in duplicate.

FIG. 122: the dissolution curve of BPBPA compared with BPBPA-Zn in PBS at 37° C. About 46% of BPBPA was released from the BPBPA-Zn after 72 h. The experiment was performed in duplicate.

FIG. 123: The dissolution curve of BPBPA compared with BPBPA-Mg in PBS at 37° C. About 10% of BPBPA was released from the BPBPA-Ca after 72 h. The experiment was performed in duplicate.

FIG. 124: Absorption spectra (200-350 nm) for the BPBPA standard solutions. The concentration range utilized for the calibration curve was 0.1 to 0.004 mg/mL of BPBPA in FaSSGF.

FIG. 125: Calibration curve of BPBPA in FaSSGF. The concentration range utilized for the calibration curve was 0.1 to 0.004 mg/mL of BPBPA in FaSSGF.

FIG. 126: The dissolution curve of BPBPA compared with BPBPA-Ca in FaSSGF at 37° C. About 100% of BPBPA was released from the BPBPA-Ca after 72 h. The experiment was performed in duplicate.

FIG. 127: The dissolution curve of BPBPA compared with BPBPA-Zn in FaSSGF at 37° C. About 86% of BPBPA was released from the BPBPA-Zn after 72 h. The experiment was performed in duplicate.

FIG. 128: The dissolution curve of BPBPA compared with BPBPA-Mg in FaSSGF at 37° C. About 54% of BPBPA was released from the BPBPA-Mg after 72 h. The experiment was performed in duplicate.

FIG. 129: PIT temperature determination of BPBPA. Phase inversion begins at 10° C. and finishes at 18° C. The phase inversion occurs at ˜14° C. (dashed line). The experiment was performed in triplicate

FIG. 130: DLS spectra of the nano-Ca@BPBPA nano-emulsion, which shows the particle size distribution for run 1, run 2, and run 3 in synthesis 1.

FIG. 131: DLS spectra of the nano-Ca@BPBPA nano-emulsion, which shows the particle size distribution for run 1, run 2, and run 3 in synthesis 2.

FIG. 132: DLS spectra of the nano-Ca@BPBPA nano-emulsion, which shows the particle size distribution for run 1, run 2, and run 3 in synthesis 3

FIG. 133: DLS spectra of nano-Ca@BPBPA in 10% FBS: PBS after 0 h, showing the particle size distribution for run 1, run 2, and run 3.

FIG. 134: DLS spectra of nano-Ca@BPBPA in 10% FBS: PBS after 24 h, showing the particle size distribution for run 1, run 2, and run 3.

FIG. 135: DLS spectra of nano-Ca@BPBPA in 10% FBS: PBS after 48 h, showing the particle size distribution for run 1, run 2, and run 3.

FIG. 136: The binding curve for BPBPA (0.5 mg/mL), which shows the maximum binding (100%) reached by BPBPA to HA in 12 d. Some error bars are not observed, indicating the small coefficient of variation (% CV<5%) achieved during the experiment.

FIG. 137: The binding curve for nano-Ca@BPBPA (0.5 mg/mL), which shows the maximum binding (100%) reached by nano-Ca@BPBPA to HA in 12 d. Some error bars are not observed, indicating the small coefficient of variation (% CV<5%) achieved during the experiment.

FIG. 138: Energy dispersive spectroscopy (EDS) analysis for HA (control), which shows the presence of carbon, oxygen, phosphorus, and calcium.

FIG. 139: Energy dispersive spectroscopy (EDS) analysis for HA-BPBPA (control), which shows the presence of carbon, oxygen, phosphorus, and calcium.

FIG. 140: Energy dispersive spectroscopy (EDS) analysis for HA-nano-Ca@BPBPA (experimental), which shows the presence of carbon, oxygen, phosphorus, and calcium.

FIG. 141: Absorption spectra (200-300 nm) for BPBPA-Ca, LET, and drug-loaded BPBPA-Ca after the loading procedure. The absorption spectra was collected at 275 nm (BPBPA-Ca, black) demonstrate that this selected framework did not collapse during the LET-loading. The amount of LET remained supersaturated during the experiment.

FIG. 142: Energy dispersive spectroscopy (EDS) analysis for letrozole (LET, control) after the loading experiment, which shows the presence of carbon and nitrogen.

FIG. 143: Energy dispersive spectroscopy (EDS) analysis for BPBPA-Ca (control) after the loading experiment, which shows the presence of carbon, oxygen, phosphorus, and calcium.

FIG. 144: Energy dispersive spectroscopy (EDS) analysis for drug-loaded BPBPA-Ca (experimental) after the loading experiment, which shows the presence of carbon, oxygen, phosphorus, calcium, and nitrogen.

FIG. 145: Energy dispersive spectroscopy (EDS) analysis for drug-loaded nano-Ca@BPBPA (experimental) after the loading experiment, which shows the presence of carbon, oxygen, phosphorus, calcium, and nitrogen.

FIG. 146: TGA thermographs of unloaded BPBPA-Ca compared with letrozole (LET, black), drug-loaded BPBPA-Ca, and drug-loaded nano-Ca@BPBPA. The TGA thermographs of the drug-loaded BPBPA-Ca (24.52%) and nano-Ca@BPBPA (23.48%) show temperatures weight loss corresponding to the loss of LET encapsulated into the channels of this framework.

FIG. 147: Powder X-ray diffractograms of letrozole (LET, black), BPBPA-Ca, drug-loaded BPBPA-Ca, and drug-loaded nano-Ca@BPBPA.

FIG. 148: Absorption spectra (200-300 nm) for LET in FaSSGF. The concentration of LET employed ranges between 0.0008-0.025 mg/mL.

FIG. 149: Calibration curve for LET in FaSSGF. The concentration of LET employed for the calibration curve ranges between 0.0008-0.025 mg/mL.

FIG. 150: Release curve of letrozole (LET, black, control) compared with the drug-loaded BPBPA-Ca (red, experimental) in FaSSGF at 37° C. The experiment was performed in duplicate. Some error bars are not observed, which indicates the small coefficient of variation achieved (% CV<5%).

FIGS. 151A-151C: IC₅₀ curve for MCF-7 cell line treated with BPBPA (0-200 μM) after 24 h of treatment as shown in FIG. 151A, 48 h of treatment as shown in FIG. 151B, and 72 h of treatment as shown in FIG. 151C. The experiments were performed in triplicate. Some error bars are not observed, which indicates the small coefficient of variation achieved (% CV<5%).

FIGS. 152A-152C: IC₅₀ curve for MDA-MB-231 cell line treated with BPBPA (0-400 μM) after 24 h of treatment as shown in FIG. 152A, 48 h of treatment as shown in FIG. 152B, and 72 h of treatment as shown in FIG. 152C. The experiments were performed in triplicate. Some error bars are not observed, which indicates the small coefficient of variation achieved (% CV<5%).

FIGS. 153A-153C: IC₅₀ curve for hFOB 1.19 cell line treated with BPBPA (0-400 μM) after 24 h of treatment as shown in FIG. 153A, 48 h of treatment as shown in FIG. 153B, and 72 h of treatment as shown in FIG. 153C. The experiments were performed in triplicate. Some error bars are not observed, which indicates the small coefficient of variation achieved (% CV<5%).

FIGS. 154A-154C: IC₅₀ curve for MCF-7 cell line treated with LET (0-50 μM) after 24 h of treatment as shown in FIG. 154A, 48 h of treatment as shown in FIG. 154B, and 72 h of treatment as shown in FIG. 154C. The experiments were performed in triplicate. Some error bars are not observed, which indicates the small coefficient of variation achieved (% CV<5%).

FIGS. 155A-155C: IC₅₀ curve for MDA-MB-231 cell line treated with LET (0-200 μM) after 24 h of treatment as shown in FIG. 155A, 48 h of treatment as shown in FIG. 155B, and 72 h of treatment as shown in FIG. 155C. The experiments were performed in triplicate. Some error bars are not observed, which indicates the small coefficient of variation achieved (% CV<5%).

FIGS. 156A-156C: IC₅₀ curve for hFOB 1.19 cell line treated with LET (0-200 μM) after 24 h of treatment as shown in FIG. 156A, 48 h of treatment as shown in FIG. 156B, and 72 h of treatment as shown in FIG. 156C. The experiments were performed in triplicate. Some error bars are not observed, which indicates the small coefficient of variation achieved (% CV<5%).

FIGS. 157A-157C: Relative cell live (% RCL) for the MCF-7 cells treated with DMEM (control, black), nano-Ca@BPBPA (control, red), letrozole (LET, control, blue), and drug-loaded nano-Ca@BPBPA (experimental, green) in concentrations of 12.5 μM after 24, 48, and 72 h of treatment as shown in FIG. 157A; 25 μM after 24, 48, and 72 h of treatment as shown in FIG. 157B; and 50 μM after 24, 48, and 72 h of treatment as shown in FIG. 157C.

FIGS. 158A-158C: SEM-EDS analysis for 2,2′-BPBPA-Ca as shown in FIG. 158A, 2,2-BPBPA-Zn as shown in FIG. 158B, and 2,2′-BPBPA-Mg as shown in FIG. 158C. SEM micrographs were collected using a 5 nm thick layer of Au. Elements such as carbon, oxygen, phosphorus, nitrogen, calcium, zinc, and magnesium were detected by EDS analysis. These elements are part of the crystal structure of the 2,2′-BPBPA-based BPCCs.

FIGS. 159A-159B: FIG. 159A shows raman spectra and FIG. 159B shows PXRD diffractograms for 2,2′-BPBPA, compared with 2,2′-BPBPA-Ca, 2,2′-BPBPA-Zn, and 2,2′-BPBPA-Mg. Raman spectra were collected from 3,500 to 250 cm¹. PXRDs were accumulated at 300 K in fast phi mode using a 90 s exposure time

FIGS. 160A-160B: Dissolution curve for 2,2′-BPBPA, 2,2′-BPBPA-Ca, 2,2′-BPBPA-Zn, and 2,2′-BPBPA-Mg in PBS as shown in FIG. 160A and FaSSGF at 37° C. as shown in FIG. 160B. For a small coefficient of variation (% CV<5%) error bars are not observed.

FIGS. 161A-161C: FIG. 161A shows diagram of the PIT nano-emulsion synthesis of nano-Ca@2,2′-BPBPA. The phase inversion temperature was determined to occur at about −10° C. FIG. 161B shows DLS spectra displaying the particle size distribution (˜288 d.nm) of nano-Ca@2,2′-BPBPA. FIG. 161C shows experimental PXRD overlays of 2,2′-BPBPA, 2,2′-BPBPA-Ca associated with nano-Ca@2,2′-BPBPA.

FIGS. 162A-162E: FIG. 162A shows binding curve for 2,2′-BPBPA and nano-Ca@2,2′-BPBPA to HA in PBS at 37° C. Error bars are not observed for coefficients of variation<5%. EDS analysis for HA as shown in FIG. 162B, HA-2,2′-BPBPA as shown in FIG. 162C, and HA-nano-Ca@2,2′-BPBPA at a 3000× magnification as shown in FIG. 162D. FIG. 162E shows PXRD diffractograms for 2,2′-BPBPA and HA compared with HA-2,2′-BPBPA and HA-nano-Ca@2,2′-BPBPA.

FIGS. 163A-163C: FIG. 163A shows energy dispersive spectroscopy (EDS) analysis for (i) letrozole (LET), (ii) 2,2′-BPBPA-Ca, (iii) drug-loaded 2,2′-BPBPA-Ca, and (iv) drug-loaded nano-Ca@2,2′-BPBPA. FIG. 163B shows TGA thermograph of letrozole and 2,2′-BPBPA-Ca compared with the drug-loaded 2,2′-BPBPA-Ca, and drug-loaded nano-Ca@2,2′-BPBPA. FIG. 163C shows the percent % release curve of letrozole (black, control) and drug-loaded 2,2′-BPBPA-Ca (green, experimental) in FaSSGF (pH=1.60) at 37° C. Error bars are not observed for data points with a coefficient of variation<5%.

FIGS. 164A-164L: Relative cell live (% RCL) for the MCF-7, MDA-MB-231, and hFOB 1.19 cells treated with DMEM or DMEM:F12 (control, black), nano-Ca@2,2′-BPBPA (control, red), letrozole (LET, control, blue), and drug-loaded nano-Ca@2,2′-BPBPA (experimental, green) in concentrations of (FIGS. 164A, 164E and 164I) 6.3, (FIGS. 164B, 164F and 164J) 12.5, (FIGS. 164C, 164G and 164K) 25 and (FIGS. 164D, 164H and 164L) 50 μM after 24, 48, and 72 h of treatment.

FIG. 165: ¹H-NMR spectrum of 2,2′-BPBPA. The experiment was conducted at room temperature in D₂O. The chemical shifts (6) around 4.8 ppm corresponds to D₂O the solvent.

FIG. 166: ³¹P-NMR spectrum of 2,2′-BPBPA. The experiment was conducted at room temperature in D₂O. The signal corresponding to the symmetric phosphorus in the molecular structure of 2,2′-BPBPA appears at 16.67 ppm.

FIG. 167: ¹³C-APT NMR spectrum of 2,2′-BPBPA. The experiment was conducted at room temperature in D₂O. The 13C-APT-NMR depicts methine (CH) as positive signals, and quaternary (C) as negative signals.

FIG. 168: Raman spectra of the 2,2′-BPBPA collected from 3,250 to 250 cm⁻¹.

FIG. 169: PXRD diffractogram of 2,2′-BPBPA. The experiment was performed using the fast phi mode for powders at 300 K and with a 90 s exposure.

FIG. 170: TGA thermograph of 2,2′-BPBPA. The experiment was performed using a temperature range starting at 25 to 700° C. at 5° C./min.

FIG. 171: Raman spectra overlay of 2,2′-BPBPA and 2,2′-BPBPA-Ca. The Raman spectra were recorded from 3,250 to 250 cm⁻¹.

FIG. 172: Raman spectra overlay of 2,2′-BPBPA and 2,2′-BPBPA-Zn. The Raman spectra were recorded from 3,250 to 250 cm⁻¹.

FIG. 173: Raman spectra overlay of 2,2′-BPBPA and 2,2′-BPBPA-Mg. The Raman spectra were recorded from 3,250 to 250 cm⁻¹.

FIG. 174: Diffractograms of 2,2′-BPBPA contrasted with 2,2′-BPBPA-Mg. The experiment was performed in fast phi mode for powders (90 s) at 5° C./min.

FIGS. 175A-175D: The crystalline structure of 2,2′-BPBPA-Ca depicting the asymmetric unit as shown in FIG. 175A and packing along the α-axis as shown in FIG. 175B, b-axis as shown in FIG. 175C, and c-axis of 2,2′-BPBPA-Ca as shown in FIG. 175D.

FIG. 176: TGA thermographs of 2,2′-BPBPA compared with 2,2′-BPBPA-Ca. The experiment was performed at 5° C./min in a temperature range of 25-700° C.

FIG. 177: TGA thermographs of 2,2′-BPBPA compared with 2,2′-BPBPA-Zn. The experiment was performed at 5° C./min in a temperature range of 25-700° C.

FIG. 178: TGA thermographs of 2,2′-BPBPA compared with 2,2′-BPBPA-Mg. The experiment was performed at 5° C./min in a temperature range of 25-700° C.

FIGS. 179A-179B: SEM micrographs of 2,2′-BPBPA-Ca at 1900× magnification as shown in FIGS. 179A and 3700× magnification as shown in FIG. 179B, respectively. Samples were coated with a 5 nm layer of Au prior to SEM analysis.

FIGS. 180A-180B: SEM micrographs of 2,2′-BPBPA-Zn at 160× magnification as shown in FIGS. 180A and 500× magnification as shown in FIG. 180B, respectively. Samples were coated with a 5 nm layer of Au prior to SEM analysis.

FIGS. 181A-181B: SEM micrographs of 2,2′-BPBPA-Mg at 1200× magnification as shown in FIGS. 181A and 1500× magnification as shown in FIG. 181B, respectively. Samples were coated with a 5 nm layer of Au prior to SEM analysis.

FIG. 182: EDS analysis for 2,2′-BPBPA-Ca. The EDS allowed the detection of characteristic elements (carbon, nitrogen, oxygen, phosphorus, and calcium) in 2,2′-BPBPA-Ca.

FIG. 183: EDS analysis for 2,2′-BPBPA-Zn. The EDS allowed the detection of characteristic elements (carbon, nitrogen, oxygen, phosphorus, and zinc) in 2,2′-BPBPA-Zn.

FIG. 184: EDS analysis for 2,2′-BPBPA-Mg. The EDS allowed the detection of characteristic elements (carbon, nitrogen, oxygen, phosphorus, and magnesium) in 2,2′-BPBPA-Mg.

FIG. 185: Calibration curve of 2,2′-BPBPA in PBS. The concentration range utilized for the calibration curve is 0.050 to 0.0016 mg/mL.

FIG. 186: Dissolution curve of 2,2′-BPBPA compared to 2,2′-BPBPA-Ca in PBS at 37° C. About 13% of 2,2-BPBPA was released from the 2,2′-BPBPA-Ca after 72 h. The experiment was performed in duplicate.

FIG. 187: The dissolution curve of 2,2-BPBPA compared to 2,2′-BPBPA-Zn in PBS at 37° C. About 8% of 2,2′-BPBPA was released from the 2,2′-BPBPA-Zn after 72 h. The experiment was performed in duplicate.

FIG. 188: The dissolution curve of 2,2′-BPBPA compared to 2,2′-BPBPA-Mg in PBS at 37° C. About 10% of 2,2′-BPBPA was released from the 2,2′-BPBPA-Ca after 72 h. The experiment was performed in duplicate.

FIG. 189: Calibration curve of 2,2′-BPBPA in FaSSGF. The concentration range utilized for the calibration curve was 0.050 to 0.0016 mg/mL of 2,2′-BPBPA in FaSSGF.

FIG. 190: Dissolution curve of 2,2′-BPBPA compared to 2,2′-BPBPA-Ca in FaSSGF at 37° C. About 89% of 2,2′-BPBPA was released from the 2,2′-BPBPA-Ca after 72 h.

The experiment was performed in duplicate.

FIG. 191: Dissolution curve of 2,BPBPA compared to 2,2′-BPBPA-Zn in FaSSGF at 37° C. About 84% of 2,2′-BPBPA was released from the 2,2′-BPBPA-Zn after 72 h.

The experiment was performed in duplicate.

FIG. 192: Dissolution curve of 2,2′-BPBPA compared to 2,2′-BPBPA-Mg in FaSSGF at 37° C. About 64% of 2,2′-BPBPA was released from the 2,2′-BPBPA-Mg after 72 h.

The experiment was performed in duplicate.

FIG. 193: PIT curves of 2,2′-BPBPA. Phase inversion starts at 6° C. and ends at 14° C. The phase inversion occurs at ˜10° C. (dashed line).

FIG. 194: DLS spectra of the nano-Ca@2,2′-BPBPA nano-emulsion demonstrate the particle size distribution performed in triplicate in synthesis 1.

FIG. 195: DLS spectra of the nano-Ca@2,2′-BPBPA nano-emulsion demonstrate the particle size distribution performed in triplicate in synthesis 2.

FIG. 196: DLS spectra of the nano-Ca@2,2′-BPBPA nano-emulsion demonstrate the particle size distribution performed in triplicate in synthesis 3.

FIG. 197: DLS spectra of nano-Ca@2,2′-BPBPA in 10% FBS:PBS after 0 h, showing the particle size distribution performed in triplicate.

FIG. 198: DLS spectra of nano-Ca@2,2′-BPBPA in 10% FBS:PBS after 24 h, showing the particle size distribution performed in triplicate.

FIG. 199: DLS spectra of nano-Ca@2,2′-BPBPA in 10% FBS:PBS after 48 h, showing the particle size distribution performed in triplicate.

FIG. 200: The binding curve for 2,2′-BPBPA (0.5 mg/mL) shows the maximum binding (99%) reached by 2,2′-BPBPA to HA in 12 d. For a small coefficient of variation (% CV<5%), error bars are not observed.

FIG. 201: The binding curve for nano-Ca@2,2′-BPBPA (0.5 mg/mL) shows the maximum binding (95%) reached by nano-Ca@2,2′-BPBPA to HA in 12 d. For a small coefficient of variation (% CV<5%), error bars are not observed.

FIG. 202: EDS analysis for HA (control), showing the presence of carbon, oxygen, phosphorus, and calcium.

FIG. 203: EDS analysis for HA-2,2′-BPBPA (control), showing the presence of carbon, oxygen, phosphorus, and calcium.

FIG. 204: EDS analysis for HA-nano-Ca@2,2′-BPBPA (experimental), showing the presence of carbon, oxygen, phosphorus, and calcium.

FIG. 205: After the loading experiment, EDS analysis for letrozole (LET, control) showed carbon and nitrogen detection.

FIG. 206: After the loading experiment, EDS analysis for 2,2′-BPBPA-Ca (control) showed the carbon, oxygen, phosphorus, and calcium detection.

FIG. 207: After the loading experiment, EDS analysis for drug-loaded 2,2′-BPBPA-Ca (experimental) showed carbon, oxygen, phosphorus, calcium, and nitrogen detection.

FIG. 208: EDS analysis for drug-loaded nano-Ca@2,2′-BPBPA (experimental) showed the presence of carbon, oxygen, phosphorus, calcium, and nitrogen after the loading experiment.

FIG. 209: TGA thermographs of unloaded 2,2′-BPBPA-Ca (red) compared to letrozole (LET, black), drug-loaded 2,2′-BPBPA-Ca, and drug-loaded nano-Ca@2,2′-BPBPA. The TGA thermographs of the drug-loaded 2,2′-BPBPA-Ca (24.52%) and nano-Ca@2,2′-BPBPA (23.48%) show temperatures weight loss corresponding to the loss of LET encapsulated into the channels of this framework.

FIG. 210: Calibration curve for LET in FaSSGF. The concentration of LET employed for the calibration curve ranges between 0.0008-0.025 mg/mL.

FIGS. 211A-211C: IC₅₀ curve for MCF-7 cell line treated with 2,2′-BPBPA (0-200 μM) after 24 h of treatment as shown in FIG. 211A, 48 h of treatment as shown in FIG. 211B, and 72 h of treatment as shown in FIG. 211C. The experiments were performed in triplicate. For a small coefficient of variation (% CV<5%), error bars are not observed.

FIGS. 212A-212C: IC₅₀ curve for MDA-MB-231 cell line treated with 2,2-BPBPA (0-400 μM) after 24 h of treatment as shown in FIG. 212A, 48 h of treatment as shown in FIG. 212B, and 72 h of treatment as shown in FIG. 212C. The experiments were performed in triplicate. For a small coefficient of variation (% CV<5%), error bars are not observed.

FIGS. 213A-213C: IC₅₀ curve for hFOB 1.19 cell line treated with 2,2′-BPBPA (0-400 μM) after 24 h of treatment as shown in FIG. 213A, 48 h of treatment as shown in FIG. 213B, and 72 h of treatment as shown in FIG. 213C. The experiments were performed in triplicate. For a small coefficient of variation (% CV<5%), error bars are not observed.

FIG. 214: Scheme summarizing the synthetic pathways leading to six crystalline phases of ZOLE-based BPCCs, showing coordination of zoledronate (ZOLE) with three different bioactive metals (M²⁺=Ca²⁺Mg²⁺, and Zn²⁺) at several synthesis conditions.

### DETAILED DESCRIPTION

Various bisphosphonate-type compounds are used clinically. Among clinically utilized bisphosphonates, alendronate, risedronate (RISE) and ibandronate present lower therapeutic efficacy compared to zoledronate (ZOLE). ZOLE is a last generation bisphosphonate which exhibits the most potent and prolonged osteoclast antiresorptive activity. At the present, an optimal regimen for ZOLE against bone-related disease and osteolytic metathesis is not known.

This is because most of the drug undergoes renal clearance, reaching a maximum plasma concentration of 1 [M. This concentration is 10-100 times lower than the concentration required to kill cancer cell in vitro. Several attempts have been carried out to employ ZOLE to design effective therapies against bone-related diseases. However, these research approaches have focused mainly on the labeling efficiency of ZOLE to beta emitters, adsoption to hydroxyapatite, biodistribution, and cytotoxicity through in vitro assays employing prostate, lung and liver cancerous cells. As such, there is little research focused on the potential of ZOLE-based therapies to treat osteolytic metastasis, such as that induced by breast cancer. Similarly, Different metal ions such as Cd²⁺, Cu²⁺, Mg²⁺, Ni²⁺, Pb²⁺ and Zn²⁺ have been employed to form coordination complexes (CCs) with RISE. However, these reports focus mainly on structural properties of the materials, applications for sensing, electronics and therapies for non-bone related diseases. The development of a phosphonate-based therapy that can selectively treat breast cancer-induced osteolytic metastasis remains an important challenge.

Bisphosphonates define a class of drugs widely indicated since the 1990s to treat osteoporosis both in men and women. Their effectiveness in treating osteoporosis and other conditions is related to their ability to inhibit bone resorption. FDA-approved indications for bisphosphonates include treatment of osteoporosis in postmenopausal women, osteoporosis in men, glucocorticoid-induced osteoporosis, hypercalcemia of malignancy, Paget disease of the bone, and malignancies with metastasis to the bone. Non-FDA-approved indications include the treatment of osteogenesis imperfecta in children as well as adults and the prevention of glucocorticoid-induced osteoporosis.

As described herein, zoledronate is the anionic form of zolidronic acid, for example the zwitterionic monoanionic form, comprising a protonated imidazolium group, or a dianionic form. Both zoledronate, zoledronic acid, and salts thereof are referred to herein as ZOLE. Zoledronic acid is available commercially as a treatment for osteoporosis (Reclast®, available from Novartis), and has the formula:

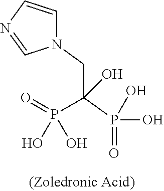 [SMILES: O=P(O)(O)C(O)(Cn1ccnc1)P(=O)(O)O]

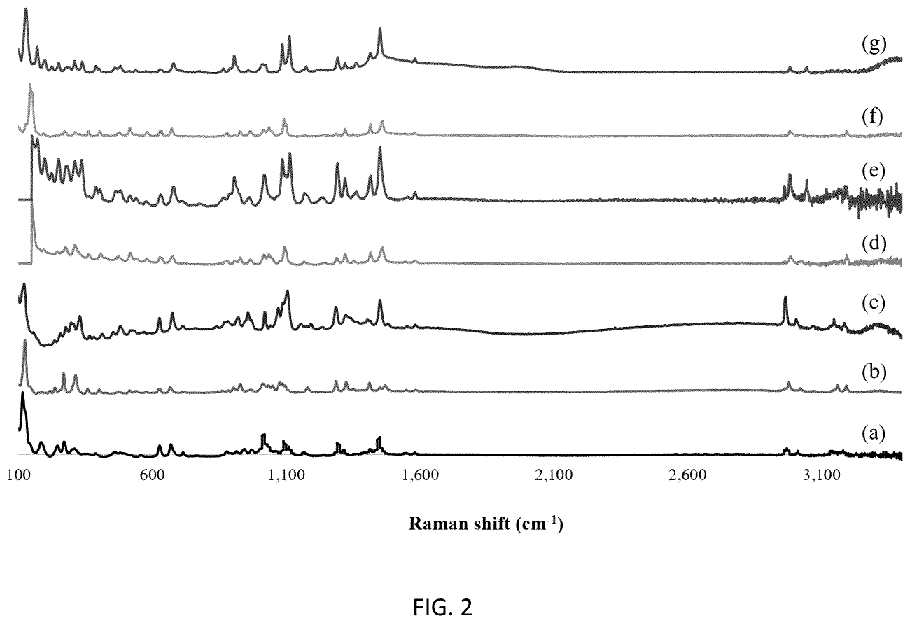

As described herein, RISE is utilized as bioactive ligand for the reaction with three different bioactive metals (M²⁺=Ca²⁺, Mg²⁺ and Zn²⁺) to form RISE-based BPCCs (FIG. 2) with the potential to treat OM. The ability of the resulting crystalline materials to be employed for biomedical applications was assessed through determination of their structural and thermal stability, as well their degradation in different physiological media. Moreover, a phase inversion temperature (PIT)-nano-emulsion synthesis allowed to efficiently reduce the crystal size of a selected RISE-based BPCC to the nano-range, thus resulting in the formation of nano-Ca@RISE.

Several biomedical properties of the nanomaterial were determined, which included its aggregation behavior in biological relevant media, binding affinity to HA crystals, and cytotoxicity against both triple-negative breast cancer cells that metastasize to the bone (MDA-MB-231) and normal osteoblast cells (hFOB 1.19). This study is intended to expand the therapeutic potential of RISE by the design of BPCCs, specifically nano-Ca@RISE, and provide evidence of the nanomaterial as a promising approach to treat and prevent breast-cancer-induced OM.

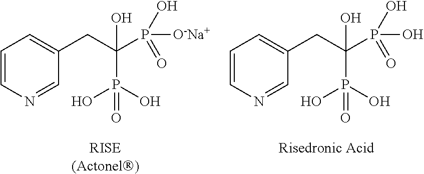

The compounds as otherwise described herein can also be used as drug delivery systems, such as in a drug-loaded composition. Such systems can be employed to reduce the side effects of free active pharmaceutical ingredients, control the release of cargo drug molecules, and target cancer-related diseases selectively. Coordination complexes (CCs) such as metal-organic frameworks (MOFs) have become promising candidates as DDSs due to their well-defined structures, tunable pore size, high surface area, high drug loading/release, amphiphilic internal microenvironment, and controlled pH-dependent degradation under physiological conditions.^{12,13} These materials have been employed as nanocarriers for intracellular delivery of chemotherapeutic agents such as doxorubicin, cisplatin, and 5-fluorouracil (5-FU). Specifically, 5-FU (7-30%) was loaded into IRMOF-10 and UiO-67 frameworks, both MOFs are formed by 1,1′-biphenyl-4,4′-dicarboxylic acid (BPDC, Scheme 1, left) coordinated with Zn²⁺ metals clusters. These MOFs demonstrate a pH-dependent degradation and a complete controlled-release of 5-FU (˜90%) in physiological conditions. In addition, CCs based on BPs such as alendronic (ALEN) and zoledronic (ZOLE) acids were explored recently, demonstrating a suitable pH-dependent degradation, bone affinity (e.g., nano-Ca@ZOLE to hydroxyapatite, 36%, 1 d), and cytotoxicity (e.g., nano-Ca@ZOLE, % RCL=55+1% at 3.8 μM in 72 h) against MDA-MB-231 cell line. However, these BPs-based CCs did not lead to porous crystalline materials.^{17,18} As described herein, BP analogues of BPDC are synthesized, allowing the design of porous extended bisphosphonate-based coordination complexes (BPCCs); with bone affinity, able to encapsulate antineoplastic drugs into the BPCCs channels and release the cargo in a pH-dependent manner.

As described above, the main bone target groups employed to treat OM include anti-resorptive agents such as bisphosphonates (BPs). BPs are small-molecule analogues to pyrophosphates (P—O—P) containing a P—C—P backbone that facilitates their affinity to Ca²⁺ ions in the bone matrix. The hydroxyl group in the geminal carbon (P—C(OH)—P) allows BPs to increase their binding to the bone microenvironment. BPs can inhibit bone resorption, increase bone mineral density, and interrupt the activity of the cancerous cells reducing tumor growth. Pamidronic, alendronic, zoledronic, and risedronic acids are common BPs drugs employed to treat OM. However, BPs are poorly absorbed and present a small plasma half-life; only 1-10% of the administered drug can reach the systemic circulation showing about 1-2 h of half-life. Treatments involving BPs usually require high concentration doses leading to several side effects on patients; this disadvantage restricts the application of BPs in breast cancer-induced OM treatments.^{8,9,10} The present study intends to design porous extended bisphosphonate-based coordination complexes as platforms for drug delivery systems (DDSs) aimed to treat and prevent OM.

DDSs can be employed to reduce the side effects of free active pharmaceutical ingredients, control the release of cargo drug molecules, and target cancer-related diseases selectively. Coordination complexes (CCs) such as metal-organic frameworks (MOFs) have become promising candidates as DDSs due to their well-defined structures, tunable pore size, high surface area, high drug loading/release, amphiphilic internal microenvironment, and controlled pH-dependent degradation under physiological conditions.¹²¹³ These materials have been employed as nanocarriers for intracellular delivery of chemotherapeutic agents such as doxorubicin, cisplatin, and 5-fluorouracil (5-FU). Specifically, 5-FU (7-30%) was loaded into IRMOF-10 and UiO-67 frameworks, both MOFs are formed by 1,1′-biphenyl-4,4′-dicarboxylic acid (BPDC, Scheme 1, left) coordinated with Zn²⁺ metals clusters.^{15,16} These MOFs demonstrate a pH-dependent degradation and a complete controlled-release of 5-FU (˜90%) in physiological conditions.¹⁶ In addition, CCs based on BPs such as alendronic (ALEN) and zoledronic (ZOLE) acids were explored recently, demonstrating a suitable pH-dependent degradation, bone affinity (e.g., nano-Ca@ZOLE to hydroxyapatite, 36%, 1 d), and cytotoxicity (e.g., nano-Ca@ZOLE, % RCL=55+1% at 3.8 μM in 72 h) against MDA-MB-231 cell line. However, these BPs-based CCs did not lead to porous crystalline materials. As described herein, the BP analogue of BPDC I synthesized, allowing the design of porous extended bisphosphonate-based coordination complexes (BPCCs); with bone affinity, able to encapsulate antineoplastic drugs into the BPCCs channels and release the cargo in a pH-dependent manner.

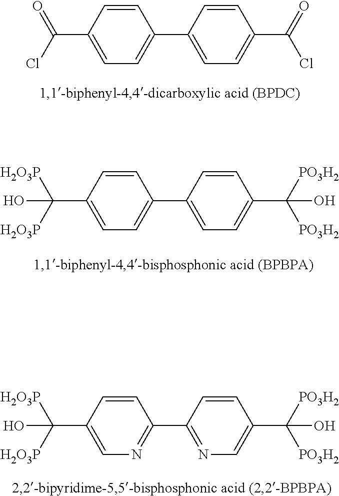

Scheme 1. Molecular structures of 1,1′-biphenyl-4,4′-dicarboxylic acid (BPDC, left) and its bisphosphonate analogue, 1,1′-biphenyl-4,4′-bisphosphonic acid (BPBPA, middle), and bipyridine analoge, 2,2′-bipyridine-5,5′-bisphosphonic acid (2,2′-BPBPA, right).

The organic ligand 1,1′-biphenyl-4,4′-bisphosphonic acid was, for the first time, synthesized (BPBPA, Scheme 1, middle) and coordinated with bioactive metal (Ca²⁺, Zn²⁺, and Mg²⁺) to achieve new 3D porous extended BPBPA-based BPCCs. It was expected that the resulting materials might bind to the bone microenvironment due to the high affinity of the P—C—P backbone of BPBPA for Ca²⁺ ions. In addition, the hydroxyl groups in the geminal carbon (P—C(OH)—P) of this BP can provide BPBPA-based BPCCs with higher bone affinity. These bioactive metals (LD₅₀=0.35 (Ca²⁺), 1.0 (Zn²⁺), and 8.1 (Mg²⁺) g/kg) were selected due to their role in several physiological processes, specifically, osteoblastic bone formation and mineralization processes. The crystalline phases of these unique BPBPA-based BPCCs obtained here were investigated in terms of their structure, pH-dependent degradation, bone affinity, and cytotoxicity to gain insights into their potential as DDSs, with bone affinity, able to encapsulate and release antineoplastic drugs to treat and prevent breast cancer-induced OM.

Additionally, the organic ligand 2,2-bipyridine-5,5′-bisphosphonic acid was reacted with bioactive metals as described. The combination was found to produce new 3D porous extended 2,2′-BPBPA-based BPCCs as well, and displayed the ability for drug loading as well as hydroxyapatite binding.

Accordingly, one aspect of the present disclosure is a compound comprising one or more ligand molecules bound to one or more bioactive metal ions, wherein:
the one or more ligand molecule is:
   zoledronate;
   risedronate;

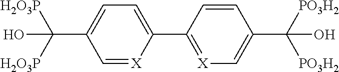

or an anionic derivative thereof, wherein X is N
or C(H); and
the one or more bioactive metal ion is one of Mg²⁺, Ca²⁺, or Zn²⁺ For example, in particular embodiments the bioactive metal is one of Mg²⁺ or Ca²⁺ (e.g., Ca²⁺).

As otherwise described herein, the compound comprises one or more ligand molecules coordinated to the one or more bioactive metals. In certain embodiments, each ligand molecule is coordinated to a bioactive metal ion through at least one phosphonate. In particular embodiments, the bioactive metal (e.g., each bioactive metal of the compound) is coordinated by 1-6 ligand molecules. For example, in certain embodiments, the bioactive metal is coordinated by 1-5 ligand molecules, e.g., 2-4 ligand molecules, or 2-3 ligand molecules. In embodiments wherein the ligand molecule further comprises a hydroxyl group, in some such embodiments the bioactive metal ion may be further coordinated through the hydroxyl group.

The bioactive metal and ligand molecule can be present in various stoichiometric ratios. In certain embodiments as otherwise described herein, the bioactive metal and ligand molecule are present in a 1:1, 2:1, or 3:1 stoichiometric ratio. In embodiments wherein the ligand molecule is zoledronate or risedronate, the bioactive metal and ligand may be present in a 1:1 or 2:1 ratio, for example, a 1:1 ratio. In other embodiments, wherein the ligand molecule is BPBPA or 2,2′-BPBPA, the bioactive metal and ligand may be present in a 3:1 or 2:1 ratio, for example, a 3:1 ratio.

The ligand molecules as described herein have several possible coordination modes that can be utilized. In the present invention, ligand molecule is coordinated to the bioactive metal through at least one phosphonate. In certain embodiments as otherwise described herein, the bioactive metal is coordinated by at least one ligand molecule in a bidentate matter, wherein two phosphonate groups of a single ligand molecule are coordinated to the bioactive metal. For example, in certain embodiments the bioactive metal can be coordinated by two ligand molecules, each in a bidentate manner. In other embodiments, the bioactive metal can be coordinated by three ligand molecules, wherein the bioactive metal is coordinated to one ligand molecule in a bidentate manner and two ligand molecules each in a monodentate manner.

The ligand molecules as described herein can also function as a bridging ligand, wherein each phosphonate binds in a monodentate manner to neighboring bioactive metals. In embodiments wherein the ligand molecule is BPBPA or 2,2′-BPBPA, the ligand molecule can function as a bridging ligand while binding in a monodendate or bidentate manner to neighboring bioactive materials. Accordingly, in some embodiments as otherwise described herein, each monodentate ligand molecule links the bioactive metal to a neighboring bioactive metal. In particular embodiments, the bioactive metal and neighboring bioactive metal are crystallographically equivalent.

When ligand molecule acts as a bridging molecule, it can be used to construct repeating structures, such as one-dimensional chains, or two-dimensional or three-dimensional frameworks. In certain embodiments as otherwise described herein, the bioactive metal and ligand molecule together form a one-dimensional chain (i.e., a chain formed from covalent and/or coordination bonds). For example, in particular embodiments wherein the ligand molecule is risedronate or zoledronate, the bioactive metal and ligand molecule do not form a covalent two-dimensional or three-dimensional framework, for example, do not form a metal-organic framework. In other embodiments, wherein the ligand molecule is BPBPA or 2,2′-BPBPA, the bioactive metal and ligand molecule form a covalent two-dimensional or three-dimensional framework, for example, form a metal-organic framework.

In certain embodiments as otherwise described herein, the ligand molecule is risedronate or zoledronate and the ligand molecule carries an overall monoanionic charge or an overall dianionic charge. For example, in particular embodiments, the ligand molecule is zwitterionic, and comprises an imidazolium group or pyridinium group and two phosphonate groups. In other embodiments, the ligand molecule is BPBPA or 2,2′-BPBPA and each ligand molecule carries a tetraanionic or trianionic charge.

The bioactive metal can be coordinated with molecules besides the ligand molecule. For example, in various embodiments as otherwise described herein, the bioactive metal is coordinated by at least one water molecule, or comprises at least one lattice water molecule. For example, there may be 1-3 unbound lattice water molecules, per bioactive metal. In particular embodiments, the bioactive metal is coordinated by 1-3 water molecules. For example, in certain embodiments the bioactive metal is coordinated by two water molecules, for example, apical water molecules.

The compounds as otherwise described herein form particular crystal modes that are believed to be beneficial to therapeutic properties. Thus, the compound can be provided in crystals, wherein the crystals are made up of the compound as otherwise described herein with at least 90% purity (e.g., at least 95% purity, or at least 99% purity).

One major aspect is the size of the crystals, which, in general, can be provided in the micron size range or nano size range. Accordingly, in certain embodiments as otherwise described herein, the compound is provided in crystals with an average diameter of no more than 500 m. For example, in particular embodiments, the compound is provided in crystals with an average diameter in the range of 50 m to 500 m, e.g., 50 m to 400 m, or 50 m to 300 m.

In other embodiments, the compound is provided in smaller crystals in the nanometer size range. Accordingly, in certain embodiments as otherwise described herein, the compound is provided in crystals with an average diameter of no more than 1000 nm. For example, in particular embodiments, the compound is provided in crystals with an average diameter of no more than 900 nm, e.g., no more than 800 nm, or 700 nm, or 600 nm, or 500 nm, or 400 nm, or 300 nm, or 250 nm. In certain embodiments as otherwise described herein, the compound is provided in crystals with an average diameter of at least 20 nm, e.g., at least 30 nm, or 40 nm, or 50 nm, or 60 nm, or 70 nm, or 80 nm, or 90 nm, or 100 nm.

The crystals prepared according to the present disclosure possess advantageously low polydispersity. Accordingly, in certain embodiments as otherwise described herein, the compound is provided in a collection of crystals with a polydispersity index of no more than 0.600, or no more than 0.500. For example, in particular embodiments, the compound is provided in a collection of crystals with a polydispersity index in the range of 0.100 to 0.600, e.g., 0.100 to 0.600, or 0.100 to 0.500, or 0.100 to 350, or 0.100 to 300, or 0.100 to 0.250. Polydispersity can be measured by the person of skill in the art, for example using dynamic light scattering.

A common issue with suspended particles is the tendency to agglomerate over time.

Solution stability is important for utilization of the compounds as described herein, so that prepared solutions or suspensions maintain the desired properties during production, transport, and/or storage. Accordingly, in certain embodiments as otherwise described herein, the compound is provided in a collection of crystals, wherein the collection of crystals exhibits an increase in average diameter of no more than 50% after suspension in cell media for 48 hours. For example, in particular embodiments, the collection of crystals exhibits an increase in cell diameter of no more than 40%, e.g., no more than 30%, after suspension in cell media for 48 hours.

As discussed herein, the compounds of the present disclosure crystallize in distinct crystalline polymorphs. Without wishing to be bound by theory, it is presently believed that higher crystallization in higher symmetry space groups promotes stability (Lin, S. K., Correlation of Entropy with Similarity and Symmetry. J. Chem. Inf Comput. Sci. 36(3), 367-376). Accordingly, in certain embodiments as otherwise described herein, the compound crystallizes in a space group with at least monoclinic symmetry. For example, in particular embodiments, the compound is provided in crystals with monoclinic or orthorhombic symmetry (e.g., crystals with orthorhombic symmetry).

As known in the art, such polymorphs can be distinguished by reflections observed using single-crystal or powder x-ray diffraction. Accordingly, in certain embodiments as otherwise described herein, the ligand molecule is zoledronate, and the compound forms a crystal polymorph characterized in that is provides a powder X-ray diffraction pattern comprising four or more peaks selected from one of the following sets (2θ±0.1 degrees):
(a) 12.4, 13.1, 14.7, 17.5, 20.9, 23.5, 31.5, 36.3;
(b) 8.2, 9.3, 11.6, 19.5, 23.2, 26.7;
(c) 12.5, 15.4, 17.3, 17.4, 17.7, 20.8, 22.6, 24.7, 28.7, 31.4, 38.1;
(d) 8.6, 10.8, 12.4, 19.2, 25.3, 28.8;
(e) 12.4, 15.1, 17.3, 20.8, 24.5, 28.4, 31.4; or
(f) 8.5, 10.8, 12.4, 18.6, 25.0, 28.8.

For example, in particular embodiments, the compound forms a crystal polymorph characterized in that is provides a powder X-ray diffraction pattern comprising four or more peaks selected from sets (a), (e), (e), or (f), e.g., from sets (a), b), or (f), or from sets (a) or (b), or from set (b).

In other embodiments as otherwise described herein, the ligand molecule is risedronate, and the compound forms a crystal polymorph characterized in that is provides a powder X-ray diffraction pattern comprising four or more peaks selected from one of the following sets (2θ±0.1 degrees):
(g) 7.9, 10.6, 11.7, 18.7, 28.7, 31.5;
(h) 9.6, 14.3, 15.5, 17.5, 20.9, 22.7, 29.2, 31.1, 34.2; and
(i) 6.3, 10.9, 12.6, 14.4, 19.5, 20.4, 24.9, 27.5, 29.4, 30.6.

For example, in particular embodiments, the compound forms a crystal polymorph characterized in that is provides a powder X-ray diffraction pattern comprising four or more peaks selected from sets (g) or (h), e.g., from set (g).

In other embodiments as otherwise described herein, the ligand molecule is BPBPA, and the compound forms a crystal polymorph characterized in that is provides a powder X-ray diffraction pattern comprising four or more peaks selected from one of the following sets (2θ±0.1 degrees):
(j) 7.5, 8.4, 10.1, 12.4, 15.2, 17.1, 25.1, 26.8, 27.9, 33.2;
(k) 7.2, 9.1, 11.8, 16.9, 18.1, 23.3, 29.1, 29.6, 35.1; and
(1) 6.7, 9.9, 11.5, 13.7, 16.9, 25.8, 26.6.

For example, in particular embodiments, the compound forms a crystal polymorph characterized in that is provides a powder X-ray diffraction pattern comprising four or more peaks selected from sets (j) or (k), e.g., from set (j).

In other embodiments as otherwise described herein, the ligand molecule is 2,2′-BPBPA, and the compound forms a crystal polymorph characterized in that is provides a powder X-ray diffraction pattern comprising four or more peaks selected from one of the following sets (2θ±0.1 degrees):
(m) 7.8, 8.6, 10.1, 16.6, 18.7, 21.3, 28.6, 31.8;
(n) 10.9, 13.1, 15.2, 18.3, 23.9, 26.4, 28.8, 36.1; and
(o) 8.7, 11.4, 13.4, 16.6, 18.4, 20.6, 24.7, 30.7.

For example, in particular embodiments, the compound forms a crystal polymorph characterized in that is provides a powder X-ray diffraction pattern comprising four or more peaks selected from sets (m) or (n), e.g., from set (m).

As appreciated in the art, crystals may also be characterized by unit cell parameters. Accordingly, in certain embodiments as otherwise described herein, the ligand molecule is zoledronate, and the compound forms a crystal characterized in unit cell of parameters:

| | (i) | (ii) | (iii) | (iv) | (v) | (vi) |
|---|---|---|---|---|---|---|
| a (Å, ± 0.1) | 7.4 | 10.2 | 7.4 | 5.0 | 7.4 | 5.0 |
| b (Å, ± 0.1) | 9.0 | 20.9 | 8.4 | 16.4 | 8.4 | 16.4 |
| c (Å, ± 0.1) | 9.5 | 22.5 | 9.7 | 14.4 | 9.7 | 14.4 |
| α (°, ± 0.1) | 105.7 | 90 | 105.2 | 90 | 105.3 | 90 |
| β (°, ± 0.1) | 108.7 | 90 | 111.4 | 93.2 | 111.2 | 93.5 |
| γ (°, ± 0.1) | 97.9 | 90 | 97.1 | 90 | 97.4 | 90 |

In other embodiments as otherwise described herein, the ligand molecule is risedronate, and the compound forms a crystal characterized in unit cell of parameters: vii viii ix

| | (vii) | (viii) | (ix) |
|---|---|---|---|
| a (Å, ±0.1) | 5.1 | 13.2 | 8.2 |
| b (Å, ±0.1) | 16.6 | 5.2 | 28.3 |
| c (Å, ±0.1) | 15.2 | 19.0 | 10.1 |
| α (°, ±0.1) | 90 | 90 | 90 |
| β (°, ±0.1) | 95.0 | 104.5 | 149.0 |
| γ (°, ±0.1) | 90 | 90 | 90 |

In other embodiments as otherwise described herein, the ligand molecule is BPBPA, and the compound forms a crystal characterized in unit cell of parameters:

| | (x) | (xi) |
|---|---|---|
| a (Å, ±0.1) | 11.0 | 5.4 |
| b (Å, ±0.1) | 11.9 | 9.6 |
| c (Å, ±0.1) | 13.1 | 12.2 |
| α (°, ±0.1) | 87.5 | 88.2 |
| β (°, ±0.1) | 76.7 | 88.7 |
| γ (°, ±0.1) | 78.7 | 85.9 |

In other embodiments as otherwise described herein, the ligand molecule is 2,2′-BPBPA, and the compound forms a crystal characterized in unit cell of parameters:

| | (xii) | (xiii) |
|---|---|---|
| a (Å, ±0.1) | 10.9 | 6.4 |
| b (Å, ±0.1) | 11.6 | 10.3 |
| c (Å, ±0.1) | 13.0 | 10.4 |
| α (°, ±0.1) | 90.3 | 96.7 |
| β (°, ±0.1) | 103.9 | 103.3 |
| γ (°, ±0.1) | 104.7 | 98.7 |

In various embodiments as described herein, the ligand molecule is

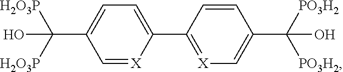

or an anionic derivative thereof, wherein each X is N or each X is C(H). For example, in certain embodiments, the ligand molecule is

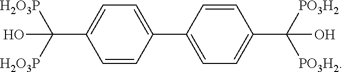

In other embodiments, the ligand molecule is

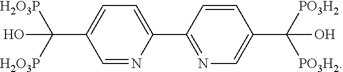

In some of such embodiments, the ligand molecule binds the bioactive metal in a bidentate or tridentate manner through at least one phosphonate group and at least one hydroxyl group of the ligand molecule.

In another aspect, the present disclosure provides for a compound having the structure

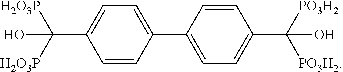

In various embodiments, the ligand molecule may be in its acidic form (i.e., fully protonated form), or in an deprotonated form. The ligand molecules as described herein are capable of multiple deprotonations. Accordingly, in embodiments describing the ligand molecule, all protonation states are included unless otherwise explicitly stated, and drawn protons should be viewed as optional unless otherwise explicitly stated. For example, the ligand molecules may be neutral, monoanionic, dianionic, trianionic, tetraanionic, pentaanionic, or hexaanionic as appropriate.

Advantageously, certain crystal polymorphs as described herein are porous in that they exhibit well-defined channels within the crystal structure. As synthesized, the channels may contain a solvent, and optionally may be evacuated through means known in the art. In certain embodiments as otherwise described herein, the compounds is provided in a crystal form that further comprises channels, wherein the channels have a width and height each of at least 5 Å. For example, in particular embodiments, the channels have a width and height each of at least 6 Å, or at least 7 Å, or at least 8 Å. In various embodiments, the channels have at least one of a height or width that is greater than 10 Å. In some embodiments, the channels have a width and height each of no more than 25 Å, or no more than 20 Å.

Advantageously, it has been found that various compounds as described herein have an affinity for hydroxyapatite. As known in the art, natural bone material contains hydroxyapatite, or a modified form thereof Accordingly, binding of hydroxyapatite may aid in the treatment of bone-related diseases. Accordingly, in various embodiments as otherwise described herein, the compound binds hydroxyapatite. For example, in various embodiments, the compound binds hydroxyapatite in an amount greater than the ligand alone. Methods of determining hydroxyapatite binding are known in the art, and further disclosed herein. In particular embodiments, the compound binds hydroxyapatite in PBS solution in an amount of at least 50% after 5 days, e.g., at least 60% after 5 days, or at least 70% after 5 days.

The present inventors have surprisingly determined a method of synthesizing nanocrystalline compounds with excellent crystalline attributes. Accordingly, in another aspect, the present disclosure provides for a method preparing a nanocrystalline compound, the method comprising:
admixing a solution of a ligand molecule with a hydrophobic reagent and an emulsifier; homogenizing the mixture;
heating the mixture to a phase inversion temperature characteristic of the mixture; and adding to the mixture an aqueous solution of a bioactive metal to form a nanocrystalline compound with an average diameter of no more than 1000 nm.

The solution of ligand molecule can be in the form of a suitable salt, such as sodium or potassium salt, or as a neutral acid. In certain embodiments, the solution of ligand molecule is an aqueous solution.

In certain embodiments as otherwise described herein, the hydrophobic reagent can be any reagent suitably immiscible with water, such as an unsubstituted alkane. Suitable examples of hydrophobic reagents include hexane, heptane, octane and isomers thereof The emulsifier employed can be any suitable emulsifier or surfactant known in the art. In various embodiments as otherwise described herein, the emulsifier is a polyoxyethylene fatty ether, for example that sold as Brij® L4.

In certain embodiments as otherwise described herein, the phase inversion temperature is in the range of −5° C. to 20° C., for example in the range of 0° C. to 20° C., or 5° C. to 15° C. The phase inversion temperature can be determined by monitoring the conductivity of the solution, and is dependent on the ingredients of the mixture, such as the identity of the hydrophobic reagent.

The method as otherwise described herein forms a nanocrystalline compound. For example, in particular embodiments, the nanocrystalline compound is provided in crystals with an average diameter of no more than 900 nm, e.g., no more than 800 nm, or 700 nm, or 600 nm, or 500 nm, or 400 nm, or 300 nm, or 250 nm. In certain embodiments as otherwise described herein, the nanocrystalline compound is provided in crystals with an average diameter of at least 20 nm, e.g., at least 30 nm, or 40 nm, or 50 nm, or 60 nm, or 70 nm, or 80 nm, or 90 nm, or 100 nm.

In embodiments wherein the crystal contains channels, a drug-loaded composition may be prepared. Accordingly, in one aspect, the present disclosure provides for a drug-loaded composition comprising the compound as otherwise described herein and a drug composition, wherein the compound is provided in a crystal with a plurality of channels, and wherein the drug composition is disposed within the plurality of channels. Any suitable small-molecule drug may be loaded into the crystal channels. For example, in certain embodiments, the drug composition comprises a drug for the treatment of breast cancer, e.g., letrozole.

In various embodiments, the drug-loaded composition may be prepared by a method comprising providing the compound as otherwise described herein, and contacting the compound with a solution of a drug composition.

The bis-phosphonate-based coordination complexes may advantageously possess increased thermal stability compared to the free ligand. For example, all zoledronate-based coordination complexes disclosed herein presented higher thermal stability compared to ZOLE, as a result from the presence of coordination bonds and extensive intermolecular hydrogen bonding within their crystal lattices. The dissolution of the ZOLE-based BPCCs was compared to that of ZOLE, to assess the structural stability of these materials in two different simulated physiological media (PBS and FaSSGF). All ZOLE-based coordination complexes surprisingly presented lower dissolution and equilibrium solubility than ZOLE (60-85%, in 18-24 h) in PBS, thus remaining coordinated for a longer period when in contact with the neutral physiological condition.

Meanwhile, the dissolution profile of the selected BPCC model ZOLE-Ca form II in FaSSGF, revealed a higher dissolution and equilibrium solubility (88% in 1 h) in acidic physiological media when compared to PBS (83% in 24 h). These results suggest the ability of these materials to release the drug content (ZOLE) in a controlled and pH-dependent manner. The PIT-nano-emulsion method decreased the crystal size of ZOLE-Ca form II significantly, from a micron-range (˜200 μm) to a nano-range (˜150 d.nm), thus resulting in nano-Ca@ZOLE. The particle size decrease of nano-Ca@ZOLE presents several advantages towards the therapeutic applications of this coordination complex, potentiating it use as a nanocrystals-based therapy. Furthermore, the aggregation behavior of the nano-Ca@ZOLE in 10% FBS:PBS was investigated, which provided a further assessment of the potential of this nanomaterial to be employed for drug delivery. Nano-Ca@ZOLE presents a low aggregation behavior in biological relevant conditions, after O, 24 and 48 h of being synthesized. These results provide insights about the potential of the nanocrystals to maintain their particle size when in contact with different biological serum-like components without forming larger aggregates, possibly avoiding excretion through phagocytosis mechanisms during cellular uptake. Moreover, the binding affinity of this nanomaterial to the bone microenvironment was addressed to provide insights about its potential to bind to HA, thus possibly enabling localized therapeutic effects at the metastatic site. Results showed that nano-Ca@ZOLE binds ˜2.5x more (36%) to HA than ZOLE (15%) in 1 day, demonstrating that it can bind to the main constituent of the bone microenvironment at the metastatic site with higher affinity. This, along with the dissolution results, suggests the use of nanocrystals to sustaining higher blood plasma concentrations of the drug and degrading selectively at the metastatic site. Furthermore, the cytotoxicity of nano-Ca@ZOLE was compared to that of ZOLE against the human breast cancer MDA-MB-231 and normal osteoblast-like hFOB 1.19 cell lines. Results demonstrated significant cell growth inhibition for nano-Ca@ZOLE against the cancerous model after 72 h of treatment, specifically at a concentration of 3.8 μM (% RCL=55±1%). At this concentration, the nanocrystals did not present cytotoxicity against the normal osteoblastic cells (% RCL=100±2%). These results demonstrate the potential of this nanomaterial to treat cancerous cells that are prone to metastasize with minimal cell death in a model representing healthy tissue at the bone microenvironment. These important outcomes provide evidence that nano-ZOLE-based coordination complexes possess viable properties regarding structure, dissolution, stability, binding, and cytotoxicity, to render them suitable for therapy, including treatment of osteolytic metastases.

The present inventors have surprisingly determined that coordination complexes incorporating bis-phosphonate ligand molecules and a bioactive metal possess certain advantageous properties, including anticancer activity. In another aspect, the present disclosure provides for a method for treating a disease in a subject in need thereof, the method comprising administering a therapeutically effective amount of a compound comprising a bioactive metal and ligand molecule, for example the compound as otherwise described herein.

Examples of suitable disease for use according to the present invention include osteoporosis, glucocorticoid-induced osteoporosis, Paget's disease, Duchenne muscular dystrophy, and cancer. For example, in various embodiments as otherwise described herein, the disease is cancer. In particular embodiments, the cancer is metastatic cancer. Examples of suitable cancers include breast cancer-induced metastases, lung cancer-induced metastases, prostate cancer-induced metastases, multiple myeloma, chrondrosarcoma, Ewing sarcoma, and osteosarcoma. In particular embodiments, the cancer is a breast cancer-induced metastasis.

The compound described herein can be administered orally or intraveneously in dosage unit formulations containing conventional non-toxic pharmaceutically acceptable carriers, adjuvants and vehicles. The pharmaceutical compositions described herein can be in a form suitable for oral use, for example, as tablets, troches, lozenges, aqueous or oily suspensions, dispersible powders or granules, emulsion, hard or soft capsules, or syrups or elixirs.

Compositions intended for oral use can be prepared according to any method known in the art for the manufacture of pharmaceutical compositions and such compositions can contain one or more agents selected from the group consisting of sweetening agents, flavoring agents, coloring agents and preservative agents in order to provide pharmaceutically elegant and palatable preparations. Tablets contain the active ingredient in admixture with non-toxic pharmaceutically acceptable excipients that are suitable for the manufacture of tablets. These excipients can be for example, inert diluents, such as calcium carbonate, sodium carbonate, lactose, calcium phosphate or sodium phosphate; granulating and disintegrating agents, for example, corn starch, or alginic acid; binding agents, for example starch, gelatin or acacia, and lubricating agents, for example magnesium stearate, stearic acid or talc. The tablets can be uncoated or they can be coated by known techniques, for example with an enteric coating. In some cases such coatings can be prepared by known techniques to delay disintegration and absorption in the gastrointestinal tract and thereby provide a sustained action over a longer period. For example, a time delay material such as glyceryl monostearate or glyceryl distearate can be employed.

Formulations for oral use can also be presented as hard gelatin capsules, wherein the active ingredient is mixed with an inert solid diluent, for example, calcium carbonate, calcium phosphate or kaolin, or as soft gelatin capsules wherein the active ingredient is mixed with water or an oil medium, for example peanut oil, liquid paraffin or olive oil. Formulations for oral use can also be presented as lozenges.

Aqueous suspensions contain the active materials in admixture with excipients suitable for the manufacture of aqueous suspensions. Such excipients are suspending agents, for example sodium carboxymethylcellulose, methylcellulose, hydropropyl-methylcellulose, sodium alginate, polyvinylpyrrolidone, gum tragacanth and gum acacia; dispersing or wetting agents can be a naturally-occurring phosphatide, for example, lecithin, or condensation products of an alkylene oxide with fatty acids, for example polyoxyethylene stearate, or condensation products of ethylene oxide with long chain aliphatic alcohols, for example heptadecaethyleneoxycetanol, or condensation products of ethylene oxide with partial esters derived from fatty acids and a hexitol such as polyoxyethylene sorbitol monooleate, or condensation products of ethylene oxide with partial esters derived from fatty acids and hexitol anhydrides, for example polyethylene sorbitan monooleate. The aqueous suspensions can also contain one or more preservatives, for example ethyl, or n-propyl p-hydroxybenzoate, one or more coloring agents, one or more flavoring agents, and one or more sweetening agents, such as sucrose or saccharin.

The methods of the present disclosure involve the administration of an effective dose of the compound as otherwise described herein to a subject in need thereof. In certain embodiments as otherwise described herein, the cysteamine can be administered in an amount ranging 0.1 mg/kg to 400 mg/kg. For example, in certain embodiments, the compound can be administered in an amount ranging from 1 mg/kg to 300 mg/kg. In other embodiments, the compound can be administered in amount ranging from 10 mg/kg to 200 mg/kg.

In certain embodiments as otherwise described herein, the dose of compound as otherwise described herein can be administered one or more times per day, such as one time per day, two times per day, three, four, or six times per day. In certain embodiments as otherwise described herein, compound as otherwise described herein is administered for any suitable period of time. For example, the compound as otherwise described herein can be administered for a period of at least three weeks, or a period of 4-6 weeks, or for a period of at least 4 weeks, 6 weeks, 8 weeks, 12 weeks, or at least 24 weeks.

### EXAMPLES

The Examples that follow are illustrative of specific embodiments of the disclosure, and various uses thereof. They are set forth for explanatory purposes only, and should not be construed as limiting the scope of the disclosure in any way.

### Zoledronate (ZOLE)

Materials: Calcium nitrate tetrahydrate (Ca(NO₃)₂·4H₂O, 99% pure), calcium chloride dihydrate (CaCl₂·2H₂O, USP grade), zinc nitrate hexahydrate (Zn(NO₃)₂·6H₂O, 98% pure), zinc chloride anhydrous (ZnCl₂, >98% pure), magnesium nitrate hexahydrate (Mg(NO₃)₂·6H₂O, 99% pure), magnesium chloride anhydrous (MgCl₂, >98% pure), and etidronic acid 60% aqueous solution (HEDP) were purchased from Sigma-Aldrich (St. Louis, MO). Zoledronic acid monohydrate (C₅H₁₀N₂O₇P₂·H₂O) was acquired from TCI America (St. Portland, OR). Any pH adjustments were obtained using a stock solution of sodium hydroxide (NaOH, USP grade, 0.3 M). Nanopure water was used as solvent in all syntheses. Phosphate buffered saline tablets, from Sigma Aldrich (St. Louis, MO), were used to make phosphate buffered saline (PBS) solutions (pH=7.4). Hydrochloric acid (HCl, 37%) and sodium chloride (NaCl, ACS reagent>99.0% pure) from Sigma-Aldrich (St. Louis, MO) were used to prepare fasted-state simulated gastric fluid (FaSSGF) solutions (pH=1.60). Heptane (CH₃(CH₂)₅CH₃) and Brij® L4 ((C₂₀H₄₂O₅)ₙ, average Mn −362 g/mol) from Sigma-Aldrich (St. Louis, MO), were used to prepare the emulsion for the phase inversion temperature (PIT) determination and nano-emulsion synthesis of nano-Ca@ZOLE. Fetal bovine serum (FBS, mammalian and insect cell culture tested) from Sigma-Aldrich (St. Louis, MO), was used for the particle size distribution and aggregation tendency measurements of nano-Ca@ZOLE. Hydroxyapatite (Ca₅(OH)(PO₄)₃, synthetic powder) from Sigma-Aldrich (Milwaukee, WI) was utilized to carry out the binding assays of nano-Ca@ZOLE. Human breast cancer MDA-MB-231 cell line (ATCC® HTB-26™, Manassas, VA), normal osteoblast-like hFOB 1.19 cell line (ATCC® CRL-11372™, Manassas, VA), Dulbecco's Modified Eagle's Medium (DMEM) from Sigma-Aldrich (Milwaukee, WI), 1:1 mixture of Ham's F-12 Medium/Dulbecco's Modified Eagle's Medium (1:1 DMEM:F-12) and geneticin (G418) from Bioanalytical Instruments (San Juan, PR), penicillin-streptomycin (Pen-Strep) from Sigma-Aldrich (St. Louis, MO), and AlamarBlue® from Bio-Rad (Kidlington, Oxford) were employed to investigate effects on cell proliferation of ZOLE and nano-Ca@ZOLE.

General hydrothermal synthesis procedure: The hydrothermal syntheses of ZOLE-based BPCCs were carried out by preparing solutions of the ligand (ZOLE) and the metal salt independently in nanopure water at room temperature. If required, 0.3 M NaOH was added to the ligand solution for pH adjustment above several of the principal species pKa's (pH=1.23 -4.40). HEDP was added in some cases as an auxiliary ligand to decrease the pH below the pKa's of the principal ligand zoledronate (ZOLE). The metal salt solution was added to the ligand solution with a syringe and mixed thoroughly. The formation of metal hydroxides was avoided by adjusting the pH of the resulting solution below the M(OH)ₙ precipitation pH. Heat was applied to the resulting mixture until crystals appeared. Nucleation induction times varied between minutes to hours. Once crystals were visually detected, vials were removed from heat and left undisturbed to let the crystals grow. The product was collected by vacuum filtration and air-dried.

Raman microscopy: Raman spectra were recorded in a Thermo Scientific DXR Raman microscope, equipped with a 780 nm laser, 400 lines/nm grating, and 50 m slit. Spectra were collected at room temperature over a range of 3,400 and 100 cm¹ by averaging 32 scans with exposures of 5 sec. OMNIC for Dispersive Raman software version 9.2.0 was employed for data collection and analysis.

Scanning electron microscopy-energy dispersive spectroscopy (SEM-EDS): X-ray microanalysis was conducted in a JEOL JSM-6480LV scanning electron microscope with an energy dispersive X-ray analysis (EDAX) Genesis 2000 detector. Micrographs were recorded with the same instrument, employing an Evenhart Thomley secondary electron imagining (SEI) detector. SEM samples were coated with a 5-10 nm gold layer with a gold sputtering target (10 s), employing a PELCO® SC-7 Auto Sputter Coater coupled with a PELCO® FTM-2 Film Thickness Monitor. Images were taken under high vacuum mode with an acceleration voltage of 20 kV, an electron beam of 11 mm width, with a spot size value of 36 and SEI signal.

Powder X-ray diffraction (PXRD): Powder diffractograms were collected in transmission mode (100 K) using a Rigaku XtaLAB SuperNova X-ray diffractometer with a micro-focus Cu-Kα radiation (λ=1.5417 Å) source and equipped with a HyPix3000 X-ray detector (50 kV, 1 mA). Powder samples were mounted in MiTeGen micro loops using paratone oil. Powder diffractograms were collected between 6-600 with a step of 0.01° using the Gandalfi move experiment. Data was analyzed within CrystAllis^{PRO} software v. 1.171.3920a.

Single crystal X-ray diffraction (SC-XRD): Crystals were observed under the microscope using polarized light to assess their quality. Optical micrographs were recorded with a Nikon Eclipse Microscope LV100NPOL, equipped with a Nikon DS-Fi2 camera and NIS Elements BR software version 4.30.01. Suitable single crystals were mounted using paratone oil in MiTeGen micro loops for structure elucidation. Structural elucidation was performed in a Bruker AXS SMART APEX-II single crystal diffractometer equipped with a Monocap collimator and APEX-II CCD detector with a Mo-Kα (λ=0.71073 Å) radiation source operating at 50 kV and 40 mA. Data collection was carried out at 100 K using an Oxford Cryosystems Cryostream 700 cooler.

Other crystal structures (ZOLE-Ca forms I and II, ZOLE-Mg forms I and II, and ZOLE-Zn form II) were collected with a Rigaku XtaLAB SuperNova single micro-focus Cu-Kα radiation (λ=1.5417 Å) source equipped with a HyPix3000 X-ray detector in transmission mode operating at 50 kV and 1 mA within the CrystAllis^{PRO} software v. 1.171.3920a. Data collection was carried out at 100 K using an Oxford Cryosystems Cryostream 800 cooler. All crystal structures were solved by direct methods. Refinement was performed using full-matrix least squares on F² within the Olex2 software v1.2. All non-hydrogen atoms were anisotropically refined.

Thermogravimetric analysis (TGA): TGA of ligand and coordination complexes were recorded in a Q500 (TA Instruments Inc.). Profile consisted of a temperature range of 10 -700° C. at 5° C./min under a N₂ gas purge (60 mL/min). For all measurements, −10 mg of powder sample was thermally treated. Data was processed with TA Universal Analysis software version 4.3 Å.

Dissolution rate measurements: Dissolution profiles were performed via direct quantification by measuring absorbance at 208 nm. Rate measurements were recorded for the reagent grade ZOLE, ZOLE-Ca forms I and II, ZOLE-Mg forms I and II, ZOLE-Zn forms I and II in PBS, against a reagent blank. For ZOLE and ZOLE-Ca form II, dissolution measurements were performed in fasted-state simulated gastric fluid (FaSSGF). Dissolution tests were performed in 100 mL of PBS (pH=7.4) or FaSSGF (pH=1.6) buffers at 37° C. under constant stirring at 150 rpm, for 48 h (PBS) or 36 h (FaSSGF). Absorbance measurements were performed on an Agilent Technologies Cary Series UV-Vis Spectrophotometer, Cary 100 UV-Vis model; using the UV Cary Scan software version v.20.0.470. All measurements were performed with a 400-200 nm scan.

Determination of the phase inversion temperature (PIT) and PIT-nano-emulsion synthesis: To reduce particle size, a PIT-nano-emulsion method was employed during synthesis of a selected BPCC, specifically ZOLE-Ca form II. The PIT temperature was determined by measuring the conductivity of an aqueous emulsion containing ZOLE in heptane (oil phase) and Brij® L4 (surfactant) during a temperature profile (2-40° C. at 1° C./min). After homogenizing the emulsions, conductivity measurements started at 2° C. with an O/W micro-emulsion. As the emulsion was heated, a phase inversion occurred from oil in water (0/W, conductive) micro-emulsion to water in oil (W/O, not conductive) nano-emulsion.

Nano-emulsion synthesis of nano-Ca@ZOLE was conducted in a Crystalline™ (Technobis, Crystallization Systems, Alkmaar, Netherlands). Pre-homogenized emulsions (ZOLE, heptane, Brij® L4) prepared for PIT determination were used to perform nano-Ca@ZOLE nano-emulsion synthesis. The emulsion was homogenized before being transferred to a reaction vial and placed in a first reactor at a temperature of 5° C. and 1,250 rpm for 30 min. After 30 min, the reaction vial was transferred to a second reactor at 45° C. and 1,250 rpm. The emulsion was stirred for 30 min before heating to a reaction temperature of 85° C. Subsequently, the metal salt solution was added with a syringe and left undisturbed for 30 min. Once completed, the reaction vial was left undisturbed for 30 min before analyzing the supernatant from the aqueous phase using dynamic light scattering (DLS).

Dynamic light scattering (DLS) and aggregation tendency measurements: Samples resulting from nano-emulsion synthesis of nano-Ca@ZOLE were analyzed in a Malvern Panalytical Zetasizer NanoZS equipped with a He—Ne orange laser (633 nm, max 4 mW) (Spectris PLC, Surrey, England). Data was analyzed with Malvern software version 7.12. Aliquots of 50 L of the supernatant from the aqueous phase were transferred to disposable polystyrol/polystyrene cuvettes (REF: 67.754 10×10×45 mm) (Sarsted, Germany), in a 1:20 dilution ratio with 10% FBS in PBS. The refractive index of ZOLE in water was found to be 1.333. This value was determined by measuring an aliquot of 2.5 mg/mL ZOLE stock solution with a Mettler Toledo Refracto 30GS (Mettler Toledo, Columbus, OH).

For aggregation tendency measurements, 50 L aliquots of the supernatant from the water phase were transferred into disposable polystyrol/polystyrene cuvettes in a 1:20 dilution ratio with 10% FBS in PBS. The prepared sample was let stand undisturbed near the Zetasizer for 30 min prior to the measurements. Size measurements were performed in the dispersant after O, 24 and 48 h of sample preparation. Sample equilibration inside the instrument at room temperature (25° C.) was performed for 2 min before measurements.

Hydroxyapatite (HA) binding assay: For the binding assay of nano-Ca@ZOLE, 20 mg of hydroxyapatite (HA) were exposed to 3 mL of a nano-Ca@ZOLE in PBS solution (0.5 mg/mL), for 0-11 days at 37° C. As control groups, nano-Ca@ZOLE and HA, both in PBS, were employed. As a comparative method, the binding assay for ZOLE “as received” was performed employing the same parameters as for the nanocrystals. For the experimental groups (HA-nano-Ca@ZOLE and HA-ZOLE), collection was performed in duplicate. Samples were collected each day for 11 consecutive days. After each time point, supernatant was collected and centrifuged (1,500 rpm, 8 min). Absorbance measurements were performed at 208 nm (λₘₐₓ) to determine the percentage of ZOLE and nano-Ca@ZOLE bound to HA. Solid samples of HA, HA-ZOLE, and HA-nano-Ca@ZOLE were characterized by EDS.

Cell culture methods: The MDA-MB-231 cell line was cultured in DMEM, 1% Pen-Strep, and 10% FBS at 37° C. in 5% CO₂. The hFOB 1.19 cell line was cultured in 1:1 DMEM:F-12, 0.3 mg/mL G418, and 10% FBS at 34° C. in 5% CO₂. Cell passages were performed weekly at 80% of cell confluency, and media was exchanged twice a week.

Cell treatments: Both cell lines were treated with ZOLE (control) and nano-Ca@ZOLE (experimental). First, to determine the half-maximal inhibitory concentration (IC₅₀) two-fold serial dilutions of ZOLE (0-200 μM) were prepared. Both cell lines (MDA-MB-231 and hFOB 1.19) were seeded in 96 well plates at 2.5×105 cell/mL. The cells were incubated for 24 h at 37° C. (MDA-MB-231) and 34° C. (hFOB 1.19), respectively. After an initial incubation period, both cell lines were treated with 100 μL of the ZOLE solutions previously prepared, and incubation was performed for 24, 48, and 72 h at the respective incubation temperatures. For both cell lines, media (MDA-MB-231: DMEM, Pen-Strep and hFOB 1.19: DMEM, F-12, G418) were used with control groups. AlamarBlue® assay was utilized to determine cell proliferation; for this, 10% of AlamarBlue® solution in PBS was prepared. Finally, media was removed from the 96 well plates, 100 μL of 10% AlamarBlue® solution was added, and the cells were incubated for 4 h at the conditions previously set forth herein. After the AlamarBlue® assay, fluorescence (λ_{exc}=560 nm, m=590 nm) was evaluated employing an Infinite M200 PRO Tecan Microplate Reader. Live cells were assessed comparing viability of the control group (100%) with cells treated with the ZOLE solutions. The nonlinear regression method using Graph Pad Prism 8 was applied to fit the dose-response curves (% cell live vs concentration) and determined the IC₅₀ values for ZOLE.

The percentage of relative cell live (% RCL) for ZOLE (control) and nano-Ca@ZOLE (experimental) were investigated at selected concentrations (1.9, 3.8, 7.5, and 15 μM) in both cell lines. Treatments at these concentrations were carried out at 24, 48, and 72 h for ZOLE and nano-Ca@ZOLE. The cell seeding and AlamarBlue® assay were completed as described above for IC₅₀ determination in both cell lines. Graph Pad Prism 8 was utilized to plot the % RCL found at concentrations of 1.9, 3.8, 7.5, and 15 μM after 24, 48, and 72 h of treatment. All experiments were performed in triplicates and the data was statistically treated using mean, standard deviation, and the coefficient of variation percentage (% CV).

### Example 1: Phase Selection of ZOLE-Based Coordination Complexes

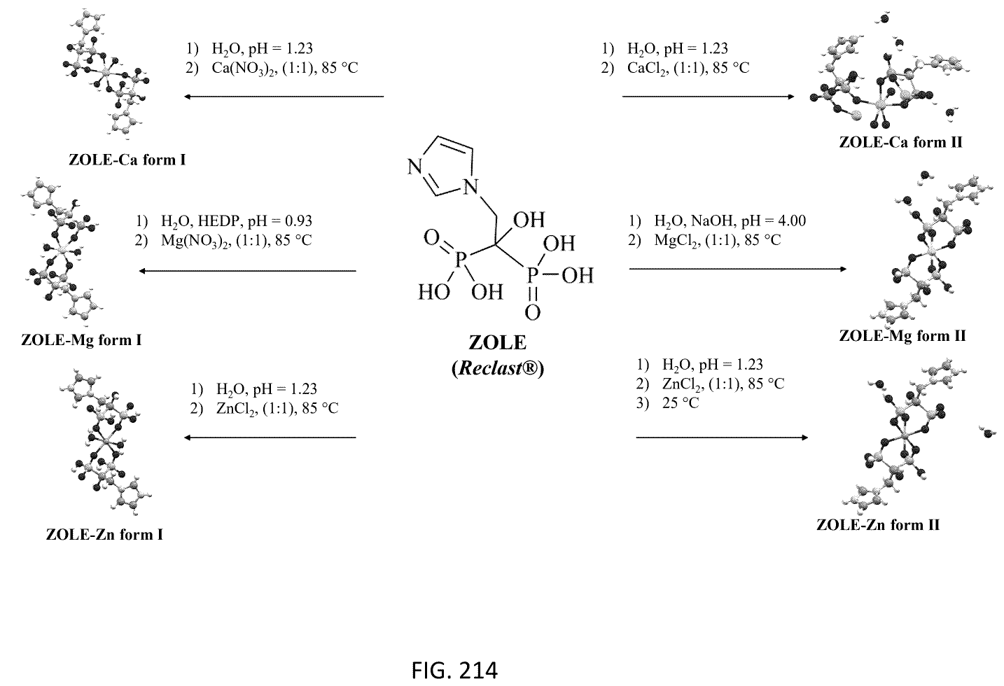

It was found that most of the crystallized materials formed while employing a 1:1 M²⁺/BP molar ratio at 85° C. and in acidic conditions (pH<4.40). Concomitant polymorphism phenomena was observed in all the hydrothermal reactions between ZOLE and the metals. Phase selection was achieved by varying the anion of the metal salt (NO₃⁻ vs. Cl⁻), adding etidronate (HEDP) as an auxiliary ligand to lower the pH (pH=0.93) below the pKa's of the principal ligand (pH=1.23-4.40), or decreasing the temperature of the reaction supernatant after collection of the form that precipitated first. A scheme for the hydrothermal syntheses of the ZOLE-based BPCCs are presented in FIG. 214.

FIG. 214 summarizes the synthetic pathways leading to six crystalline phases of ZOLE-based BPCCs, showing coordination of zoledronate (ZOLE) with three different bioactive metals (M²⁺=Ca²⁺, Mg²⁺, and Zn²⁺) at several synthesis conditions. The variables explored were pH, metal salt anion (NO₃⁻ vs Cl⁻), and addition of etidronic acid (HEDP) as auxiliary ligand.

### Example 2: Optical Microscopy of Crystal Polymorphs

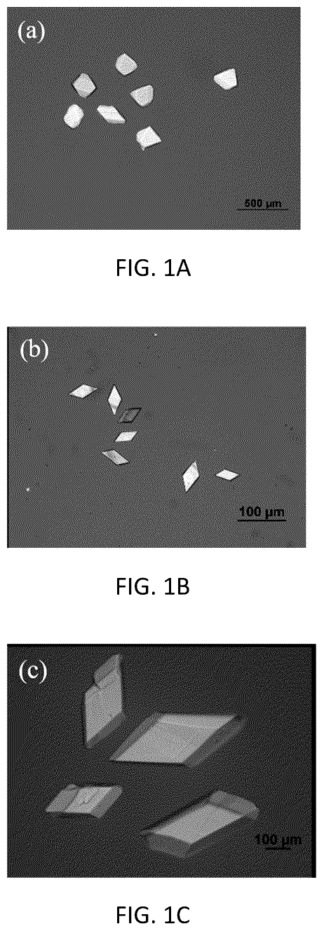

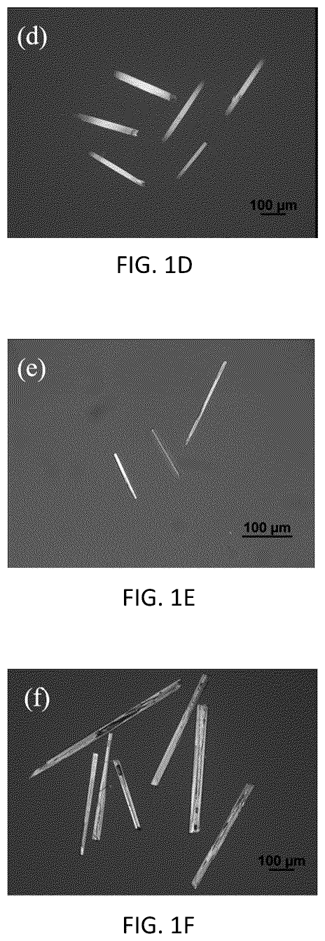

After performing the hydrothermal syntheses, six coordination complexes were obtained with high crystal quality for structural elucidation, as seen under polarized light (FIG. 1). For these ZOLE-based BPCCs, their solid-state characterization, stability in physiological media, particle size and aggregation tendency were assessed to assess their biomedical applications as a nanocrystals-based therapy against osteolytic metastases. As can be observed, the six crystalline polymorphs obtained thereby can be separated into two groups. Form I generally produces octahedral or rhomboid crystallites, while Form II produces needles. All metals tested, Ca²⁺, Mg²⁺, and Zn²⁺, were found to form both Form I and Form II crystals.

### Example 3: Raman Spectroscopy Analysis

Representative Raman spectra of the isolated ZOLE-based BPCCs were collected from 3,400 to 100 cm⁻¹, and are shown in FIG. 2. This analysis confirmed that a distinctive solid-form was produced by the presence and absence of different Raman shifts among the ZOLE and the ZOLE-based BPCCs spectra. Significant differences were observed among the six crystalline phases, compared to the ligand. Two different characteristic signals can be observed in the 3,200 -2,900 cm⁻¹ region. These bands correspond to the hydrogen phosphate H−OPO2C moieties (3,000 -2,900 cm⁻¹) and the stretching vibrations vO-H/H₂O (3,200-3,100 cm⁻¹) due to coordinated and lattice water molecules in the crystal structure, and hydroxyl group in ZOLE. This suggests that an extensive hydrogen bonding is present within the crystal structure of the ZOLE-based BPCCs. Compared to ZOLE, increased intensity of the signal at ˜3,000 cm⁻¹ for the coordination complexes corroborates the presence of various strong hydrogen bonds within each lattice. Incorporation of ZOLE in the coordination sphere of the resulting materials was confirmed by two bands at 1,100 cm⁻¹ (strong) and 1,020 cm⁻¹ (medium), respectively. This strong signal was characteristic for vasP O(H) asymmetric stretching vibrations, while the medium signal corresponded to δPO—H bending of the phosphonate P—O₃ groups. A band at 1,290 cm⁻¹ was attributed to the P═O deformation vibration. A signal at around 1,190 cm⁻¹ was characteristic of vP═O/δ^{π} POH stretching vibrations. Similarly, to the asymmetric stretching vibration of the P—O bonds, bands at the 950-900 cm⁻¹ region were attributed to symmetric v^{s}P—O(H) stretching vibrations. Different vibrational modes of coordination of divalent metal ions (M²⁺) with phosphorus-bonded oxygen atoms, induced changes in the P——O bond order and generated differences observed in both symmetric and asymmetric P—O(H) stretching vibrations among the BPCCs and the ligand. Some Raman shifts were observed at lower wavenumber (<1,000 cm⁻¹), which were assigned to vibrational modes characteristics of CH₂, C—C, C—P, C—OH and M²⁺—O groups present in the ZOLE-based BPCCs.

### Example 4: Scanning Electron Microscopy-Energy Dispersive Spectroscopy (SEM-EDS)

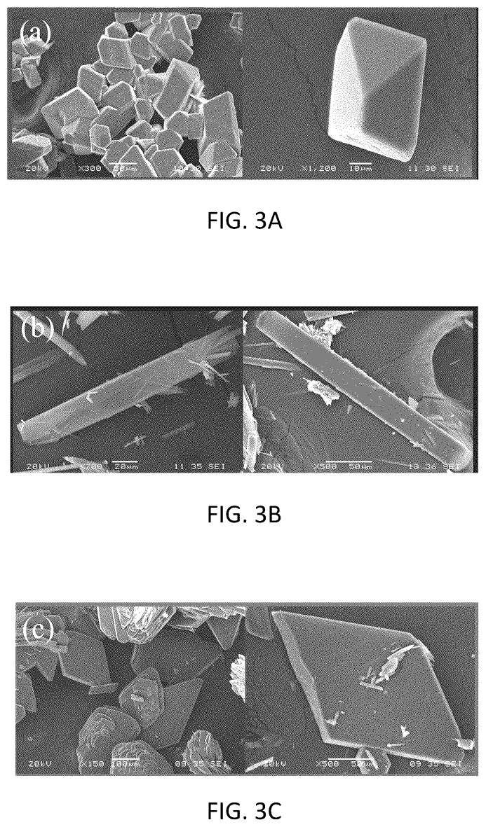

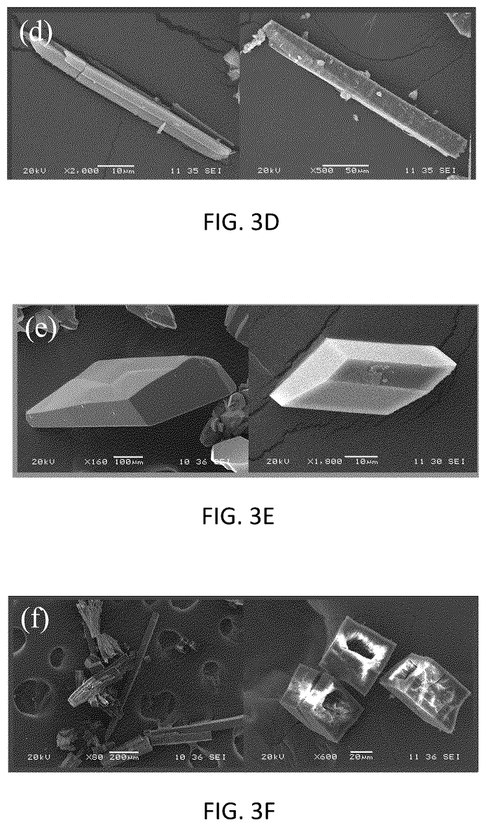

Representative SEM images collected for isolated ZOLE-based BPCCs showed crystals with well-defined morphologies (FIG. 3). As observed, all Form I species of the ZOLE-based BPCCs crystallized in a prismatic crystal habit, while the Form II species existed in an acicular crystal habit. SEM analysis revealed that ZOLE-Zn Form II crystallized in a hollowed acicular, needle-like crystal habit, which is shown in FIG. 3, Panel f. SEM images indicate that the diameter of the resulting crystals ranged between 10-200 m.

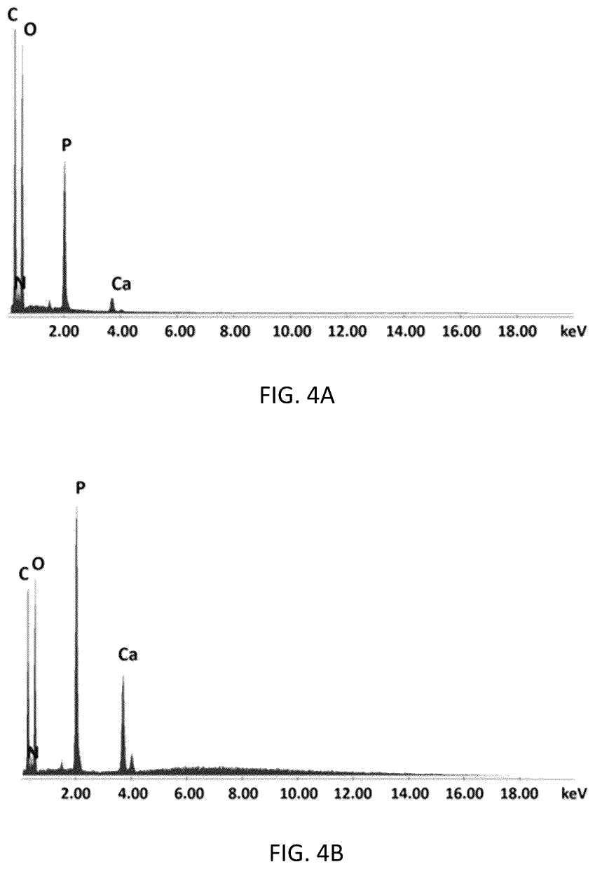

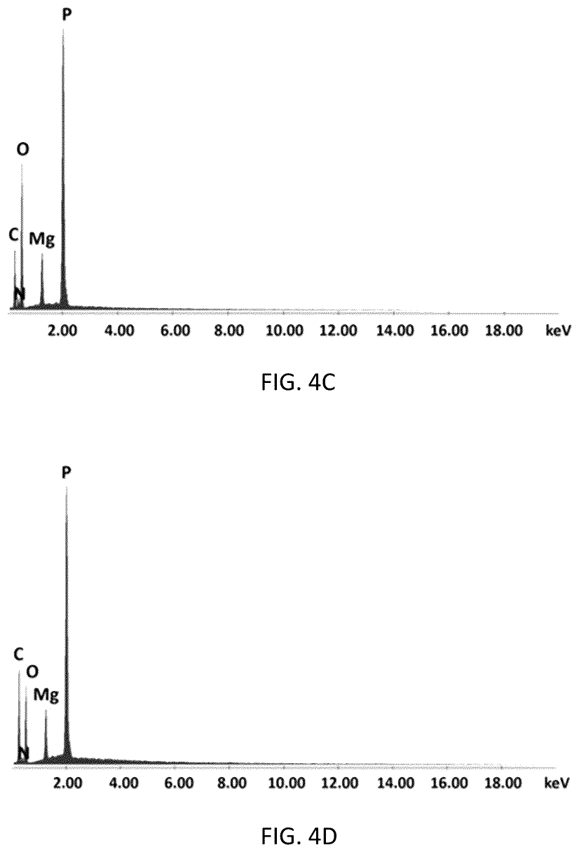

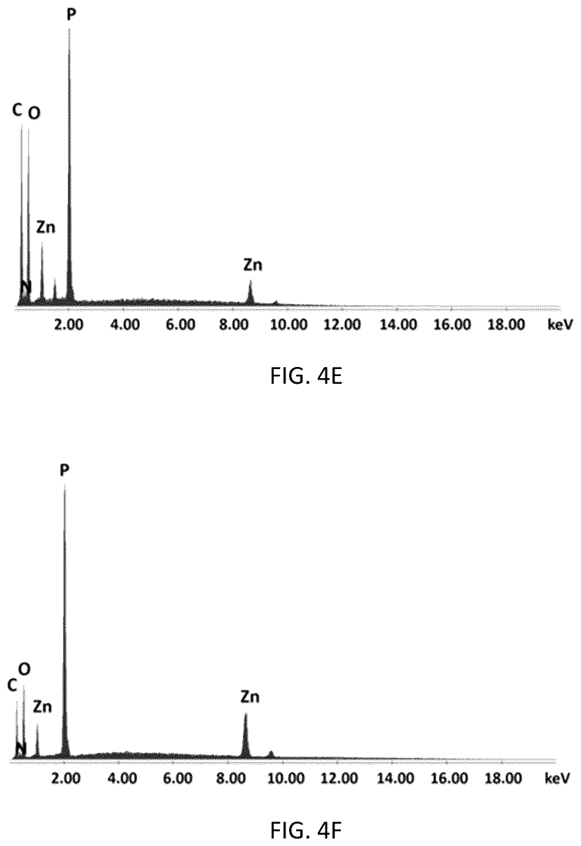

Representative EDS spectra of these materials presented characteristic signals of the metal and other elements, which were present in the ZOLE molecular structure (i.e., carbon, nitrogen, phosphorous, and oxygen atoms), and had been employed for hydrothermal synthesis (FIG. 4). Synthesis of six crystalline phases distinct from the starting materials was supported with these results, taken along with the Raman spectra analysis.

### Example 5: Powder X-Ray Diffraction (PXRD) Analysis

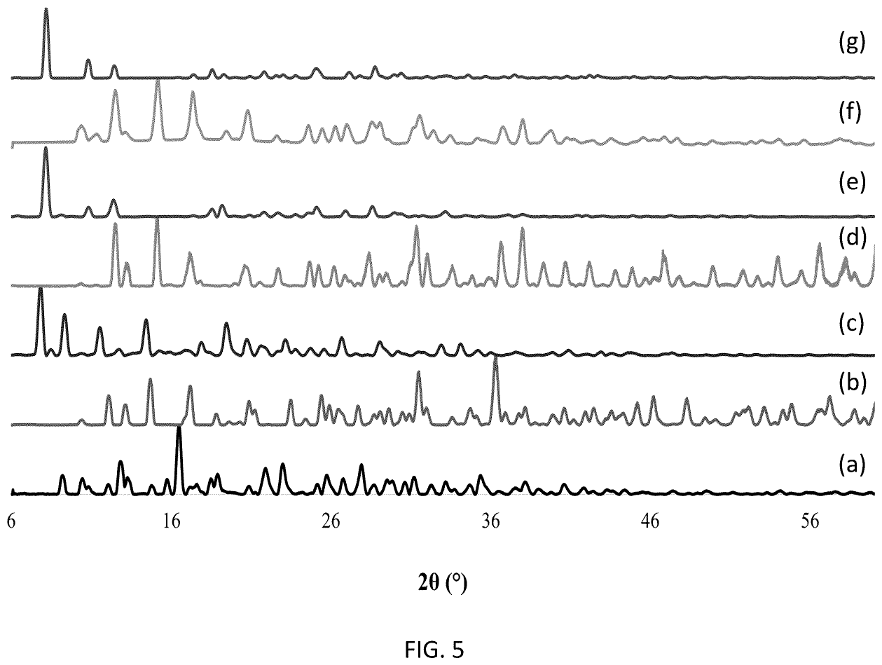

Representative PXRD diffractograms of the six phases presenting the highest crystal quality, as observed by the polarized optical microscope (FIG. 1), are shown in FIG. 5. Each X-ray diffractogram revealed a high degree of crystallinity of the isolated synthesized materials due to the observed low amorphous background. Additionally, these six phases presented a unique crystal structure compared to the starting materials employed during the hydrothermal syntheses; this indicated am absence of concomitant recrystallization of the ligand (ZOLE) and the metal salt. The crystal phases that presented a rhombohedron/prismatic crystal habit (Form I species of ZOLE-based BPCCs), resulted in formation of three isostructural materials, that were distinct to the other polymorphs described herein. In contrast, the diffractogram of each Form II species of ZOLE-based BPCCs confirmed that they were structurally distinct, despite presenting the same acicular crystal habit. The peak lists from FIG. 5 are set forth in Table 1:

TABLE 1
Summary of prominent peaks (2θ) observed in the powder X-ray diffraction (PXRD)
patterns of the Zoledronate-based bisphosphonate coordination complexes (BPCCs).
Coordination Complex

| ZOLE-Ca | | ZOLE-Ca | | ZOLE-Mg | | ZOLE-Mg | | ZOLE-Zn | | ZOLE-Zn | |
|---|---|---|---|---|---|---|---|---|---|---|---|
| form I | | form II | | form I | | form II | | form I | | form II | |
| 2θ (°) | I/Iₘₐₓ | 2θ (°) | I/Iₘₐₓ | 2θ (°) | I/Iₘₐₓ | 2θ (°) | I/Iₘₐₓ | 2θ (°) | I/Iₘₐₓ | 2θ (°) | I/Iₘₐₓ |
| 10.36 | 0.073 | 8.18 | 1.001 | 10.32 | 0.045 | 8.56 | 1.002 | 10.34 | 0.189 | 8.49 | 1.015 |
| 12.37 | 1.007 | 8.46 | 0.114 | 11.21 | 0.023 | 10.82 | 0.160 | 11.23 | 0.142 | 10.76 | 0.187 |
| 13.12 | 0.382 | 9.33 | 0.624 | 12.50 | 0.912 | 12.41 | 0.231 | 12.44 | 0.967 | 12.44 | 0.110 |
| 14.67 | 0.923 | 11.56 | 0.464 | 13.21 | 0.277 | 18.61 | 0.147 | 13.05 | 0.109 | 18.55 | 0.129 |
| 17.48 | 1.009 | 17.91 | 0.193 | 15.44 | 1.013 | 19.24 | 0.205 | 15.09 | 0.955 | 19.22 | 0.039 |
| 18.77 | 0.102 | 19.47 | 0.447 | 17.32 | 0.417 | 20.91 | 0.048 | 17.07 | 0.114 | 20.85 | 0.023 |
| 20.85 | 0.556 | 20.65 | 0.152 | 17.36 | 0.599 | 21.88 | 0.072 | 17.34 | 0.571 | 21.76 | 0.073 |
| 21.18 | 0.257 | 21.53 | 0.183 | 17.67 | 0.405 | 22.54 | 0.062 | 17.67 | 0.112 | 22.51 | 0.043 |
| 23.45 | 0.319 | 23.23 | 0.260 | 20.77 | 0.335 | 23.86 | 0.033 | 20.76 | 0.187 | 23.02 | 0.031 |
| 25.44 | 0.248 | 26.73 | 0.284 | 21.50 | 0.039 | 25.28 | 0.134 | 20.83 | 0.315 | 24.97 | 0.086 |
| 25.88 | 0.164 | 29.08 | 0.182 | 22.61 | 0.258 | 27.07 | 0.083 | 22.57 | 0.052 | 27.11 | 0.057 |
| 26.39 | 0.163 | 30.17 | 0.079 | 24.65 | 0.227 | 28.75 | 0.169 | 24.52 | 0.231 | 28.77 | 0.103 |
| 27.67 | 0.229 | 33.01 | 0.143 | 25.44 | 0.169 | 30.00 | 0.068 | 25.43 | 0.197 | 30.26 | 0.041 |
| 31.48 | 0.431 | 34.15 | 0.176 | 26.30 | 0.135 | 33.13 | 0.060 | 26.21 | 0.151 | 30.28 | 0.043 |
| 33.13 | 0.255 | | | 28.33 | 0.211 | | | 28.43 | 0.210 | | |
| 36.30 | 0.318 | | | 28.74 | 0.275 | | | 29.07 | 0.137 | | |
| 40.73 | 0.222 | | | 29.01 | 0.203 | | | 29.01 | 0.202 | | |
| | | | | 29.58 | 0.130 | | | 31.44 | 0.313 | | |
| | | | | 31.37 | 0.340 | | | 32.44 | 0.148 | | |
| | | | | 32.35 | 0.165 | | | 33.44 | 0.076 | | |
| | | | | 36.63 | 0.168 | | | 36.66 | 0.143 | | |
| | | | | 38.08 | 0.296 | | | 39.78 | 0.153 | | |

### Example 6: Single-Crystal X-Ray Diffraction (SC-XRD) Analysis

Crystal structure elucidation performed by SCXRD confirmed formation of six ZOLE-based BPCCs. Crystal structures were collected at low temperature (100 K) and solved using direct methods. The crystallographic parameters of the structure refinement for each crystalline phase are summarized in Tables 2-4.

TABLE 2

| | Compound | |
|---|---|---|
| | ZOLE-Ca | |
| Polymorph | Form I | Form II |
| Empirical | [Ca(C₁₀H₁₈N₄O₁₄P₄)(H₂O)₂] | [Ca(C₁₀H₁₈N₄O₁₄P₄)]•3H₂O |
| formula | | |
| FW (g/mol) | 618.27 | 636.29 |
| Space group | P1̅ | Pbca |
| Temperature (K) | 99.99(10) | 100.00(10) |
| λ (Å) | 1.54184 | 1.54184 |
| a (Å) | 7.3520(2) | 10.2301(2) |
| b (Å) | 8.9793(2) | 20.8833(5) |
| c (Å) | 9.5484(2) | 22.4723(5) |
| α (°) | 105.677(2) | 90 |
| β (°) | 108.739(2) | 90 |
| γ (°) | 97.937(2) | 90 |
| V (Å³) | 556.97(2) | 4801.0(2) |
| Z | 1 | 8 |
| ρ_{calc} (g/cm³) | 1.843 | 1.761 |
| R_{wp} | 0.0609 | 0.1211 |
| Rₚ | 0.0224 | 0.0448 |

TABLE 3

| | Compound | |
|---|---|---|
| | ZOLE-Mg | |
| Polymorph | Form I | Form II |
| Empirical formula | [Mg(C₁₀H₁₈N₄O₁₄P₄)(H₂O)₂] | [Mg(C₁₀H₁₈N₄O₁₄P₄)]•4H₂O |
| FW (g/mol) | 602.51 | 638.54 |
| Space group | P1̅ | P2₁/n |
| Temperature (K) | 100.0(4) | 100.00(10) |
| λ (Å) | 1.54184 | 1.54184 |
| a (Å) | 7.4070(2) | 4.96400(10) |
| b (Å) | 8.40350(10) | 16.3671(3) |
| c (Å) | 9.7306(2) | 14.4253(3) |
| α (°) | 105.249(2) | 90 |
| β (°) | 111.368(2) | 93.241(2) |
| γ (°) | 97.085(2) | 90 |
| V (Å³) | 527.74(2) | 1170.13(4) |
| Z | 2 | 2 |
| ρ_{calc} (g/cm³) | 1.896 | 1.812 |
| R_{wp} | 0.0732 | 0.3380 |
| Rₚ | 0.0272 | 0.1210 |

TABLE 4

| | Compound | |
|---|---|---|
| | ZOLE-Zn | |
| Polymorph | Form I | Form II |
| Empirical formula | [Zn(C₁₀H₁₈N₄O₁₄P₄)(H₂O)₂] | [Zn(C₁₀H₁₈N₄O₁₄P₄)]•2H₂O |
| FW (g/mol) | 643.59 | 679.60 |
| Space group | P1̅ | P2₁/n |
| Temperature (K) | 100 | 101(1) |
| λ (Å) | 0.71073 | 1.54184 |
| a (Å) | 7.3868(5) | 4.96680(10) |
| b (Å) | 8.4456(5) | 16.4043(3) |
| c (Å) | 9.7191(6) | 14.4177(4) |
| α (°) | 105.3330(10) | 90 |
| β (°) | 111.2460(10) | 93.452(2) |
| γ (°) | 97.4060(10) | 90 |
| V (Å³) | 527.70(6) | 1172.58(5) |
| Z | 2 | 2 |
| ρ_{calc} (g/cm³) | 2.025 | 1.925 |
| R_{wp} | 0.0787 | 0.1321 |
| Rₚ | 0.0304 | 0.0511 |

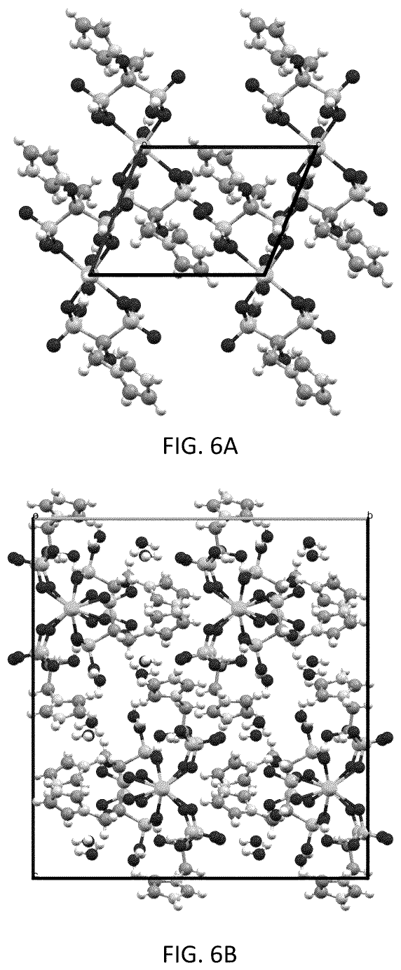

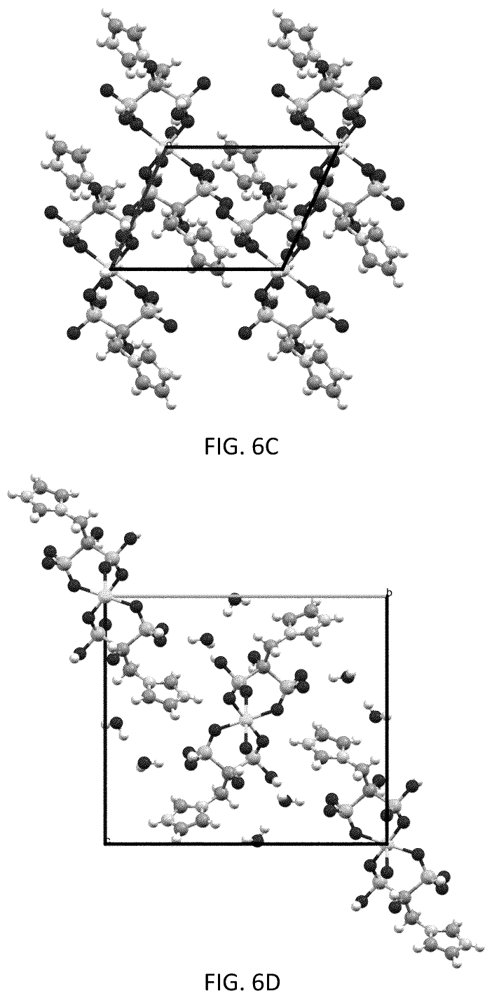

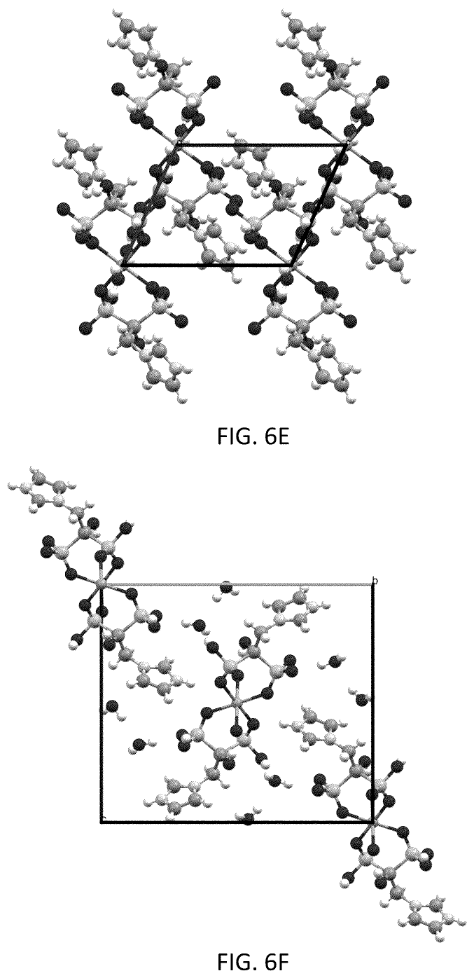

Structural description of ZOLE-Ca Form I: The compound [Ca(C₁₀H₁₈N₄O₁₄P₄)(H₂O)₂] crystallized in the P1̅ space group, containing a half molecule in the asymmetric unit with the calcium atom located in an inversion center (FIG. 6, panel A). A distorted CaO₆ octahedron (supplementary angles: O1-Ca1-O7, 83.290, O1-Ca1-O8, 94.500, O8-Ca1-O7, 80.710) was bonded to four phosphonate oxygen atoms from two distinct bidentate ZOLE ligands, while a water molecule occupies the remaining two axial sites. The phosphonate oxygen atoms were bound to the equatorial positions of the octahedral Ca² center forming two identical six-membered chelate rings. The Ca—O bond distances are 2.322 Å (Ca1 . . . O1) and 2.286 Å (Ca . . . O7).

The conformation of the ligand was reinforced by intramolecular hydrogen bonds (O6..08, 2.899 Å and O2 . . . O6, 2.960 Å). The ZOLE ligands were linked into chains that propagate tilted along the b-axis through strong intermolecular hydrogen bonds (O6-H6 . . . O5, 1.736 Å) between the oxygen atoms from the phosphonate moieties. The ZOLE ligands were linked into chains that propagate tilted along the α-axis through intermolecular hydrogen bonds (O8-H8A . . . O5, 1.856 Å), between the coordinated water molecule and the oxygen atom from the phosphonate moiety. Adjacent chains are linked by a single intermolecular hydrogen bond (N₂-H2A . . . O1, 1.852 Å) that propagates this chain along the bc-plane. This represents a unique packing mode when compared to the other ZOLE-Ca metal complex previously detected.

Structural description of ZOLE-Ca form II. The compound [Ca(C₁₀H₁₈N₄O₁₄P₄)]3H₂O crystallized in the Pbca space group, and was completely distinct to any other ZOLE-Ca metal complex previously reported (FIG. 6, panel B). The asymmetric unit has two ZOLE molecules coordinated to a Ca²⁺ center, surrounded by three uncoordinated water molecules. The Ca²⁺ center is in a distorted octahedral environment (supplementary angles: O1-Ca1-O4, 80.88°, O1-Ca1-O3, 86.29°, O4-Ca1-O3, 80.42°), with four ZOLE ligands coordinated.

Two different binding modes are observed for the ZOLE molecules. One ZOLE ligand is coordinated to the Ca²⁺ cation in a bidentate mode alternating oxygens from the bisphosphonate group. The Ca—O bond distances range between 2.296 and 2.375 Å. The metal cluster is linked by a single ligand coordinated to form a chain (Ca1-O4-P₂-O5-Ca1) that propagates along the α-axis. This chain is additionally reinforced by intermolecular hydrogen bonds (O4 . . . H9-O9, 1.793 Å; O5 . . . H13-O13, 1.841 Å; and O5 . . . -O11, 3.020 Å). Adjacent chains are linked by uncoordinated water molecules forming hydrogen bonds with the oxygens of the bisphosphonate moieties along the b-axis (O16-H16B . . . O12, 1.824 Å and O17-H17B . . . O10, 1.813 Å). An additional intermolecular hydrogen bond occurs through the b-axis, which involves the nitrogen from an imidazole group and the oxygen from an adjacent phosphonate moiety (N1-H1 . . . O11, 1.880 Å). An extensive network of intermolecular hydrogen bonds facilitated by the uncoordinated water molecules, serve to propagate the chain along the c-axis (O14 . . . H15B-O15, 2.043 Å; O15-H15A . . . O16, 1.857 Å; O16-H16A . . . O7, 2.003 Å; N3-H3 . . . -O10, 1.775 Å).

Structural description of ZOLE-Mg form I. The structure of the compound [Mg(C₁₀H₁₈N₄O₁₄P₄)(H₂O)₂], which crystallized in the P1̅ space group, has been previously reported at 294 K (FIG. 6, panel C). The crystal structure was re-determined herein at 100 K, and the R-factor was improved (5.23% vs. 2.72%). Two bidentate ZOLE ligands and two water molecules are coordinated to a Mg²⁺ atom in an inversion center. The octahedral Mg²⁺ center equatorial positions are occupied by two bidentate ZOLE ligands, forming two identical six-membered chelate rings. In the remaining axial positions, water molecules are coordinated. A rather regular octahedral environment is observed for the metal cation (supplementary angles: O1-Mg1-O5, 89.66°, O5-Mg1-O8, 88.21°, O1-Mg1-O8, 94.14°). The equatorial Mg—O bond distances are 2.033 Å (Mg1-O1) and 2.078 Å (Mg1-O5), while the axial Mg—O bond distance is 2.097 Å (Mg1-O8). The compound is reinforced by a single intramolecular hydrogen bond between the oxygens of the phosphonate moiety (03 . . . O7, 2.974 Å). The ZOLE ligands are linked by several intermolecular hydrogen bonds, the strongest of which (O3-H3 . . . O2, 1.780 Å), propagates the metal cluster laterally along the b-axis forming chains reinforced by addition hydrogen bonds (O4-H4 . . . O6, 2.071 Å; and O7-H7 . . . O6, 1.853 Å). A single intermolecular hydrogen bond (N₂-H2 . . . O5, 1.885 Å) links adjacent chains, and propagate these along the c-axis. Additional chains are linked by intermolecular hydrogen bonds along the α-axis, through a coordinated water molecule and oxygen from adjacent phosphonate moiety (O8-H8B . . . O2, 1.957 Å). ZOLE-Mg form I did not incorporate the auxiliary ligand HEDP in its crystal lattice during the hydrothermal synthesis.

Structural description of ZOLE-Mg form II. The compound [Mg(C₁₀H₁₈N₄O₁₄P₄)]·4H₂O crystallized in the P2_{1/n} space group. The asymmetric unit has one ZOLE molecule coordinated to a Mg²⁺ center, surrounded by two uncoordinated water molecules (FIG. 6, panel D). A regular octahedral environment is observed for the Mg²⁺ cation (supplementary angles: O1-Mg1-O5, 90.55°, O1-Mg1-O6, 90.58°, O5-Mg1-O6, 94.76°), with Mg—O bond distances ranging from 2.037 to 2.122 Å. Intramolecular hydrogen bonds reinforce the metal cluster (O5 . . . O7, 2.533 Å; O4 . . . O6, 2.634 Å; O1 . . . O6, 2.932 Å; and O5 . . . O6, 2.817 Å). The ligand is coordinated to the metal center in a bidentate mode (O1-Mg1-O5), forming a six-membered chelate ring. The same ligand is coordinated to the Mg²⁺ center in a monodentate mode (Mg1-O6). Coordination between the Mg²⁺ cation and the O6 and O5 from the ZOLE molecule results in the formation of an eight-membered chelate ring that fuses adjacent metal centers, resulting in the propagation of chains through the α-axis. An extensive hydrogen bond network reinforces the chains along the b-axis connecting adjacent chains through the imidazole groups of the ligand and the uncoordinated lattice water (N₂-H2 . . . O5, 4.477 Å; N₂ . . . O1, 2.985 Å; O2 . . . H8A-O8, 1.985 Å; O8 . . . O4, 2.927 Å; and O8 . . . H7-O7, 1.917 Å). Propagation of the metal cluster though the c-axis can be described by the presence of a c glide plane symmetry element, which is perpendicular to b [0, 1, 0] with glide component [1/2, 0, 1/2]. Additional intermolecular hydrogen bonds between the two uncoordinated lattice waters link chains through the c-axis (O8 . . . H9B-O9, 2.862 Å and O9 . . . O9, 2.845 Å). The ZOLE-Mg form II BPCC presents a unique packing arrangement when compared to other ZOLE-Mg metal complexes that have been previously described in the literature.

Structural description of ZOLE-Zn form I. The structure [Zn(C₁₀H₁₈N₄O₁₄P₄)(H₂O)₂] is isostructural to ZOLE-Mg form I. The structure crystallized in the P1 space group. The Zn²⁺ center is in a regular octahedral environment (supplementary angles: O1-Zn1-O5, 90.82°, O5-Zn1-O8, 93.09°, O1-Zn-O8, 85.45°), and coordinated by two bidentate ZOLE ligands and two water molecules (FIG. 6, panel E). There is one half-molecule in the asymmetric unit with the zinc atom located in an inversion center. The phosphonate oxygen atoms are bound to the equatorial positions of the octahedral Zn²⁺ center forming two identical six-membered chelate rings. Water molecules occupy the remaining two sites of the octahedral (axial positions). The equatorial Zn-O bond distances are 2.042 Å (Zn1-O1) and 2.093 Å (Zn1-O5), while the bond distance of the axial position is 2.130 Å (Zn1-O8). The metal clusters are linked into a chain that propagates laterally through several intermolecular hydrogen bonds among the ZOLE ligands (O3-H3 . . . O2, 1.756 Å; O4-H4 . . . O6, 2.068 Å; O7-H7 . . . O6, 1.827 Å) expanding along the b-axis. Adjacent chains are linked by intermolecular hydrogen bonds along the α-axis, which involves a coordinated water molecule and an oxygen from adjacent phosphonate moiety (O8-H8A . . . O2, 1.855 Å). The coordinated water present in ZOLE-Zn form I is responsible for reinforcing this packing through a unique intramolecular hydrogen bond with an adjacent phosphonate moiety along the α-axis (O8-H8B . . . O3, 2.379 Å). Adjacent chains are linked by another unique hydrogen bond (N₂-H2 . . . O5, 2.708 Å) that expands this chain along the c-axis. The packing is reinforced by an intramolecular hydrogen bond between oxygens of different phosphonate moieties of the same ZOLE molecule (O3 . . . O7, 2.974 Å) along the c-axis.

Structural description of ZOLE-Zn form II. The compound [Zn(C₁₀H₁₈N₄O₁₄P₄)]·2H₂O crystallized in the space group P2_{1/n}. The asymmetric unit has one ZOLE molecule coordinated to a Zn²⁺ center, surrounded by two uncoordinated water molecules. The Zn²⁺ center is in a rather regular octahedral environment (supplementary angles: O1-Zn1-04, 91.06°, O4-Zn1-O3, 89.40°, O1-Zn1-O3, 85.72°), with Zn-O bond distances ranging from 2.062 to 2.152 Å (FIG. 6, panel F). The metal centers coordinates the ligand in a bidentate mode (O1-Zn1-O4), forming a six-membered chelate ring. The same metal center coordinates to the ligand in a monodentate mode (Zn1-O3). Coordination between the Zn²⁺ cation and the O1 and 03 from the ZOLE molecule results in the formation of an eight-membered chelate ring that fuses adjacent metal centers, forming a chain that propagates through the α-axis. This chain is additionally reinforced by intramolecular hydrogen bonds (O1 . . . O3, 2.867 Å; and O3 . . . O4, 2.966 Å). These chains propagate along the b-axis through an extensive network of hydrogen bonds that form either with the imidazole group or the uncoordinated water molecules (N₂ . . . O4, 2.972 Å; N₂-H2A . . . O1, 2.035 Å; O6 . . . H8 Å-O8, 1.915 Å; O2-H2 . . . O8, 1.905 Å; and O8 . . . O7, 2.943 Å). Propagation of the metal cluster though the c-axis can be described by the presence of a c glide plane symmetry element, which is perpendicular to b [0, 1, 0] with glide component [1/2, 0, 1/2]. Chains that propagate through the c-axis are linked by extensive intermolecular hydrogen bonds between two uncoordinated water molecules (O8 . . . H9B-O9, 2.868 Å and O9 . . . O9, 2.845 Å). Moreover, the metal cluster is reinforced by intramolecular hydrogen bonds (O1 . . . O4, 2.890 Å; and O7-H7 . . . O3, 1.815 Å) also through the c-axis. ZOLE-Zn form II presents a unique packing arrangement when compared to other ZOLE-Zn metal complexes that have been previously described.

### Example 7: Thermogravimetric Analysis (TGA)

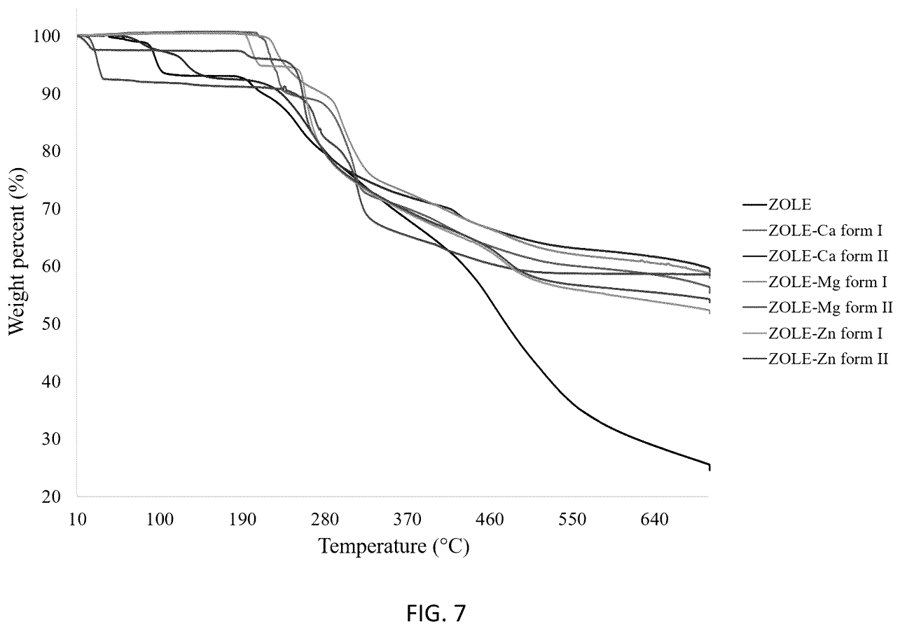

Thermographs of the disclosed coordination complexes were compared to the ligand (ZOLE). Based on the resulting thermographs from the analyzed samples, all ZOLE-based BPCCs presented higher thermal stability than the ligand (FIG. 7). Independently of the metal employed, higher thermal stability was observed for the Form I species when compared to Form II species of the coordination complexes in all instances. This was because the Form I species of ZOLE-based BPCCs were characterized by having coordinated water molecules within their crystal structure, while the Form II species only exhibited unbound lattice water molecules. Compared to coordinated H₂O, uncoordinated lattice water molecules required minimal thermal energy to observe their desolvation. Most ZOLE-based BPCCs were found to be stable up to 100-200° C., where minor loss of coordinated and lattice water molecules were observed. Above 250-300° C. a major decomposition of the ligand was observed for each coordination complex and the ZOLE ligand. Minor weight loss was observed at higher temperatures (>400° C.), accounted for the thermal degradation of the metal/metal oxide.

### Example 8: Dissolution rate measurements

Dissolution of ZOLE-based BPCCs was compared to that of ZOLE (active ingredient of Reclast@), to assess the structural stability of these materials in PBS and FaSSGF. Determination of this parameter in both media provided insights into the potential of ZOLE-based BPCCs to sustain blood plasma concentrations for ZOLE and be selectively degraded at the metastatic site. Tumor metastases and bone resorption are closely associated with an acidic microenvironment, which can alter substantially the structure of these materials, promoting their degradation at the targeted area. Therefore, release of ZOLE by structure degradation of these BPCCs at the metastatic site could induce desirable therapeutic effects against metastatic cells.

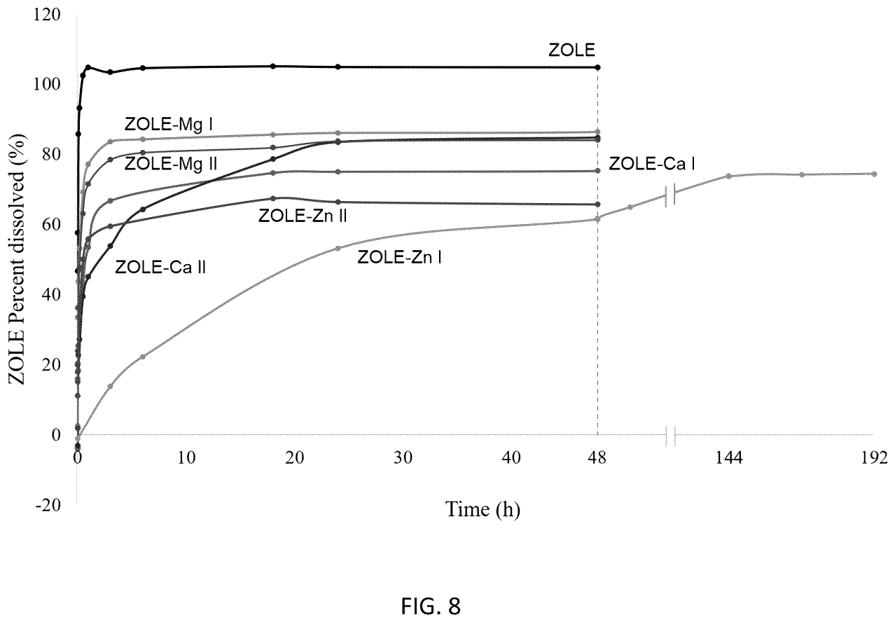

The ZOLE content released from the ZOLE-based BPCCs was quantified in neutral (PBS, pH=7.4) and acidic (FaSSGF, pH=1.6) physiological media, via direct UV-Vis spectroscopy quantification (λₘₐₓ=208 nm). Dissolution assays employed a maximum concentration of 0.05 mg/mL of ZOLE, which corresponded to the clinically utilized dosage of these BP. Results from dissolution assays in PBS demonstrated that commercial ZOLE had a higher dissolution rate (100% in 30 min) than ZOLE-based BPCCs. Most ZOLE-based BPCCs presented a slower dissolution rate and lower equilibrium solubility (60-85% in 18-24 h) than ZOLE in this media (FIG. 8). Particularly, ZOLE-Zn Form I presented a significantly slower dissolution rate in PBS, reaching its maximum concentration of ZOLE (˜74%) after 6 days.

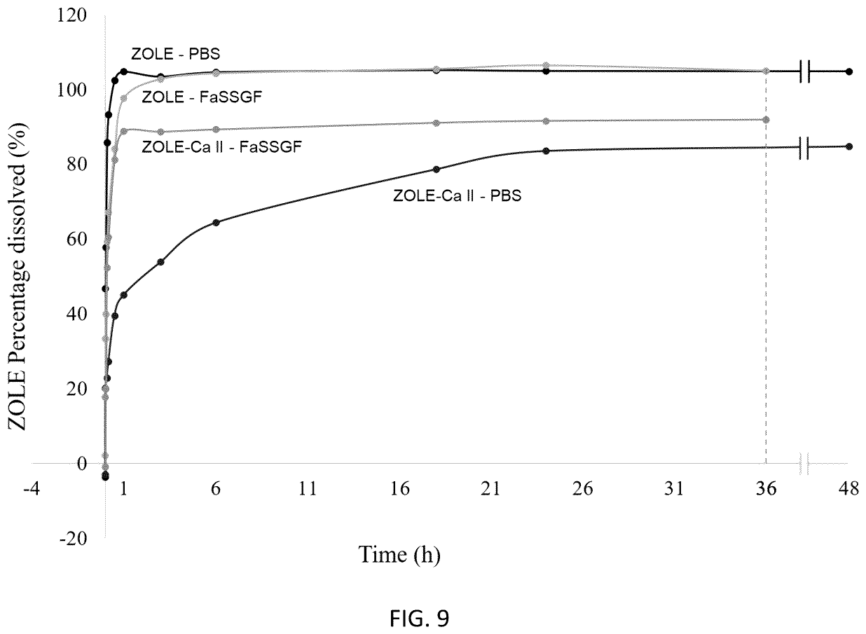

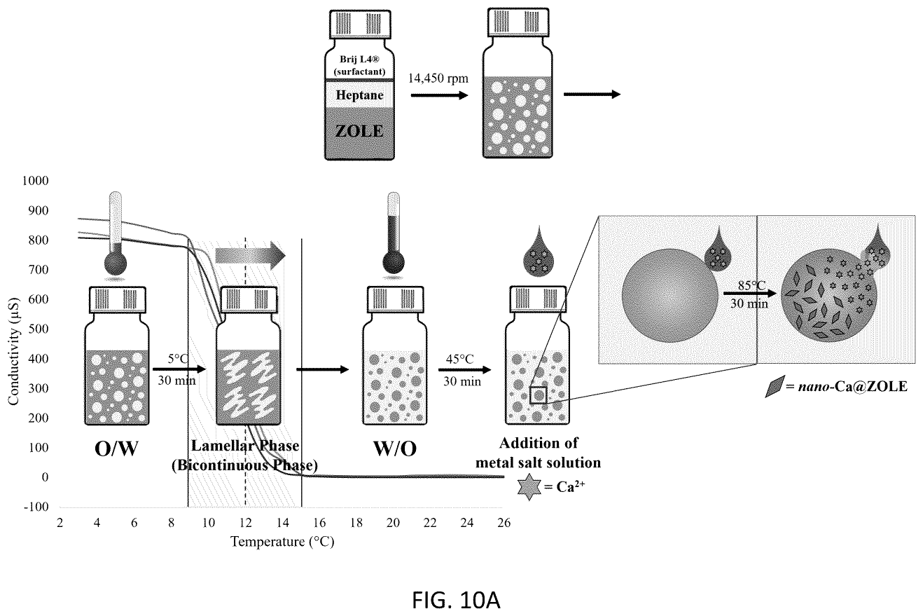

To further investigate if the ZOLE-based BPCCs presented pH-dependent degradation, dissolution of ZOLE-Ca Form II in FaSSGF was performed. From dissolution assays in FaSSGF, results demonstrated that commercial ZOLE (Reclast®) had a relatively similar dissolution rate in PBS (100%), but in lower pH reached its maximum equilibrium solubility in 3 h (FaSSGF) rather than in 30 min (PBS). ZOLE-Ca Form II presented higher dissolution and equilibrium solubility in acidic media (88% in 1 h), compared to its dissolution rate in PBS (83% in 24 h, FIG. 9). The observed pH-dependent dissolution is desirable because it can allow ZOLE-Ca Form II nanoparticles to circulate longer allowing them to reach the target site. Once there, the material can degrade due to increased acidic microenvironment at the metastatic site. These results provided evidence of structural stability for ZOLE-based BPCCs in physiological media, and suggested their ability to degrade releasing the drug content (ZOLE) in a controlled and pH-dependent manner. Because these materials are not able to encapsulate drugs within their 2D structure, the degradation of the BPCC itself could provide the release of BPs at the metastatic site.

### Example 9: Phase Inversion Temperature (PIT)-Nano-Emulsion Synthesis of Nano-Ca@ZOLE

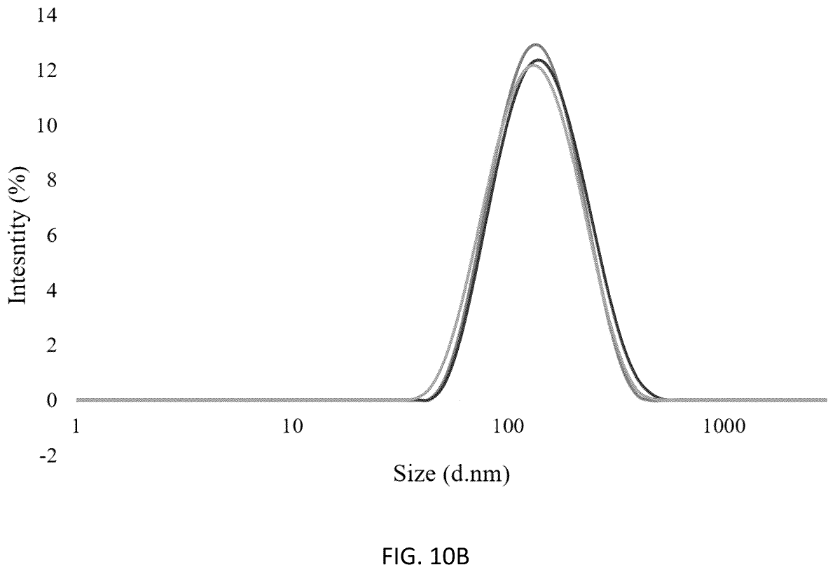

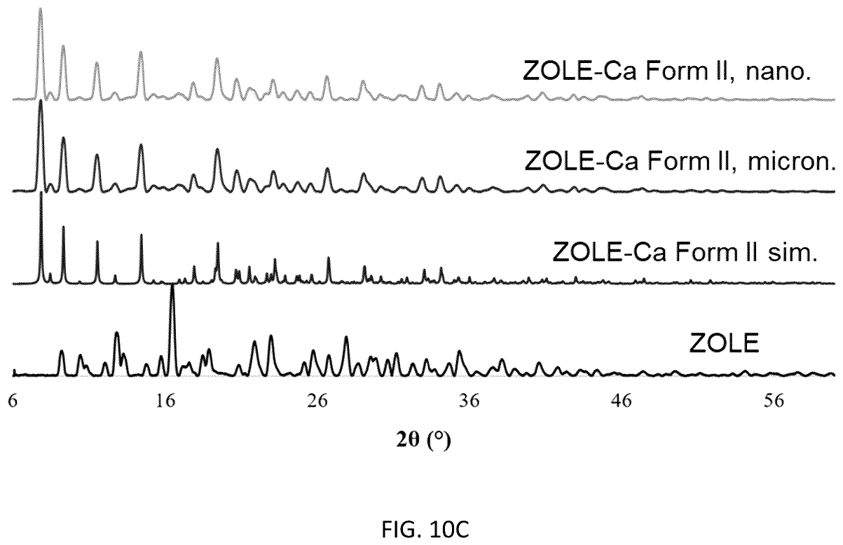

Particle size reduction of a selected ZOLE-based BPCC was performed employing the PIT-nano-emulsion method using ZOLE-Ca Form II as a test case. The PIT temperature was determined by measuring conductivity of an emulsion consisting of an aqueous phase (ZOLE), an oil phase (heptane), and a surfactant (Brij®L4). Low-temperature conductivity measurements (2° C.) presented a moderate conductivity (˜840 μS) for the oil-in-water (O/W) microemulsion. As the temperature increased (1° C./min), a phase inversion (O/W to W/O) occurred. The phase inversion started at 9° C. and ended at 15° C., wherein the conductivity measurements dropped to an average value of −8.58 μS. This led to conversion of the emulsion into a water-in-oil (W/O) nano-emulsion. The average PIT was observed at ˜12° C. for this system, after performing measurements in triplicate. Hydrothermal synthesis of ZOLE-Ca Form II was coupled to the PIT method, to decrease the particle size of this material to the nano-range (FIG. 10, panel A).

When the ligand (ZOLE) was entrapped in aqueous nanospheres suspended in the oil phase of the emulsion, nano-Ca@ZOLE particles formed inside, after addition of the metal salt solution. Once the reaction was completed, the aqueous supernatant was analyzed by DLS to determine particle size distribution of the resulting material. DLS results demonstrated average particle size distribution values of 144.4, 146.3 and 155.2 nm (average diameter) for three replicate syntheses (FIG. 10, panel B). Polydispersity indexes (PDI) between 0.202-0.206 were obtained for the nano-Ca@ZOLE analyzed, indicating a high degree of monodispersity for these nanoparticles. Therefore, the hydrothermal synthesis conditions adapted to the PIT-nanoemulsion method, significantly decreased particle size for this selected BPCC from a micron-range (˜200 μm, FIG. 3, panel B) to a nano-range (˜150 d.nm, FIG. 10 panel B), by limiting the available space for nucleation and crystal growth to occur. DLS measurements indicated an average crystal size of 144.4 nm, with a standard deviation of 63.1 nm. PXRD analysis was carried out on a micron-sized agglomerate of the nanocrystals resulting from the PIT-nanoemulsion synthesis, to verify this crystal phase against the bulk material (ZOLE-Ca Form II). PXRD analysis confirmed that the crystal phase of the nano-Ca@ZOLE nanoparticles was isostructural to that of ZOLE-Ca Form II bulk crystals (FIG. 10, panel C). Therefore, application of the PIT nano-emulsion method successfully decreased the crystal size, while maintaining the crystal phase of ZOLE-Ca form II.

### Example 10: Aggregation Measurments of Nano-Ca@ZOLE

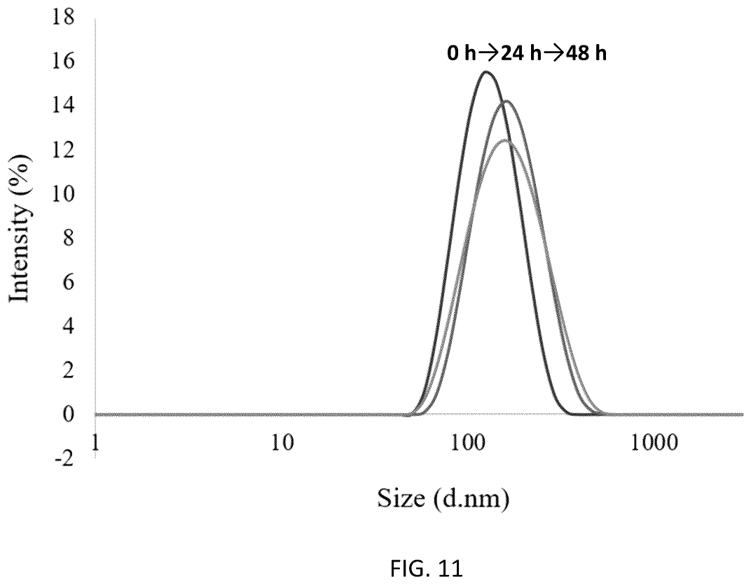

Particle size longevity and aggregation of nano-Ca@ZOLE particles was monitored in biologically relevant conditions. This analysis provided insights about the potential of the nano-Ca@ZOLE to maintain its particle size (<500 nm), and be able to serve as a drug delivery system when suspended in physiological media. Aggregation measurements were performed in 10% FBS:PBS, after 0, 24 and 48 h. This dispersant provided auspicious conditions to determine the aggregation behavior of the nanocrystals when in contact with different biological serum-like components from cell media at a pH of 7.4. Results demonstrated a homogeneous particle size distribution in 10% FBS:PBS after 0, 24 and 48 h of being synthesized. After being suspended in media, nano-Ca@ZOLE presented particle size distribution values of 137.4, 175.5, and 176.9 d.nm after 0, 24 and 48 h, respectively (FIG. 11). Furthermore, the samples remained highly monodispersed along the three-time points, showing PDI values of 0.122 (0 h), 0.154 (24 h), and 0.159 (48 h). These results confirmed that the nano-Ca@ZOLE have a low aggregation tendency when in contact with biologically relevant conditions (10% FBS:PBS), demonstrating that the nanomaterial can maintain its particle size without forming larger aggregates.

### Example 11: Binding Assays of nano-Ca@ZOLE to hydroxyapatite

The ability of nano-Ca@ZOLE to bind under simulated physiological conditions to the main constituent of the bone microenvironment, hydroxyapatite (HA), was probed through a binding assay. The binding to HA was determined by monitoring the decrease in the ZOLE concentration of the supernatant using absorption measurements (λₘₐₓ=208 nm). Binding curves (FIG. 11) demonstrated that 15% of ZOLE (control) bound to HA in 1 day and reached a maximum binding of 82% in 8 days under simulated physiological conditions (PBS, pH=7.4). Binding curve results for nano-Ca@ZOLE demonstrated that the nanomaterial reaches its maximum binding of 36% to HA in 1 day and remained constant up to 11 days under the same conditions. These results provided evidence of higher binding (˜2.5×) for nano-Ca@ZOLE compared to the ligand alone within a relevant time frame. This suggested that the uncoordinated phosphate groups at the surface of the nanocrystals are responsible for binding to HA.

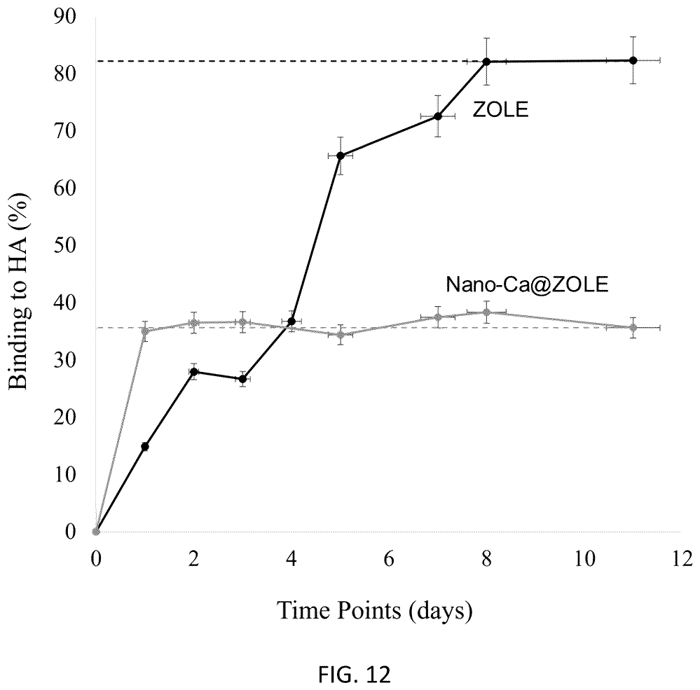

Further characterization was performed to corroborate the ability to bind of nano-Ca@ZOLE to HA, which includes EDS. After the binding assay was completed, the elemental analysis performed by EDS confirmed the effective binding of ZOLE and nano-Ca@ZOLE to HA (FIG. 12). The surface composition of HA (control) was compared with that of HA-ZOLE and HA-nano-Ca@ZOLE and contrasted with their respective weight percent (wt. %, Table 4). Table 5: Elemental analysis performed by EDS for HA (control), HA-ZOLE (control), and HA-nano-Ca@ZOLE (experimental) after the binding assay. The magnification used for elemental composition analysis was 10,000x in all surface measurements.

| | HA^{a} | HA-ZOLE^{b} | HA-nano-Ca@ZOLE^{c} |
|---|---|---|---|
| Element | (wt. %) | (wt. %) | (wt. %) |
| Calcium | 42.73 | 34.17 | 41.54 |
| Carbon | 7.14 | 11.73 | 8.37 |
| Oxygen | 29.37 | 35.11 | 30.38 |
| Phosphorous | 20.76 | 18.99 | 19.80 |

^{a}[Ca₅(OH)(PO₄)₃],
^{b}(C₅H₁₀N₂O₇P₂),
^{c}[Ca(C₁₀H₁₈N₄O₁₄P₄)]•3H₂O

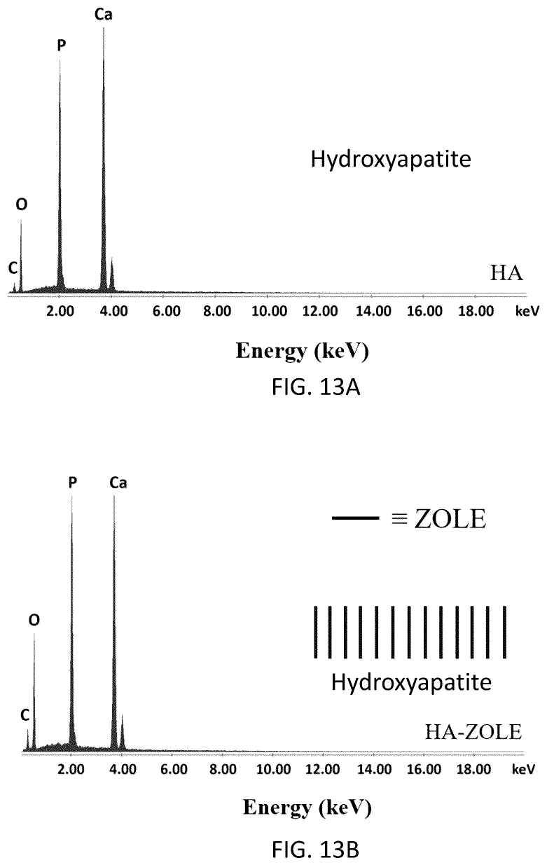

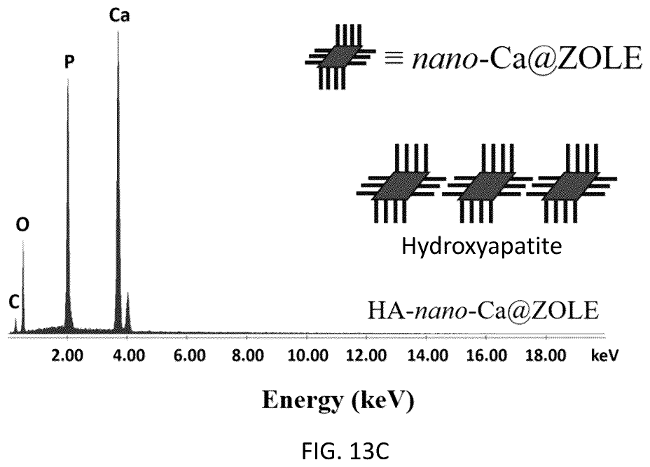

EDS analysis of HA (Ca₅(OH)(PO₄)₃, control) corroborated the elemental composition of this mineral (FIG. 13, panel A). A significant difference in the relative concentration of calcium between each sample supported the effective binding of both ZOLE (C₅H₁₀N₂O₇P₂, control) and nano-Ca@ZOLE (Ca(C₁₀H₁₅N₄O₁₄P₄))·3H₂O, experimental) to HA. For HA-ZOLE (34.17 wt. %) this concentration decreased significantly when compared to HA (42.73 wt. %). This is likely due to ZOLE (C₅H₁₀N₂O₇P₂) being incorporated as a monolayer onto the surface of the mineral, thus shielding the detection of calcium ions from HA (FIG. 13, panel B). For HA-nano-Ca@ZOLE, the relative concentration of observed calcium (41.54 wt. %) was higher than that observed for HA-ZOLE (34.17 wt. %) but lower than HA (42.73 wt. %). This was due to the nano-Ca@ZOLE binding mechanism, which suggested formation of layers of the nanocrystals on the HA surface that shielded detection of calcium ions (FIG. 13, panel C). The difference in relative concentration of calcium for HA-ZOLE and HA-nano-Ca@ZOLE was based on the molecular proportion of this metal in ZOLE (0 calcium atoms per formula unit) and nano-Ca@ZOLE (1 calcium atom per formula unit), resulting in a slight increase on the detection of calcium for the nanomaterial. A small increment in the phosphorous signals between the controls and the experimental groups was observed as a consequence of the similar composition of this element in these materials. The relative concentration of oxygen increased for both experimental (HA-nano-Ca@ZOLE) and control group (HA-ZOLE) compared to HA, suggesting the presence of ZOLE or nano-Ca@ZOLE bound to the surface of HA. The higher concentration of oxygen was observed for HA-ZOLE (35.11 wt. %) when compared to HA-nano-Ca@ZOLE (30.38 wt. %), because of the maximum binding achieved of the ligand (82%) in contrast to the maximum binding of the nanomaterial (36%). HA presented a carbon signal (7.14 wt. %) that can be attributed to the conductive tape used for mounting the solid samples. The relative concentration of carbon for HA-ZOLE (11.73 wt. %) and HA-nano-Ca@ZOLE (8.37 wt. %) slightly increased due to the presence of this element in both materials.

### Example 12: Cytotoxicity Assays of Nano-Ca@ZOLE

In this Example, the human breast cancer MDA-MB-231 and the osteoblast-like hFOB 1.19 cell lines were selected to assess cytotoxicity effects of nano-Ca@ZOLE nanocrystals. The MDA-MB-231 cell line represented a model of breast-cancer-induced OM that possess micro-RNAs involved in the development of bone metastasis. While, the immortalized human fetal hFOB 1.19 cell line is a homogeneous model that allows the study of osteoblast differentiation, these cells were employed to imitate the normal human bone microenvironment. To determine the IC₅₀ values against MDA-MB-231 and hFOB 1.19 cell lines, concentrations of 0-200 μM of ZOLE were employed. While the IC₅₀ for the MDA-MB-231 cell line treated with ZOLE for 72 h was found to be 35+4 μM, treatments at 24 and 48 h produced an IC₅₀>200 μM.

This result demonstrated that ZOLE (0-200 μM) showed cytotoxicity after 72h of treatment against the MDA-MB-231 cell line. The IC₅₀ for the hFOB 1.19 cell line was >200 μM at 24 h. For treatments at 48 and 72 h, the IC₅₀ was determined to be 86±3 and 49±4 μM, respectively, indicating that ZOLE (0-200 μM) can cause cell death after 48 h of treatment in the osteoblast cells.

Furthermore, for both cell lines, the % RCL was investigated at concentrations of 1.9, 3.8, 7.5, and 15 μM for ZOLE (control) and nano-Ca@ZOLE (experimental) during 24, 48, and 72 h.

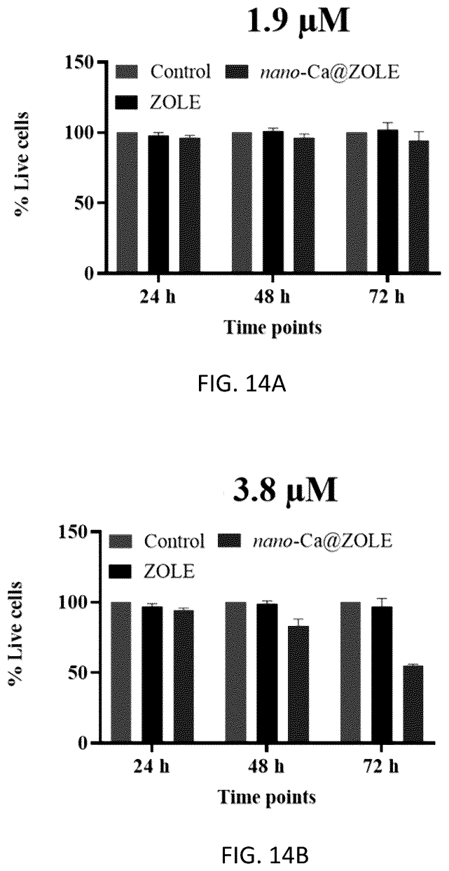

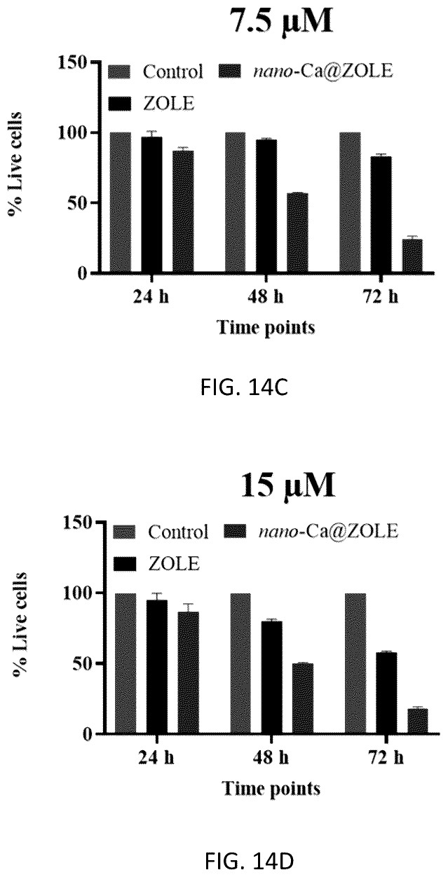

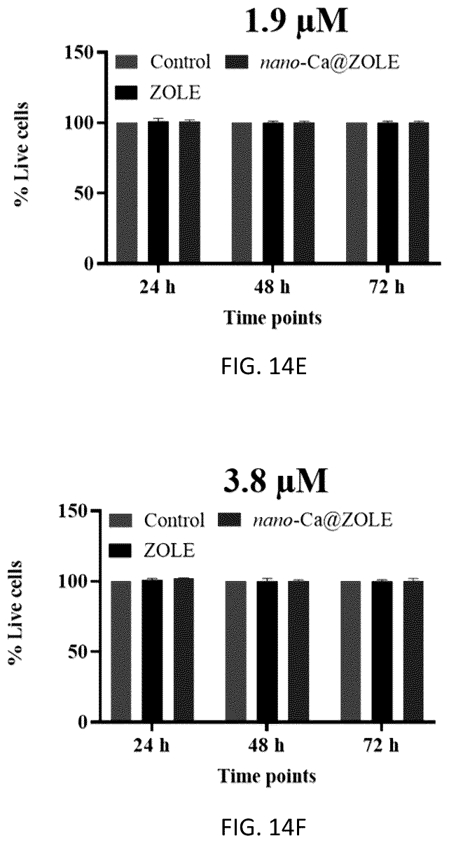

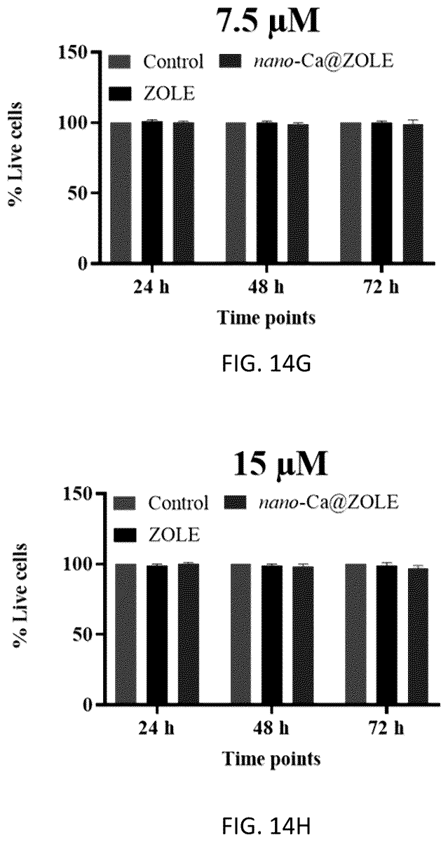

At a concentration of 1.9 μM, cell viability decreased minimally for the MDA-MB-231 cell line when treated with the nanocrystals, contrasted to ZOLE where cell viability remained at ˜100% (FIG. 14, panel A). The % RCL for MDA-MB-231 treated with nano-Ca@ZOLE at 3.8 μM decreased significantly to 83+5% and 55+1%, after 48 and 72 h, respectively (FIG. 14, panel B). At this concentration, ZOLE did not caused cell death (% RCL ˜100%) against MDA-MB-231 cells. In addition, higher cell growth inhibition of the cancerous model was observed with nano-Ca@ZOLE treatment at 7.5 μM, resulting in a % RCL of 57+1 and 24+2% after 48 and 72 h, respectively (FIG. 14, panel C). Surprisingly, at 15 μM, nano-Ca@ZOLE presented a much higher cytotoxicity effect against MDA-MB-231 cells [% RCL, 50±1 (48 h) and 18±2% (72 h)], compared to the one observed for ZOLE at this concentration [% RCL, 80±2 (48 h) and 58±2% (72 h)](FIG. 14, panel D). These results demonstrated the capacity for nano-Ca@ZOLE to induce significant cytotoxicity even at low concentrations, against cells that are prone to metastasize to the bone. Additionally, the observed efficacy beyond that of ZOLE alone clearly demonstrated that nano-Ca@ZOLE was not merely a carrier for the ZOLE molecule, but rather had synergistic effects while coordinated to the bioactive metal.

The cytotoxicity of nano-Ca@ZOLE in normal osteoblast-like cells was investigated and contrasted to that of ZOLE. Treatments were conducted with the nanocrystals (experimental) and ZOLE (control) employing the hFOB 1.19 cell line, at the same concentrations utilized for the MDA-MB-231 assays. Advantageously, nano-Ca@ZOLE did not induce cell growth inhibition against the hFOB 1.19 cell line (% RCL ˜100%) after treatment, to prevent damage to the normal cell tissue at the bone microenvironment. Interestingly, cell viability results demonstrated that no significant cell death was observed after both ZOLE and nano-Ca@ZOLE treatments at all given concentrations at 24, 48, and 72 h. After 72 h of treating the osteoblast-like cells with the nanocrystals, the resulting % RCL values were 97+2% at 1.9 μM (FIG. 14, panel E), 100+2% at 3.8 μM (FIG. 14, panel F), 99±3% at 7.5 μM (FIG. 14, panel G), and 97+2% at 15 μM (FIG. 14, panel H). These results demonstrated that at a concentration rage between 3.8-15 μM, nano-Ca@ZOLE presented significant cytotoxicity against triple-negative breast cancer cells that metastasize to the bone (MDA-MB-231), without affecting negatively normal osteoblast cells (hFOB 1.19) at the metastatic site.

### Risedronic Acid (RISE)-Containing Compounds

Calcium nitrate tetrahydrate [Ca(NO₃)₂·4H₂O, 99% pure], calcium chloride dihydrate [CaCl₂·2H₂O, USP grade], zinc nitrate hexahydrate [Zn(NO₃)₂·6H₂O, 98% pure], zinc chloride anhydrous [ZnCl₂, >98% pure], magnesium nitrate hexahydrate [Mg(NO₃)₂·6H₂O, 99% pure], magnesium chloride anhydrous [MgCl₂, >98% pure], and etidronic acid 60% aqueous solution (HEDP) were purchased from Sigma-Aldrich (St. Louis, MO). Monosodium risedronate hemipentahydrate (RISE, >97% pure) was acquired from TCI America (St. Portland, OR). The pH adjustments were obtained through a stock solution of sodium hydroxide (NaOH, USP grade, 0.3 M). Nanopure water was used as solvent in all syntheses. Phosphate buffered saline tablets, from Sigma Aldrich (St. Louis, MO), were used to make phosphate buffered saline (PBS) solutions (pH=7.40). Hydrochloric acid (HCl, 37%) and sodium chloride (NaCl, ACS reagent>99.0% pure) from Sigma-Aldrich (St. Louis, MO) were used to prepare fasted-state simulated gastric fluid (FaSSGF) solutions (pH=1.60). Heptane [CH₃(CH₂)₅CH₃, anhydrous 99%] and Brij® L4 [(C₂₀H₄₂O₅)ₙ, average Mn −362 g/mol] from Sigma-Aldrich (St. Louis, MO), were used to prepare the emulsion for the PIT determination and nano-emulsion synthesis of nano-Ca@RISE. Fetal bovine serum (FBS, mammalian and insect cell culture tested) from Sigma-Aldrich (St. Louis, MO), was used for the aggregation measurements of nano-Ca@RISE. Hydroxyapatite (Ca₅(OH)(PO₄)₃, synthetic powder) from Sigma-Aldrich (Milwaukee, WI) was utilized to carry out the binding assays of nano-Ca@RISE. Human breast cancer MDA-MB-231 cell line (ATCC® HTB-26™, Manassas, VA), normal osteoblast-like hFOB 1.19 cell line (ATCC® CRL-11372™ Manassas, VA), Dulbecco's Modified Eagle's Medium (DMEM) from Sigma-Aldrich (Milwaukee, WI), 1:1 mixture of Ham's F-12 Medium/Dulbecco's Modified Eagle's Medium (1:1 DMEM:F-12) and geneticin (G418) from Bioanalytical Instruments (San Juan, PR), penicillin-streptomycin (Pen-Strep) from Sigma-Aldrich (St. Louis, MO), and AlamarBlue® from Bio-Rad (Kidlington, Oxford) were employed to investigate the cell proliferation of RISE and nano-Ca@RISE.

Crystallization of H-RISE (protonated form). Crystallization of H-RISE (protonated form) was carried out by preparing a ligand solution (RISE) in nanopure water. HEDP was added to decrease the pH (1.61) below of the pKa's of the principal ligand (RISE) and to achieve full protonation of the phosphonate groups. Heat was applied to the resulting mixture until crystals appeared. The product was collected by vacuum filtration and air-dried.

General hydrothermal synthesis for RISE-based BPCCs. The hydrothermal synthesis of RISE-based BPCCs was carried out by preparing solutions of the ligand (RISE) and the metal salt separately in nanopure water at room temperature. 0.3 M NaOH was added to the ligand solution for pH adjustment if needed, above several of the principal species pKa's (pH=4.42-6.00). To prevent the formation of metal hydroxides of the resulting solution, the pH adjustments were kept below the M(OH)‘₈ precipitation pH. Using a syringe, the metal salt solution was added to the ligand solution and mixed thoroughly. The resulting mixture was heated until crystals were visually detected. The vials were removed from the heat and were left undisturbed to promote the growth of the crystals. The product was collected by vacuum filtration and air-dried. The nucleation induction times of the crystals varied in the range from minutes to hours. Detailed information for the synthesis conditions leading to each of the BPCC (RISE-Ca, RISE-Mg, and RISE-Zn) obtained is available in the Supporting Information.

Raman microscopy. A Thermo Scientific DXR Raman microscope, equipped with a 780 nm laser, 400 lines/nm grating, and 50 m slit, was used to record the Raman spectra. The measurements were collected at room temperature over the range of 3,400 and 100 cm¹ by averaging 32 scans with exposures of 5 sec. For data collection and analysis, the OMNIC for Dispersive Raman software version 9.2.0 was employed.

Scanning electron microscopy-energy dispersive spectroscopy (SEM-EDS). Micrographs and X-ray microanalysis were performed with a JEOL JSM-6480LV scanning electron microscope with an Evenhart Thomley secondary electron imaging (SEI) detector and an energy dispersive X-ray analysis (EDAX) Genesis 2000 detector. SEM samples were coated with a 5-10 nm gold layer with a gold sputtering target (10 s), employing a PELCO® SC-7 Auto Sputter Coater coupled with a PELCO® FTM-2 Film Thickness Monitor. Images were taken with an electron beam of 11 mm width, and an acceleration voltage of 20 kV, with a spot size value of 36, high vacuum mode and SEI signal.

Powder X-ray diffraction (PXRD). Powder diffractograms were collected in transmission mode (100 K) using a Rigaku XtaLAB SuperNova X-ray diffractometer with a micro-focus Cu-Kα radiation (λ=1.5417 Å) source and equipped with a HyPix3000 X-ray detector (50 kV, 1 mA). Powder samples were mounted in MiTeGen micro loops. The measurements were collected between 6-600 with a step of 0.01° using the Gandalfi move experiment. The CrystAllis^{PRO} software v. 1.171.3920a was used for data analysis.

Single crystal X-ray diffraction (SCXRD). To assess the quality of the crystals, they were observed under a microscope using polarized light. Optical micrographs were recorded on a Nikon Eclipse microscope LV100NPOL, equipped with a Nikon DS-Fi2 camera and NIS Elements BR software version 4.30.01. Suitable single crystals of H-RISE, RISE-Ca, RISE-Zn and RISE-Mg were mounted in MiTeGen micro loops and structural elucidation was carried out in a Rigaku XtaLAB SuperNova single micro-focus Cu-Kα radiation (λ=1.5417 Å) source equipped with a HyPix3000 X-ray detector in transmission mode operating at 50 kV and 1 mA within the CrystAllisPRO software v.1.171.3920a. The data collection was carried out at 100 K using an Oxford Cryosystems Cryostream 800 cooler. All crystal structures were solved by direct methods. The refinement was performed using full-matrix least squares on F2 within the Olex2 software v1.2. All non-hydrogen atoms were anisotropically refined.

Thermogravimetric analysis (TGA). TGA of RISE, H-RISE and RISE-based BPCCs was performed using TGA Q500 (TA Instruments Inc.). In all cases, -1-5 mg of powder sample was thermally treated between 10-700° C. at 5° C./min under a N₂ gas atmosphere (60 mL min⁻¹). Data were analyzed with TA Universal Analysis software version 4.3 Å.

Dissolution rate measurements. Dissolution profiles were performed by measuring absorbance at 260 nm via direct quantification. Dissolution measurements were recorded for the reagent grade RISE, H-RISE, RISE-Ca, RISE-Mg, and RISE-Zn in PBS and in fasted-state simulated gastric fluid (FaSSGF) against a reagent blank. Dissolution tests were performed in 100 mL of PBS (pH=7.40) or FaSSGF (pH=1.60) buffers at 37° C. under constant stirring at 150 rpm, for 48h. Absorbance measurements were collected on an Agilent Technologies Cary Series UV-Vis Spectrophotometer, Cary 100 UV-Vis model; using the UV Cary Scan software version v.20.0.470. All measurements were performed with a 400-200 nm scan.

Determination of the phase inversion temperature (PIT) and PIT-nano-emulsion synthesis of nano-Ca@RISE. The PIT-nano-emulsion method was implemented during the synthesis of a selected BPCC (RISE-Ca) to reduce its particle size. To determine the phase inversion temperature, conductivity measurements of an aqueous emulsion containing RISE, heptane (oil phase), and Brij®L4 (surfactant) were carried out in a temperature profile of 2-40° C. at 1° C./min. As the temperature of the emulsion rises, a phase inversion occurs from a conductive oil in water (0/W) micro-emulsion to a non-conductive water in oil (W/O) nano-emulsion.

Dynamic light scattering (DLS) and aggregation measurements. Samples resulting from the nano-emulsion synthesis of nano-Ca@RISE were analyzed in a Malvern Panalytical Zetasizer NanoZS equipped with a He—Ne orange laser (633 nm, max 4 mW) (Spectris PLC, Surrey, England). Data was analyzed with Malvern software version 7.12. Aliquots of 50 L of the supernatant from the aqueous phase were transferred to disposable polystyrol/polystyrene cuvettes (REF: 67.754 10×10×45 mm) (Sarsted, Germany), in a 1:20 dilution ratio with nanopure water. The refractive index of RISE in water is 1.334. This value was determined by measuring an aliquot of 2.5 mg/mL RISE stock solution with a Mettler Toledo Refracto 30GS (Mettler Toledo, Columbus, OH).

For the aggregation measurements, aliquots of 50 L of the supernatant from the water phase were transferred in disposable polystyrol/polystyrene cuvettes in a 1:20 dilution ratio with nanopure water and 1% FBS in PBS, respectively. The prepared samples remained undisturbed near the Zetasizer for 30 min prior to the measurements. Size measurements were performed in both dispersants after 0, 24 and 48 h of sample preparation. Sample equilibration inside the instrument at room temperature (25° C.) was performed for 2 min before measurements.

Hydroxyapatite (HA) binding assay. For the binding assay of nano-Ca@RISE, 20 mg of hydroxyapatite (HA) were exposed to 3 mL of a nano-Ca@RISE in PBS solution (0.5 mg/mL), for 0-11 days at 37° C. As control groups, RISE and HA, both in PBS, were employed. Samples were collected each day from 11 consecutive days. After each time point, the supernatant was collected and centrifuged (1,500 rpm, 8 min). Absorbance measurements were performed at 206 nm (nanocrystals λₘₐₓ) to determine the percentage of nano-Ca@RISE bound to HA.

Cell culture methods. The MDA-MB-231 cell line was incubated with DMEM, 1% Pen-Strep, and 10% FBS at 37° C. in 5% CO₂. The hFOB 1.19 cell line was incubated with 1:1 DMEM:F-12, 0.3 mg/mL G418, and 10% FBS at 34° C. in 5% CO₂. Cell passages were performed weekly at 80% of cell confluency, media was exchanged twice a week.

Cell treatments. Both cell lines were treated with RISE (control) and nano-Ca@RISE (experimental). First, to determine the half-maximal inhibitory concentration (IC₅₀) two-fold serial dilutions of RISE (0-200 μM) were prepared. Both cell lines (MDA-MB-231 and hFOB 1.19) were seeded in 96 well plates at 2.5×105 cell/mL. The cells were incubated for 24 h at 37° C. (MDA-MB-231) and 34° C. (hFOB 1.19), respectively. After the initial incubation period, both cell lines were treated with 100 μL of the RISE solutions previously prepared, and incubation was performed for 24, 48, and 72 h at the respective incubation temperatures. For both cell lines, media (MDA-MB-231: DMEM, Pen-Strep) and (hFOB 1.19: DMEM, F-12, G418) were used with control groups. AlamarBlue® assay was utilized to determine cell proliferation, for this, 10% of AlamarBlue® solution in PBS was prepared. Finally, the media was removed from the 96 well plates, 100 μL of 10% AlamarBlue® solution was added, and the cells were incubated for 4 h at the same previously mentioned conditions. After the AlamarBlue® assay, the fluorescence (λ_{exc}=560 nm, λₑₘ=590 nm) was evaluated employing an Infinite M200 PRO Tecan Microplate Reader. The live cells were assessed comparing the viability of the control group (100%) with the cells treated with the RISE solutions. The nonlinear regression method using Graph Pad Prism 8 was applied to fit the dose-response curves (% cell live vs concentration) and determined the IC₅₀ values for RISE.

The percentage of relative cell live (% RCL) for RISE (control) and nano-Ca@RISE were additionally investigated at selected concentrations (35, 40, 45 and 50 μM) in both cell lines. Treatments at these concentrations were carried out at 24, 48, and 72 h for RISE and nano-Ca@RISE. The cell seeding and AlamarBlue® assay were completed as described above for the IC₅₀ determination in both cell lines. Graph Pad Prism 8 was utilized to plot the % RCL found at concentrations of 35, 40, 45 and 50 μM after 24, 48, and 72 h of treatment. All experiments were performed in triplicates and the data was statistically treated using mean, standard deviation, and the coefficient of variation percentage (% CV).

### Results and Discussion.

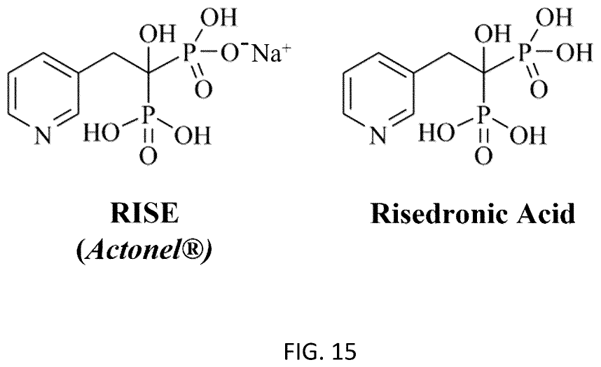

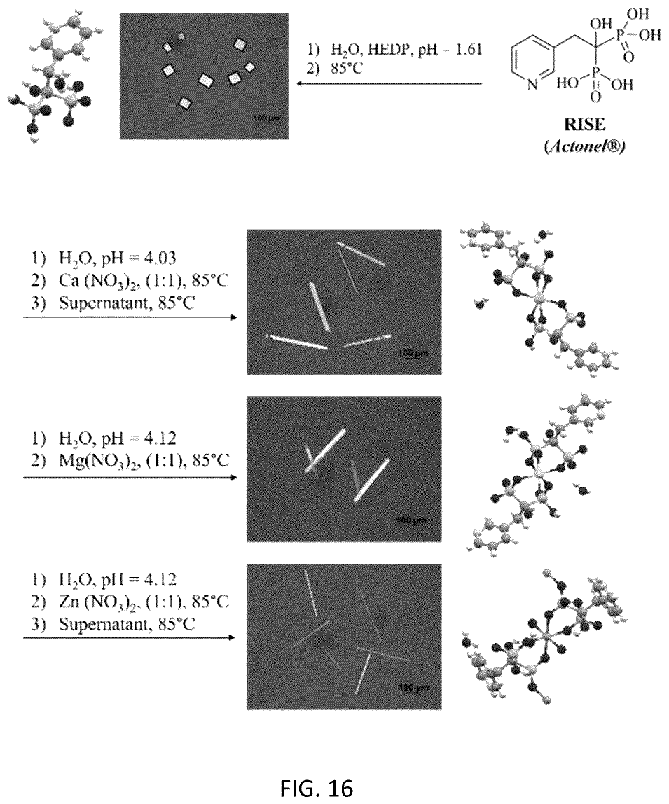

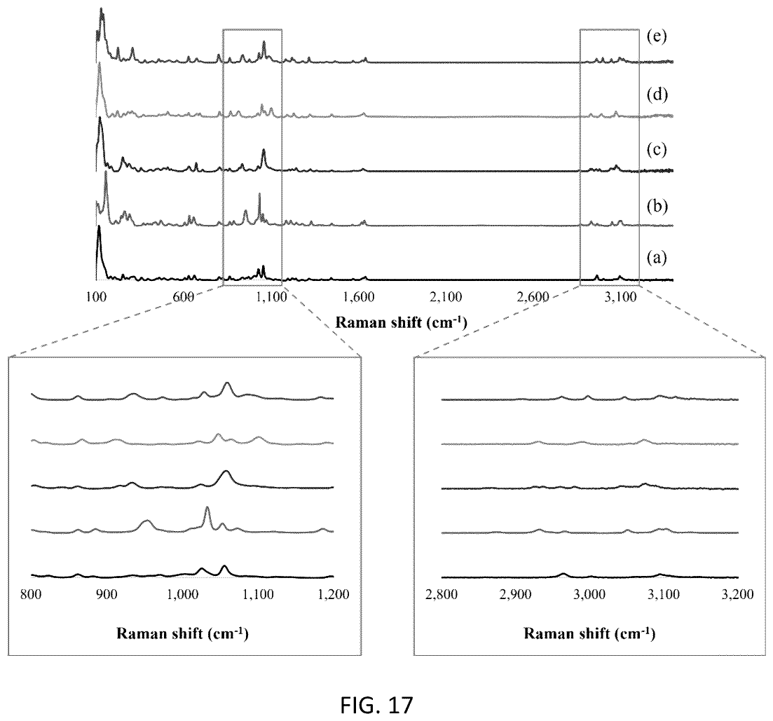

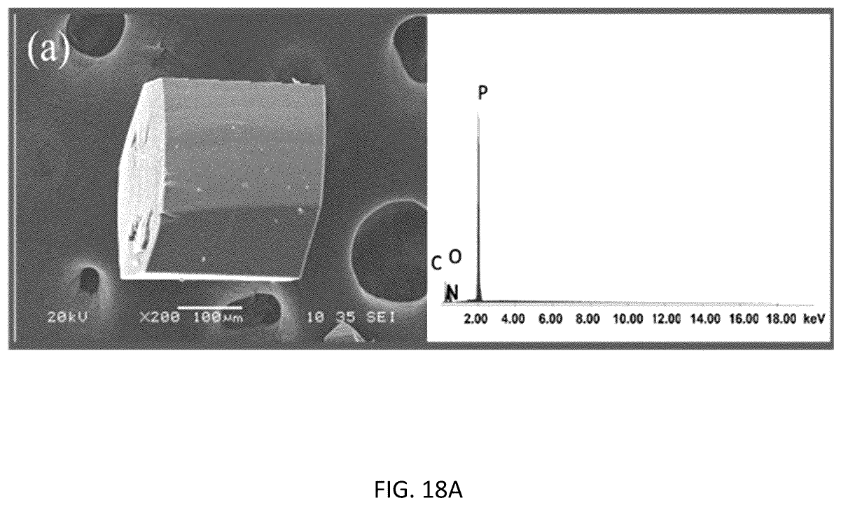

Three crystalline products were obtained by employing a 1:1 M²⁺ BP molar ratio at 85° C. and in acidic conditions (pH=4.12) in the proposed design space for the hydrothermal reaction syntheses (FIG. 15, right). Moreover, addition of HEDP to the ligand solution was done to decrease the pH of the reaction (pH=0.93) to explore more synthetic pathways that could yield polymorphs of the BPCCs synthesized at pH=4.12. A crystalline product was observed after several minutes of heat application, but it was further demonstrated that it was RISE in its protonated form (acidic form, H-RISE) recrystallized (FIG. 15, left). Moreover, it was observed that the variation of the anion of the metal salt (NO₃⁻ vs. Cl⁻) highly influenced the crystal quality of the resulting BPCCs. Employing the respective nitrate metal salt, three coordination complexes with crystal quality for structural elucidation by single crystal X-ray diffraction were obtained as seen under polarized light (FIG. 15). Interestingly, the reaction of RISE with the selected metal ions yielded crystalline materials with the similar morphology, which corresponded to the acicular crystal habit.

Solid-state characterization, structural stability in physiological media, particle size and aggregation measurements of the obtained RISE-based BPCCs were assessed to determine their potential for biomedical applications as a nanocrystals-based therapy against OM.

### Raman Spectroscopy Analysis.

Representative Raman spectra of the isolated RISE-based BPCCs were collected from 3,400 to 100 cm⁻¹ and are shown in FIG. 17. The presence and absence of different Raman shifts between H-RISE, RISE, and the RISE-based BPCCs spectra confirm that a distinctive solid-form was produced by the hydrothermal synthesis. Significant differences were observed among the three crystalline phases, compared to the ligand. Two different characteristic signals can be observed in the 3,100-2,900 cm⁻¹ region. These bands correspond to the hydrogen phosphate H—OPO₂ C moieties (3,100-2,900 cm⁻¹) and the stretching vibrations vO-H/H₂O (3,000-3,100 cm ⁻¹) due to coordinated and lattice water molecules in the crystal structure, and hydroxyl group in RISE. This suggests that an extensive hydrogen bonding is present within the crystal structure of the RISE-based BPCCs. Compared to RISE, the appearance and increased intensity of signals at ˜3,000 cm⁻¹ for the coordination complexes corroborates the presence of different strong hydrogen bonds within each lattice. Additionally, H-RISE presents additional signals around this region due to the presence of hydrogen bond interactions from the protonated phosphonate groups within its crystal lattice. The band at 1,320 cm⁻¹ can be attributed to the P═O deformation vibration, while the differences observed in the signal at around 1,190 cm⁻¹ are characteristic of vP═O/δ^{π} POH stretching vibrations. The incorporation of RISE in the coordination sphere of the resulting materials is confirmed by two bands at 1,060 cm⁻¹ (strong) and 1,020 cm⁻¹ (medium), respectively. This strong signal is characteristic for the v^{as}P—O(H) asymmetric stretching vibrations, while the medium signal corresponds to the δPO—H bending of the phosphonate P—O₃ groups. Formation of a coordination sphere in the BPCCs was additionally corroborated by the absence of a strong signal at 960 cm⁻¹, which is present in H-RISE. This signal corresponds to the symmetric v^{s}P—O(H) stretching vibrations of the protonated sites from the phosphonate moieties in the ligand. This corroborates the protonation of the phosphonate groups after being crystallized. Due to the interaction of phosphonate deprotonated sites with the metal ions within the BPCCs structures, the absence of this signal at this region was expected. Moreover, this symmetric stretching was expected to occur at lower Raman shifts (950-800 cm⁻¹) for the coordination complexes as observed from their Raman spectra. Different vibrational modes of coordination of the divalent metal ions (M²⁺) with phosphorus bonded oxygen atoms, induce changes in the P—O bond order, generating the differences observed in the symmetric and asymmetric P—O(H) stretching vibrations among the BPCCs and the ligand. Some Raman shifts can be observed at lower wavenumber (<1,000 cm⁻¹), which are assigned to vibrational modes characteristics of the CH₂, C—C, C—P, C—OH and M²⁺—O groups present in the RISE-based BPCCs.

Scanning electron microscopy-energy dispersive spectroscopy (SEM-EDS).

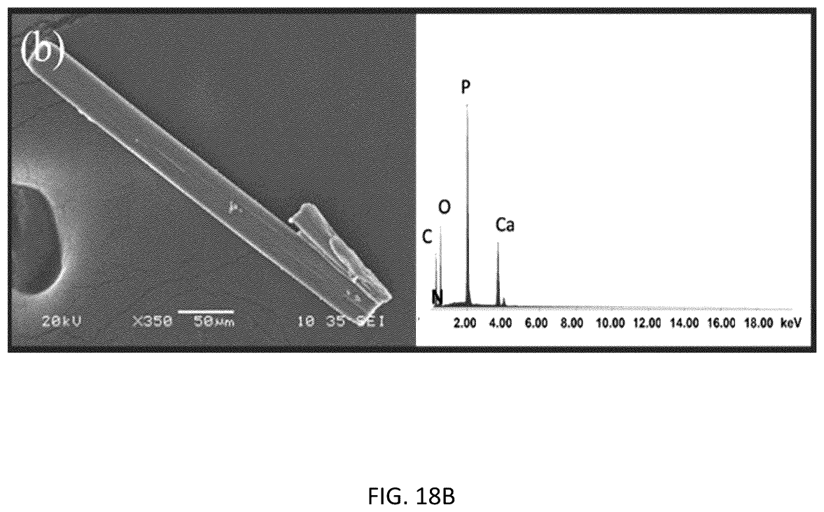

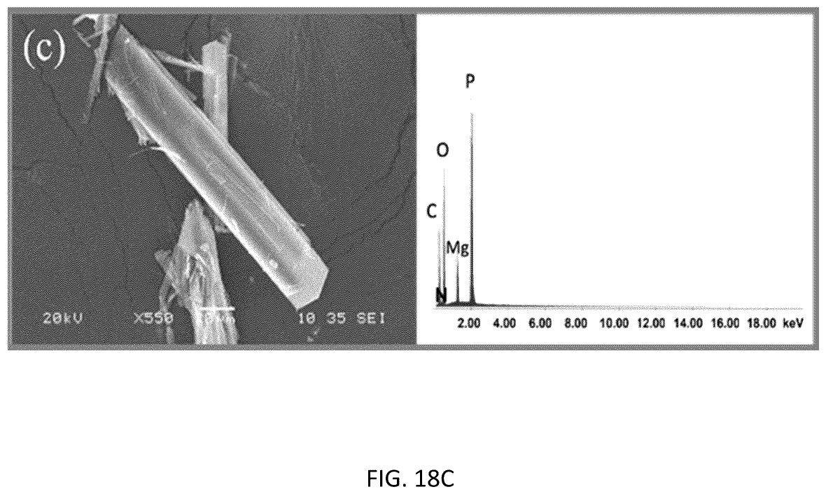

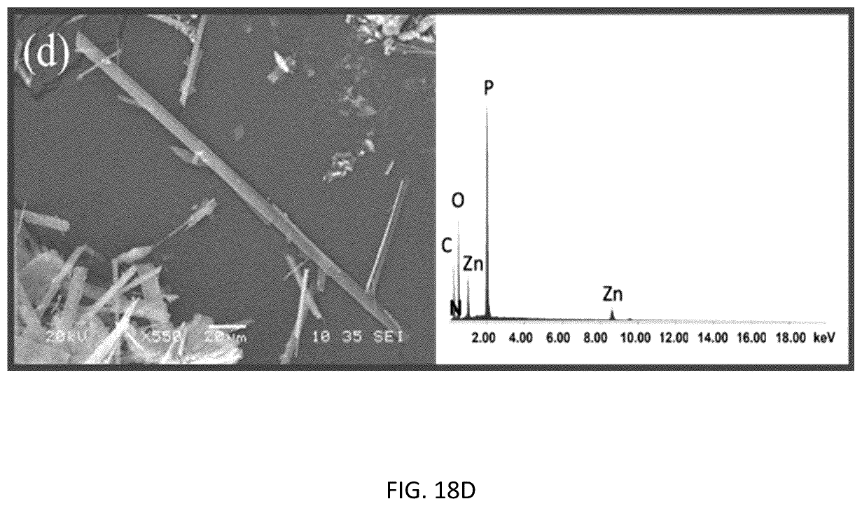

To assess the morphology and elemental composition of the yielded crystalline materials, analysis with SEM-EDS was performed to H-RISE and the RISE-based BPCC crystals. Representative SEM images demonstrate a distinct morphology for H-RISE and similar well-defined morphologies for all the BPCCs (FIG. 18). All three coordination complexes crystallize in an acicular crystal habit, with needles in a size range of 100-450 m, while H-RISE crystallized in a cubic crystal habit, with a diameter of the crystals between 200-300 m.

The EDS spectra of these coordination complexes exhibit characteristic signals of the metal (calcium, magnesium, and zinc) and of the elements present in the molecular structure of RISE (carbon, oxygen, nitrogen, and phosphorus) (FIG. 18). EDS spectra of H-RISE confirmed that the crystallized product was the ligand, these without the detection of any other element within its structure. These results, along with the Raman spectra analysis support, thus far, that the hydrothermal reactions have produced three crystalline phases that are distinct from the starting materials employed.

FIG. S6.1.1-6.1.4 represent energy dispersive spectra of H-RISE and the RISE-based BPCCs. FIGS. S6.2.1-S6.2.4 depict the scanning electron micrographs showing single crystals and clusters of H-RISE and the synthesized RISE-based BPCCs.

Powder X-ray diffraction analysis (PXRD).

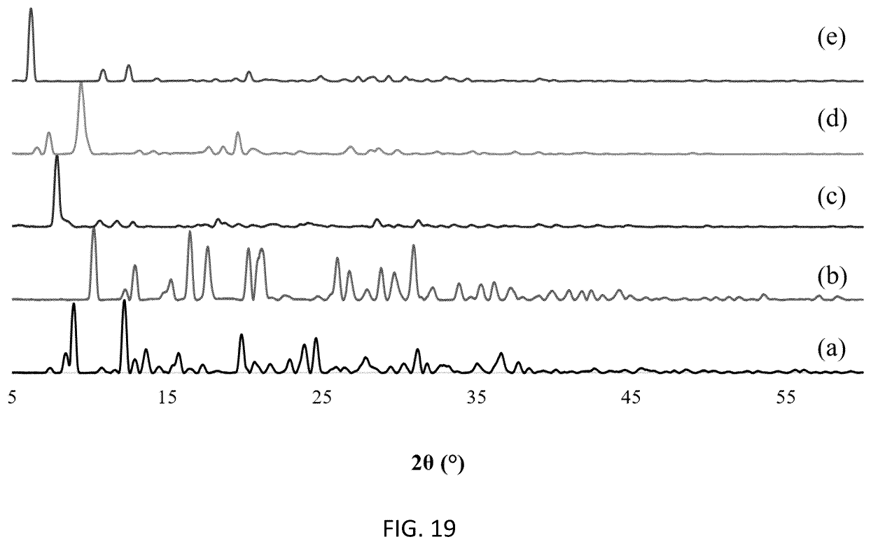

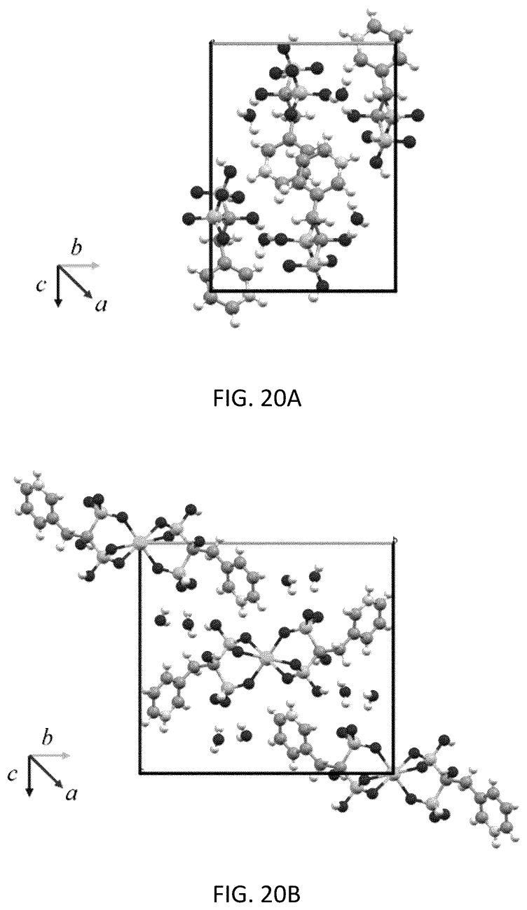

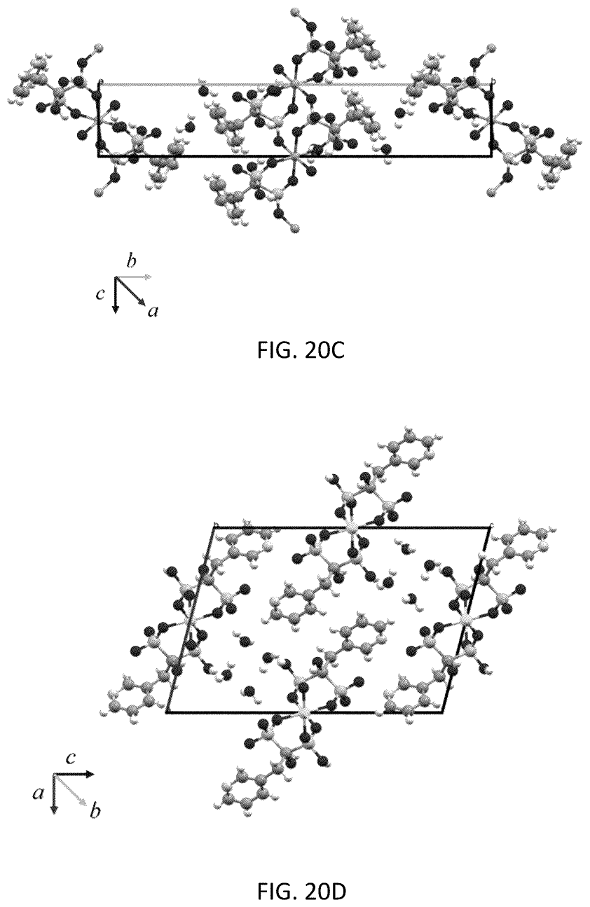

Representative PXRD diffractograms of RISE, H-RISE and the coordination complexes, revealing a high degree of crystallinity of the materials, are shown in FIG. 19. All RISE-based BPCCs presented a unique crystal structure compared to the starting materials, confirming that recrystallization of the RISE ligand and the metal salt was not occurring. Additionally, the three BPCCs phases resulted structurally distinct among each other based on the diffractograms. The high angle peaks (>5° in 20) suggest that all four crystals are composed of 2D layers instead of 3D porous networks. The crystallization of the coordination complexes in 2D sheets will allow the BPCC to degrade selectively and subsequently release the BP from the structure for its intended therapeutic treatment.

Previously reported structures of coordination complexes containing RISE were compared to the ones described within this work.^{18,20,22} Interestingly, the RISE-based BPCCs resulted in unique materials when compared to other previously phases reported in literature containing Cd²⁺, Cu²⁺, and Ni^{2+18,20,22}

Single crystal X-ray diffraction (SCXRD) analysis.

Structural elucidation of the three RISE-based BPCCs crystals obtained was performed to confirm the formation of these materials. Crystallographic parameters of the structure refinements for H-RISE and RISE-based BPCCs are summarized in Table 1. Oak Ridge Thermal Ellipsoid Plots (ORTEPs), packing motifs, asymmetric units, and simulated powder pattern overlays between already reported RISE metal complexes and the ones synthesized within this work are available in the Supporting Information.^{18,20,22}

FIG. S4.1-S4.4 display the ball-stick representation of the asymmetric unit and crystalline packing for the refined structures. FIGS. 4.5-4.8 show the Oak Ridge Thermal Ellipsoid Plots (ORTEPs) for each crystal structure of H-RISE and the RISE-based BPCCs. FIGS. S4.9-S4.12 depict an overlay of the simulated and experimental powder patterns for all structures solved. FIGS. S4.13-S4.14 show distinct overlays of the simulated powder diffraction pattern overlay for other previously known structures of RISE metal complexes in comparison to the structures solved within this work. Simulated PXRDs were extracted from the crystallographic information files (CIF files) obtained from the Cambridge Structural Database or obtained within this work.

TABLE 6
Summary of the crystallographic parameters of the structure refinements of the
isolated H-RISE and the RISE-based BPCCs; RISE-Ca, RISE-Mg, and RISE-Zn.

| Compound | H-RISE | | RISE-Ca | | RISE-Mg | | RISE-Zn | |
|---|---|---|---|---|---|---|---|---|
| Empirical formula | C₇H₁₁NO₇P₂•H₂O | | [Ca_{0.5}(C₇H₉NO₇P₂)]•2H₂O | | [Mg_{0.5}(C₇H₈NO₇P₂)]•2H₂O | | [Zn_{0.5}(C₇H₉NO₇P₂)]•2H₂O | |
| FW (g/mol) | 301.12 | | 338.17 | | 328.27 | | 349.81 | |
| Space group | P2₁/n | | P2₁/n | | P2₁/n | | P2₁/n | |
| Temperature (K) | 104 | (5) | 100.02 | (18) | 223 | (110) | 100 | (1) |
| λ (Å) | 1.54184 | | 1.54184 | | 1.54184 | | 1.54184 | |
| a (Å) | 7.10270 | (10) | 5.08867 | (5) | 13.1771 | (9) | 8.152 | (3) |
| b (Å) | 10.69540 | (10) | 16.59739 | (14) | 5.1651 | (3) | 28.2673 | (14) |
| c (Å) | 14.7084 | (2) | 15.19404 | (11) | 19.0084 | (10) | 10.101 | (3) |
| α (°) | 90 | | 90 | | 90 | | 90 | |
| β (°) | 102.2280 | (10) | 95.0417 | (8) | 104.477 | (6) | 149.02 | (8) |
| γ (°) | 90 | | 90 | | 90 | | 90 | |
| V (Å³) | 1091.99 | (2) | 1278.302 | (19) | 1252.65 | (13) | 1198.0 | (15) |

| | | | | |
|---|---|---|---|---|
| Z | 4 | 4 | 4 | 4 |
| ρ_{calc} (g/cm³) | 1.832 | 1.757 | 1.741 | 1.939 |
| R_{wp} | 0.1295 | 0.0735 | 0.3158 | 0.1723 |
| Rₚ | 0.0504 | 0.0271 | 0.1191 | 0.0620 |

Abbreviations: λ (X-ray source wavelength, Å), a/b/c (unit cell lengths, Å), α/β/γ (unit cell angle, °), V (unit cell volume, Å³), Z (number of formula units per unit cell), ρ_{calc} (unit cell calculated density, g/cm³), R_{wp} (weighted R-factor, %), and Rₚ (R-factor, %).

Structural description of H-RISE. The compound C₇H₁₁NO₇P₂·H₂O crystallizes in the space group P2_{1/n}, containing a RISE molecule in the asymmetric unit with a single lattice water molecule. Four RISE molecules are contained within the unit cell (Z=4). The conformation of the ligand is reinforced by a single intramolecular hydrogen bond between oxygens from the phosphonate moieties (O2 . . . O6, 3.026 Å). The RISE molecules are linked into molecular chains that propagate along the α-axis through strong intermolecular hydrogen bonds between the single lattice water molecule (O8 . . . O1, 2.666 Å; O8-H8B . . . O5, 2.693 Å) and oxygen atoms from the bisphosphonate group (O3-H3 . . . O6, 2.637 Å). Adjacent molecular chains are linked by intermolecular hydrogen bonds, resulting in their propagation along the b-axis (O4-H4 . . . O5, 2.717 Å; O7-H7 . . . O8, 2.489 Å). A single intermolecular hydrogen bond propagates molecular chains along the c-axis through the nitrogen of the pyridine and oxygen from the phosphonate moiety (N1-H1 . . . O6, 2.850 Å).

Structural description of RISE-Ca. The structure of the compound [Ca_{0.5}(C₇H₉NO₇P₂)]·2H₂O, which crystallizes in the P2_{1/n} space group, has not been previously reported. The asymmetric unit contains one bidentate RISE ligand coordinated to a Ca²⁺ center, surrounded by two uncoordinated water molecules. The Ca²⁺ center is in a distorted octahedral environment (supplementary angles: O1-Ca1-03, 76.91°, O1-Ca1-O5, 82.42°, O3-Ca1-O5, 88.30°), with four RISE ligands coordinated. Two different binding modes are observed for the RISE molecules. One RISE ligand is coordinated to the Ca²⁺ cation in a bidentate mode alternating oxygen from the bisphosphonate group, while another RISE ligand in a monodentate mode. The Ca—O bond distances range between 2.263 and 2.367 Å. The metal cluster is linked by a single RISE molecule coordinated to form a chain (Ca1-01-P1-O3-Ca1) that propagates slightly tilted along the α-axis. This chain is additionally reinforced by intermolecular hydrogen bonds (O3 . . . O1, 2.571 and 2.935 Å; O6 . . . O7, 2.766 Å). Adjacent molecular chains are linked by uncoordinated water molecules forming hydrogen bonds either with the oxygens of the bisphosphonate moieties or the water molecules along the b-axis (O2-H2 . . . O8, 2.637 Å and O9-H9B . . . O8, 2.990 Å). The structure is reinforced by additional intramolecular hydrogen bonds through the b-axis, which involves the oxygens from the bisphosphonate groups (O1 . . . O2, 2.443 Å; O5 . . . O6, 2.522; 05 . . . O7, 2.570 Å). An extensive network of intermolecular hydrogen bonds facilitated by the uncoordinated water molecules and the nitrogen from the pyridine group of the ligand, serves to propagate adjacent molecular chains along the c-axis (O7 . . . H9 Å-O9, 2.961 Å; O8-H8B . . . O7, 2.876 Å; O6 . . . O8, 2.854 Å; Ni-Hi . . . O1, 2.791 Å).

Structural description of RISE-Mg. The compound [Mg_{0.5}(C₇H₈NO₇P₂)]·2H₂O crystallizes in the P2_{1/n} space group and presents a unique packing arrangement when compared to other RISE-based metal complexes previously reported. The asymmetric unit has one RISE molecule coordinated to a Mg²⁺ center, surrounded by two uncoordinated water molecules. The Mg²⁺ center is in a rather regular octahedral environment (supplementary angles: O1-Mg1-O5, 88.78°, O1-Mg1-O7, 91.01°, O5-Mg1-O7, 90.77°), with four RISE ligands coordinated. The metal centers coordinate the ligand in a bidentate mode (O1-Mg1-O7) forming a six-membered chelate ring. The Mg—O bond distances range between 2.023 and 2.099 Å. The same metal center coordinates to the ligand in a monodentate mode (Mg1-O5). Coordination between the Mg²⁺ cation and the O5 and O7 from the RISE molecule results in the formation of an eight-membered chelate ring that fuses adjacent metal centers, forming a chain that propagates through the b-axis. This chain is reinforced by intramolecular hydrogen bonds (O1 . . . O2, 3.021 Å; O1 . . . O7, 2.889 Å; O5 . . . O1, 2.870 Å; O5 . . . O7, 2.975 Å; O5 . . . H4-04, 2.716 Å). These chains propagate along the c-axis through an extensive network of hydrogen bonds that form either with the pyridine group or the uncoordinated water molecules (N1 . . . O-3, 2.573 Å; O1 . . . H8B-O8, 2.767 Å; O6-H6 . . . O9, 2.685 Å; and O8 . . . O9, 2.845 Å). Propagation of the metal cluster though the α-axis can be described by the presence of an ac glide plane symmetry element, which is perpendicular to b [0, 1, 0] with glide component [1/2, 0, 1/2]. Moreover, the metal cluster is reinforced by intramolecular hydrogen bonds (O1 . . . O3, 2.540 Å; and O2 . . . O7, 2.804 Å) also through the α-axis.

Structural description of RISE-Zn. The compound [Zn_{0.5}(C₇H₉NO₇P₂)]·2H₂O crystallizes in the space group P2_{1/n}, with one RISE molecule coordinated to a Zn²⁺ center surrounded by two uncoordinated water molecules in the asymmetric unit. The Zn²⁺ center is in a rather regular octahedral environment (supplementary angles: O1-Zn1-O2, 89.39°, O1-Zn1-O4, 91.47°, O2-Zn1-O4, 89.10°), with four RISE ligands coordinated. The Zn-O bond distances range from 2.010 to 2.166 Å. Intramolecular hydrogen bonds reinforce the metal cluster (O2 . . . H7 Å-O7, 2.648 Å). The ligand is coordinated to the metal center in a bidentate mode (O1-Zn1-O4), forming a six-membered chelate ring. The same ligand is coordinated to the Zn²⁺ center in a monodentate mode (Zn1-O2). Coordination between the Zn²⁺ cation and the O1 and O2 from the RISE molecule results in the formation of an eight-membered chelate ring that fuses adjacent metal centers, resulting in the propagation of molecular chains through the c-axis. An extensive hydrogen bond network reinforces the chains along the b-axis connecting adjacent chains through one of the uncoordinated lattice water molecules (O6 . . . H9 Å-O9, 2.774 Å; O9 . . . H9B-O9, 2.792 Å). These chains propagate along the α-axis through an additional extensive network of hydrogen bonds that form either with the pyridine group or the other uncoordinated water molecule (N1-H1 . . . 06, 2.683 Å; N1 . . . O5, 3.026 Å; O3 . . . O8, 2.642 Å; O8-H8B . . . O4, 2.775 Å; O8 . . . O8, 2.969 Å). When compared to other structures of RISE-based metal complexes previously reported, RISE-Zn presents a unique packing arrangement.

### Thermogravimetric Analysis (TGA).

TGA thermographs of the coordination complexes were obtained in which three principal thermal events are observed. Most of the BPCCs are stable up to 200° C., where the first thermal event occurs, corresponding to the desolvation of the coordinated and/or lattice water molecules from the crystal structure. The organic combustion of the ligand was observed above 250-300° C. for each coordination complex. Lastly, the thermal degradation of the metal/metal oxide from the coordination sphere accounted for a minor weight loss that was observed at higher temperatures (>400° C.).

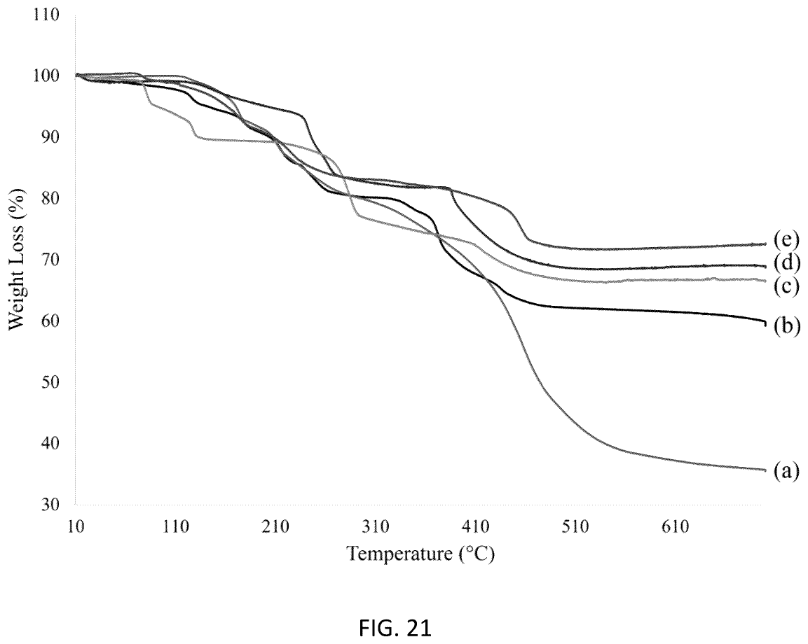

TGA thermographs of the RISE-based BPCCs were compared to the ligand (RISE) and its protonated form (H-RISE). Results on FIG. 21 showed that all RISE-based BPCCs presented higher thermal stability than the ligand (salt and protonated form). Higher thermal stability was observed for RISE-Ca when compared to RISE-Mg and RISE-Zn.

FIG. S5.1-5.4 depict overlay of thermographs for H-RISE, the RISE-based BPCCs and RISE recorded in a TGA Q500 (TA Instruments Inc.) using a temperature range of 10-700° C. at 5° C./min under a N₂ gas purge (60 mL/min). In all cases, ˜1-5 mg of powder sample was thermally treated. TGA data was analyzed with TA Universal Analysis software version 4.3 Å. TGA analysis of the “as received” RISE shows a low temperature (100° C.) weight lost which corresponds to the dehydration of the ligand (hemipentahydrate). Subsequently, at 250-350° C., weight loss occurred, which was attributed to the decomposition of RISE.

Dissolution Profiles for the RISE-based BPCCs.

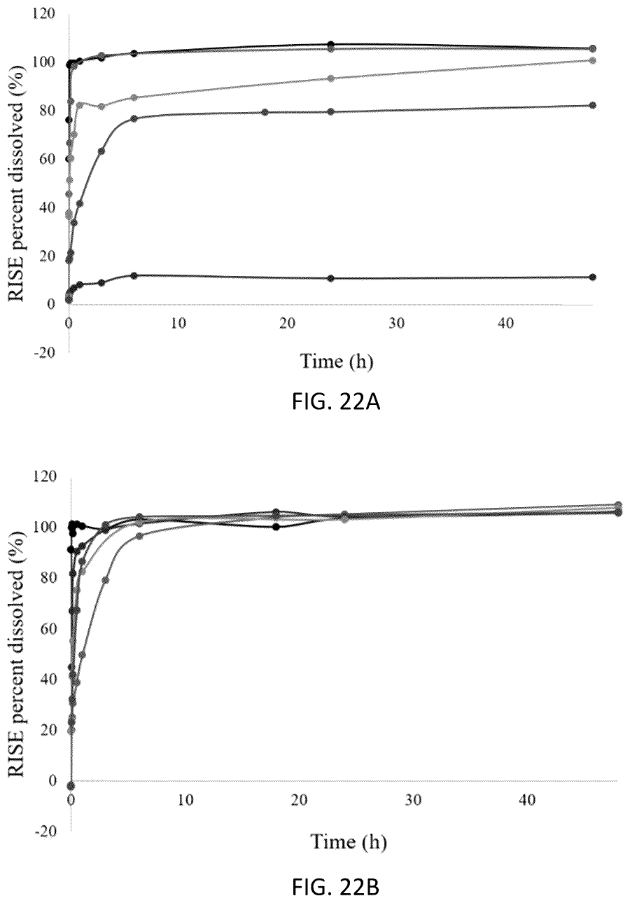

The dissolution of RISE, H-RISE and the RISE-based BPCCs under simulated physiological conditions (PBS, pH=7.40; and FaSSGF, pH=1.60) was assessed to verify the structural stability of these materials. The degradation of the RISE-based BPPCs was quantified via direct UV-Vis spectroscopy (λₘₐₓ=260 nm). Dissolutions profiles of the RISE-based BPCCs were compared to that of RISE and H-RISE. The administered dosage of RISE in tablets is 35 mg,^{23,24} which correspond to the initial weight for the RISE-based BPCCs, H-RISE and RISE (active ingredient in Actonel@) for the dissolution measurements. Results from dissolution assays in PBS (FIG. 22A) demonstrate that RISE and H-RISE reached a higher equilibrium solubility (100% in 30 min) faster than the RISE-based BPCCs (70-85% in 18-24 h). RISE-Ca presented a distinctly lower equilibrium solubility in PBS, reaching its maximum concentration of RISE (˜10%) in 6 h.

FIG. S7.1-S7.2: depict the absorption spectra with the respective calibration curve for the RISE quantification in PBS.

To further investigate if the RISE-based BPCCs present a pH-dependent degradation, dissolution of the metal complexes in FaSSGF was performed. From the dissolution assays in FaSSGF, results demonstrate that RISE (Actonel®) presents a higher dissolution rate compared to PBS, reaching its maximum equilibrium solubility (100%) in 1 min (FIG. 22B). All RISE-based BPCCs present significantly higher dissolution rate and equilibrium solubility in acidic media (100% in 3 h), compared to their dissolution rate in PBS (70-85% in 18-24 h). The lowest dissolution rate observed corresponds to H-RISE, which reached its maximum equilibrium solubility (100%) in 18 h. The observed pH-dependent dissolution is desirable because it may allow RISE-based BPCCs nanoparticles to circulate longer allowing them to sustain blood plasma concentrations for RISE and reach the target site. Once there, this material might be able to degrade due to the increased acidic microenvironment at the metastatic site.^{25,26,27} These results provide evidence of the structural stability of the RISE-based BPCCs in physiological media, and hint at their ability to degrade releasing the drug content (RISE) in a controlled and pH-dependent manner. Because these materials are not able to encapsulate drugs within their 2D structure, the degradation of the BPCC itself could provide the release of the BP (RISE) at the metastatic site.

Phase Inversion Temperature (PIT)-nano-emulsion synthesis of nano-Ca@RISE.

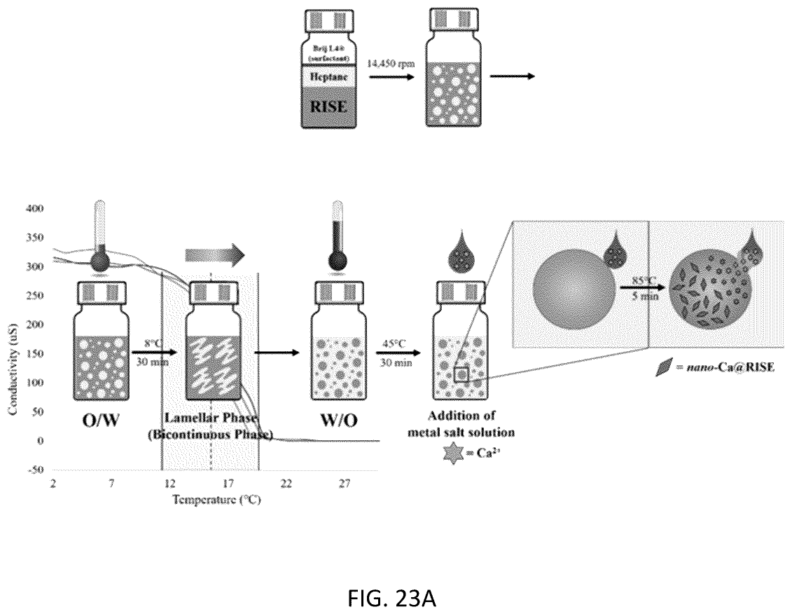

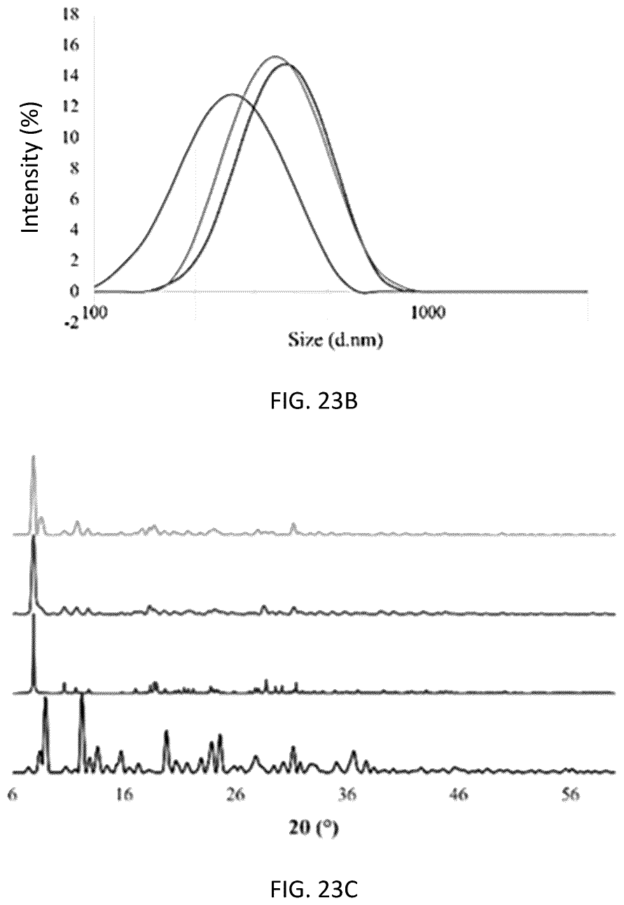

A PIT-nano-emulsion method was employed during the synthesis of a selected RISE-based BPCC to reduce its particle size. RISE-Ca was used since it demonstrated a higher thermal stability and pH-dependent degradation. To determine the PIT temperature, conductivity measurements of a homogenized aqueous solution containing RISE, heptane and a surfactant (Brij®L4), were performed. This emulsion results in an oil-in-water (O/W) system reporting an average value of −340.0 S with measurements starting at 2° C. As the emulsion is heated (1° C./min), a phase inversion occurs from the O/W micro-emulsion to a water in oil (W/O) nano-emulsion. The phase inversion started at 11° C. and ended at 20° C., where the conductivity measurements dropped to an average value of −9.74 p S. FIG. 23A shows the PIT of the RISE/Heptane system in which it was observe an average temperature for the phase inversion of −16° C.

After identifying the PIT, the synthesis of nano-Ca@RISE was performed. An emulsion comprised of a RISE solution, heptane, and Brij® L4 was homogenized and treated using the PIT- nano-emulsion method. When the formation of droplets containing the ligand solution were obtained, addition of the metal salt solution promoted the formation of the nano-Ca@RISE nanoparticles. Particle size analysis using dynamic light scattering (DLS) demonstrated average particle size distributions of 269.8, 385.1 and 371.0 d.nm, and average polydispersity index (PDI) values of 0.738, 0.604 and 0.495 (FIG. 23B). This PDI values are representative of moderately monodisperse nanoparticles. The hydrothermal synthesis for the BPCC was adapted using the PIT-nano-emulsion method. By limiting the available space and confining the crystallization process, the size of the particles was decreased from a micron range of −300 μm to a nano range of −342 d.nm. To verify the crystal phase of nano-Ca@RISE against the bulk material (RISE-Ca), PXRD analysis was carried out on a micron-sized agglomerate. PXRD results demonstrated that the crystal phase of nano-Ca@RISE particles and RISE-Ca bulk crystals are isostructural (FIG. 23C). Therefore, the crystal phase of RISE-Ca was maintained through the successful decrease of the crystal size by applying the PIT nano-emulsion method.

Aggregation measurements of nano-Ca@RISE in biorelevant dispersant.

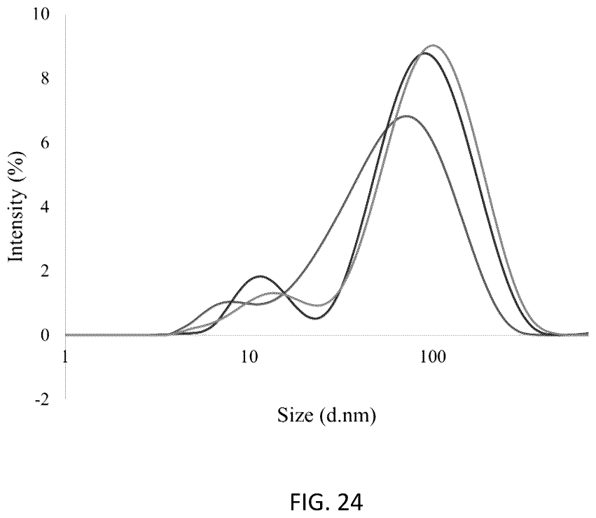

Aggregation of the nano-Ca@RISE particles was monitored in biologically relevant conditions (1% FBS:H₂O) after 24, 48 and 72 h. This analysis can provide insights about the potential of the nanocrystals to maintain their particle size (<500 nm) and be able to serve for drug delivery when suspended in physiological media.²⁸ DLS results demonstrate a relatively homogeneous particle size distribution of nano-Ca@RISE in the biorelevant dispersant at every time point. Average particle size distribution values obtained for the three time points were 74.03 d.nm (24 h), 104.7 d.nm (48 h), and 112.0 d.nm (72 h) (FIG. 24). Furthermore, nano-Ca@RISE particles remained moderately monodispersed along the three-time points, showing PDI values of 0.578 (24 h), 0.479 (48 h), and 0.465 (72 h). These results confirmed that nano-Ca@RISE has a low aggregation tendency when suspended in biologically relevant conditions (1% FBS:H₂O), demonstrating the ability to maintain its particle size without forming larger aggregates.

Binding Assays of nano-Ca@RISE to HA.

The capacity of nano-Ca@RISE to bind to the main constituent of the bone microenvironment, HA, under simulated physiological conditions, was evaluated through a binding assay. The nano-Ca@RISE bound to HA was quantified by monitoring the decrease in the nano-Ca@RISE concentration of the supernatant employing absorption measurements (λₘₐₓ=206 nm). Unlike previously investigated nano-BPCCs, the quantification of the binding percentage of the nanocrystals was not measured by the direct quantification at the same wavenumber of the ligand (RISE, λₘₐₓ=260 nm). It was observed that the RISE chromophore changes its behavior when complexed with a divalent metal such as calcium (Ca²⁺). The absorption spectrum of RISE compared to the one of nano-Ca@RISE, revealed a change in the lambda max (λₘₐₓ) from 260 nm to 206 nm, respectively. This could be attributed to a quenching effect since this process decreases the intensity of a substance (the ligand) based on complex formations. Therefore, a calibration curve of nano-Ca@RISE in PBS was employed for quantification of the nanocrystal's concentration in the supernatant after the binding assay.

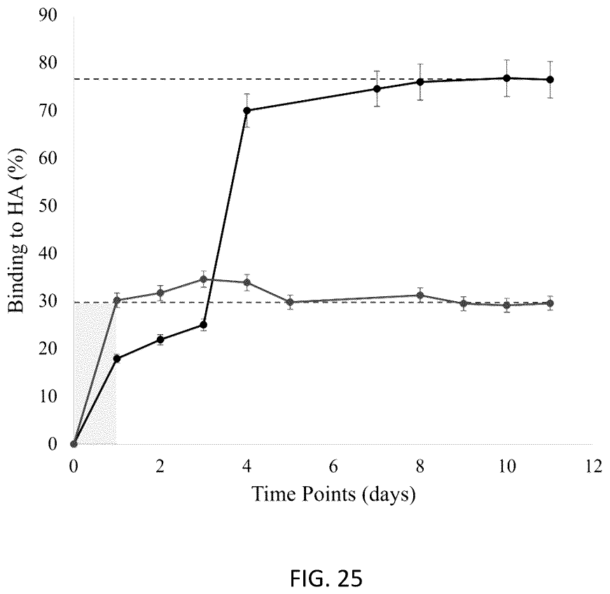

Binding curves (FIG. 25) demonstrate that 18% of RISE (control) binds to HA in 1 day and reaches a maximum binding of 76% in 8 days under simulated physiological conditions (PBS, pH=7.40). Results for nano-Ca@RISE demonstrate that the nanomaterial reaches its maximum binding of 30% to HA in 1 day and remains constant up to 11 days under the same conditions. These results prove the higher binding (˜1.7×) for nano-Ca@RISE compared to the ligand alone within a relevant time frame (FIG. 25). Here, it is presumed that the uncoordinated phosphate groups at the surface of the nanocrystals are responsible for the binding to HA.

Cytotoxicity Assays of nano-Ca@RISE.

The cytotoxicity effects of nano-Ca@RISE nanocrystals were assessed through in vitro assays against the human breast cancer MDA-MB-231 and osteoblast like hFOB 1.19 cell lines. The MDA-MB-231 cell line represents a model of breast-cancer-induced OM that possess micro-RNAs involved in the development of bone metastasis.^{7,29} While the immortalized human fetal hFOB 1.19 cell line is a homogeneous model that allows the study of osteoblast differentiation, in this work, these cells were employed to imitate the normal human bone microenvironment.³⁰ Determination of the IC₅₀ values against MDA-MB-231 and hFOB 1.19 cell lines was performed employing RISE concentrations of 0-200 μM. After treating the MDA-MB-231 cell line with RISE, an IC₅₀ value of 98±3 μM was determined at 72 h, while for treatment at 48 h an IC₅₀ of 175±3 μM was observed. Moreover, at 24 h of treatment, an IC₅₀>200 μM was obtained. This result demonstrated that RISE (0-200 μM) shows cytotoxicity after 48 h of treatment against the MDA-MB-231 cell line. Moreover, the IC₅₀ for the hFOB 1.19 cell line was >200 μM at 24, 48 and 72 h, indicating that RISE (0-200 μM) did not cause cell death after 72 h of treatment in the osteoblast cells. The IC₅₀ curves for the above-described treatments are described herein.

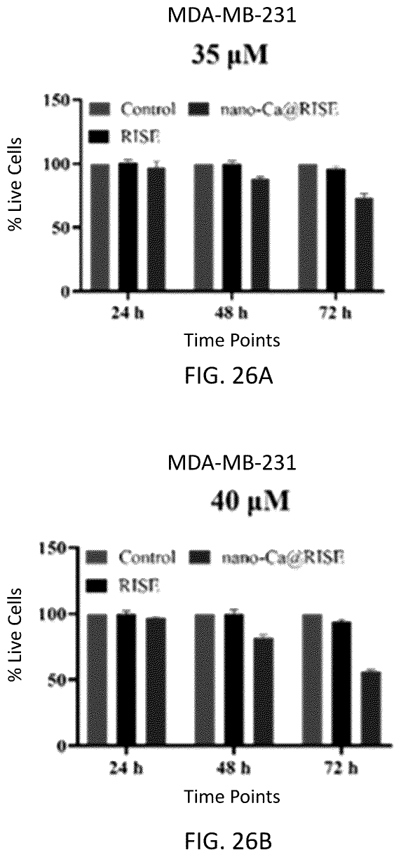

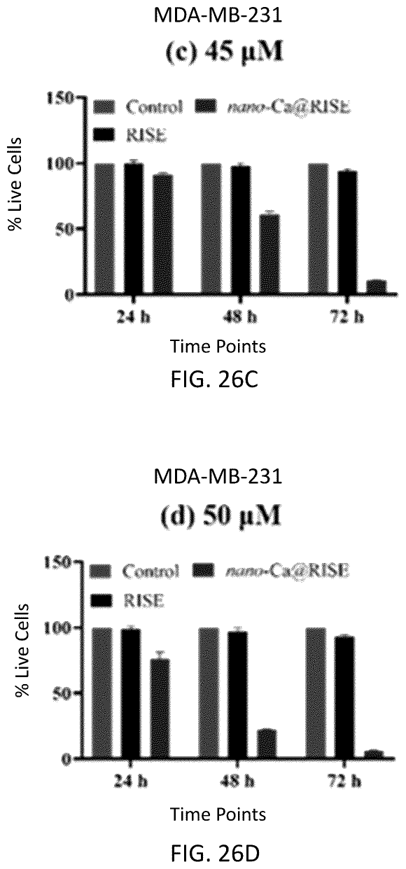

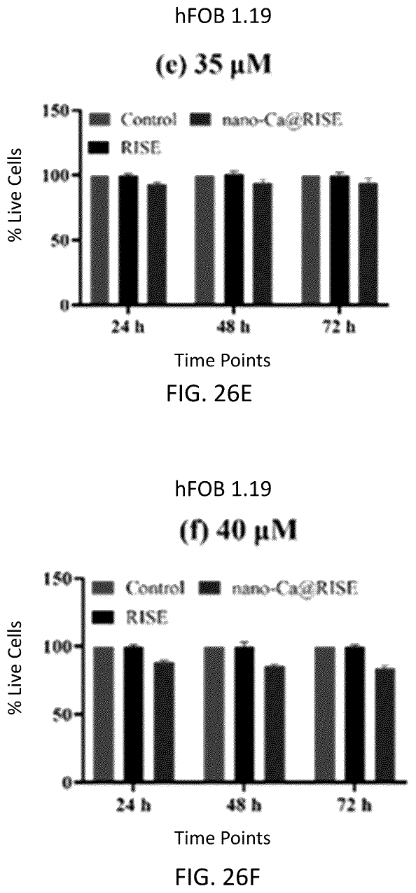

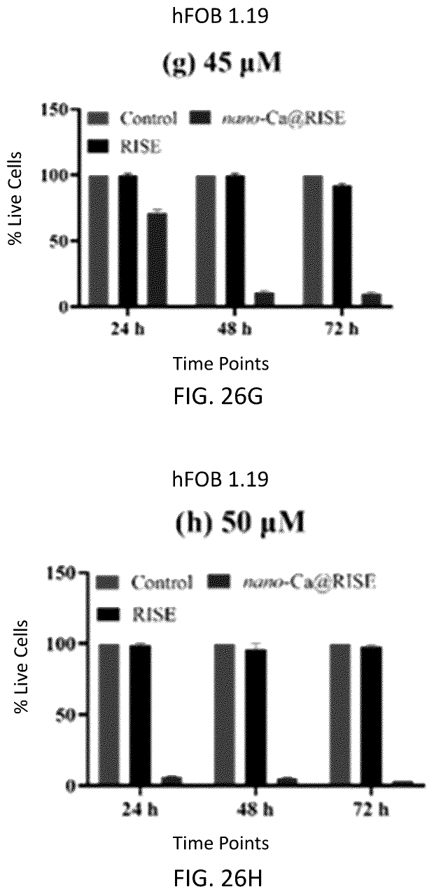

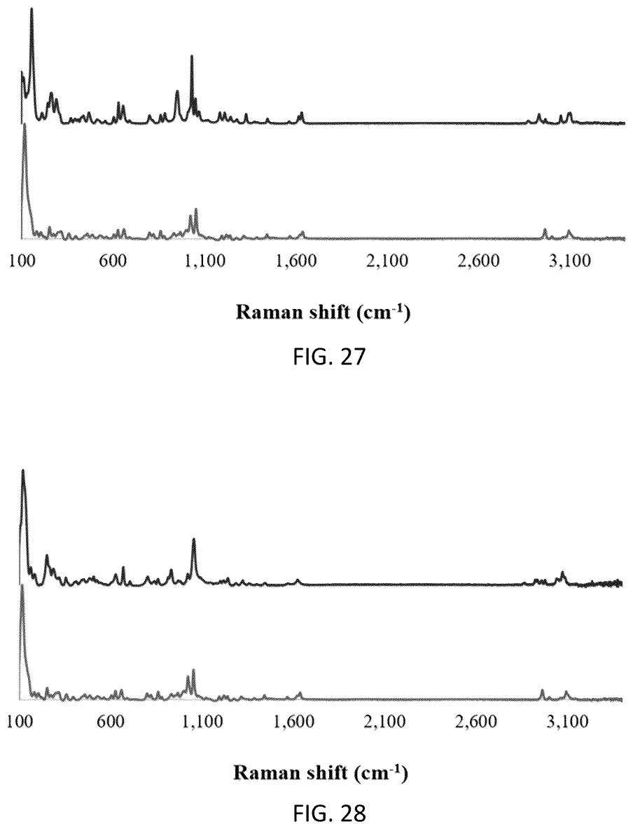

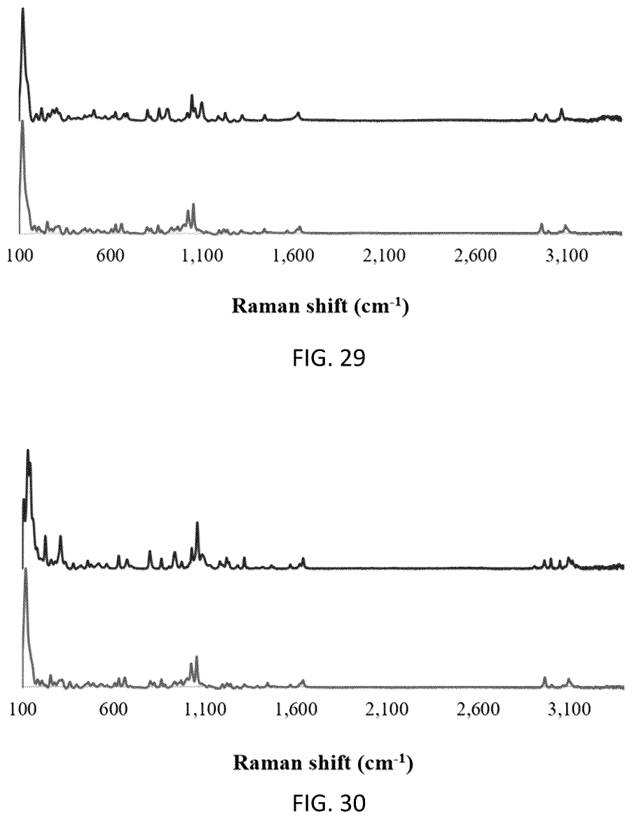

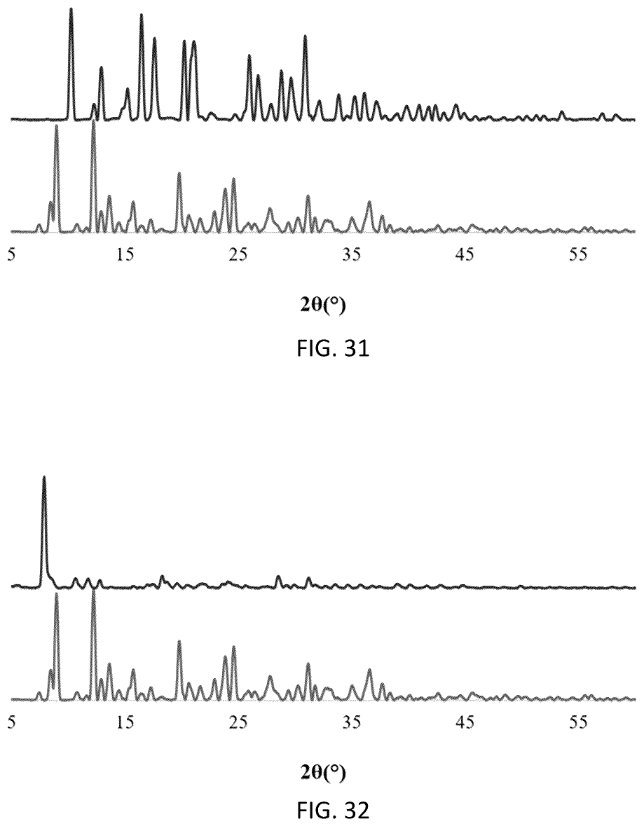

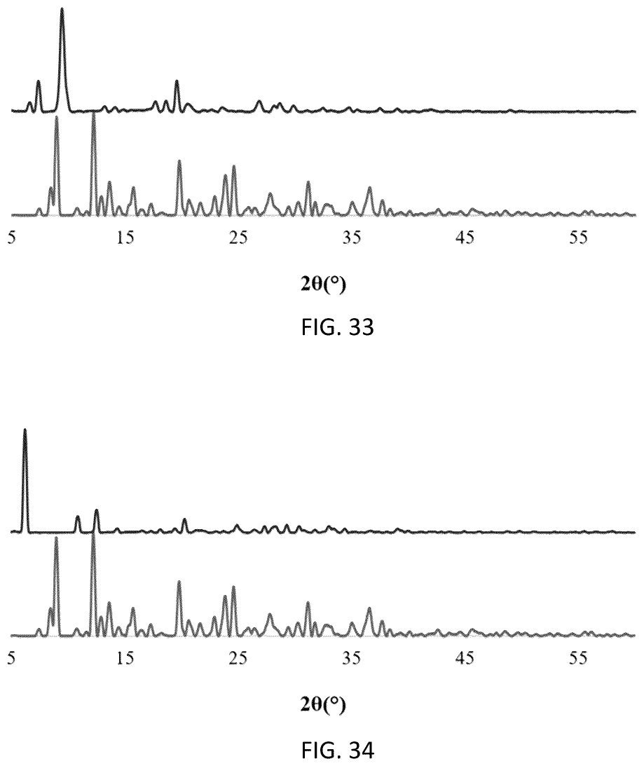

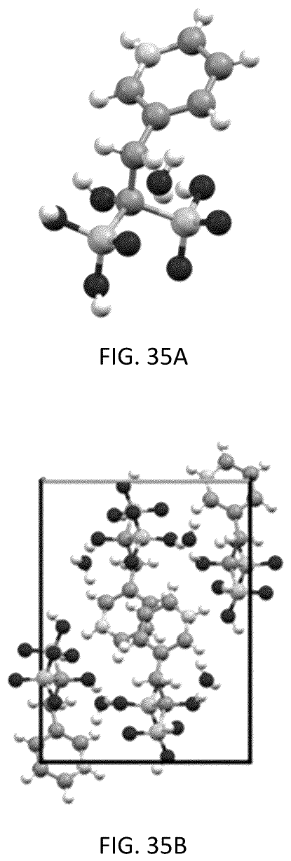

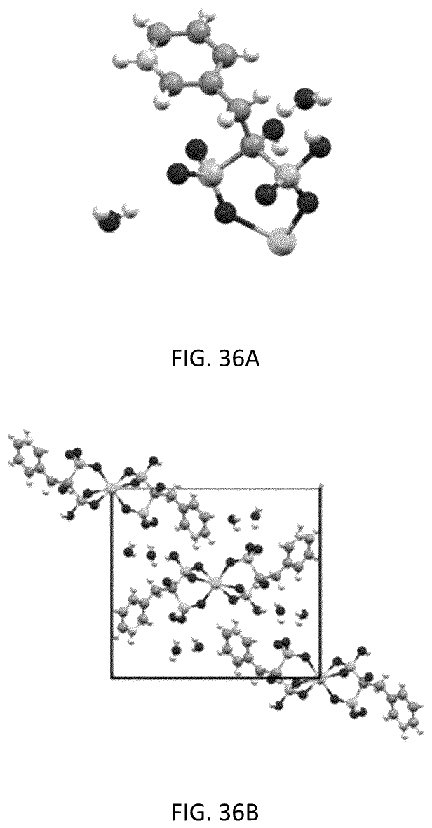

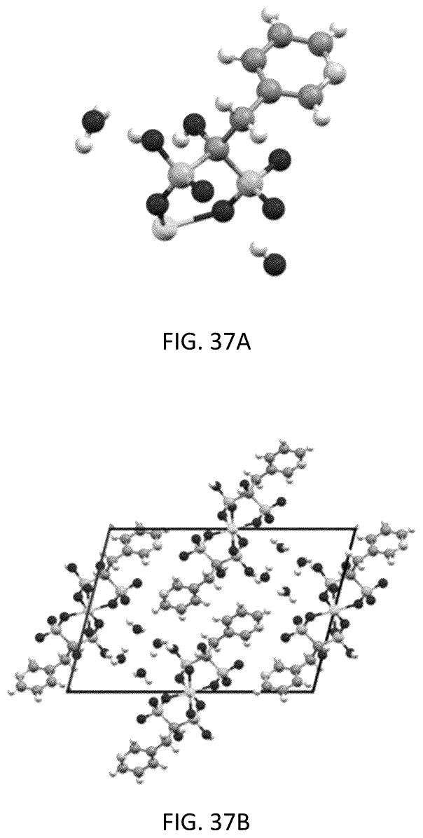

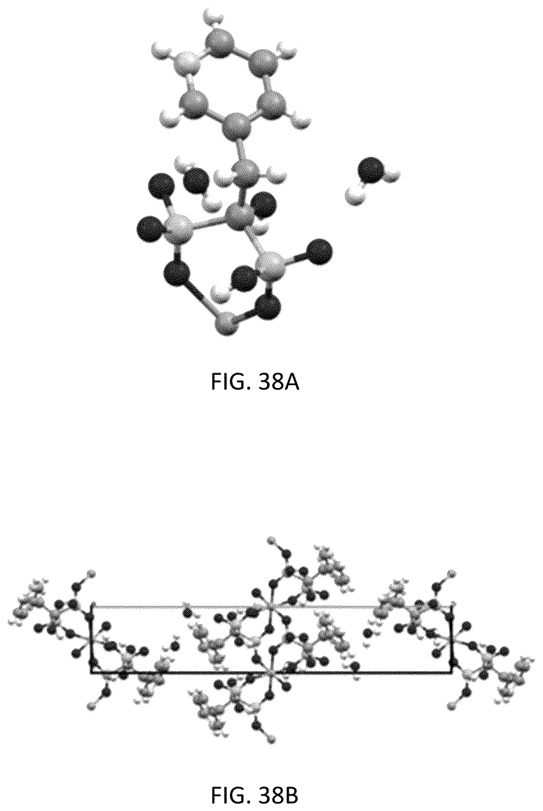

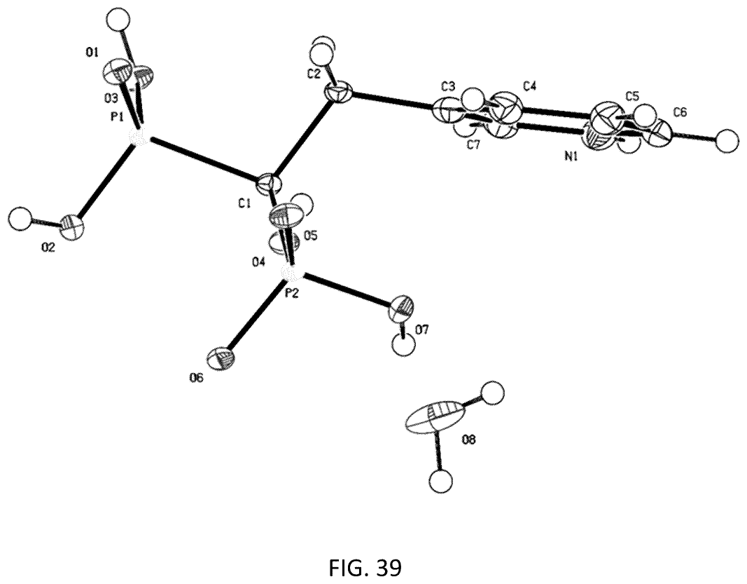

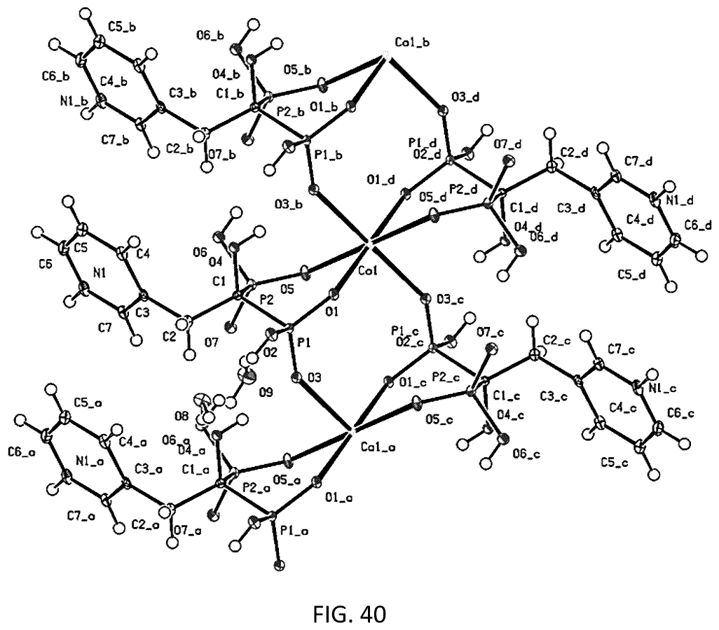

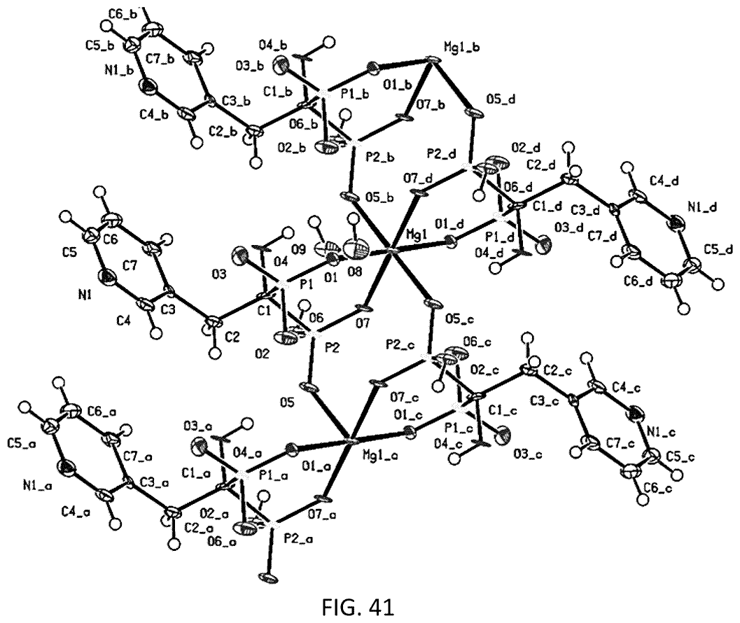

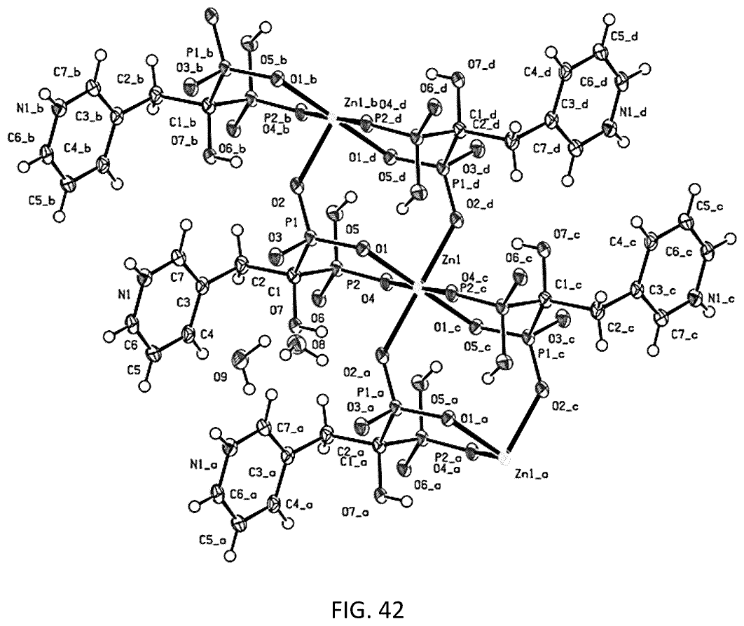

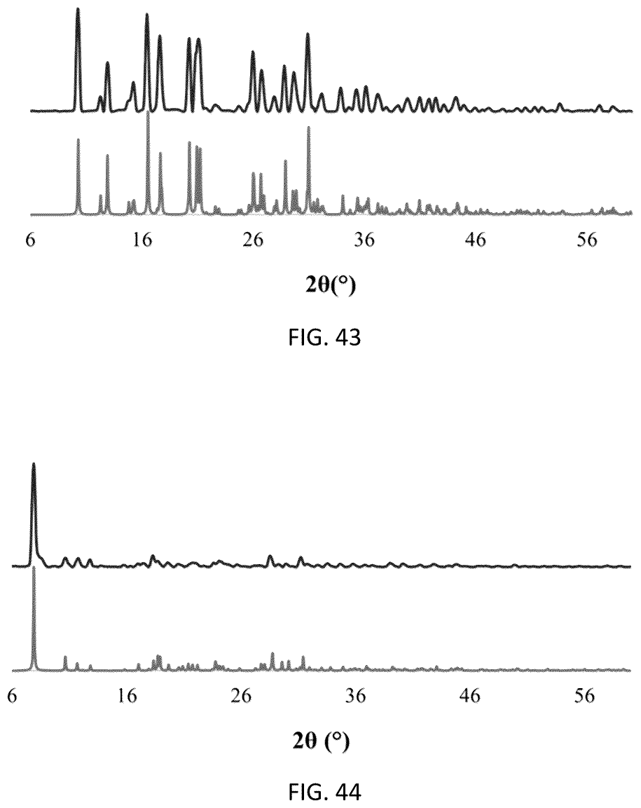

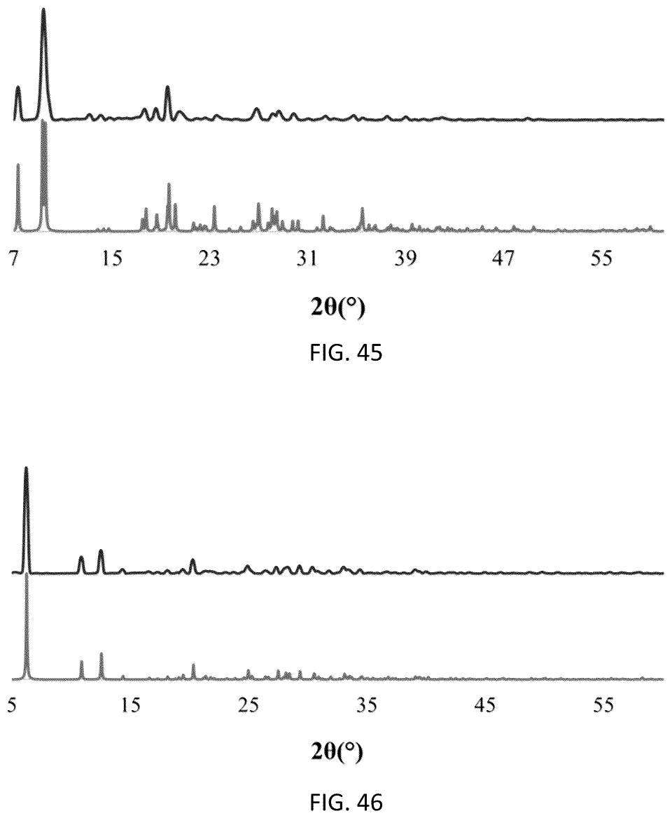

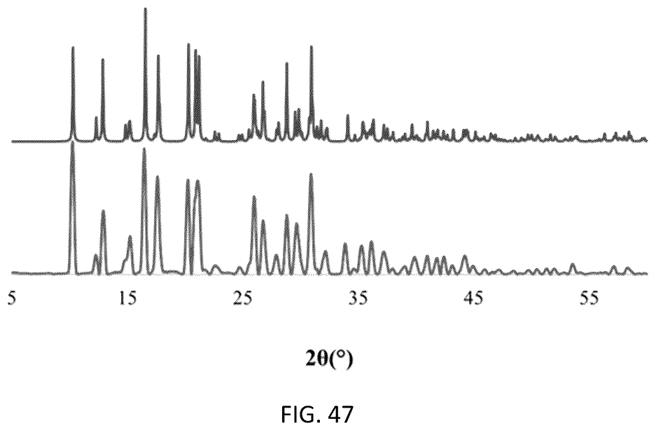

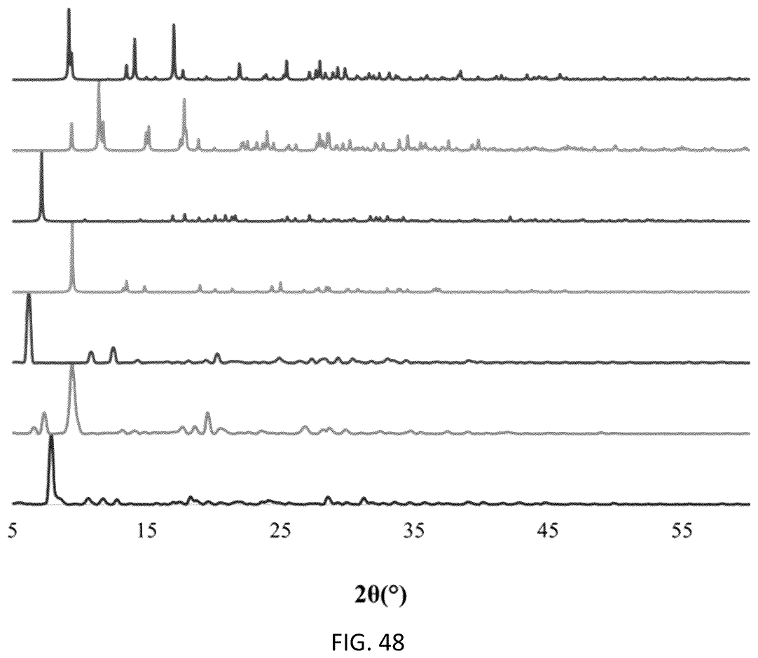

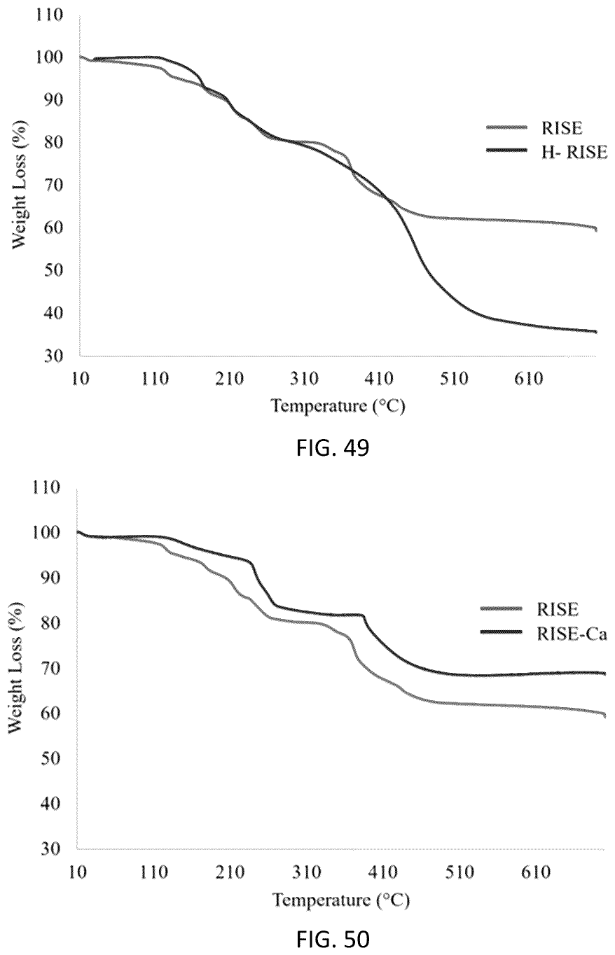

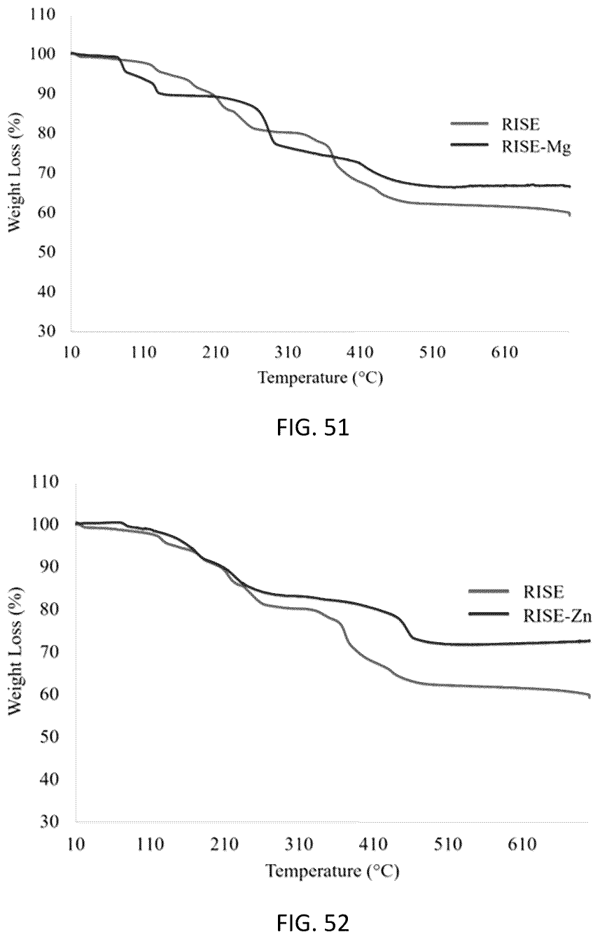

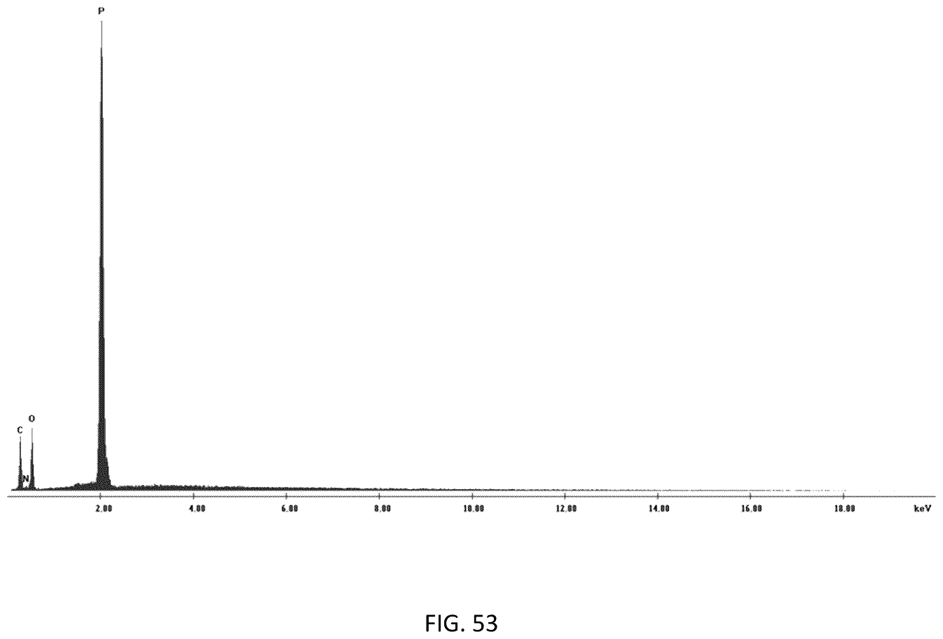

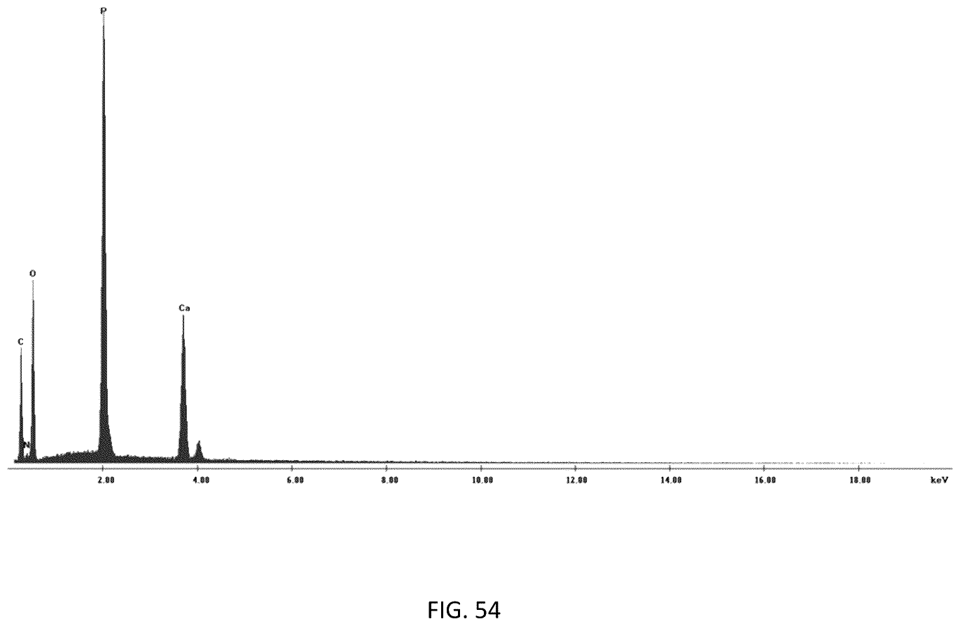

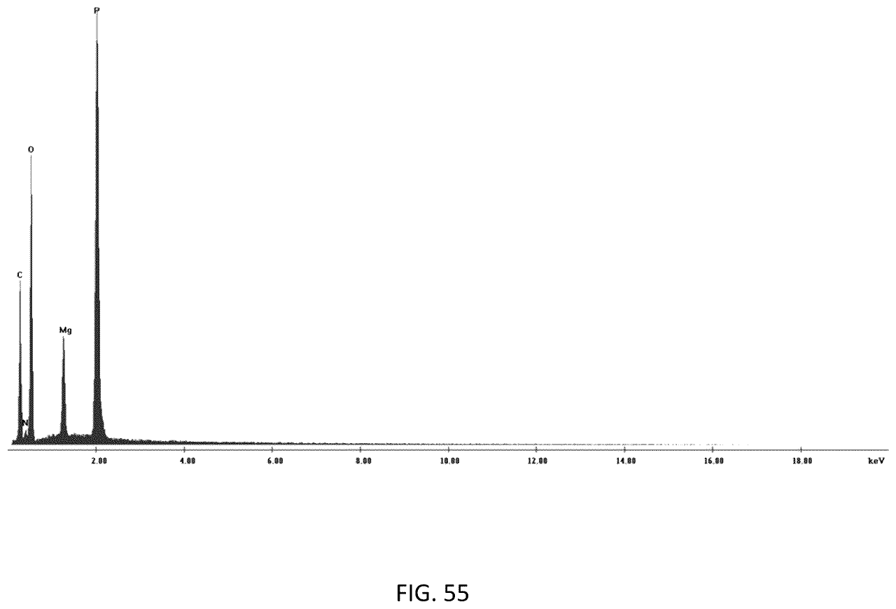

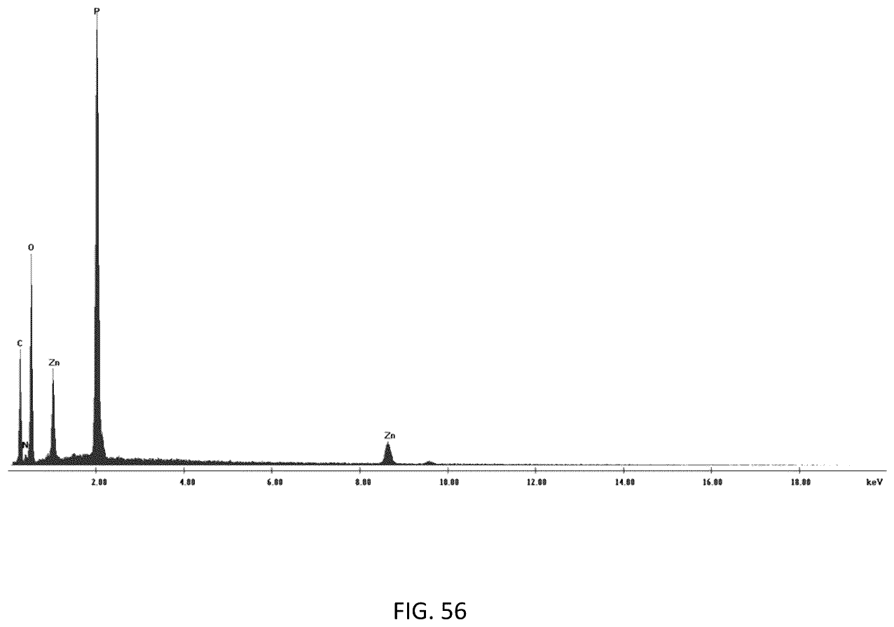

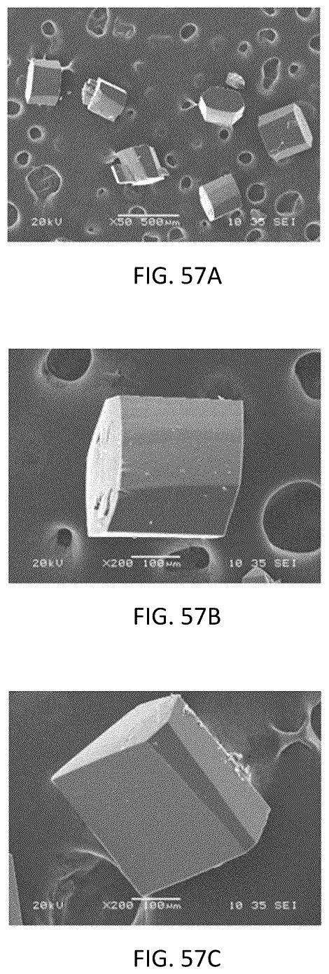

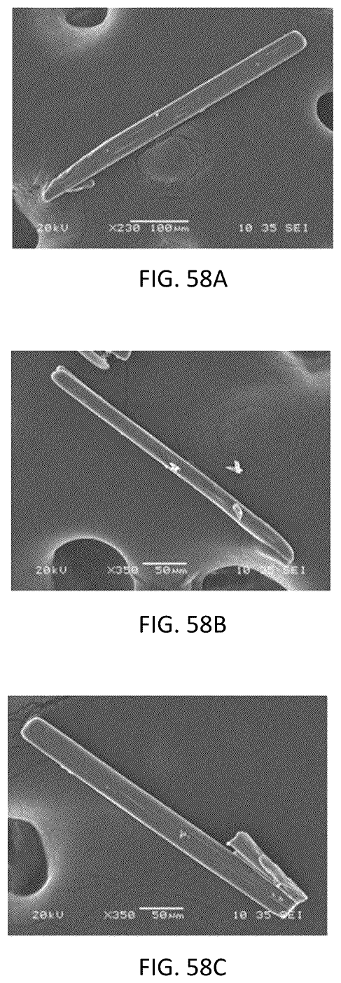

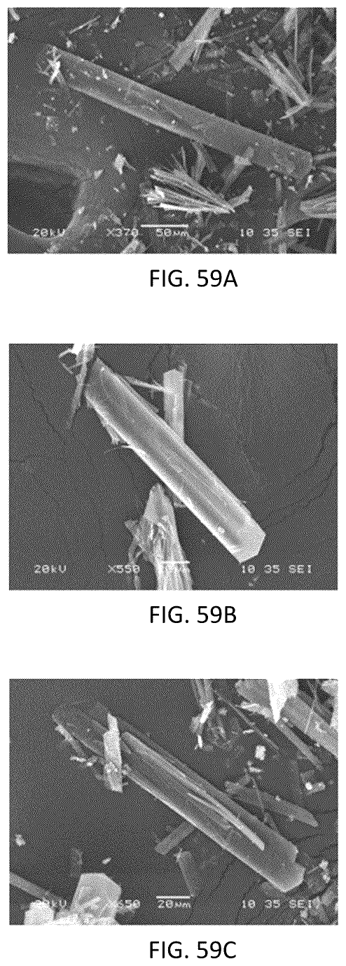

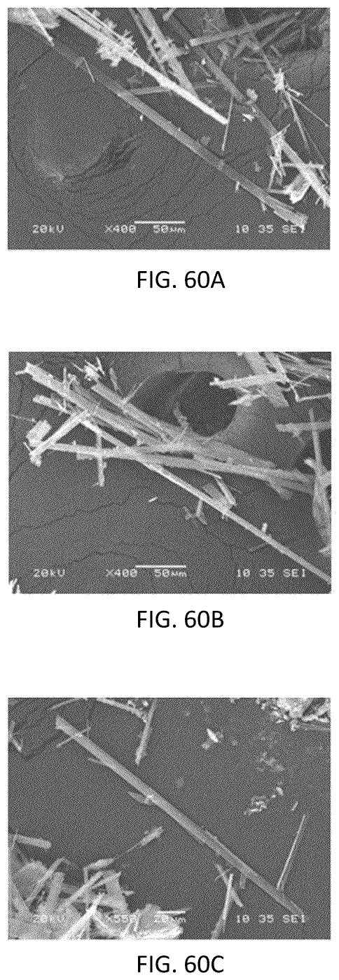

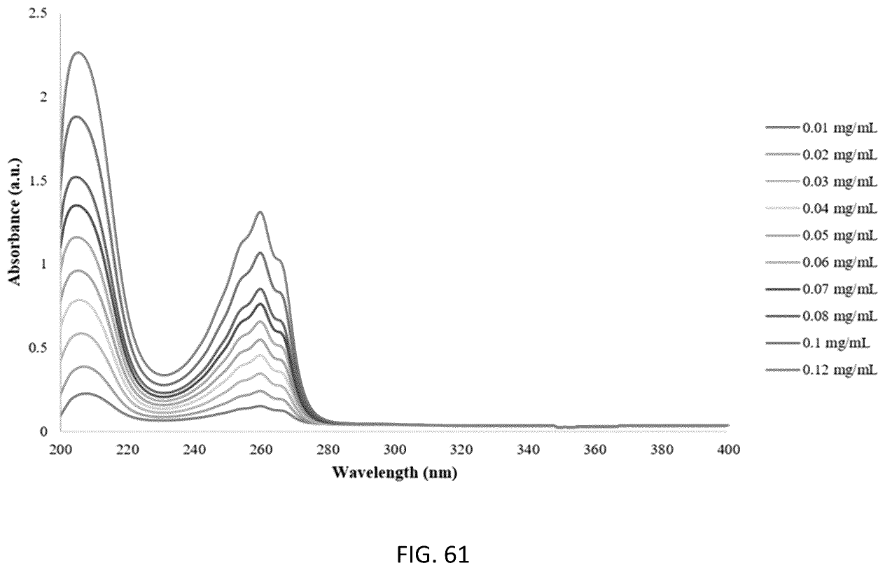

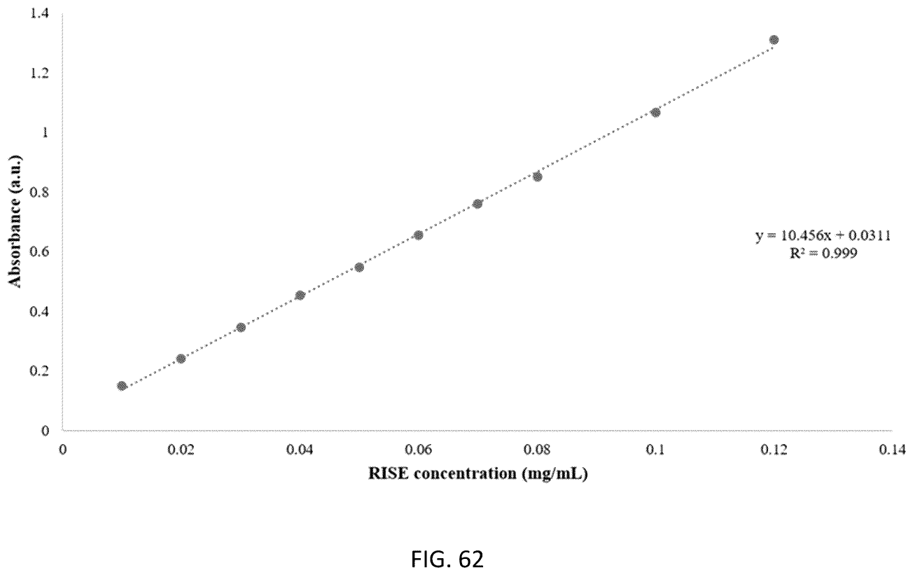

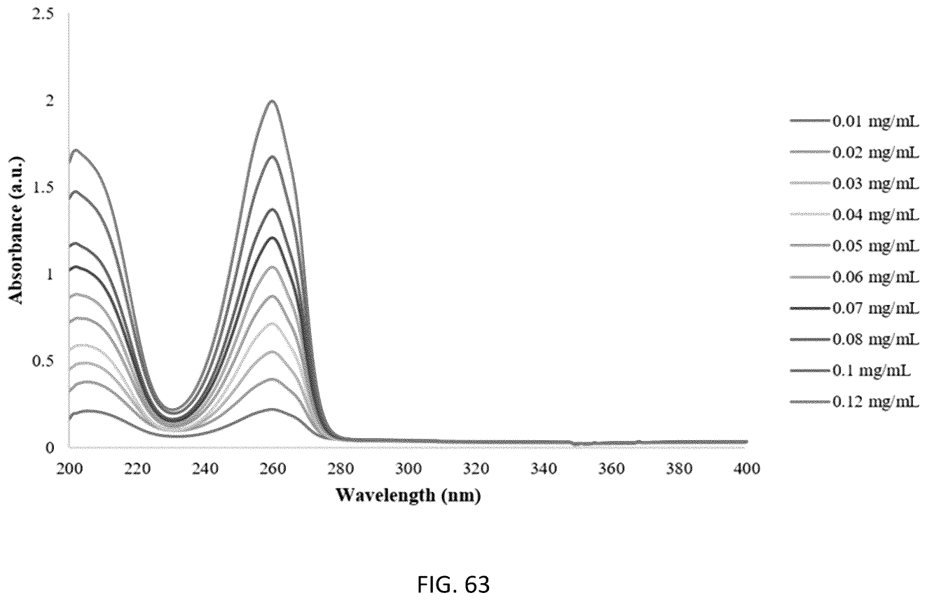

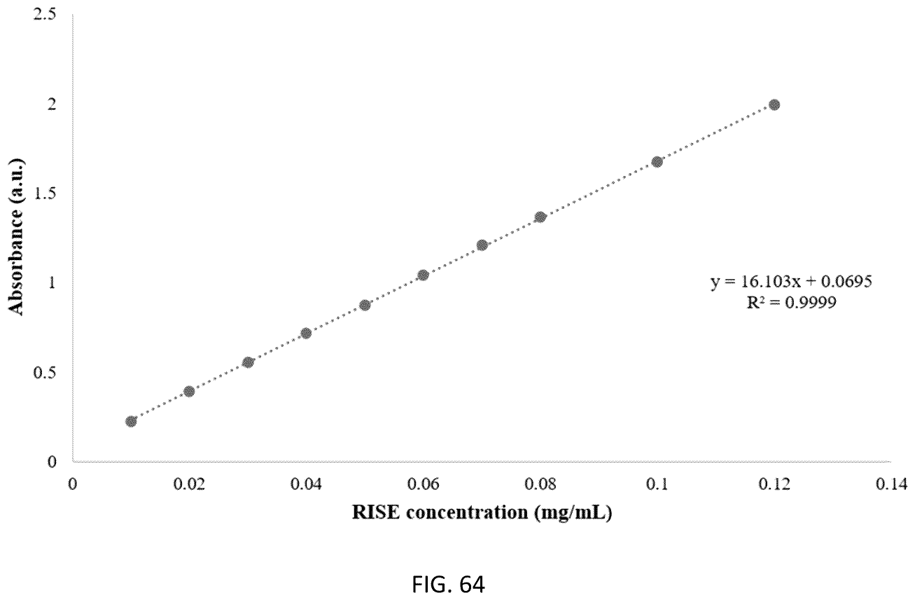

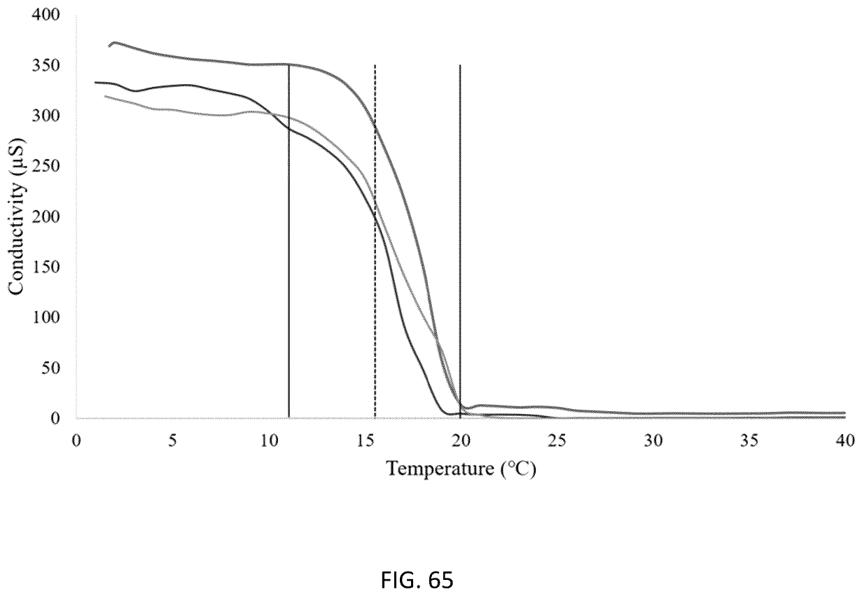

Furthermore, the % RCL was investigated for both cell lines at concentrations of 35, 40, 45, and 50 μM for RISE (control) and nano-Ca@RISE (experimental) during 24, 48, and 72 h. At a concentration of 35 μM, the cell viability decreased moderately for the MDA-MB-231 cell line when treated with the nanocrystals after 72 h (73±3%), contrasted to RISE where the cell viability was ˜100% (FIG. 26A). The % RCL for MDA-MB-231 treated with nano-Ca@RISE at 40 μM decreased significantly to 82±3% and 56+2%, after 48 and 72 h, respectively (FIG. 26B). At this concentration, RISE did not cause cell death (% RCL ˜100%) against the MDA-MB-231. Moreover, a significantly higher cell growth inhibition of the cancerous model was observed with nano-Ca@RISE treatments at 45 and 50 μM. For treatment at 45 μM, an % RCL of 61±2 and 11±1% after 48 and 72 h, respectively, was observed for the nanocrystals (FIG. 26C). Thereafter, treating the cells with nano-Ca@RISE at 50 μM, resulted in a much higher cytotoxicity effect against the MDA-MB-231 [% RCL, 22±3 (48 h) and 6±1% (72 h)], compared to the one observed for RISE at this concentration [% RCL, 97±3 (48 h) and 93±2% (72 h), FIG. 26D]. These results demonstrate the potential of nano-Ca@RISE to induce significant cytotoxicity at a concentration range of 35-50 μM against cells that are prone to metastasize to the bone.

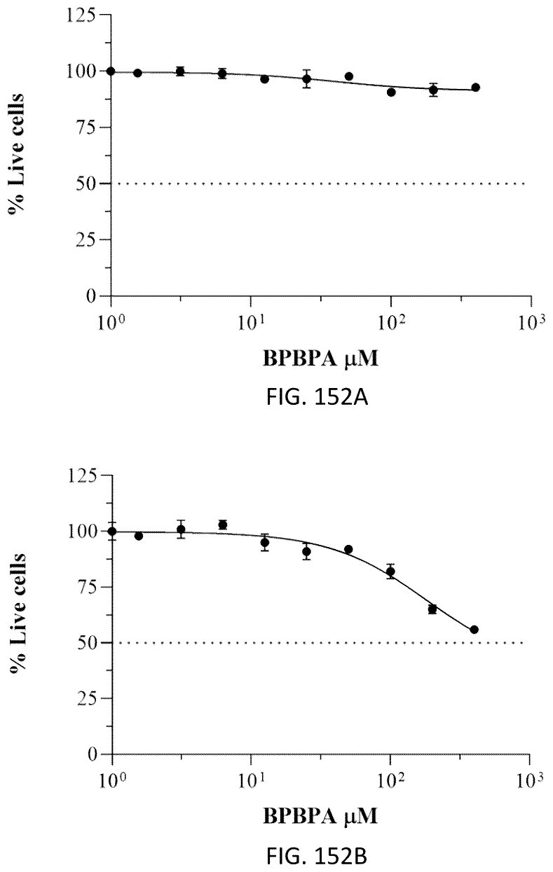

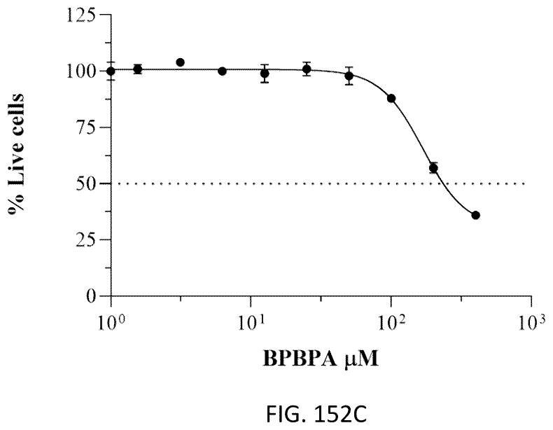

The cytotoxicity of nano-Ca@RISE was investigated in normal osteoblast-like cells and compared to that of RISE. Treatments were conducted with the nanocrystals (experimental) and RISE (control) employing the hFOB 1.19 cell line, at the same concentrations utilized for the MDA-MB-231 assays. In this assay, after nano-Ca@RISE treatment, no cell growth inhibition against the hFOB 1.19 cell line (% RCL ˜100%) was expected, to prevent damage to the normal cell tissue at the bone microenvironment. The cell viability results confirmed that no significant cell death was observed after both RISE and nano-Ca@RISE treatments at the lower concentrations (35 and 40 μM), after 24, 48, and 72 h. After treating the osteoblast-like cells with the nanocrystals, the resulting % RCL values were 94±3% (48 h) and 94±4% (72 h) at 35 μM, (FIG. 152E), while 85±2% (48 h) and 84±2% (72 h) at 40 μM (FIG. 152F). Moreover, at concentrations of 45 and 50 μM, significant cell death was observed against the hFOB 1.19 cell line after nano-Ca@RISE treatment, but not for RISE (% RCL ˜100%). After 48 h of treatment with the nanocrystals, % RCL values of 11±1 (45 μM) and 5±1% (50 μM ) were obtained, while after 72 h, % RCL values of 10±1 (45 μM) and 3±1% (50 μM) were observed (FIGS. 152G-15211). These results demonstrate that at a concentration rage between 35-40 μM, nano-Ca@RISE present significant cytotoxicity against triple-negative breast cancer cells that metastasize to the bone (MDA-MB-231), without affecting negatively normal osteoblast cells (hFOB 1.19) at the metastatic site.

### Conclusions.

Herein, the reaction between clinically employed RISE, and three biologically relevant metals (Ca²⁺, Mg²⁺, and Zn²⁺) resulted in three different crystal phases of RISE-based BPCCs. These were structurally characterized to provide further insights into the structural motifs observed in these types of materials. Based on the higher thermal and structural stability, as well the observed pH-dependent degradation in physiological media, RISE-Ca was selected for particle size reduction and to assess the biomedical properties. The crystal size of RISE-Ca (˜300 m), was significantly reduced by employing the PIT-nano-emulsion method, thus resulting in nano-Ca@RISE (˜342 d.nm). The particle size reduction of this BPCC provides several advantages towards its biomedical applications, as it potentiates its use as a nanocrystal-based therapy. Additionally, nano-Ca@RISE presented low aggregation when in contact with biological relevant conditions (10% FBS:H₂O) after 24-72 h of being synthesized. More important, this suggest that nano-Ca@RISE could avoid excretion through phagocytosis mechanisms during cellular uptake as it complies with the desirable particle size without forming larger aggregates. Furthermore, to investigate the ability of this nanomaterial to bind to HA, and possibly provide localized therapeutic effects at the metastatic site, binding affinity assays were performed. Results demonstrate that nano-Ca@RISE binds -1.7x more (30%) to HA than RISE (17%) in 1 day, suggesting that it could bind to the main constituent of the bone microenvironment at the metastatic site with higher affinity and within a relevant time frame. Because it was previously demonstrated that the nanomaterial could degrade in a pH-dependent manner, and with the outcome revealed through the binding assays, it is suggested that the nanocrystals possess the ability to degrade selectively at the metastatic site. Thereafter, the cytotoxicity effects of nano-Ca@RISE were compared to that of RISE in vitro against the human breast cancer MDA-MB-231 and normal osteoblast-like hFOB 1.19 cell lines. Results demonstrated significant cell growth inhibition for nano-Ca@RISE against the cancerous model after 72 h of treatment, specifically at a concentration of 40 μM (% RCL=56±2%). At the same concentration, the nanocrystals did not reveal significant cytotoxicity effects against the normal osteoblastic cells (% RCL=84±2%). With these results, it is demonstrated that this nanomaterial has the potential to treat cancerous cells that are prone to metastasize without significantly affecting a cell model that represents healthy tissue at the bone microenvironment. The properties exhibited by the nano-RISE-based BPCC regarding structure, dissolution, stability, binding, and cytotoxicity suggest a high potential of this nanomaterial to serve as an alternative approach aimed to treat and prevent breast-cancer-induced OM.

### Supporting Information

### 1.1. Synthesis of RISE-Based BPCCs.

Note: HEDP was added as an auxiliary ligand when needed to decrease the pH below the pKa's (pH=1.13-4.02) of the principal ligand (RISE) in the reactions with the bioactive metals Ca²⁺, Zn²⁺, and Mg²⁺. When HEDP was employed in the synthesis of RISE-Ca, RISE-Zn and RISE-Mg, single crystals were detected but turned out to be the ligand (RISE) recrystallized in its acid form. For RISE-Zn, when HEDP was employed, no crystalline product was observed.

H-RISE. Crystallization of H-RISE was carried out by preparing a ligand solution (RISE) in nanopure water. HEDP was added to decrease the pH (1.161) below of the pKa's of the principal ligand (RISE) and to achieve full protonation of the phosphonate groups. Heat was applied to the resulting mixture until crystals appeared (˜24 h). The product was collected by vacuum filtration and air-dried.

RISE-Ca. A mixture of RISE and Ca(NO₃)₂·4H₂O with a molar ratio (1:1) was prepared at room temperature using distilled water as follows. The ligand solution was prepared by dissolving 0.25 mmol (0.0763 g) of solid RISE with 2.5 mL of distilled water in a 20 mL vial and heating it at 85° C. for 30 min. The metal salt solution was prepared by dissolving 0.25 mmol (0.0368 g) of Ca(NO₃)₂·4H₂O with 2.5 mL of distilled water. This solution was added to the ligand solution using a syringe. The resulting mixtures were heated at 85° C. until crystals were visually detected (˜15 min). The vials were removed from the heat after the crystals appeared and were left undisturbed to promote the growth of the crystals. The product was collected by vacuum filtration and air-dried.

RISE-Mg. A mixture of RISE and Mg(NO₃)₂·6H₂O with a molar ratio (1:1) was prepared at room temperature using distilled water as follows. The ligand solution was prepared by dissolving 0.25 mmol (0.0763 g) of solid RISE with 2.5 mL of distilled water in a 20 mL vial and heating it at 85° C. for 30 min. The metal salt solution was prepared by dissolving 0.25 mmol (0.0641 g) of Mg(NO₃)₂·6H₂O with 2.5 mL of distilled water. This solution was added to the ligand solution using a syringe. After mixing the solution, the resulting mixture was heated at 85° C. until crystals were visually detected (˜30 min). The vial was removed from the heat after the crystals appeared and was left undisturbed to promote the growth of the crystals. The product was collected by vacuum filtration and air-dried.

Note: For the synthesis of RISE-Mg, both metal salts, Mg(NO₃)₂ and MgCl₂, can be utilized. However, by employing Mg(NO₃)₂ for the synthesis of RISE-Mg, single crystals with a higher quality were obtained, compared to when MgCl₂ was employed.

RISE-Zn. A mixture of RISE and Zn(NO₃)₂·6H₂O with a molar ratio (1:1) was prepared at room temperature using distilled water as follows. The ligand solution was prepared by dissolving 0.25 mmol (0.0763 g) of solid RISE with 2.5 mL of distilled water in a 20 mL vial and heating it at 85° C. for 30 min. The metal salt solution was prepared by dissolving 0.25 mmol (0.0744 g) of Zn(NO₂)₂·6H2O with 2.5 mL of distilled water. This solution was added to the ligand solution using a syringe. A precipitated was formed, which was allowed to settle, and the supernatant was transferred to another vial using a pipette. The resulting mixtures were heated at 85° C. until crystals were visually detected (˜1.5 h). The vials were rem oved from the heat after the crystals appeared and were left undisturbed to promote the growth of the crystals. The product was collected by vacuum filtration and air-dried.

Note: For the synthesis of RISE-Zn, both metal salts, Zn(NO₃)₂ and ZnCl₂, can be utilized. However, by employing Zn(NO₃)₂ for the synthesis of RISE-Mg, single crystals with a higher quality were obtained, compared to when ZnCl₂ was employed.

Dissolution Profiles for RISE-based BPCCs

Dissolution profile in PBS

Stock Solution: A standard stock solution of RISE was prepared by dissolving 100 mg of the ligand in a 100 mL volumetric flask using PBS. Further dilute solutions were prepared from this stock solution (see Calibration Curve section).

Calibration Curve: A concentration range between 0.01-0.12 mg/mL was achieved by transferring accurately measured aliquots of the RISE stock solution into a series of 25 mL volumetric flasks. Each solution was completed to the 25 mL mark with PBS.

Dissolution Profile: Dissolution profiles were recorded for RISE, H-RISE, RISE-Ca, RISE-Mg, and RISE-Zn. Dissolution tests were performed in 100 mL of PBS buffer (pH=7.40), controlling temperature at 37° C. and stirring at 150 rpm. About 35 mg of the solid RISE, H-RISE and the RISE-based BPCCs and, were grinded using a mortar and pestle. The powder was added to the PBS solution at the beginning of the dissolution under stirring. To record the complete dissolution profile, samples of 1.0 mL were collected after 0, 0.0083, 0.017, 0.083, 0.17, 0.5, 1, 3, 6, 18, 24 and 48 h. The samples were placed in 5 mL volumetric flasks and completed to volume with PBS. The absorbance was measured at λₘₐₓ=260 nm against a reagent blank in a 400-200 nm scan range using an Agilent Technologies Cary Series UV-Vis spectrophotometer, Cary 100 UV-Vis mode and the UV Cary Scan software (version v.20.0.470).

### Dissolution Profile in FaSSGF

Stock Solution: A standard stock solution of RISE was prepared by dissolving 100 mg of the ligand in a 100 mL volumetric flask using FaSSGF. Further dilute solutions were prepared from this stock solution (see Calibration Curve section).

Calibration Curve: A concentration range between 0.01-0.12 mg/mL was achieved by transferring accurately measured aliquots of the RISE stock solution into a series of 25 mL volumetric flasks. Each solution was completed to the 25 mL mark with FaSSGF.

Dissolution Profile: Dissolution profiles were recorded for RISE, H-RISE, RISE-Ca, RISE-Mg, and RISE-Zn. Dissolution tests were performed in 100 mL of FaSSGF buffer (pH=1.60), controlling temperature at 37° C. and stirring at 150 rpm. 35 mg of the solid RISE, H-RISE and the RISE-based BPCCs, were grinded using a mortar and pestle. The powder was added to the PBS solution at the beginning of the dissolution under stirring. To record the complete dissolution profile, samples of 1.0 mL were collected after 0, 0.0083, 0.017, 0.083, 0.17, 0.5, 1, 3, 6, 18, 24 and 48 h. The samples were placed in 5 mL volumetric flasks and completed to volume with PBS. The absorbance was measured at λₘₐₓ=260 nm against a reagent blank in a 400-200 nm scan range using an Agilent Technologies Cary Series UV-Vis spectrophotometer, Cary 100 UV-Vis mode and the UV Cary Scan software (version v.20.0.470).

### 8.1. Phase Inversion Temperature (PIT) Determination.

A 2.5 mg/mL aqueous RISE solution was prepared by dissolving 250 mg of the drug in a 100 mL volumetric flask using nanopure water. To prepare the emulsion, 11 mL of the RISE solution was added with 3 mL of heptane and 0.9 mL of Brij®L4 in a 20 mL vial. The resulting mixture was homogenized with an IKA T10 Basic Ultra Turrax (IKA Works Inc., Wilmington, NC), for 30 sec at a speed of “4” (14,450 rpm equivalent). The experimental setup consisted of a jacketed beaker with a 20.3 cm (8”) stainless steel RTD temperature probe (VWR®, VWR International) and a Fisher brand Accumet BasicAB30 conductivity meter (Fisher Scientific UK, Loughborough, UK) used to measure the conductivity of the emulsion. Additionally, a Julabo F32-ME Refrigerated/Heating Circulator (JULABO GmbH, Seelbach, Germany) was employed to control the bath temperature and a VWR® Professional Hot Plate Stirrer (97042-714, VWR®, VWR International) was used to stir the solution in the vial and the water bath at 300 rpm. Conductivity measurements were recorded in 1-degree intervals starting when the temperature of the emulsion reached 2° C. and the temperature profile was carried out until 40° C. with a heating rate of 1° C. min¹. FIG. S8.1 depicts the PIT determination curve for an aqueous RISE solution in heptane and Brij L4®.

### 8.2. Nano-Emulsion Synthesis of Nano-Ca@RISE.

The nano-emulsion synthesis of nano-Ca@RISE was performed in a Crystalline crystallization system (Technobis Crystallization Systems, Alkmaar, Netherlands). Pre-homogenized emulsions consisting of 11 mL of RISE solution, 3 mL heptane and 0.9 mL Brij® L4 from the PIT determination were used. The emulsion was homogenized, and 2.5 mL were transferred to a Crystalline reaction vial with a stir bar and a reflux cap. The vial was placed in a reactor at a temperature of 8° C. at 1,250 rpm for 30 min. Afterwards, the vial was transferred to a second reactor at 45° C. at 1,250 for 30 min. The temperature was raised to 85° C. and 2.5 mL of the metal salt solution [94.48 mg/mL, Ca(NO₃)₂] was added with a syringe. The emulsion was left to continue stirring at 1,250 for 5 min at 85° C. before taking out of the reactor and left undisturbed for 1 h before analyzing the supernatant from the water phase.

Aliquots of the supernatant from the water phase presumed to contain nano-Ca@RISE nanoparticles were analyzed in a Malvern Panalytical Zetasizer NanoZS (Spectris PLC, Surrey, England) equipped with a He—Ne orange laser (633 nm, max 4 mW). Data was analyzed with Malvern software, version 7.12. The Zetasizer software automatically optimizes the built-in attenuator distance and the number of runs per measurement. The amount of run time was held constant at 10 sec, each measurement was performed in triplicate. The refractive index used for the sample was 1.33, which correspond to RISE in water. This value was determined by measuring an aliquot of 2.5 mg/mL RISE stock solution with a Mettler Toledo Refracto 30GS (Mettler Toledo, Columbus, OH).

8.3. Particle Size Distribution of Nano-Ca@RISE Nanoparticles (after Synthesis)

Samples were prepared by taking 50 μL aliquots of the supernatant from the nano-synthesis water phase. They were transferred in disposable polystyrene cuvettes (REF: 67.754, 10 x 10×45 mm, Sarsted, Germany) and diluted with nanopure water in a 1:20 ratio. The cuvettes containing the samples remained undisturbed near the Zetasizer for 30 min prior to the measurements. Afterwards, size measurements were performed after 2 min of sample equilibration inside the instrument at room temperature (25° C.).

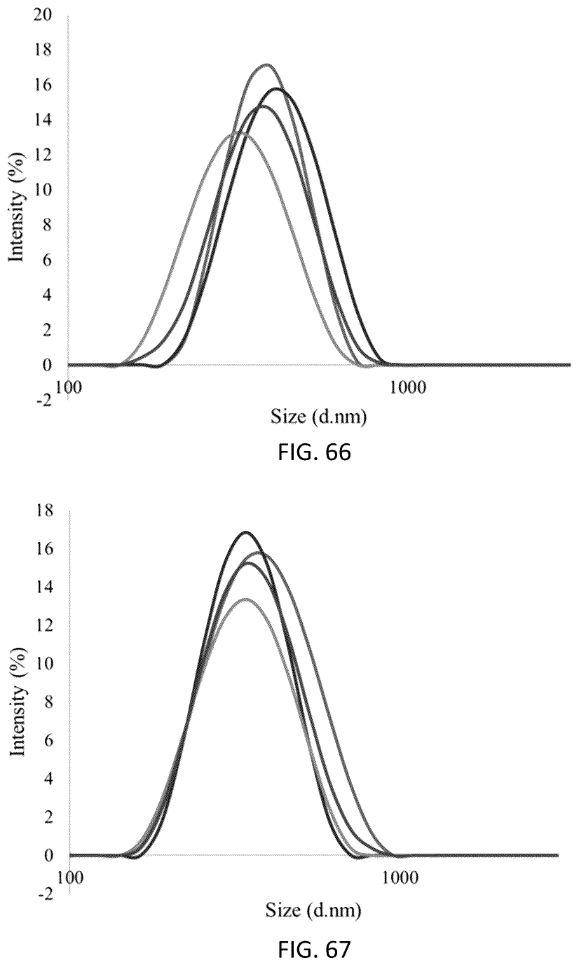

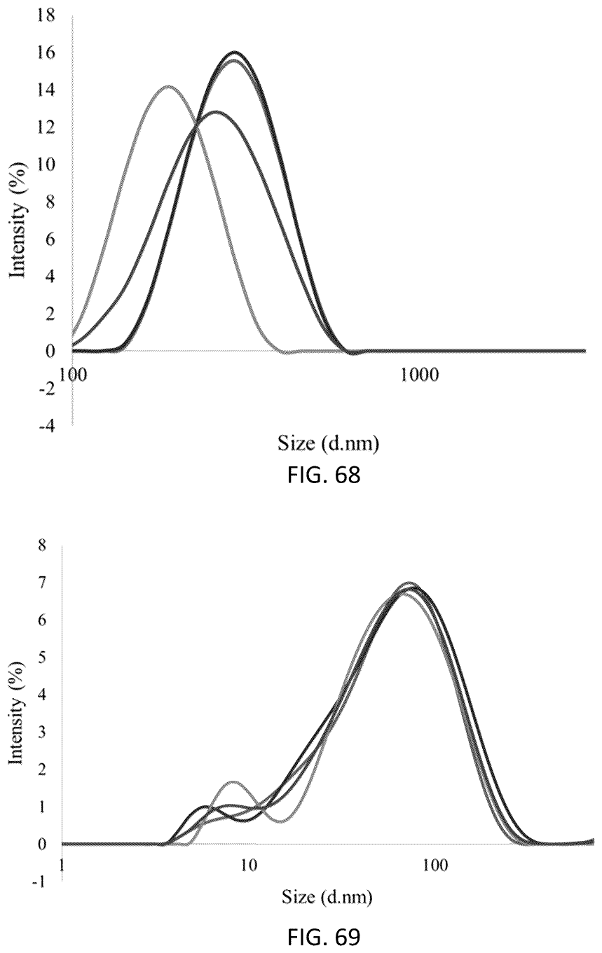

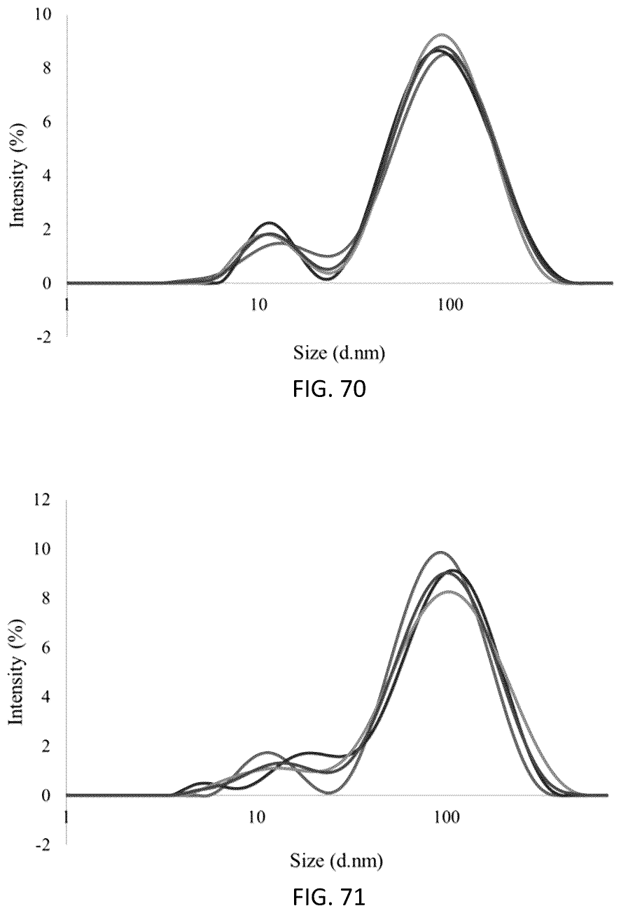

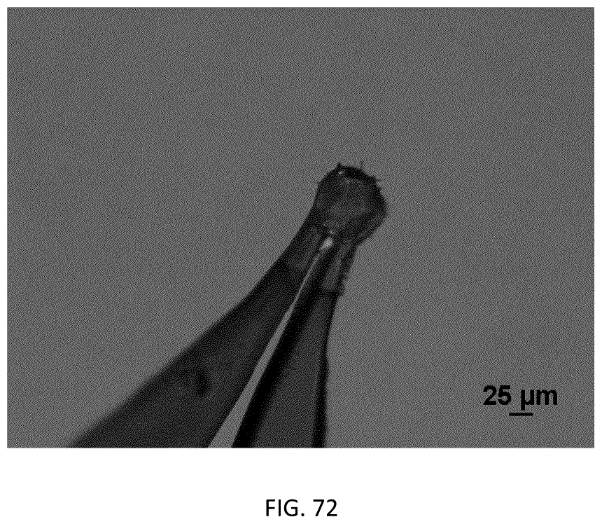

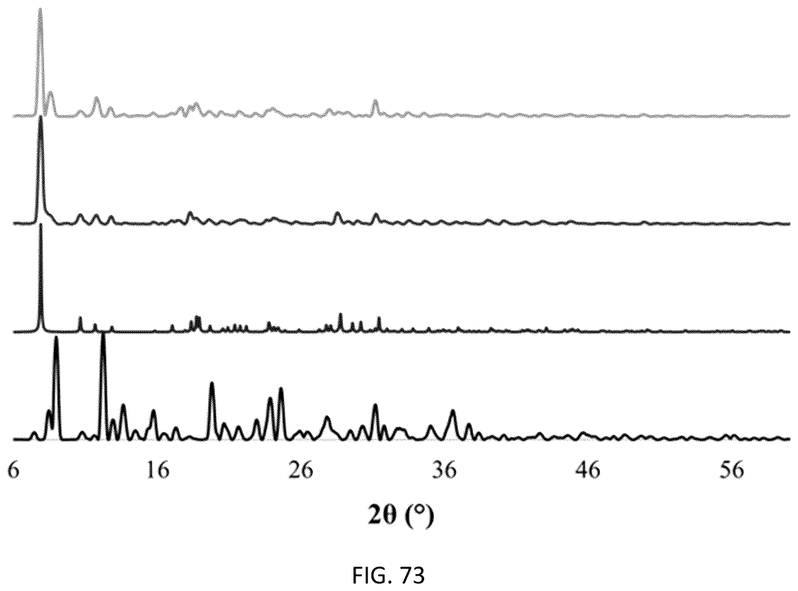

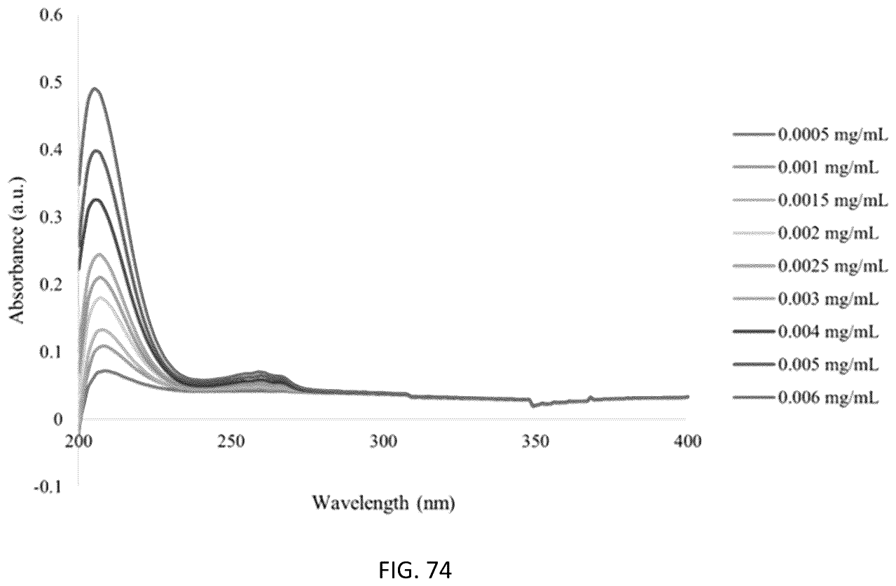

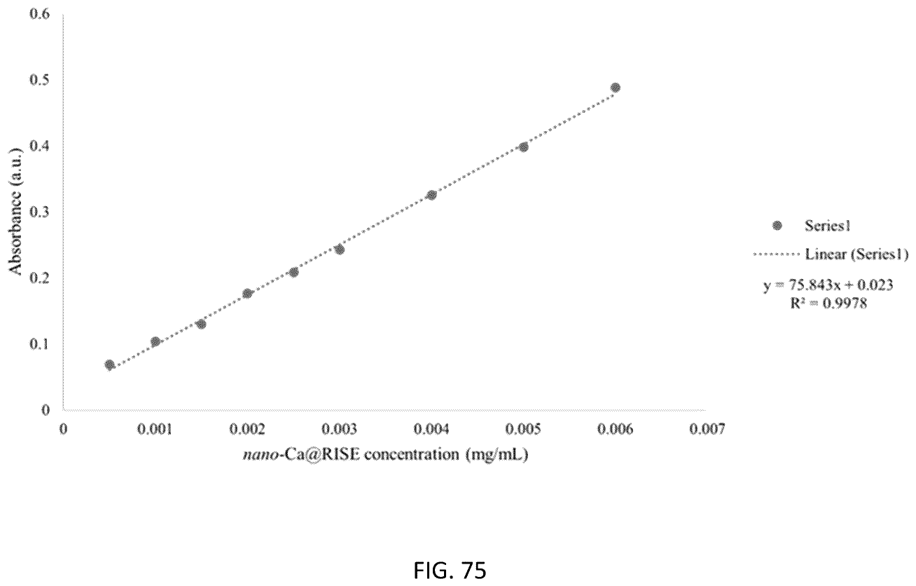

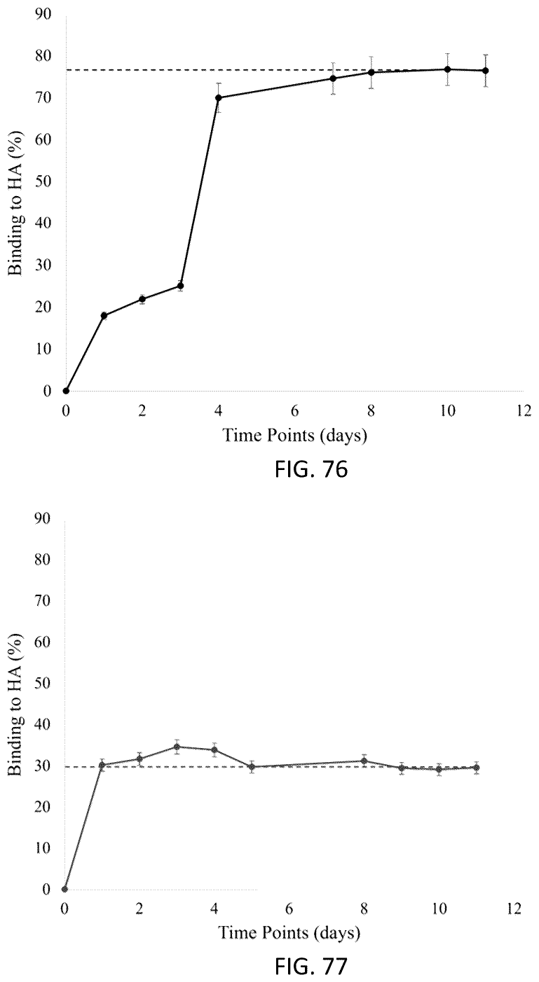

Tables 7-9 summarize the DLS parameters and values for three PIT-nano-emulsion synthesis products in nanopure water. FIG. 66-68 depict the DLS spectra showing the particle size distribution of three synthesis of the nano-Ca@RISE.

TABLE 7
Dynamic light scattering parameters and values after
analyzing the PIT-nano-emulsion synthesis product.
PIT-Nano-emulsion synthesis No. 1

| Run | Size (d · nm) | % Intensity | St Dev (d · nm) | PDI |
|---|---|---|---|---|
| 1 | 391.3 | 78.6 | 95.31 | 0.468 |
| | 5360 | 15.6 | 337.7 | |
| | 0.6779 | 5.8 | 0.07094 | |
| 2 | 427.3 | 83.0 | 120.2 | 0.464 |
| | 48.79 | 14.4 | 10.20 | |
| | 5560 | 2.6 | 6.104e−5 | |
| 3 | 330.8 | 73.6 | 98.08 | 0.880 |
| | 5170 | 19.5 | 490.2 | |
| | 34.39 | 6.9 | 7.310 | |
| Average | 385.1 | 78.4 | 112.8 | 0.604 |
| | 5275 | 12.6 | 431.1 | |
| | 44.12 | 7.1 | 11.54 | |

TABLE 8
Dynamic light scattering parameters and values after
analyzing the PIT-nano-emulsion synthesis product.
PIT-Nano-emulsion synthesis No. 2

| Run | Size (d · nm) | % Intensity | St Dev (d · nm) | PDI |
|---|---|---|---|---|
| 1 | 398.4 | 100.0 | 136.2 | 0.179 |
| | 0.000 | 0.0 | 0.000 | |
| | 0.000 | 0.0 | 0.000 | |
| 2 | 354.0 | 84.4 | 94.93 | 0.856 |
| | 5257 | 15.6 | 437.2 | |
| | 0.000 | 0.0 | 0.000 | |
| 3 | 353.6 | 75.5 | 107.4 | 0.450 |
| | 51.11 | 17.0 | 11.33 | |
| | 5375 | 7.5 | 325.9 | |
| Average | 371.0 | 86.6 | 117.8 | 0.495 |
| | 5295 | 7.7 | 408.2 | |
| | 51.11 | 5.7 | 11.33 | |

TABLE 9
Dynamic light scattering parameters and values after
analyzing the PIT-nano-emulsion synthesis product.
PIT-Nano-emulsion synthesis No. 3

| Run | Size (d · nm) | % Intensity | St Dev (d · nm) | PDI |
|---|---|---|---|---|
| 1 | 302.4 | 82.3 | 85.14 | 0.801 |
| | 5168 | 17.21 | 491.0 | |
| | 0.000 | 0.0 | 0.000 | |
| 2 | 301.5 | 83.9 | 84.36 | 0.413 |
| | 46.96 | 14.8 | 9.467 | |
| | 5560 | 1.3 | 0.000 | |
| 3 | 195.3 | 71.8 | 52.83 | 1.000 |
| | 5186 | 28.2 | 482.0 | |
| | 0.000 | 0.0 | 0.000 | |
| Average | 269.8 | 79.3 | 90.85 | 0.738 |
| | 5190 | 15.8 | 482.8 | |
| | 46.96 | 4.9 | 9.467 | |

### 8.4. Aggregation Measurements of Nano-Ca@RISE in Biorelevant Dispersant

Samples were prepared by taking 50 μL aliquots of the supermatant from the nano-synthesis water phase. They were transferred in disposable polystyrene cuvettes (REF: 67.754, 10×10×45 mm, Sarsted, Germany) and diluted with 100 fetal bovine serum in water (10% FBS:H₂O), respectively, in a 1:20 ratio. The cuvettes containing the samples remained undisturbed near the Zetasizer for 30 min prior to the measurements. Afterwards, size measurements were performed after 2 mn of sample equilibration inside the instrument at room temperature (25C). Particle size measurements was performed in the two dispersants after 24, 48 and 72 h of sample preparation.

Tables 10-12 summarize the DLS parameters and values for three PIT-nano-emulsion synthesis products in the biorelevant dispersant (1% o FBS:H₂O), at 24, 48 and 72 h.

FIGS. S8.4.1-S8.4.3 depict the DLS spectra showing the particle size distribution of three synthesis of the nano-RISE-based BPCC in biorelevant dispersant at the respective time points.

### Aggregation Tendency in 1% FBS:H₂O

Particle size distribution after 24 hours

TABLE 10
Dynamic light scattering parameters and values after
analyzing the nano-Ca@RISE in 1% FBS:H₂O at 24 h.
Particle size distribution: 1% FBS:H₂O (24 h)

| Run | Size (d · nm) | % Intensity | St Dev (d · nm) | PDI |
|---|---|---|---|---|
| 1 | 67.31 | 82.8 | 44.36 | 0.533 |
| | 2800 | 17.2 | 1354 | |
| | 0.000 | 0.0 | 0.000 | |
| 2 | 76.38 | 86.5 | 52.59 | 0.610 |
| | 4036 | 8.6 | 11.32 | |
| | 6.344 | 4.4 | 1.383 | |
| 3 | 75.22 | 74.7 | 45.00 | 0.590 |
| | 2872 | 16.8 | 1234 | |
| | 9.434 | 8.4 | 2.772 | |
| Average | 74.03 | 79.7 | 47.43 | 0.578 |
| | 3062 | 14.3 | 1363 | |
| | 8.159 | 6.1 | 2.227 | |

TABLE 11
Dynamic light scattering parameters and values after
analyzing the nano-Ca@RISE in 1% FBS:H₂O at 48 h.
Particle size distribution: 1% FBS:H₂O (48 h)

| Run | Size (d · nm) | % Intensity | St Dev (d · nm) | PDI |
|---|---|---|---|---|
| 1 | 106.5 | 84.1 | 59.02 | 0.461 |
| | 13.83 | 11.4 | 5.453 | |
| | 4225 | 4.5 | 996.1 | |
| 2 | 105.5 | 86.6 | 60.00 | 0.483 |
| | 12.03 | 10.6 | 3.104 | |
| | 4337 | 2.9 | 953.0 | |
| 3 | 102.1 | 85.2 | 52.48 | 0.492 |
| | 12.33 | 11.0 | 4.318 | |
| | 4299 | 3.9 | 967.5 | |
| Average | 104.7 | 85.2 | 57.28 | 0.479 |
| | 12.83 | 11.0 | 4.577 | |
| | 4279 | 3.8 | 976.6 | |

TABLE 12
Dynamic light scattering parameters and values after
analyzing the nano-Ca@RISE in 1% FBS:H₂O at 72 h.
Particle size distribution: 1% FBS:H₂O (72 h)

| Run | Size (d · nm) | % Intensity | St Dev (d · nm) | PDI |
|---|---|---|---|---|
| 1 | 104.5 | 88.5 | 51.65 | 0.427 |
| | 12.18 | 9.3 | 3.623 | |
| | 4789 | 2.1 | 730.4 | |
| 2 | 113.8 | 85.8 | 59.52 | 0.484 |
| | 18.59 | 11.2 | 5.921 | |
| | 5.692 | 1.8 | 1.073 | |
| 3 | 118.2 | 91.2 | 73.63 | 0.485 |
| | 12.62 | 8.8 | 4.702 | |
| | 0.000 | 0.0 | 0.000 | |
| Average | 112.0 | 88.8 | 62.76 | 0.465 |
| | 13.94 | 10.1 | 5.482 | |
| | 4866 | 1.1 | 697.0 | |

Polarized Optical Microscopy/Powder X-ray Diffraction (nano-Ca@RISE)

Agglomerated nanocrystals of nano-Ca@RISE were mounted in 20 tm MiTeGen micro loop. Optical micrograph was recorded with a Nikon Eclipse Microscope LV100NPOL, equipped with a Nikon DS-Fi2 camera and NIS Elements BR software version 4.30.01. Powder X-ray diffraction analysis parameters were maintained the same as in Section 3. FIG. S8.5.1 shows the representative sample mounted in the micro loop. FIG. S8.5.2 depicts the PXRD overlay of RISE, RISE-Ca simulated pattern, RISE-Ca bulk crystals and nano-Ca@RISE nanocrystals.

### Binding Assays of Nano-Ca@RISE to HA

### 8.6.1 Nano-Ca@RISE Calibration Curve

Stock Solution: A standard stock solution of nano-Ca@RISE (0.01 mg/mL) was prepared by transferring a 400 μL aliquot from the supernatant from the nano-synthesis water phase in a 50 mL volumetric flask using PBS. Further dilute solutions were prepared from this stock solution (see Calibration Curve section).

Calibration Curve: Accurately measured aliquots of the nano-Ca@RISE stock solution were transferred into a series of 10 mL volumetric flasks. To achieve a concentration range between 0.0005-0.006 mg/mL. Each solution was completed to the 10 mL mark with PBS.

### 8.6.2. Hydroxyapatite (HA) Assay

For the nano-Ca@RISE binding assay, 20 mg of hydroxyapatite (HA), were added to 3.00 mL of nano-Ca@RISE (0.5 mg/mL) in PBS solution. HA in PBS mixture, and the binding of RISE to HA, were used as control groups. The samples were left for 0-11 days at 37° C. and 300 rpm. As a comparative method, additional binding assay for RISE “as received” was conducted employing the same parameters as for the nanocrystals. The selected time points were: 1, 2, 3, 4, 5, 7, 8, 9, 10, and 11 days. The supernatant was collected after each time point, then centrifuged (1,500 rpm, 8 min), and absorbance measurements were performed at 206 nm to determine the binding percentage of RISE from the nano-Ca@RISE to HA. FIGS. S8.6.1 and S8.6.2 illustrate the binding curves of RISE and nano-Ca@RISE to HA in PBS.

Cytotoxicity Assays for nano-Ca@RISE

Cell culture methods for the MDA-MB-231 cell line. This cell line was grown in Dulbecco's Modified Eagle's Medium (DMEM) supplemented with 10% fetal bovine serum (FBS) and 1% penicillin-streptomycin (Pen-Strep), incubated at 37° C. and 5% CO₂. Cell passage and cell treatment were performed at 80% of cell confluency. The completed growth media was exchanged every two days.

Cell culture methods for the hFOB 1.19 cell line. This cell line was grown in 1:1 mixture of Ham's F12 Medium Dulbecco's Modified Eagle's Medium accompanied with 10% FBS and 0.3 mg/ml of geneticin (G418), incubated at 34° C. in 5% CO₂. Cell passage and cell treatment were performed at 80% of cell confluency. The completed growth media was exchanged every two days.

Cell seeding. The MDA-MB-231 and hFOB 1.19 cell lines were seeded in 96 well plates at a density of 2.5×10⁵ cells/mL, incubation was carried out for 24 h at 37° C. for MDA-MB-231 and 34° C. for osteoblast hFOB 1.19, in 5% CO₂. The experiments were conducted in triplicates, three 96 well plates were made for each treatment period (24, 48, and 72 h).

Cell treatment. To determine the half-maximal inhibitory concentration (IC₅₀), for both cell lines, two-fold serial dilutions of RISE (0-200 μM) were prepared. To assess the relative cell live (% RCL) were employed selected two-fold serial dilutions (50, 45, 40, and 35 μM) of RISE and nano-Ca@RISE for MDA-MB-231 and hFOB 1.19 cell lines. For this, after the seeding, 100 μL of RISE and nano-Ca@RISE were used to treat the cells. The control groups were treated with just media. Both cell lines were incubated for 24, 48, and 72 h after RISE and nano-Ca@RISE solutions were added.

AlamarBlue@assay. For both cell lines, after the 24, 48, and 72 h of treatment, the media was removed from the 96 well plates. Subsequently, 100 μL of 10% AlamarBlue® solution was added and incubation was carried out for 4 h. The fluorescence (λ_{exc}=570 nm, λₑₘ=590 nm) was measured employing an Infinite M200 PRO Tecan Microplate Reader. The half-maximal effective concentration (IC₅₀) and the relative cell viability (% RCL) were assessed comparing the viability of the control group (100%) with the cells treated with the RISE and nano-Ca@RISE solutions. The IC₅₀ curves and the % RCL values were plotted using the Graph Pad Prism 8 program.

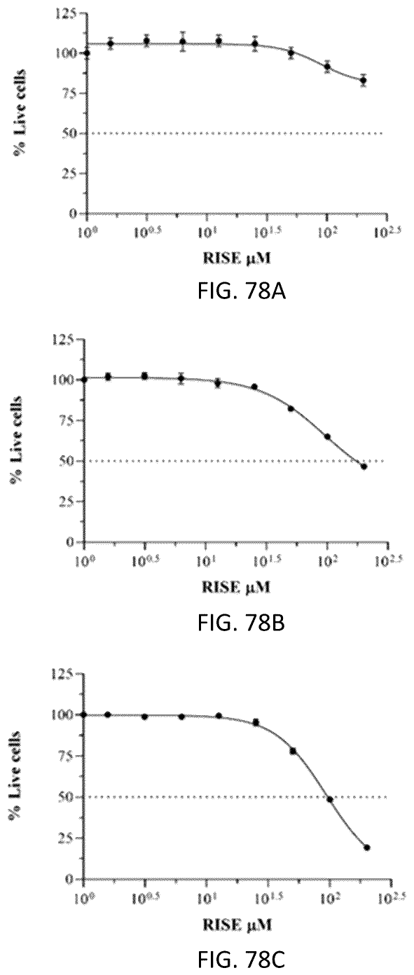

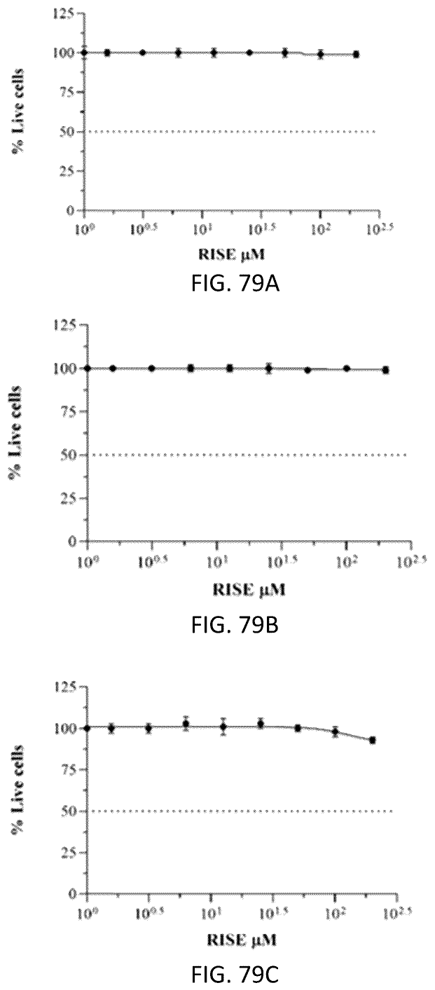

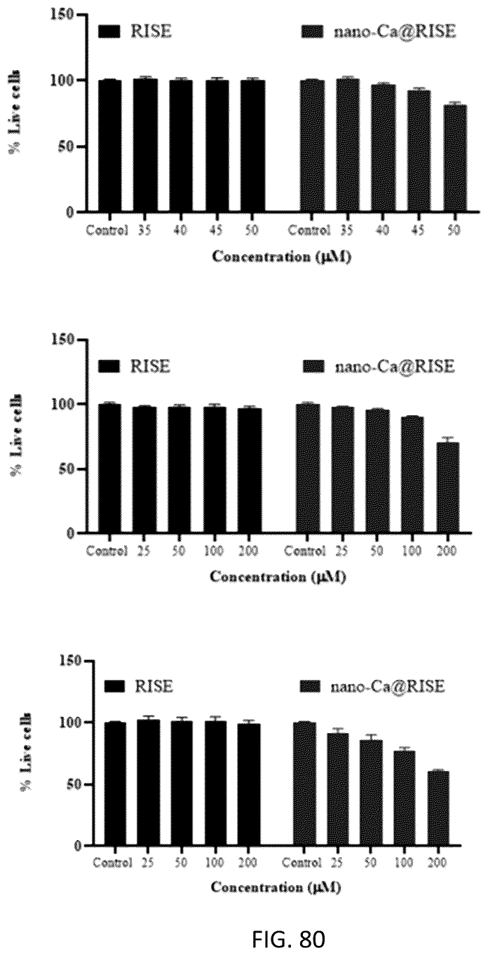

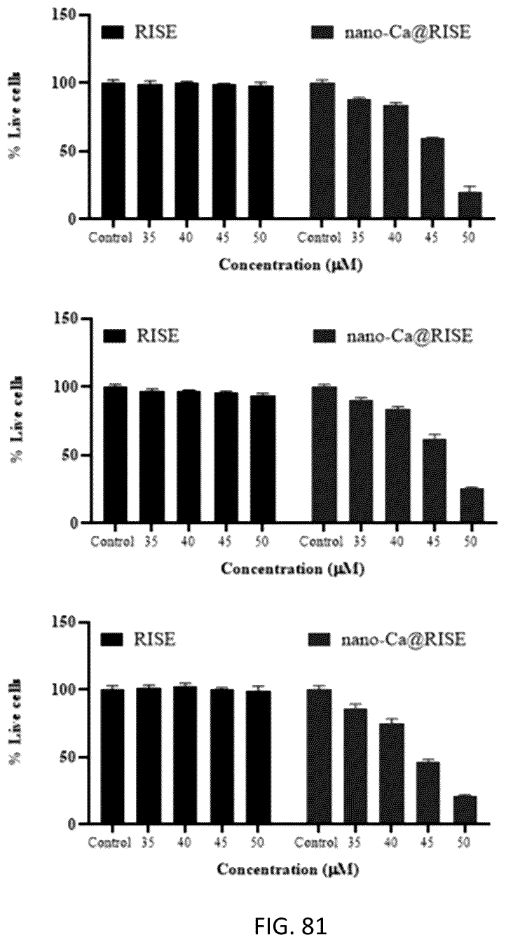

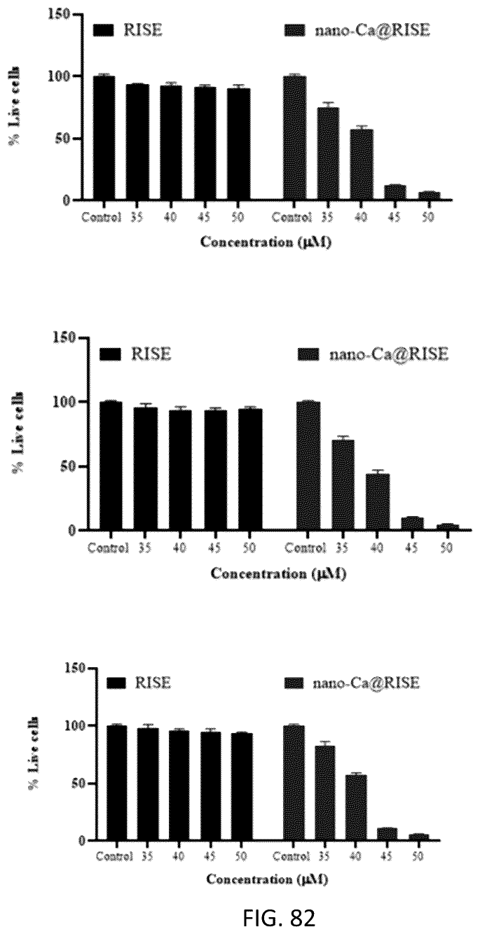

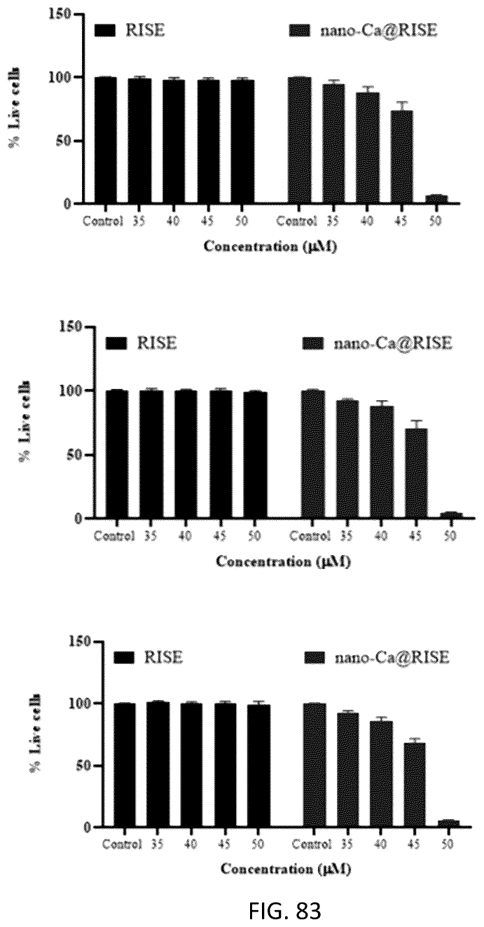

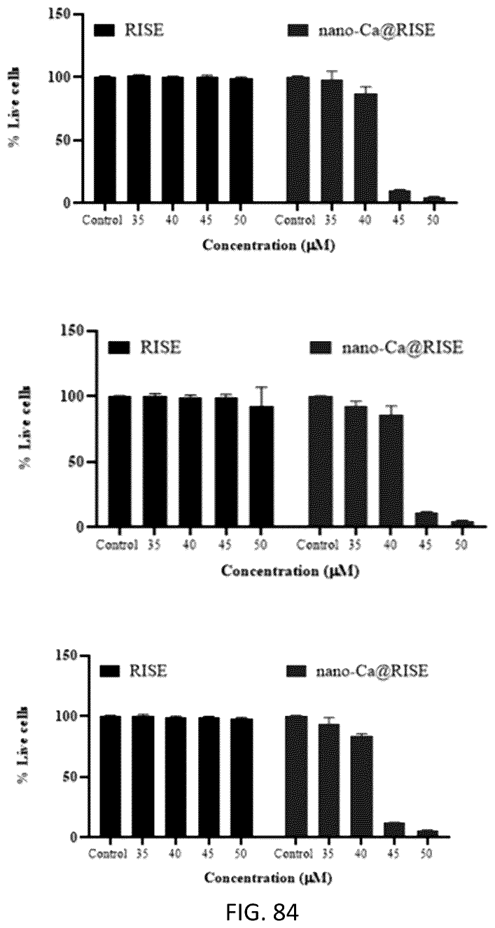

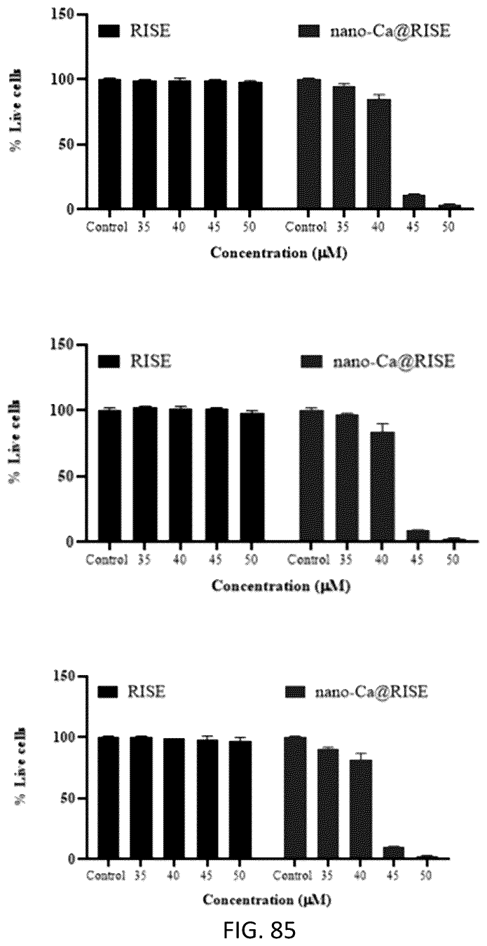

FIGS. 78-79 shows the IC₅₀ curves for MDA-MB-231 and hFOB 1.19 treated with RISE (0-200 μM). The percentage of relative cell live (% RCL) for MDA-MB-231 and hFOB 1.19 cell lines using RISE and nano-Ca@RISE in concentrations of 35, 40, 45, and 50 μM are shown is FIGS. 80-85.

TABLE 13
Relative cell viability (%) of MDA-MD-231 cell line treated with RISE
and nano-Ca@RISE at 35, 40, 45, and 50 μM after 24, 48 and 72 h of treatment.

| | 35 μM | | 40 μM | | 45 μM | | 50 μM | |
|---|---|---|---|---|---|---|---|---|
| Time | | Nano- | | Nano- | | Nano- | | Nano- |
| Points | RISE | Ca@RISE | RISE | Ca@RISE | RISE | Ca@RISE | RISE | Ca@RISE |
| Control | 100 | 100 | 100 | 100 | 100 | 100 | 100 | 100 |
| 24 h | 101 ± 2 | 97 ± 5 | 100 ± 2 | 97 ± 1 | 100 ± 2 | 91 ± 2 | 99 ± 2 | 76 ± 7 |
| 48 h | 100 ± 2 | 88 ± 2 | 100 ± 3 | 82 ± 3 | 98 ± 2 | 61 ± 2 | 97 ± 3 | 22 ± 3 |
| 72 h | 96 ± 2 | 73 ± 3 | 94 ± 1 | 56 ± 2 | 94 ± 2 | 11 ± 1 | 93 ± 2 | 6 ± 1 |

TABLE 14
Relative cell viability (%) of hFOB 1.19 cell line treated with RISE and
nano-Ca@RISE at 35, 40, 45, and 50 μM after 24, 48 and 72 h of treatment.

| | 35 μM | | 40 μM | | 45 μM | | 50 μM | |
|---|---|---|---|---|---|---|---|---|
| Time | | Nano- | | Nano- | | Nano- | | Nano- |
| Points | RISE | Ca@RISE | RISE | Ca@RISE | RISE | Ca@RISE | RISE | Ca@RISE |
| Control | 100 | 100 | 100 | 100 | 100 | 100 | 100 | 100 |
| 24 h | 100 ± 1 | 93 ± 2 | 100 ± 1 | 88 ± 2 | 100 ± 1 | 71 ± 3 | 99 ± 1 | 6 ± 1 |
| 48 h | 101 ± 0 | 94 ± 3 | 100 ± 0 | 85 ± 2 | 100 ± 1 | 11 ± 1 | 96 ± 4 | 5 ± 1 |
| 72 h | 100 ± 2 | 94 ± 4 | 100 ± 1 | 84 ± 2 | 99 ± 2 | 10 ± 1 | 98 ± 1 | 3 ± 1 |

1,1′-biphenyl-4,4′-bisphosphonic acid (BPBPA) as lisgand

### Overview

Extended bisphosphonate-based coordination complexes (BPCCs) were designed using the bisphosphonate analogue of 1,1′-biphenyl-4,4′-dicarboxylic acid (BPDC). The hydrothermal reaction of 1,1′-biphenyl-4,4′-bisphosphonic acid (BPBPA) with bioactive metals (Ca²⁺, Zn²⁺, and Mg²⁺) leads to the formation of three crystalline phases, namely; BPBPA-Ca, BPBPA-Zn, and BPBPA-Mg. The channels (9×13 Å) observed in the BPBPA-Ca framework were adequate for drug encapsulation. Dissolution curves in phosphate-buffered saline (PBS, pH=7.4) demonstrate that these materials did not collapse in a neutral environment. Moreover, in fasted-state simulated gastric fluids (FaSSGF, pH=1.6), about 80-100% of BPBPA release was achieved. These results suggest a pH-dependent degradation for the BPBPA-based BPCCs obtained in this study. Furthermore, the PIT-nano-emulsion method successfully reduced the particle size of BPBPA-Ca to the nanoscale (˜160 d. nm) range, leading to nano-Ca@BPBPA. The binding assay revealed higher affinity of this nanomaterial (25%) to hydroxyapatite (HA) contrasted with zoledronic acid (ZOLE, 15%), a commercial bisphosphonate, after 24 hr. The nano-Ca@BPBPA (93%) demonstrates a similar affinity to HA than the BPBPA (94%) after 5 d. In addition, the same amount of the antineoplastic drug letrozole (LET) that was encapsulated (˜22%) into the BPBPA-Ca and nano-Ca@BPBPA, then was completely released (˜22%) in FaSSGF. This points to the capacity of this framework to effectively encapsulate and later release its cargo in a pH-dependent manner. Cell viability assays revealed that the unloaded nano-Ca@BPBPA cause higher decrease in cell viability for the MCF-7 (% RCL=63±1%) cells contrasted with the MDA-MB-231 (% RCL=100 1%) and the hFOB 1.19 (% RCL=100 1 %) cell lines at a concentration of 12.5 μM after 72 h. Furthermore, the drug-loaded nano-Ca@BPBPA exhibits higher cytotoxicity effects against MCF-7 (% RCL=21±1%, 12.5 μM) compared with MDA-MB-231 (% RCL=45±4%, 12.5 μM) and hFOB 1.19 (% RCL=100±1 %, 12.5 μM) after 72 h. For LET, lower cytotoxicity effects were observed for MCF-7 (% RCL=70±1%, 12.5 μM), MDA-MB-231 (% RCL=99±1%, 12.5 μM) and hFOB 1.19 (% RCL=100±1%, 12.5 μM) cell lines after 72 h. Collectively, these results suggest that nano-Ca@BPBPA retains suitable characteristics as an extended nano-BPCCs nanomaterial; in terms of stability, pH dependent degradation, and drug-loading/release capacities, to be employed as a potential drug delivery system (DDS); offering bone affinity, to treat breast cancer-induce osteolytic metastases (OM).

The organic ligand 1,1′-biphenyl-4,4′-bisphosphonic acid was, for the first time, synthesized (BPBPA, Scheme 1) and coordinated with bioactive metal (Ca²⁺ Zn²⁺, and Mg²⁺) to achieve new 3D porous extended BPBPA-based BPCCs. It was expected that the resulting materials might bind to the bone microenvironment due to the high affinity of the P—C—P backbone of BPBPA for Ca²⁺ ions. In addition, the hydroxyl groups in the geminal carbon (P—C(OH)—P) of this BP can provide BPBPA-based BPCCs with higher bone affinity. These bioactive metals (LD₅₀ =0.35 (Ca²⁺), 1.0 (Zn²⁺), and 8.1 (Mg²⁺) g/kg)^{19.20.21} were selected due to their role in several physiological processes, specifically, osteoblastic bone formation and mineralization processes.^{19,20} The crystalline phases of these unique BPBPA-based BPCCs obtained here were investigated in terms of their structure, pH-dependent degradation, bone affinity, and cytotoxicity to gain insights into their potential as DDSs, with bone affinity, able to encapsulate and release antineoplastic drugs to treat and prevent breast cancer-induced OM.

The 1,1′-biphenyl-4,4′-dicarbonyl dichloride (C₁₄O₁₄P₄H₁₈, 95% pure) was purchased from Sigma Aldrich (Milwaukee, WI). Tris(trimethylsilyl) phosphite ((CH₃)₃SiO]3P, 92% pure) was purchased from Fisher Scientific (Hampton, NH). Calcium nitrate tetrahydrate (Ca(NO₃)₂·4H₂O, 99% pure), zinc nitrate hexahydrate (Zn(NO₃)₂·6H₂O, 98% pure), and magnesium nitrate hexahydrate (Mg(NO₃)₂·6H₂O, 99% pure) were obtained from Sigma-Aldrich (St. Louis, MO). Sodium chloride (NaCl, ACS reagent>99.0% pure), hydrochloric acid (HCl, 37% wt.), and sodium hydroxide (NaOH, >98% pure) were purchased from Sigma-Aldrich (St. Louis, MO). Nano pure water was acquired from an ARIES Filter Works Gemini High purity water system (18.23 M-Ohm/cm).

### Synthesis of BPBPA

The BPBPA was synthesized following the Lecouvey reaction, previously reported to obtain bisphosphonates.^{22,23,24,255} For this, about 1.0 g of 1,1′-biphenyl-4,4′-dicarbonyl dichloride (BPDCl) was added to 7 mL of tris(trimethylsilyl) phosphite at O° C. The reaction was left in constant stirring for 1 h to reach room temperature and then left undisturbed for 3 d at 50° C.

After this period, the excess of tris(trimethylsilyl) phosphite (TMSP) was removed by rotoevaporation. Subsequently, 25 mL of methanol were added to the ester product, the reaction was left under continuous stirring for 1 d at room temperature. Finally, the excess of methanol was removed by rotoevaporation, the final product (BPBPA) was washed with methanol and diethyl ether and then dried under vacuum. The BPBPA obtained through this procedure was characterized by nuclear magnetic resonance (NMR), Raman spectroscopy, powder X-ray diffraction (PXRD), thermogravimetric analysis (TGA), and differential scanning calorimetric (DSC). The synthesis of BPBPA has not been previously reported in the literature.

Nuclear magnetic resonance (NMR)for BPBPA. ¹H NMR, ¹³C-APT NMR, and ³¹P NMR were recorded employing a Bruker Ascend Aeon 700 MHz NMR. The instrument is equipped with a multilinear, variable temperature, and cross-polarization magnetic angle spinning.

The BPBPA was dissolved in deuterium oxide (D₂O), the experiment was performed at room temperature.

Raman vibrational spectroscopy for BPBPA. A Thermo Scientific DXR Raman microscope was employed to collect the Raman spectra for BPBPA. The instrument was equipped with a 532 nm laser, the experiment was performed using a 50 μm slit, 400 lines/mm grating, and 32 scans with an exposure time of 5 s. The Raman data was collected between 3,500 to 250 cm⁻¹.

The OMNIC for Dispersive Raman Software version 9.2.0 was utilized to perform the experiment and analyze the data collected.

Powder X-ray diffraction (PXRD) for BPBPA. A Rigaku XtaLAB SuperNova X-ray diffractometer equipped with micro-focus Cu-Kα radiation (λ=1.5417 Å) source and a HyPix3000 X-ray detector was utilized to record the PXRD diffractogram for BPBPA. The experiment was performed in transmission mode at 50 kV and 1 mA. BPBPA crystals were gently grinded and powder BPBPA was mounted on MiTeGen micro-loops using paratone oil. The PXRD diffractogram for BPBPA was collected at 300 K, 20 range (6-60°), and in fast phi mode (90 s) employing an Oxford Cryosystem Cryostream 800 cooler. The CrystAllis^{PRO} software version 1.171.3920a was utilized to analyze the data.

Thermogravimetric analysis (TGA) for BPBPA. A TGA Q500 (TA Instruments Inc.) was employed to record the TGA thermograph of BPBPA. The experiment was carried out from 25 to 700° C., under N₂ (60 mL/min) at 5° C./min. For this, about 2-5 mg of a powered BPBPA was used for the experiment. The TA Universal Analysis software v 4.5 Å was utilized to collect and analyze the data.

Differential scanning calorimetric (DSC) for BPBPA. A DSC Q2000 (TA Instruments Inc.) was utilized to record the DSC thermogram of BPBPA. An indium standard (Tm =156.6° C. and ΔH_{f}=28.54 J/g) was utilized to calibrate the instrument. Additionally, the instrument was equipped with a 50-position autosampler and a refrigerated cooling system (RCS40). The DSC thermograph for BPBPA was collected in a temperature range between 25-400° C. under an N₂ atmosphere (50 mL/min) at 5° C./min. For this, about 1-2 mg of powered BPBPA sample was employed to carry out the experiment, hermetically sealed aluminum pans were utilized to prepare the sample. The TA Universal Analysis software v 4.5 Å was utilized to collect and analyze the data.

### Synthesis of BPBPA-Based BPCCs

The BPBPA-based BPCCs were synthesized employing the hydrothermal method.⁵ For this, Solutions of BPBPA and the corresponding salts were separately prepared. For this, about 10.0 mg of BPBPA was dissolved in 10.0 mL of nano pure water. Subsequently, the metal salt solutions were prepared separately by adding 4.20 mg of Ca(NO₃)₂·4H₂O, 6.0 mg of Zn(NO₃)₂·6H₂O, and 4.85 mg Mg(NO₃)₂·4H₂O in 10.0 mL of nano pure water. Then, in 20.0 mL vials were transferred 5.0 mL of the previously prepared solutions (BPBPA and metal salt solutions). This mixture was left undisturbed in a heating block for 1 d at 70° C. When crystals were visually detected, the vials were removed from the heating block and left undisturbed to reach room temperature and equilibrium. The crystals obtained through this procedure were collected by vacuum filtration and air-dried.

### Solid-State Characterization of BPBPA-Based BPCCs

Raman Vibrational Spectroscopy for BPBPA-based BPCCs. The Raman spectra for BPBPA-Ca, BPBPA-Zn, and BPBPA-Mg were recorded employing a Thermo Scientific DXR Raman microscope. The data collection and analysis were performed as previously described for BPBPA.

Powder X-ray diffraction (PXRD) for BPBPA-based BPCCs. The PXRD diffractograms for BPBPA-Ca, BPBPA-Zn, and BPBPA-Mg were collected using a Rigaku XtaLAB SuperNova X-ray diffractometer. The data collection and analysis were performed as previously described for BPBPA.

Single-crystal X-ray diffraction for BPBPA-based BPCCs. The crystal quality of single crystals of BPBPA-Ca, BPBPA-Zn, and BPBPA-Mg was assessed using a polarized microscope Nikon Eclipse Microscope LV100NPOL, equipped with a Nikon DS-Fi2 camera. Optical micrographs for all BPBPA-BPCCs were recorded employing a NIS Elements BR software version 4.30.01. Suitable single crystals of BPBPA-BPCCs were mounted in MiTeGen micro-loops for structure elucidation at 100 K. The experiments were accomplished in a Rigaku XtalLAB SuperNova single micro-focus Cu-Kα radiation (λ=1.5417 Å) source. The instrument was equipped with an Oxford Cryosystems Cryostream 800 and a HyPix3000 X-ray detector in transmission mode, working at 50 kV and 1 mA. The data was collected using the CrysAlisPRO software v1.171.39.45c. All structures were solved using full-matrix least-squares (F2 mode) and direct methods in Olex2 software vs 1.2.

Thermogravimetric analysis (TGA) for BPBPA-based BPCCs. The TGA Q500 (TA Instruments Inc.) was employed to collect the TGA thermographs of BPBPA-Ca, BPBPA-Zn, and BPBPA-Mg. The data collection and analysis were performed as previously described for BPBPA.

Scanning electron microscopy-energy dispersive spectroscopy (SEM-EDS) for BPBPA-based BPCCs. The SEM micrographs and the X-ray elemental analysis of BPBPA-Ca, BPBPA-Zn, and BPBPA-Mg were recorded using a JEOL JSM-6480LV scanning electron microscope. The instrument was equipped with an Everhart Thomley secondary electron imaging (SEI) and an energy dispersive X-ray analysis (EDAX) Genesis 2000 detectors. The SEM micrographs of the BPBPA-BPCCs were collected employing an acceleration voltage of 20 kV, a spot size of 36, and an electron beam of 11 mm width in a high vacuum mode.

### Dissolution Profiles of BPBPA-Based BPCCs

Calibration curve. Stock solutions of 0.5 and 0.1 mg/mL of BPBPA in PBS and FaSSGF, respectively, were prepared. For this, 12.5 mg of BPBPA were dissolved in 25 mL of PBS and FaSSGF. Then, serial dilutions were completed to obtain standard solutions in a concentration range between 0.08-0.002 mg/mL. Finally, the absorbance was measured employing UV-Vis spectroscopy (200-400 nm), PBS and FaSSGF were employed as solvent blanks. The maximum absorbance wavelength (X(max)) was detected at 275 and 266 nm in PBS and FaSSGF, correspondingly.

Dissolution experiment. About 100.0 mL of PBS and FaSSGF were separately transferred to a 250 mL beaker, these solutions were left under stirring at 37° C. (150 rpm). To record the first time point (0 h), an aliquot (1 mL) was extracted before the addition of the BPBPA-BPCCs. Then, 15.0 mg of powered BPBPA-based BPCCs were added to the PBS and FaSSGF solutions. After selected time points (0, 1, 3, 6, 24, 48, and 72 h), aliquots of 1 mL were taken out and diluted in a 5 mL volumetric flask. Subsequently, the absorbance of BPBPA released from the coordination complexes was evaluated at 275 nm. The dissolution experiments were performed in duplicate for each BPBPA-BPCCs.

Phase inversion temperature (PIT) and PIT-nano-emulsion synthesis of nano-Ca@BPBPA

The crystalline (Technobis, Crystallization Systems, Alkmaar, Netherlands) was employed to perform the nano-emulsion synthesis of nano-Ca@BPBPA. For this, a homogenized emulsion (BPBPA, heptane, Brij L4®) was prepared and transferred to 8 mL reaction vials. Then, the reaction vials were left for 30 min at 7° C., followed by 30 min at 50° C. This procedure was carried out at constant stirring (1,250 rpm). Finally, the metal salt solution was added and the reaction was left for 1 h at 80° C. to enable the Formation of the nanocrystals (nano-Ca@BPBPA).

After the synthesis was completed, Dynamic light scattering (DLS) was utilized to assess the particle size distribution of nano-Ca@BPBPA. For this, DLS measurements were performed using the supernatant from the aqueous phase attained from the PIT nano-emulsion synthesis of these nanocrystals. All DSC experiments were performed employing the Malvern Panalytical Zetasizer NanoZS. The instrument is equipped with a He—Ne orange laser (633 nm, max 4 mW) (Spectris PLC, Surrey, England). All DLS samples (1:20, nano-Ca@BBPA:nanopure water) were prepared in disposable polystyrol/polystyrene cuvettes (Ref: 67.754 10×10×45 mm, Sarsted, Germany). The refractive index (1.336) of 2.5 mg/mL BPBPA was determined employing a Mettler Toledo Refracto 30GS (Mettler Toledo, Columbus, OH). After measurements were completed, the Malvern software version 7.12 was utilized to evaluate the data collected.

### Binding Assay to HA

Calibration curve. To quantify the BPBPA content in the binding assay, a calibration curve was previously prepared and additionally employed in the dissolution profiles before mentioned.

Binding assay experiment. Synthetic hydroxyapatite (HA) was utilized to explore the affinity of nano-Ca@BPBPA to the bone microenvironment. For this, about 20 mg of powdered HA were exposed to nano-Ca@BPBPA (5 mL, 0.5 mg/mL). In addition, BPBPA (0.5 mg/mL) and HA (20 mg) were used as control groups. All experimental and control groups were left under constant stirring (150 rpm) for 0-12 d. The supernatant was collected, centrifugated (8 min, 1200 rpm), and the absorbance was measured (275 nm) after each time point (1, 2, 3, 4, 7, 8, 9, 10, 11, 12 d) to quantify the amount (%) of BPBPA bound to HA. Moreover, HA, HA-BPBPA, and HA-nano-Ca@BPBPA were characterized by SEM-EDS and PXRD.

### Drug Loading/Release of Letrozole

Drug loading of letrozole (LET) into BPBPA-Ca. The LET loading into BPBPA-Ca was performed as follows, in a 1.5-mL vial were added BPBPA-Ca (20 mg), LET (7 mg), and ethanol (1 mL). This mixture was left undisturbed at 50° C. for 24 h. In addition, about 7 mg more of LET were added to the vial to allow the complete loading of LET into the BPBPA-Ca channels.

Furthermore, BPBPA-Ca (20 mg) and LET (7 mg) in ethanol (1 mL) were employed as control groups. Once the experiment was completed, the supernatant was collected, filtrated, and the absorbance was measured at 238 nm. Lastly, the drug-loaded BPBPA-Ca, BPBPA-Ca, and LET were characterized by SEM-EDS and PXRD.

Drug loading of LET into nano-Ca@BPBPA. The PIT-nanoemulsion method was employed to achieve the drug loading of LET into the nano-Ca@BPBPA. For this, the synthesis of the nano-Ca@BPBPA was accomplished as previously described in Section 7. Subsequently, a solution of LET was added to the synthesized nano-Ca@BPBPA. This mixture was left under stirring for 1 h allowing the loading of LET into the nano-Ca@BBPA. The drug-loaded nano-Ca@BPBPA was characterized by SEM-EDS and PXRD.

LET release curve from BPBPA-Ca. The release curve of LET from BPBPA-Ca was determined in FaSSGF. About 100 mL of FaSSGF were placed in a 250-mL beaker and left in constant stirring at 37° C. (150 rpm). To record the first time point (0 h), an aliquot (1 mL) was taken out before adding the drug-loaded BPBPA-Ca. Subsequently, about 20 mg of powdered drug-loaded BPBPA-Ca (experimental) were placed into the FaSSGF solution. After each time point (0, 1, 3, 6, 24, 48, and 72 h), an aliquot (1 mL) was taken out and diluted in a 5 mL volumetric flask. Once the experiment was completed, the absorbance was measured at 238 nm to determine the amount (%) of LET release from the BPBPA-Ca. The release curve of LET (control) in FaSSGF was determined for comparison. This experiment was accomplished in duplicate.

### Cytotoxicity Assays

Cell culture methods. MCF-7, MDA-MB-231, and hFOB 1.19 cell lines were incubated employing DMEM (37° C.) and DMEM: F12 (34° C.) medium, respectively, in a 5% CO₂. Cell lines were supplemented using 10% FBS and 1% Pen-Strep and medium exchange was performed twice a week. Cell passages were carried out at 80% confluency.

Cell-based assays. Cell lines were seeded in 96 well plates at a density of 5×103 cells/mL, cells were incubated for 24 h before treatment. Both cell lines were treated with 100 μL of BPBPA (0-400 μM), LET (0-200 μM), unloaded and loaded nano-Ca@BPBPA (0-50 μM). All cell-based assays were performed for 24, 48, and 72 h of treatment. Control groups were treated with media (DMEM or DMEM: F12) supplemented with 1% Pen-Strep. Then, the media was removed and replaced with 100 μL of 10% AlamarBlue® solution. The 96 well plates were incubated for 4 h before measurements. Then, the fluorescence was assessed at 560 nm of excitation and λₘₐₓ 590 nm of emission. The cell viability (%) was evaluated by contrasting the percentage of live cells of the control groups with the cells treated with BPBPA, LET, unloaded and loaded nano-Ca@BPBPA. The half-maximal inhibitory concentration (IC₅₀) was determined for BPBPA and letrozole employing the dose-response curves (% cell live vs. concentration). The relative cell live (% RCL) was assessed for the unloaded and loaded nano-Ca@BPBPA, utilizing LET as a control group. The IC₅₀ and % RCL were plotted using the GraphPad Prism software vs. 9.3.0.

### BPBPA Results and Discussion

### Synthesis and Solid-State Characterization of BPBPA

The corresponding BP analogue of BPBC was synthesized through the Lecouvey reaction, previously employed to synthesize extended BPs.^{23,25} The BPDCl; as a received reagent, was utilized as starting material to carry out the synthesis. The first step of the Lecouvey reaction yields an ester intermediate in the presence of TMSP. The hydrolysis of this intermediate with methanol generates the expected BPBPA (89% yield, FIG. 2). To the best of our knowledge, this is the first time that BPBPA has been synthesized. Results about the NMRs, Raman spectroscopy, TGA, DSC, and PXRD confirm the identity and purity of the obtained BPBPA (Supporting Information).

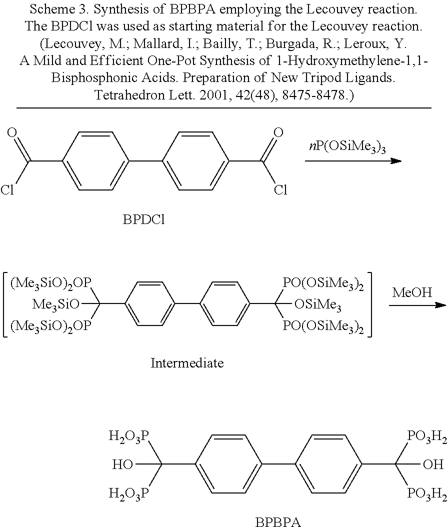

### Synthesis and Solid-State Characterization of BPBPA-Based BPCCs

The hydrothermal synthesis in nano pure water using a 1:1 M²⁺ BPBPA molar ratio at 70° C., and neutral conditions (pH=7.0) yielded three BPBPA-based BPCCs (BPBPA-Ca, BPBPA-Zn, and BPBPA-Mg). The particle size reduction, binding affinity, drug loading, and cytotoxicity were investigated for these coordination complexes to obtain insights into their capacity as possible DDSs to treat and prevent bone-related diseases such as OM.

Scanning electron microscopy-energy dispersive X-ray spectroscopy (SEM-EDS) of BPBPA-based BPCCs

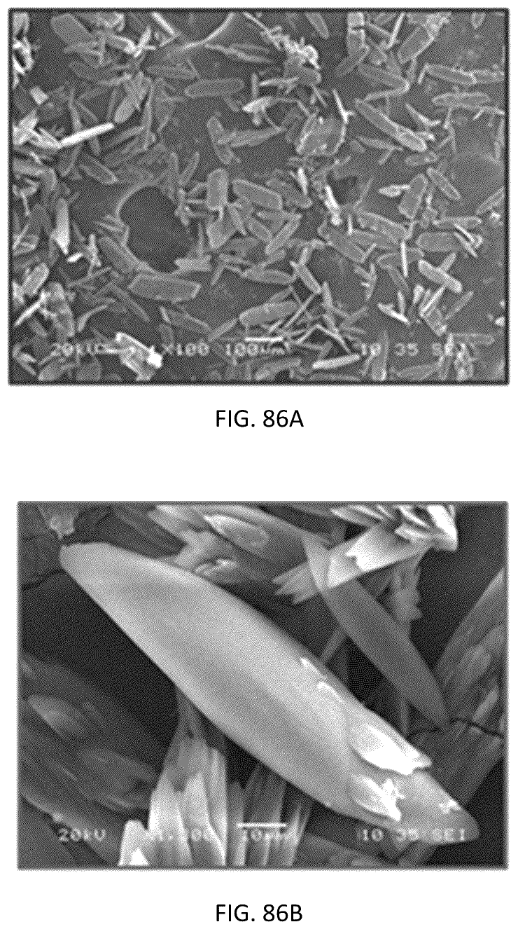

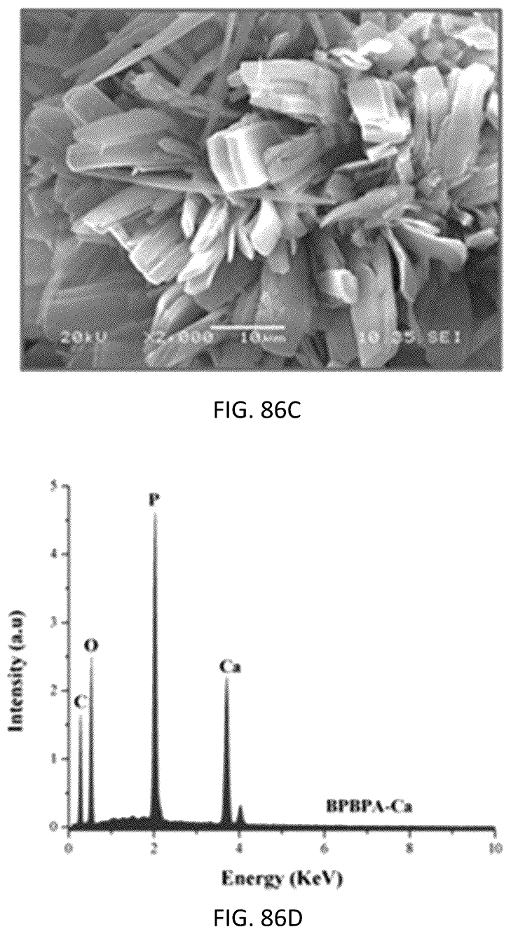

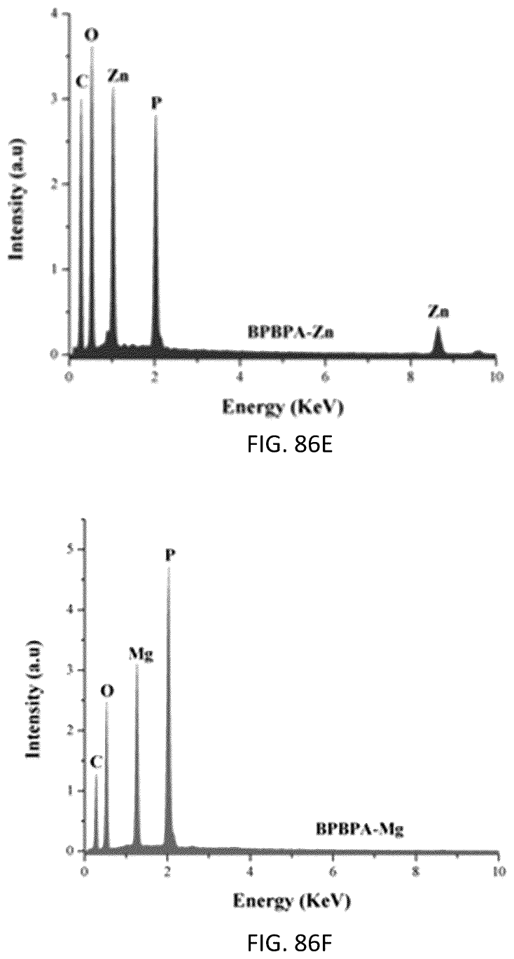

The SEM micrographs recorded for all BPBPA-based BPCCs show well-defined prisms (BPBPA-Ca, BPBPA-Zn) and needle (BPBPA-Mg) morphologies (FIGS. 86A-86C). The diameter of these BPBPA-based BPCCs ranges from 100-500 μm. Additionally, the elemental composition of these materials was investigated by EDS. The detection of characteristic signals associated with the metal centers (Ca²⁺ Zn²⁺, and Mg²⁺) and the BPBPA (carbon, oxygen, and phosphorous) supports the Formation of these BPBPA-based BPCCs (FIGS. 86D-86F).

### Raman Vibrational Spectroscopy of BPBPA-Based BPCCs

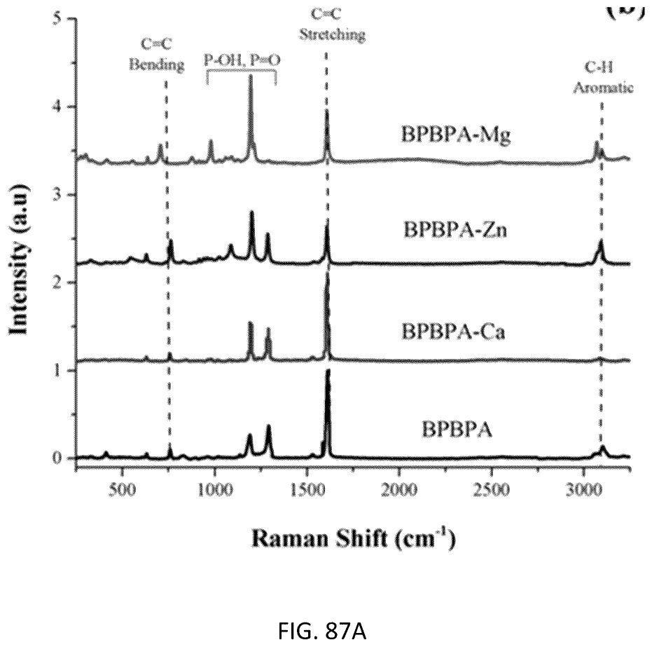

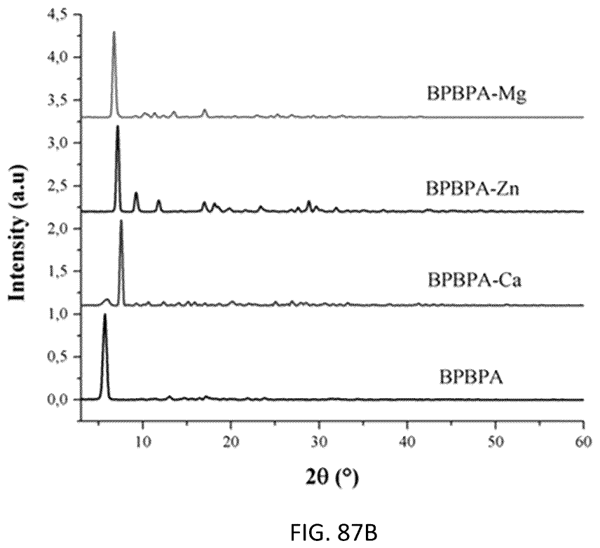

Raman spectra for the BPBPA-based BPCCs were recorded from 3,500 to 250 cm-1 (FIG. 87A). This analysis allowed to confirm that distinctive crystalline phases were produced from the hydrothermal reactions, by the detection of different vibrational modes between BPBPA and the BPBPA-based BPCCs spectra. The presence of the BPBPA ligand on the metal complexes was initially suggested by the appearance of Raman signals at the 3,100-3,000 cm⁻¹ region, which corresponded to the stretching vibration of aromatic hydrogens. Additionally, compared to BPBPA, the increased number and intensity of the signals at ˜3,000 and 3,100 cm⁻¹ for the metal complexes corroborates the presence of strong hydrogen bonds within each lattice. The latter suggests that an extensive hydrogen bond network is driven by coordinated and lattice water molecules, is present within the crystal structure of the BPBPA-based BPCCs. The strong band observed between 1,600-1,500 cm⁻¹ in the BPBPA and BPBPA-based BPCCs spectra, can be attributed to the stretching vibration of the aromatic carbons. Incorporation of the BPBPA ligand in a coordination sphere of the resulting materials is confirmed by two bands observed at the -1,300 cm⁻¹ (strong) and -1,200 cm⁻¹ (medium), respectively. The strong signal corresponded to the v^{as}P—O(H) asymmetric stretching vibrations, while the medium signal corresponds to the δPO-H bending of the phosphonate P—O₃ groups. The appearance of other signals around 1,100-1,000 cm⁻¹ suggests the deformation stretching vibration of the P═O group in these BPCCs, due to the coordination of the ligand with the metal center. These signals are absent in the BPBPA spectra.

Other signals that can confirm the incorporation of the ligand in the resulting materials are the ones observed at 700-600 cm⁻¹. These last can be attributed to the characteristic bending vibration of the aromatic carbons from the ligand. Other Raman shifts observed at lower wavenumbers (<600 cm⁻¹) can be assigned to vibrational modes characteristic of the C-P and M²⁺—O groups present in the BPBPA-based BPCCs.

### Powder X-Ray Diffraction Analysis of BPBPA-Based BPCCs

Characteristic PXRD diffractograms of the BPBPA-based BPCCs are presented in FIG. 87B. Results show a low amorphous background, demonstrating a high degree of crystallinity of the BPBPA-based BPCCs. The PXRD diffractograms of the coordination complexes did not show reflections due to the BPBPA or the metal salts, discarding the possibility of recrystallization of these starting materials during the synthesis of each BPBPA-based BPCCs In addition, it was observed that the BPBPA and the BPBPA-based BPCCs present distinctive crystal phases, showing unique reflections between each other.

### Single Crystal X-Ray Diffraction Analysis of BPBPA-Based BPCCs

The crystalline phases of each BPBPA-based BPCCs were elucidated by SC-XRD. Direct methods were employed to solve the crystal structure parameters of these coordination complexes (Table 14). Asymmetric units and packing along with the a, b, and c-axis for the BPBPA-based BPCCs can be found in the Supporting Information. Furthermore, the simulated PXRD from the solved crystal structures was contrasted with the experimental PXRD of these materials, suggesting that representative solutions were obtained for each BPBPA-based BPCCs. Interestingly, channels (9×13 Å) were observed in the BPBPA-Ca crystal packing. The presence of these channels might potentiate the use of BPBPA-Ca as a possible DDS, by assessing the loading/releasing capacity of antineoplastic drugs such as letrozole in this framework.

TABLE 14
Summary of the crystallographic parameters of the
structure refinements for BPBPA-Ca and BPBPA-Zn

| Compound | BPBPA-Ca | | BPBPA-Zn | |
|---|---|---|---|---|
| Empirical | [Ca₃(C₁₄H₁₀O₁₄P₄)(6H₂O)]•7H₂O | | [Zn₂(C₇H₄O₇P₂)(2H₂O)]•2H₂O | |
| formula | | | | |
| FW (g/mol) | 880.55 | | 864.38 | |
| Space group | P1 | | P1 | |
| Temperature (K) | 100 | (1) | 139 | (4) |
| λ (Å) | 1.54184 | | 1.54184 | |
| a (Å) | 10.9829 | (2) | 5.4039 | (4) |
| b (Å) | 11.8825 | (2) | 9.6464 | (8) |
| c (Å) | 13.0827 | (2) | 12.2483 | (9) |
| α (°) | 87.510 | (1) | 88.190 | (7) |
| β (°) | 76.716 | (1) | 88.742 | (6) |
| γ (°) | 78.678 | (1) | 85.889 | (7) |
| V (Å³) | 1629.33 | (5) | 636.40 | (9) |

| | | |
|---|---|---|
| Z | 2 | 1 |
| ρ_{calc} (g/cm³) | 1.795 | 2.255 |
| R_{wp} | 0.0629 | 0.0642 |
| Rₚ | 0.1770 | 0.1949 |

Abbreviations: λ (X-ray source wavelength, Å), a/b/c (unit cell lengths, Å), α/β/γ (unit cell angle, °), V (unit cell volume, Å³), Z (number of formula units per unit cell), ρ_{calc} (unit cell calculated density, g/cm³), R_{wp} (weighted R-factor, %), and Rₚ (R-factor, %).

Structural description of BPBPA-Ca: The BPBPA-Ca presents an empirical formula of [Ca₃(C₁₄H₁₀O₁₄P₄)(6H₂O)]·7H₂O and belongs to the triclinic P1 space group. Close examination of the crystal packing of BPBPA-Ca reveals that the metal centers (Ca²⁺) are interconnected by BPs-bridge ligands that lead to a continuous 3D network parallel to the (010) plane. The Ca²⁺ ions display distorted bicapped trigonal prismatic (Ca1 and Ca₃) and capped trigonal prismatic (Ca2) geometries. The O-Ca1-O presented polar bond angles (0) ranging between 45.32-58.08° and a bond angle (a) between the capped ligands of 126.14°. While O-Ca₃-O displayed θ angles between 44.82-54.34° and a angle of 112.90°. The bond angles in the coordination spheres of Ca1 and Ca₃ are distorted by 0.18-13.08° (0) and 6.14-7.1° (α) compared with a regular bicapped trigonal prismatic geometry, where θ=45° and α=120°²⁶ The O—Ca2—O exhibited bond angles varying from 68.91-82.88°; these angles are distorted by 5.88-8.09° from a regular capped trigonal prismatic molecular geometry, where the predicted bond angle is about 77° C.²⁷ Furthermore, the Ca1—O, Ca2—O, and Ca3—O bond distances range between 2.311-2.767 Å, 2.313-2.559 Å, and 2.402-2.534 Å, correspondingly. The Ca—O bond distances noticed in the BPBPA-Ca are similar to those found in other BPs-based BPCCs obtained using commercial BPs such as etidronic acid (HEDP), ALEN, RISE, or ZOLE (average=2.4+0.1 Å) found in the Cambridge Structural Database (CSD).^{28,29,30,31} In addition, this crystal structure displayed channels (9×11 Å) formed by adjacent BPs-bridge ligands that allow the integration of water molecules into the crystalline phase of BPBPA-Ca.

Structural description of BPBPA-Zn: The BPBPA-Zn presents an empirical formula of [Zn₃(C₁₄H₁₀O₁₄P₄)(2H₂O)]·2H₂O and also crystallizes in the P 1 space group.

Assessment of the crystal packing of BPBPA-Zn reveals that the Zn²⁺ metal centers are interconnected through BPs-bridge ligands producing a 3D framework parallel to the (002) plane.

The Zn²⁺ metal centers show distorted octahedral geometry. This geometry type is usually found in Zn²⁺ ions with six coordination numbers. The O—Zn1—O and O—Zn2—O bond angles range between 74.18-108.59° and 84.10-95.90°, respectively. The bond angles in the coordination spheres of Zn1 and Zn2 metal centers are distorted by 5.9-18.59°.³² from a regular octahedral molecular geometry, where the predicted bond angle is 90°.³² The Zn1—O and Zn2—O bond distances range between 1.989-2.365 Å and 2.022-2.167 Å, respectively. The Zn1—O and Zn2—O bond distances found in the crystal packing of BPBPA-Zn are comparable to those observed in other BPs-based BPCCs synthesized using commercial BPs (HEDP, ALEN, RISE, or ZOLE) coordinated with a Zn²⁺ metal center (average=2.1±0.1 Å) from the CSD.^{33,34} Additionally, neighboring BPs-bridge ligands generate channels (10×13 Å) in the BPBPA-Zn framework that facilitates the incorporation of water molecules into this crystal lattice.

### Dissolution Curve of BPBPA-Based BPCCs

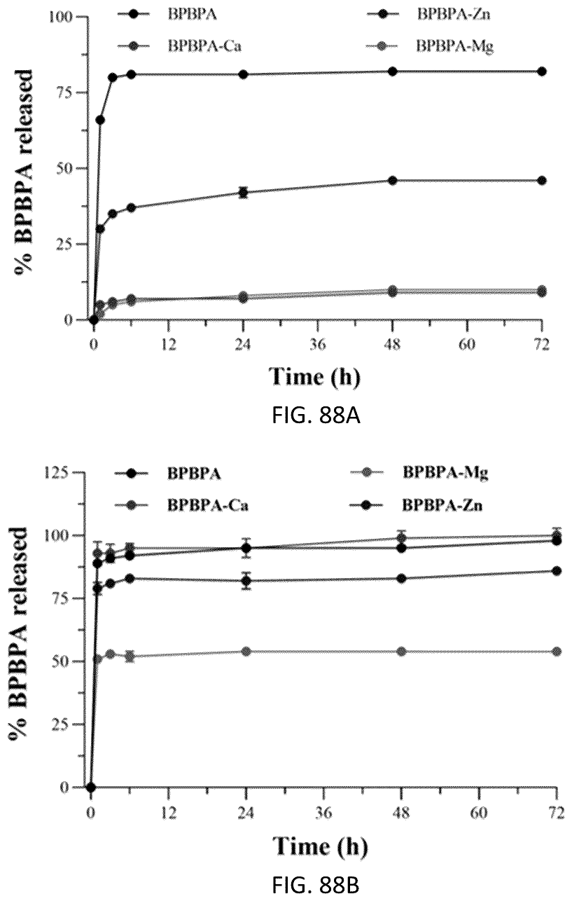

The dissolution curves of all BPBPA-based BPCCs were investigated in physiological conditions (PBS, pH=7.40 and FaSSGF, pH=1.60) to determine the release of BPBPA from the coordination complexes. The absorbance of the supernatant was measured to quantify the amount of BPBPA released over time in PBS (λₘₐₓ=275 nm) and FaSSGF (λₘₐₓ=266 nm) at 37° C. Results revealed that the BPBPA-based BPCCs release between 9-50% of BPBPA in neutral conditions. It was observed that BPBPA-Ca (9%) and BPBPA-Mg (10%) released a lower amount of BPBPA compared with BPBPA-Zn (46%) from its crystal phases (FIG. 88A). These results demonstrate that these BPBPA-based BPCCs do not degrade significantly in neutral conditions, maintaining their crystalline structures in PBS. Furthermore, it was found that these coordination complexes released about 50-100% of BPBPA in an acidic environment. The BPBPA-Ca (100%) and BPBPA-Zn (86%) released almost completely the ligand in FaSSGF contrasted with BPBPA-Mg (54%) (FIG. 88B). Specifically, BPBPA-Ca was wholly collapsed in acidic conditions, suggesting that this coordination complex might be able to degrade at the metastatic site (acid environment) of cancerous cells, releasing potential antineoplastic-loaded drugs.³⁵

Phase inversion temperature (PIT) and PIT-nano-emulsion synthesis of nano-Ca@BPBPA

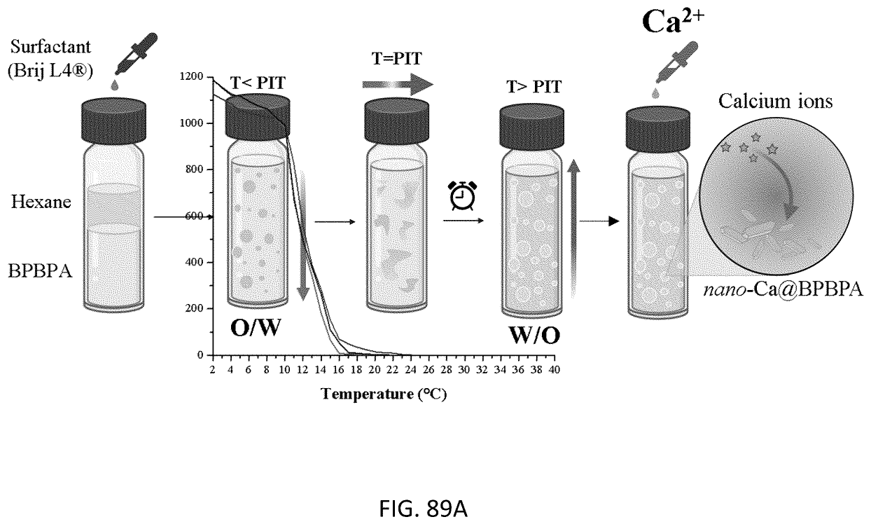

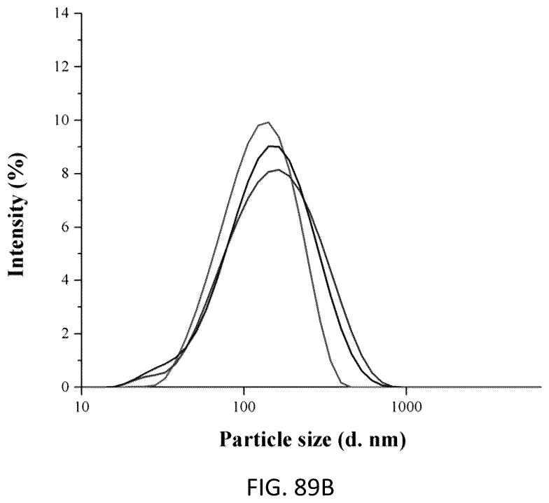

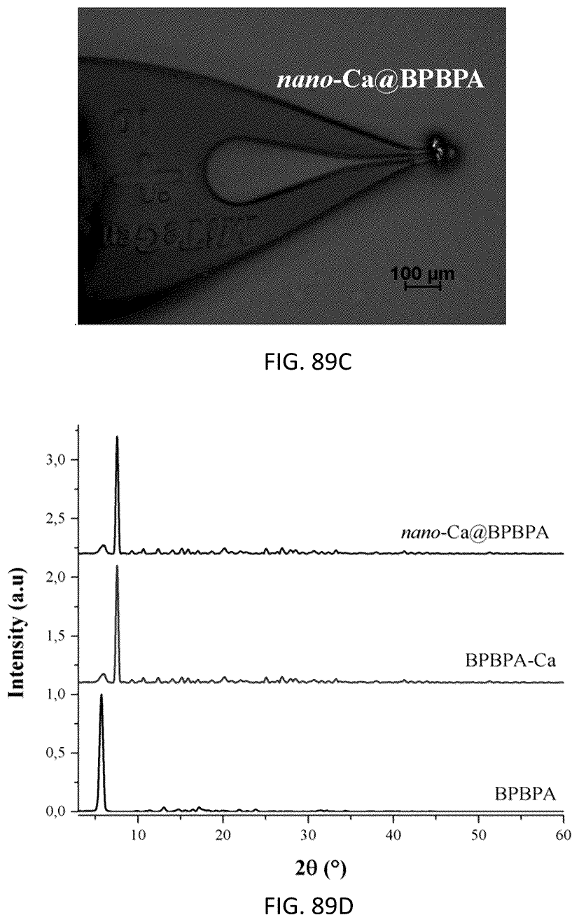

The particle size of BPBPA-Ca was decreased by the PIT-nano-emulsion method. This framework was selected for further analysis due to its high thermal stability, pH-dependant degradation, and the presence of channels (9×11 Å) to assess its capacity as a possible DDS. The PIT-nano-emulsion method was adapted to carry out the hydrothermal synthesis of BPBPA-Ca, acquiring crystals in the nanoscale range.^{17,18} Å water-in-oil (W/O) nano-emulsion is produced using this method, where BPBPA is entrapped in aqueous nanospheres. This method restricts the reaction space when the metal salt is added, allowing the Formation of nano-Ca@BPBPA (FIG. 89A). Results demonstrate that particle size distribution values and polydispersity indexes (PDI) range between 136-180 d. nm (nanoscale) and 0.493-0.538 (monodispersive), respectively (FIG. 89B). Additionally, PXRD diffractograms (agglomerate of nano-Ca@BPBPA, FIG. 89C) confirm that the nanomaterial synthesized by this method is isostructural to BPBPA-Ca (bulk) (FIG. 89D). These results demonstrate that the PIT-nano-emulsion method combined with the hydrothermal conditions allowed the particle size to decrease from the microscale (BPBPA-Ca, ˜100 m) to the nanoscale (nano-Ca@BPBPA, ˜160 d. nm).

### Aggregation Measurements of Nano-Ca@BPBPA

Aggregation measurements were conducted in 10% FBS:PBS to investigate the aggregation tendency of nano-Ca@BPBPA in physiological conditions. It is expected to assess the ability of nano-Ca@BPBPA to retain its particle size over time in the nanoscale range (<300 nm) in 10% FBS:PBS serum-like media. Results reveal that nano-Ca@BPBPA maintains a homogeneous particle size distribution in 10% FBS:PBS after O(150 d. nm), 24 (158 d. nm), and 48 (179 d. nm) h. Furthermore, the resulting PDI values after O(0.458), 24 (0.517), and 48 (0.463) h demonstrate the monodispersity of nano-Ca@BPBPA within the three-time points selected (Supporting Information). These results suggest low aggregation (large aggregates are not formed, and particle size is maintained) for nano-Ca@BPBPA in physiological environments.

### Binding Assays for Nano-Ca@BPBPA

The affinity of nano-Ca@BPBPA to the main constituent of the bone microenvironment was determined through the binding assay to HA.^{36,37} The binding assay of nano-Ca@BPBPA to HA was assessed under physiological conditions (PBS, pH=7.4, and 37° C.), exposing HA as a received reagent to BPBPA and nano-Ca@BPBPA solutions for 0-12 d. The binding affinity to this mineral was determined by quantifying the decrease in BPBPA and nano-Ca@BPBPA concentration of the supernatant by measuring the absorbance at the lambda max (λₘₐₓ=275 nm). Binding curves for BPBPA and nano-Ca@BPBPA are shown in FIG. 8A. It was found that BPBPA presented >70% (3 d) binding to HA, reaching >90% after 4 d under physiological conditions. Additionally, nano-Ca@BPBPA demonstrates a similar binding to HA than BPBPA after 5d, achieving >90% binding to HA. It is suggested that the uncoordinated BPs from the nano-Ca@BPBPA surface are the principal groups responsible for the affinity of these nanocrystals to HA.

TABLE 15
EDS elemental analysis of HA, HA-BPBPA, and nano-Ca@BPBPA
after the binding assay. The EDS analysis was collected
at a 3000x magnification for all samples.

| | | | HA-nano- |
|---|---|---|---|
| Element | HA^{a} | HA-BPBPA^{b} | Ca@BPBPA^{c} |
| Phosphorous | 19.70 | 19.05 | 19.01 |
| Carbon | 7.84 | 12.76 | 12.08 |
| Oxygen | 30.48 | 33.70 | 34.56 |
| Calcium | 41.09 | 33.88 | 34.27 |

^{a}HA [Ca₅(OH)(PO₄)₃],
^{b}BPBPA [C₁₄H₁₈O₁₄P₄],
^{c}nano-Ca@BPBPA [[Ca₃(C₁₄H₁₀O₁₄P₂)(6H₂O)]•7H₂O]

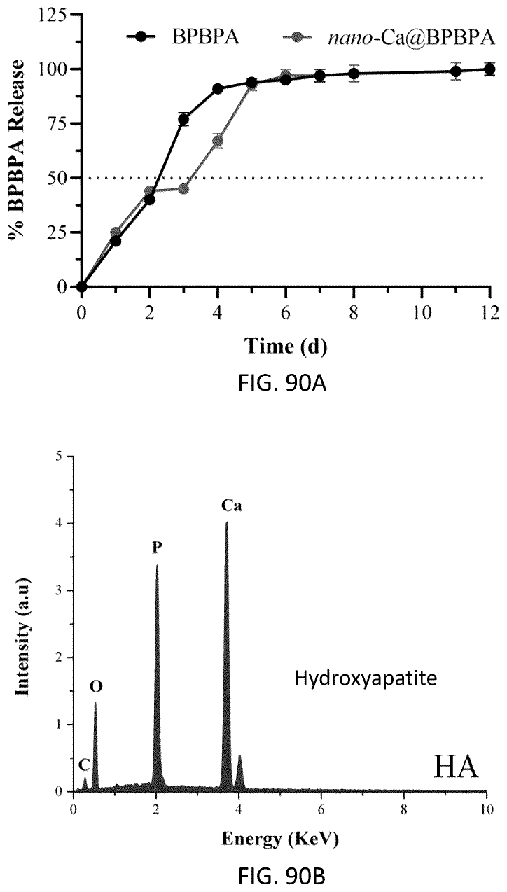

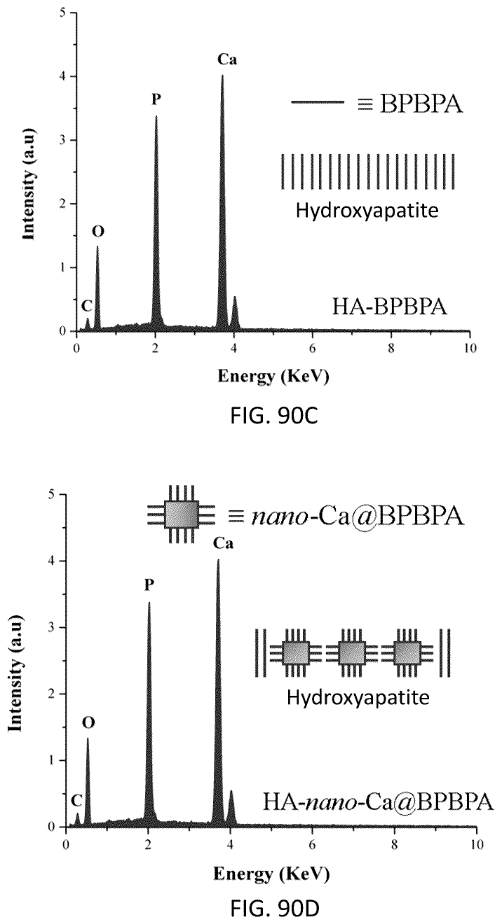

Moreover, solid-state characterization through EDS and PXRD to HA (control), HA-BPBPA (control), and HA-nano-Ca@BPBPA (experimental) was accomplished to confirm the binding to HA. The elemental composition of these materials was contrasted using the weight percentage (wt. %) obtained by EDS (Table 15). Results demonstrate that the relative concentration of calcium in HA-BPBPA (33.88 wt. %) and nano-Ca@BPBPA (34.27 wt. %) decreases in comparison to that observed in HA (41.09 wt. %, FIG. 90B). This result suggests that BPBPA (0 calcium per formula unit, FIG. 90C) and nano-Ca@BPBPA (3 calciums per formula unit, FIG. 90D) might form layers on the HA surface, shielding the detection of calcium ions. The conductive tape used for the SEM-EDS analysis led to a small amount of carbon (7.84 wt. %) detected in the EDS spectra of HA. The carbon signal was found also in HA-BPBPA (12.76 wt. %) and HA-nano-Ca@BPBPA (12.08 wt. %). The signal for the latter two decreases as a result of the molecular structure of BPBPA and nano-Ca@BPBPA (14 carbons atoms per formula unit each). In addition, a similar relative phosphorous signal was found for HA-BPBPA (19.70 wt. %) and HA-nano-Ca@BPBPA (19.05 wt. %) when contrasted with HA (19.01 wt. %). This result is in agreement with the relative composition of this element in these materials. An increase in the relative concentration of oxygen in HA-BPBPA (33.70 wt. %) and HA-nano-Ca@BPBPA (34.76 wt. %) compared to HA (30.48 wt. %). This result supports the presence of BPBPA or nano-Ca@BPBPA (14 and 20 oxygens per formula unit, respectively) on the HA surface.

Loading and Release of Letrozole into the BPBPA-Ca and Nano-Ca@BPBPA

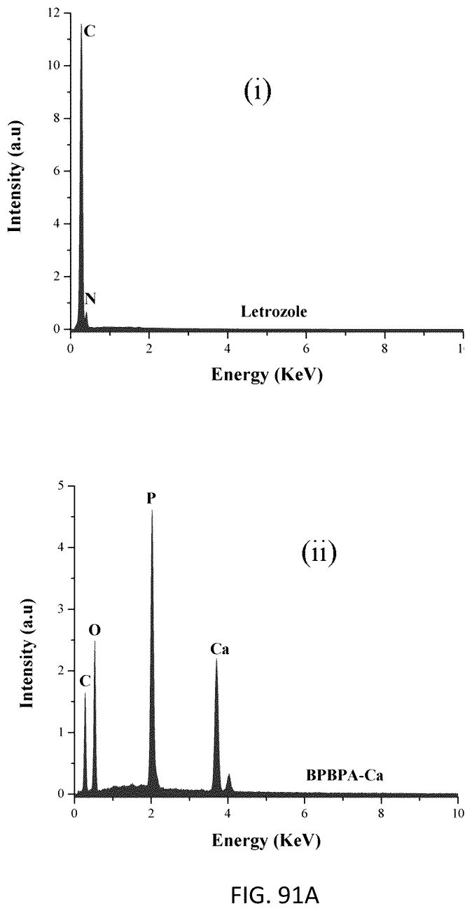

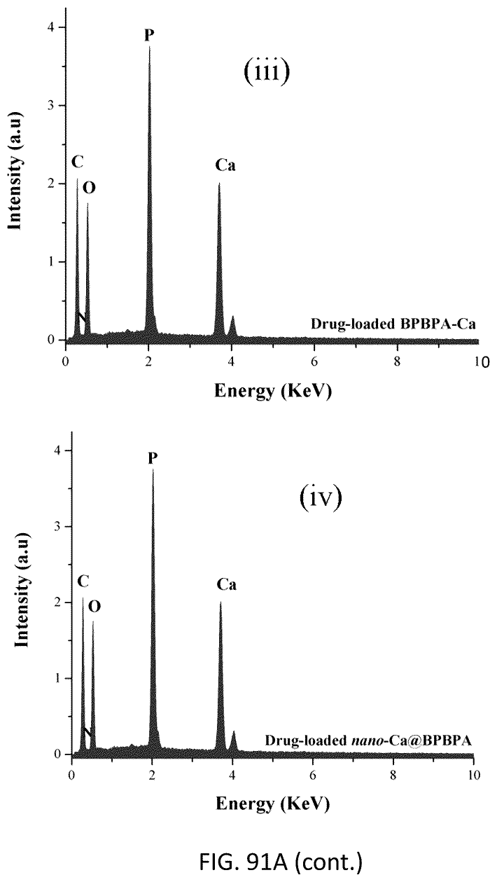

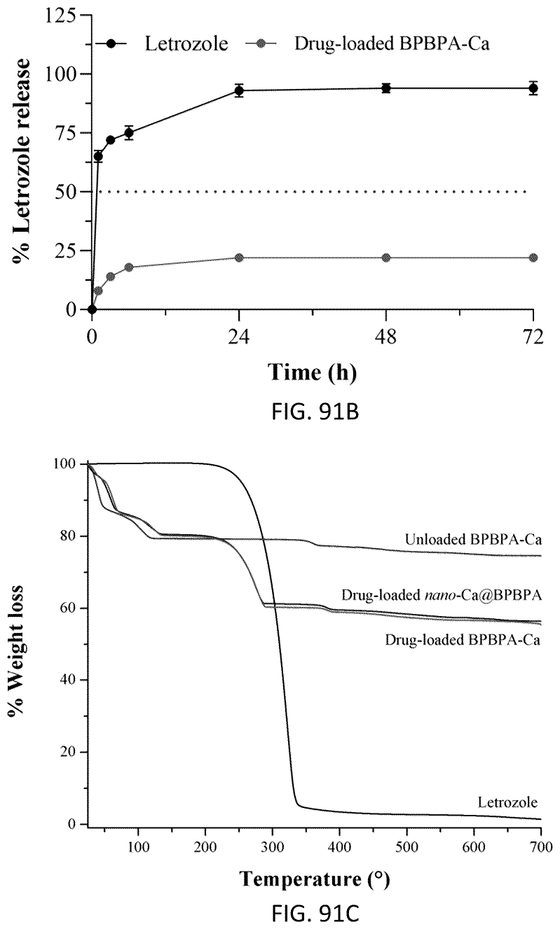

The drug loading capacity of BPBPA-Ca (bulk crystals) and nano-Ca@BPBPA (nanocrystals) was assessed by encapsulating letrozole (LET) into the channels of these materials since LET is an antineoplastic drug (type II aromatase inhibitor) usually prescribed for the treatment of breast cancer. The drug-loading of LET into the BPBPA-Ca framework was performed in ethanol leading to drug-loaded BPBPA-Ca (Supporting Information). In the case of nano-Ca@BPBPA, the PIT-nano-emulsion method was employed to achieve the drug-loaded nano-Ca@BPBPA (Supporting Information). Solid-state characterization of BPBPA-Ca (control), LET (control), drug-loaded BPBPA-Ca (experimental), and drug-loaded nano-Ca@BPBPA (experimental) through EDS (Table 16, FIG. 91), TGA (FIG. 91), and PXRD (Supporting Information) was performed to confirm the successful loading of LET into these materials.

TABLE 16
EDS elemental analysis of LET (control), BPBPA-Ca (control),
drug-loaded BPBPA-Ca (experimental), and drug-loaded nano-
Ca@BPBPA after drug loading experiment. The EDS analysis
was collected at a 3000x magnification for all the samples.

| | | | Drug-loaded | Drug-loaded |
|---|---|---|---|---|
| Element | LET^{a} | BPBPA-Ca^{b} | BPBPA-Ca | nano-Ca@BPBPA^{c} |
| Carbon | 87.20 | 38.49 | 47.38 | 45.93 |
| Nitrogen | 12.80 | — | 0.61 | 0.42 |
| Oxygen | — | 25.46 | 25.30 | 25.53 |
| Calcium | — | 18.65 | 13.02 | 13.78 |
| Phosphorous | — | 17.40 | 13.69 | 14.34 |

^{a}LET [C₁₇H₁₁N₅],
^{b}BPBPA- Ca[C₁₄H₁₈O₁₄P₄] and
^{c}nano-Ca@BPBPA [[Ca₃(C₁₄H₁₀O₁₄P₂)(6H₂O)]•7H₂O]

The EDS elemental analysis of the unloaded and drug-loaded BPBPA-Ca and nano-Ca@BPBPA was assessed by contrasting the weight percentage (wt. %) of all elements detected by EDS. The EDS elemental analysis of LET was used as control (graph (i) in FIG. 91A). Results demonstrate that the BPBPA-Ca (graph (ii) of FIG. 91A) presented a relative concentration of carbon of about 38.49 wt. %. An increase in the relative concentration of carbon was observed for the drug-loaded BPBPA-Ca (47.38 wt. %, graph (iii) of FIG. 91A) and nano-Ca@BPBPA (45.93 wt. %, graph (iv) of FIG. 91A) contrasted with BPBPA-Ca. This result might be attributed due to the presence of carbon in the molecular structure of LET (17 carbons per formula unit). Moreover, a small amount of nitrogen was detected in the drug-loaded BPBPA-Ca (0.61 wt. %) and nano-Ca@BPBPA (0.42 wt. %). The relative concentration of nitrogen in these drug-loaded materials decreases in contrast with LET (12. 80 wt. %), indicating that the encapsulation of this drug into the BPCCs might have shielded the detection of this characteristic element in LET when it was loaded. A similar relative concentration of oxygen, calcium, and phosphorus was observed for the drug-loaded BPBPA-Ca (25.30, 13.02, and 13.69 wt. %, respectively) and nano-Ca@BPBPA (25.53, 13.78, and 14.38 wt. %, respectively) compared with BPBPA-Ca (25.46, 18.65, and 17.40 wt. %, correspondingly). This result is because of the deficiency of these elements in the molecular structure of LET (0 atoms per formula unit each).

Furthermore, the release of LET from the drug-loaded BPBPA-Ca was investigated in FaSSGF (pH=1.60) at 37° C. The LET released from BPBPA-Ca was quantified by measuring the increase in the LET concentration over time of the supernatant at the lambda max (λₘₐₓ=238 nm). It was noticed that the drug-loaded BPBPA-Ca reaches a maximum release of LET (22%) at 24 h (FIG. 91B). This result is in agreement with the amount (%) of LET encapsulated into the channels of BPBPA-Ca and nano-Ca@BPBPA determined by TGA (22-24%, FIG. 91C). These findings confirm that BPBPA-Ca can be degraded in acidic conditions and release its cargo (LET) in a controlled and pH-dependent manner.

### Cell-Based Assays for Nano-Ca@BPBPA

The cytotoxicity of BPBPA (control), LET (control), nano-Ca@BPBPA (control), and drug-loaded nano-Ca@BPBPA (experimental) was investigated employing the human breast cancer, MCF-7 and MDA-MB-231, and the human osteoblast, hFOB 1.19, cell lines. The human MCF-7 cell line represents an ER-positive breast cancer model with estrogen, progesterone, and glucocorticoid receptors.¹ While, the human MDA-MB-231 cells correspond to a model of ER-negative breast cancer. Both selected cancer cell lines can be implicated in the development and progress of bone metastases in patients.^{40,41} The human fetal hFOB 1.19 cells represent a homogeneous osteoblast-like (non-cancerous) model commonly employed to assess osteoblast differentiation.⁴² The cytotoxicity of these materials was evaluated by determining the IC₅₀ and % RCL. Results show a decrease in the cell viability of MCF-7 cells treated with LET, with an IC₅₀ of about 20±3 μM after 72 h of treatment (Supporting Information). Lower cytotoxicity effects were observed for MDA-MB-231 and hFOB 1.19 cells treated with BPBPA (IC₅₀ >200 μM at 24, 48, 72 h), determining an IC₅₀=229+5 μM for MDA-MB-231 treated with BPBPA at 72 h. Similar results were found for MDA-MB-231 and hFOB 1.19 cell lines treated with LET (IC₅₀ >200 μM) at the same time points (Supporting Information).

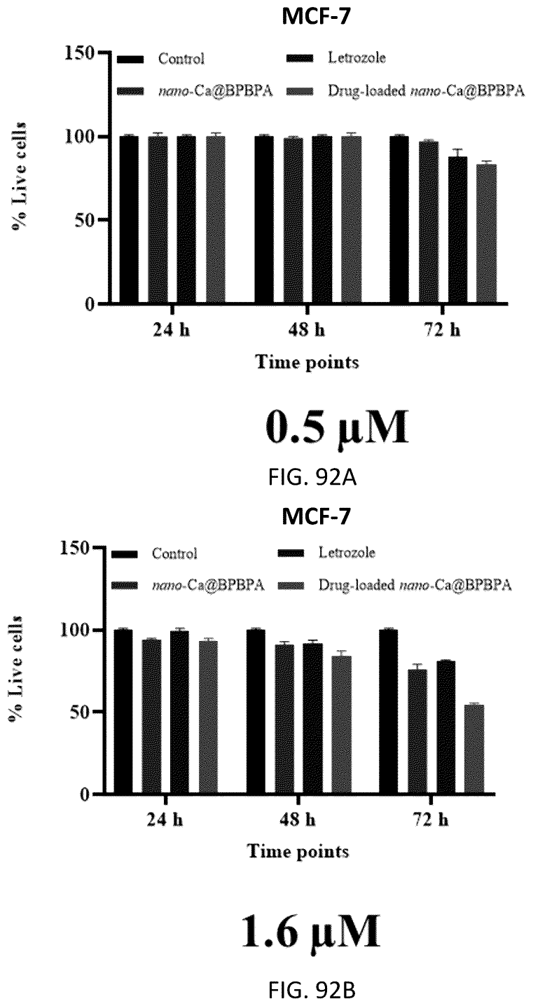

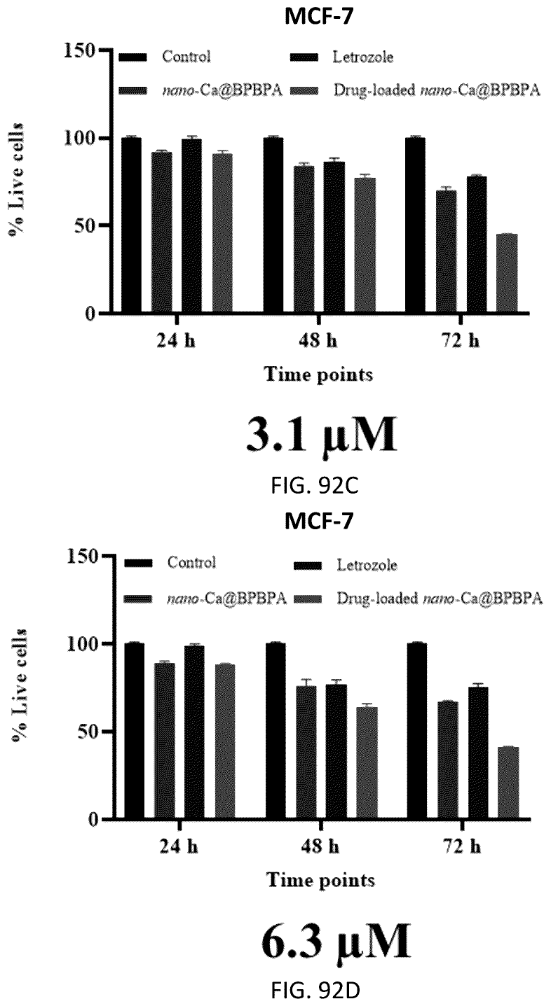

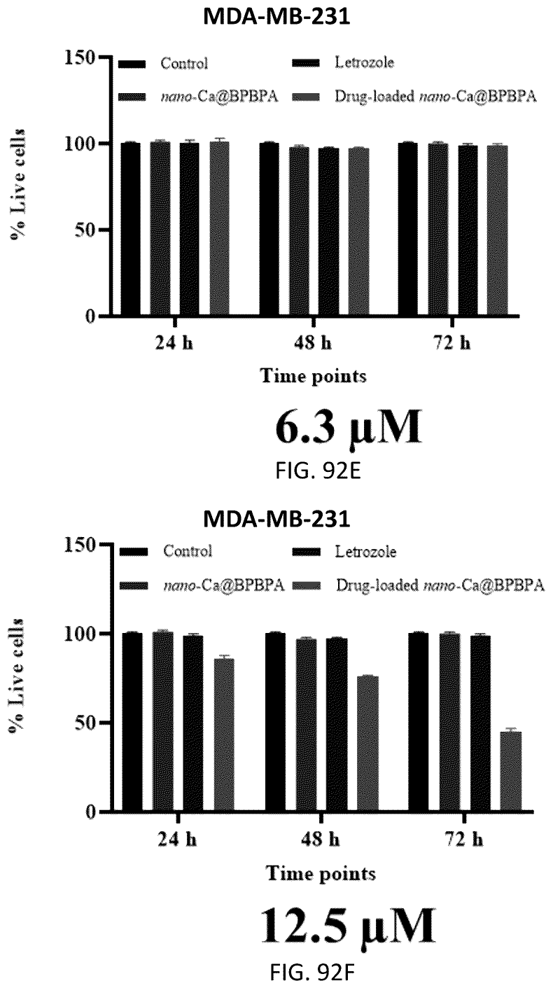

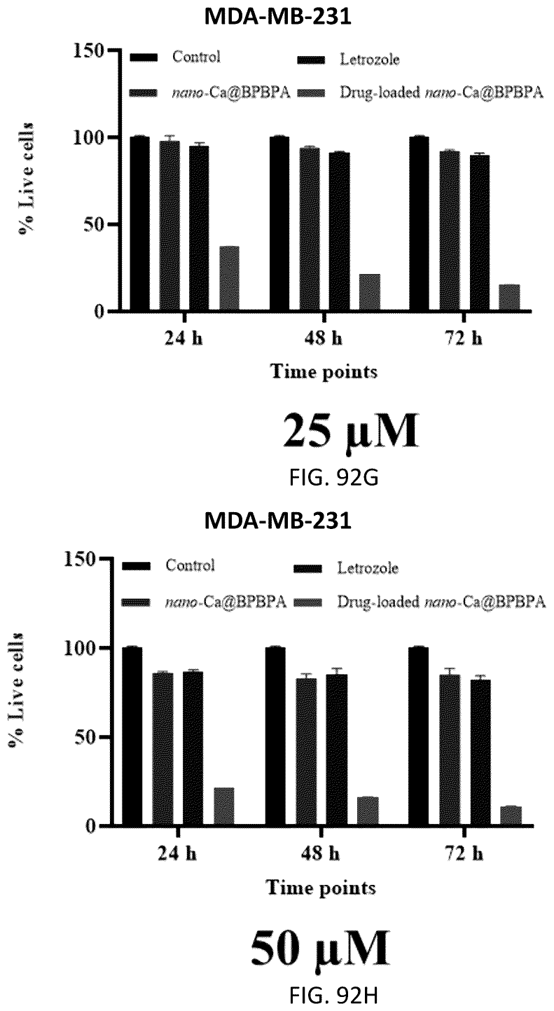

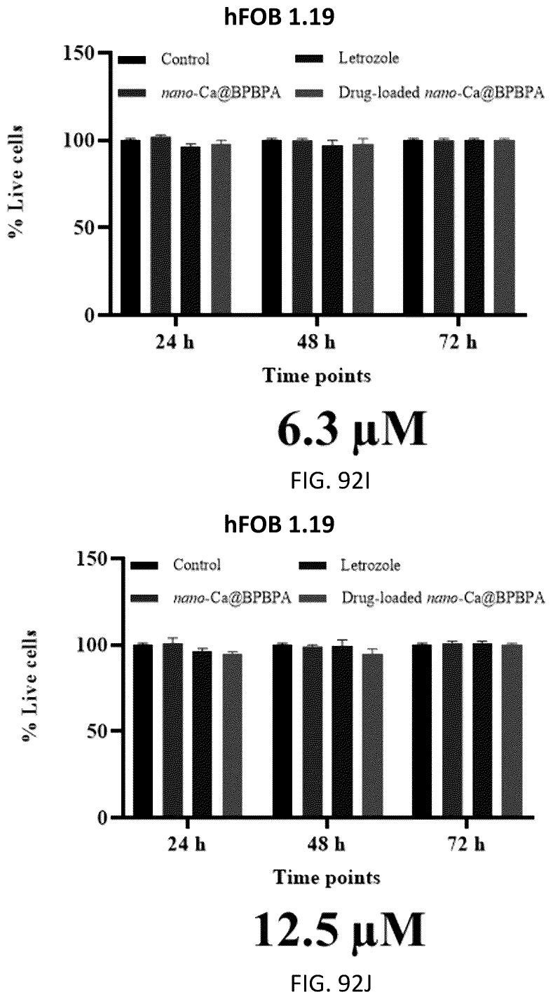

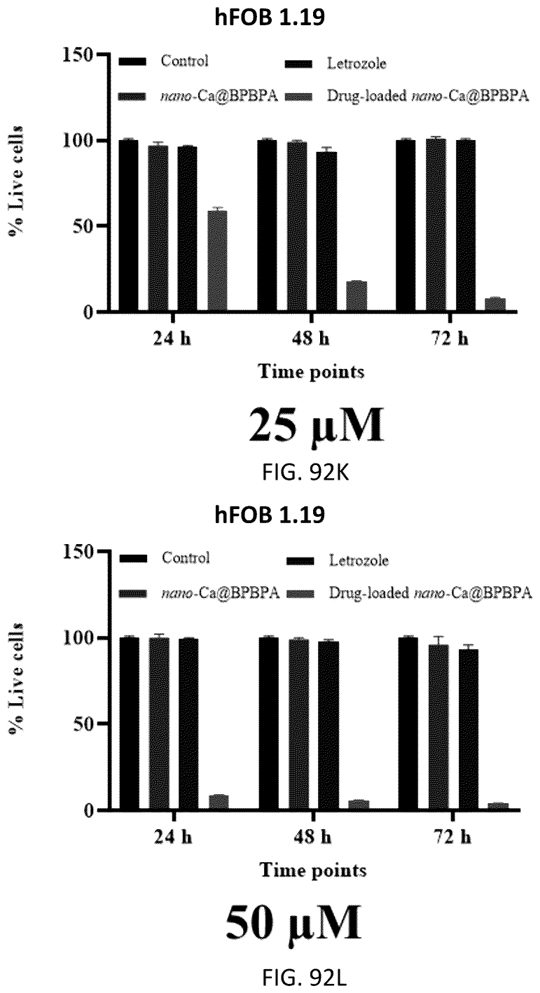

The MCF-7 cells were treated with the unloaded and drug-loaded nano-Ca@BPBPA in the concentration range of 0.5-6.3 μM (FIGS. 92A-92D). At 0.5 μM, the % RCL results demonstrate that the nano-Ca@BPBPA did not cause a significant decrease in cell viability for MCF-7 cells after 24 (% RCL=100±1%), 48 (% RCL=99±1%), and 72 h (% RCL=97±1%) of treatment. A similar result was observed for LET and the drug-loaded nano-Ca@BPBPA after 24 and 48 h, both presenting % RCL values near 100%. A slight decrease in cell viability was observed for MCF-7 cells treated with LET (% RCL=88±5%) and the drug-loaded nano-Ca@BPBPA (% RCL=83±3%) after 72 h (FIG. 92A). Results at 1.6 μM, demonstrate that LET, nano-Ca@BPBPA, and the drug-loaded nano-Ca@BPBPA did not display significant cytotoxicity against the MCF-7 cells after 24 h (% RCL >93%) and 48 h (% RCL >84%) of being treated. A higher cytotoxicity effect was observed for the drug-loaded nano-Ca@BPBPA (% RCL=54±3 %) contrasted with nano-Ca@BPBPA (% RCL=76±4%) and LET (% RCL=81%) after 72 h (FIG. 92B). Furthermore, it was noticed that the cell viability was maintained above 91% for the MCF-7 cells treated at a concentration of 3.1 μM with LET (% RCL=99±2%), nano-Ca@BPBPA (% RCL=92±1%), and the drug-loaded nano-Ca@BPBPA (% RCL=91±2%) after 24 h. A slight decrease in cell viability was detected after 48 h for LET (% RCL=86±3%), nano-Ca@BPBPA (% RCL=84±2%), and the drug-loaded nano-Ca@BPBPA (% RCL=77+3%). At 72 h, was observed that the drug-loaded nano-Ca@BPBPA (% RCL=45±2%) presented higher decrease in cell viability than LET (% RCL=78±1%) and nano-Ca@BPBPA (% RCL=70±3%, FIG. 92C). Similar results were found at a concentration of 6.3 μM, the cell viability was remained above 88% after 24 h for LET (% RCL=99±1%), nano-Ca@BPBPA (% RCL=89±1%), and the drug-loaded nano-Ca@BPBPA (% RCL=88±1%). Results demonstrate higher decrease in cell viability after 72 h for the drug-loaded nano-Ca@BPBPA (% RCL=41+1%) compared with LET (% RCL=75±3%) and nano-Ca@BPBPA (% RCL=67±1%, FIG. 92D). These results demonstrate higher cytotoxicity effects by the drug-loaded nano-Ca@BPBPA against MCF-7 cancerous cells than LET (control) at low concentrations of 0.5 to 6.3 μM of LET.

Additionally, MDA-MB-231 cells were treated with the unloaded and drug-loaded nano-Ca@BPBPA at a higher concentration range of 6.3-50 μM for 24, 48, and 72 h. The % RCL results demonstrate that the nano-Ca@BPBPA and LET did not lead to a significant decrease in cell viability in MDA-MB-231 cells (FIGS. 92E-92H) after treatment (% RCL >92%) in the three time points. At a concentration of 6.3 μM, the drug-loaded nano-Ca@BPBPA presented similar cytotoxicity to LET, showing a % RCL >97% (FIG. 92E). At 12.5 μM, the drug-loaded nano-Ca@BPBPA presents a decrease in cell viability after 24 (% RCL=86±1%), 48 (% RCL=76+1%), and 72 h (% RCL=45±4%) of treatment contrasted with LET (FIG. 92F). Higher cytotoxicity effects were found for the drug-loaded nano-Ca@BPBPA at a concentration of 25 μM after 24 (% RCL=37 1%), 48 (% RCL=21±1%), and 72 h (% RCL=8 1%, FIG. 92G). At 50 μM, a slight decrease in cell viability was observed for LET and nano-Ca@BPBPA after 24 (% RCL ˜86%), 48 (% RCL ˜83%), and 72 h (% RCL ˜82%) of treatment. A higher cytotoxicity effect was found for the drug-loaded nano-Ca@BPBPA after 24 (% RCL=21±1 %), 48 (% RCL=16±2%), and 72 h (% RCL=11±1%, FIG. 9211). These results demonstrate that the drug-loaded nano-Ca@BPBPA presented higher cytotoxicity to the selected cancerous model (MDA-MB-231) than LET (control) and the unloaded nano-Ca@BPBPA (control) at concentrations range of 12.5-50 μM.

The osteoblast hFOB 1.19 cells were treated with the same conditions as the MDA-MB-231 cells. It was not expected to have significant cytotoxicity against this cell line, indicating that these materials will not cause cell damage to the normal tissue. Results demonstrate that the nano-Ca@BPBPA and LET did not cause a considerable decrease in cell viability (% RCL >93%) at a concentration range of 6.3-25 μM after all time points. Furthermore, it was found that at concentrations of 6.3 and 12.5 μM the drug-loaded nano-Ca@BPBPA did not generate a decrease in cell viability (% RCL >93%) in this normal osteoblast cell line (FIGS. 92I-92J). However, at a concentration of 25 and 50 μM, the drug-loaded nano-Ca@BPBPA causes a significant decrease in cell viability after 24 (% RCL <59%), 48 (% RCL <18%), and 72 h (% RCL <8%) of treatment (FIGS. 92K-92L). These results indicate the possibility of designing a drug-loaded nano-Ca@BPCC nanomaterial in a concentration range of 1.6-12.5 μM that might lead to a decrease in cell viability in the MCF-7 and MDA-MB-231 without affecting the normal osteoblast hFOB 1.19 cells at the metastatic environment.

### Conclusions

Three crystalline phases, namely, BPBPA-Ca, BPBPA-Zn, and BPBPA-Mg, were obtained from the hydrothermal synthesis of BPBPA with bioactive metals (Ca²⁺, Zn²⁺, and Mg²⁺ j For BPBPA-Ca were observed channels (9×13 Å) that enable the use of this framework as a possible DDS. The PIT-nano-emulsion method effectively reduced the particle size of BPBPA-Ca, leading to nano-Ca@BPBPA (˜160 d. nm). Moreover, a low aggregation tendency was found for nano-Ca@BPBPA after 0, 24, and 48 h in 10% FBS:PBS; this result provided insights into the capacity of this nanomaterial to maintain its particle size distribution in biological serum-like media. The binding assay showed a higher affinity of this nanomaterial (25%) to hydroxyapatite (HA) compared with zoledronic acid alone (15%), a commercial BP, after 24 hr. Additionally, LET, an antineoplastic drug, was loaded and released (˜22%) from the BPBPA-Ca and nano-Ca@BPBPA, demonstrating the capacity of this material to encapsulate and release its cargo in a pH-dependent manner. Cell-based assays demonstrated that the unloaded nano-Ca@BPBPA cause higher decrease in cell viability for the MCF-7 (% RCL=63±1%) cells when compared with the MDA-MB-231 (% RCL=100±1%) and the hFOB 1.19 (% RCL=100±1%) cell lines at a concentration of 12.5 μM after 72 h. Furthermore, the drug-loaded nano-Ca@BPBPA displays higher cytotoxicity effects against MCF-7 (% RCL=21±1%, 12.5 μM) contrasted with MDA-MB-231 (% RCL=45±4%, 12.5 μM) and hFOB 1.19 (% RCL=100±1%, 12.5 μM) at the same time point. The results obtained here provide insights into the design of nano-Ca@BPCCs with adequate characteristics (pH-dependent degradation, affinity to HA, drug-loading capacity, and cytotoxicity) to be employed as DDS to treat breast cancer-induced OM.

### BPBPA Supporting Information

### 1. Materials

The 1,1′-biphenyl-4,4′-dicarbonyl dichloride (C₁₄O₁₄P₄H₁₈, 95% pure) was purchased from Sigma Aldrich (Milwaukee, WI). Tris(trimethylsilyl) phosphite ((CH₃)₃SiO]3P, 92% pure) was purchased from Fisher Scientific (Hampton, NH). Calcium nitrate tetrahydrate (Ca(NO₃)₂·4H₂O, 99% pure), zinc nitrate hexahydrate (Zn(NO₃)₂·6H₂O, 98% pure), and magnesium nitrate hexahydrate (Mg(NO₃)₂·6H₂O, 99% pure) were obtained from Sigma-Aldrich (St. Louis, MO). Sodium chloride (NaCl, ACS reagent>99.0% pure), hydrochloric acid (HCl, 37% wt.), and sodium hydroxide (NaOH, >98% pure) were purchased from Sigma-Aldrich (St. Louis, MO). Hydroxyapatite (Ca₅(OH)(PO₄)₃, synthetic powder) and phosphate-buffered saline (PBS, tablets) were purchased from Sigma-Aldrich (Milwaukee, WI). Nano pure water was acquired from an ARIES Filter Works Gemini High purity water system (18.23 M-Ohm/cm). Dulbecco's Modified Eagle's Medium (DMEM) was obtained from Sigma-Aldrich (Milwaukee, WI). Penicillin-streptomycin (Pen-Strep) and fetal bovine serum (FBS) were purchased from Sigma-Aldrich (St. Louis, MO). The 1:1 mixture of Ham's F-12 Medium/Dulbecco's Modified Eagle's Medium (1:1 DMEM: F-12) was purchased from Bioanalytical Instruments (San Juan, PR). Human breast cancer MDA-MB-231 and normal osteoblast-like hFOB 1.19 cell lines were acquired from ATCC (Manassas, VA).

### 2. Synthesis and Characterization of BPBPA

2.1. Synthesis of 1,1′-biphenyl-4,4′-bisphosphonic acid (BPBPA). The BPBPA was synthesized following the Lecouvey reaction, previously reported to obtain bisphosphonates.^{1,2,3,4} For this, about 1.0 g of 1,1′-biphenyl-4,4′-dicarbonyl dichloride was added to 7 mL of tris(trimethylsilyl) phosphite at O° C. The reaction was left in constant stirring for 1 h to reach room temperature and then left undisturbed for 3 d at 50° C. After this period, the excess of tris(trimethylsilyl) phosphite was removed by rotoevaporation. Subsequently, 25 mL of methanol were added to the ester product, the reaction was left under continuous stirring for 1 d at room temperature. Finally, the excess of methanol was removed by rotoevaporation, and the final product (BPBPA) was washed with methanol and diethyl ether, and then dried under vacuum. The BPBPA obtained through this procedure was characterized by nuclear magnetic resonance (NMR), Raman spectroscopy, powder X-ray diffraction (PXRD), thermogravimetric analysis (TGA), and differential scanning calorimetric (DSC). The synthesis of BPBPA has not been previously reported in the literature.

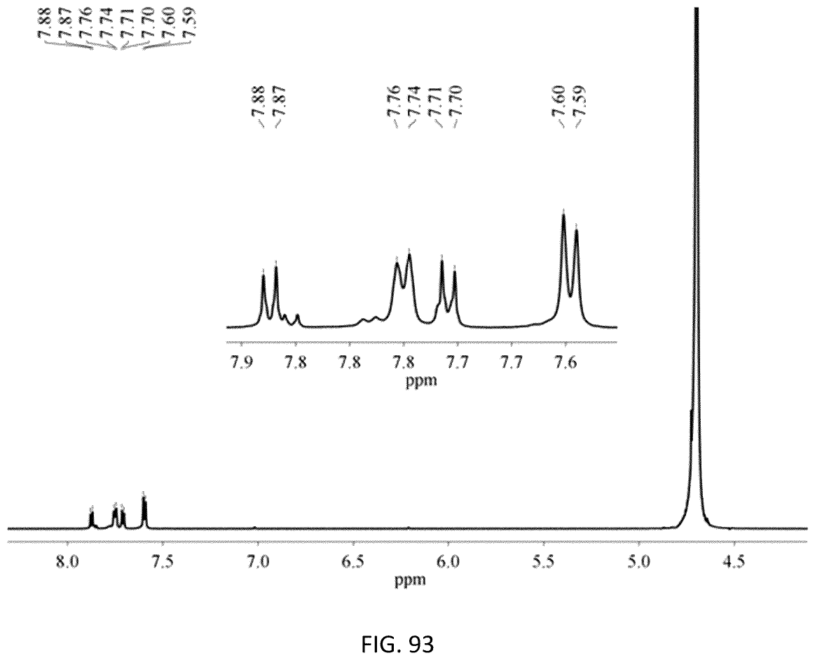

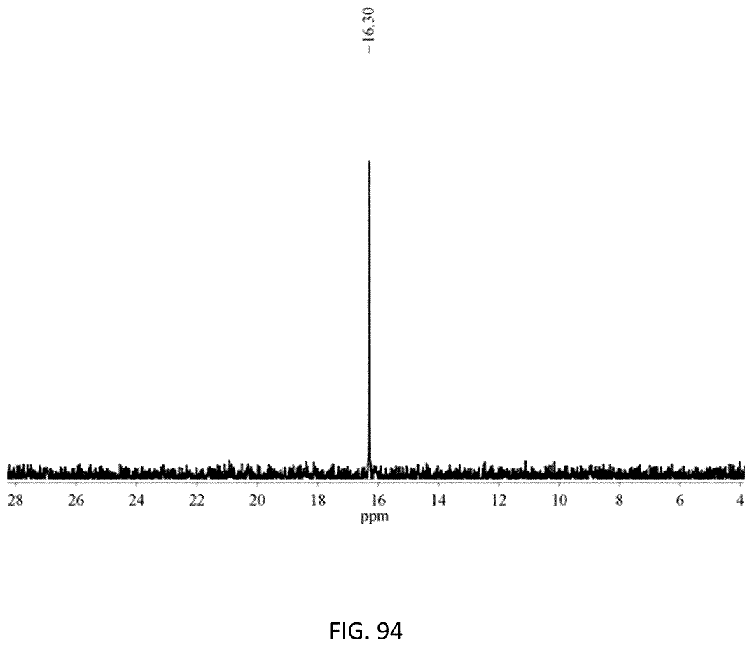

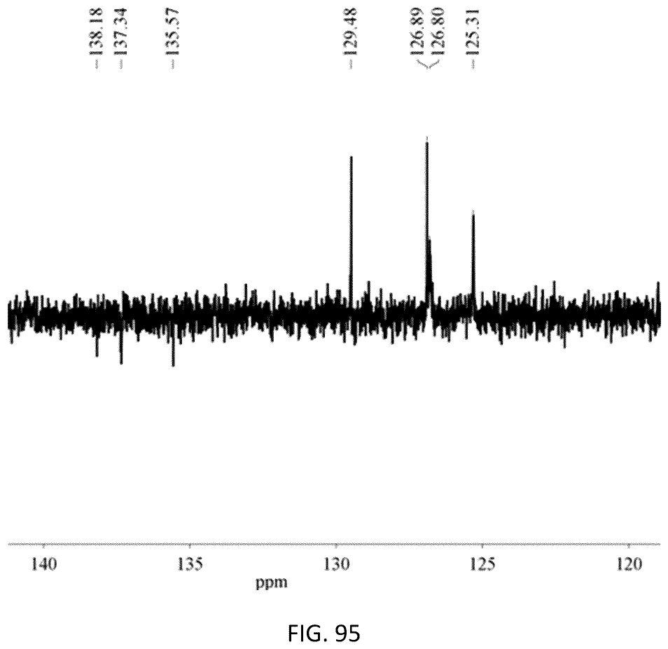

2.2. Nuclear magnetic resonance (NMR) for BPBPA. ¹H NMR, ¹³C-APT NMR, and ³¹P NMR were recorded employing a Bruker Ascend Aeon 700 MHz NMR. The instrument is equipped with a multilinear, variable temperature, and cross-polarization magnetic angle spinning. The BPBPA was dissolved in deuterium oxide (D₂O), and the experiment was performed at room temperature. FIG. 93-95 show the ¹H NMR, ³¹P NMR, and ¹³C-APT NMR for the BPBPA. Chemical shifts (6) were recorded in ppm. The main signals are described as follows: ¹H NMR (700 MHz, D₂O): δ(ppm)=7.59, 7.60 (dd, 2H, aromatic H), 7.70, 7.71 (dd, 2H, aromatic H), 7.74, 7.76 (dd, 2H, aromatic H), and 7.87, 7.88 (dd, 2H, aromatic H). ³¹P NMR (700 MHz, D₂O): δ(ppm) =16.30 (s, 4P). ¹³C-APT NMR (700 MHz, D₂O): δ(ppm)=125.31 (s, 2CH, aromatic C), 126.80 (s, 2CH, aromatic C), 126.89 (s, 2CH, aromatic C), 129.48 (s, 2CH, aromatic C), 135.57 (s, 2C, quaternary C, bisphosphonate group), 137.34 (s, 2C, quaternary, aromatic C), and 138.18 (s, 2C, quaternary, aromatic C). The signals observed in all NMR spectra for BPBPA have not been previously reported in the literature for this compound.

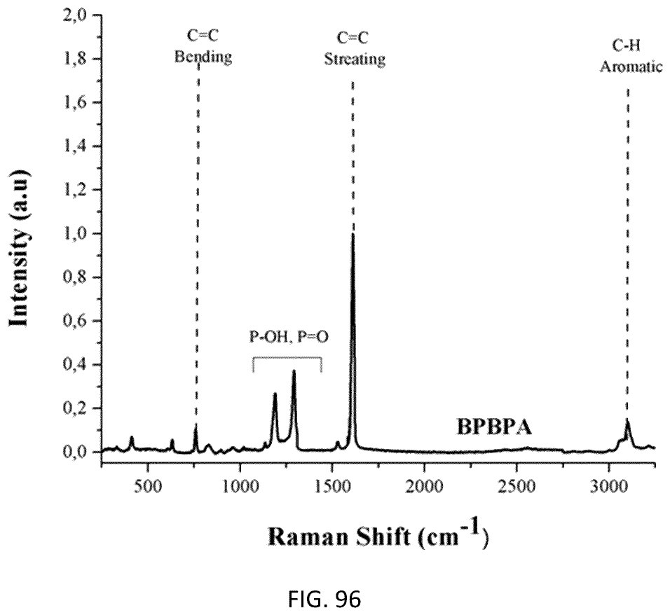

2.3. Raman Vibrational Spectroscopy for BPBPA. A Thermo Scientific DXR Raman microscope was employed to collect the Raman spectra for BPBPA. The instrument was equipped with a 532 nm laser, the experiment was performed using a 50 μm slit, 400 lines/mm grating, and 32 scans with an exposure time of 5 s. The Raman data was collected between 3,500 to 250 cm⁻¹. The OMNIC for Dispersive Raman Software version 9.2.0 was utilized to perform the experiment and analyze the data collected. The Raman spectra for BPBPA (FIG. 96) presents the principal Raman shifts corresponding to the vibrational modes of this ligand. Raman shifts (v max, cm⁻¹): >3,200 (v OH/H₂O), 3,108 (CH aromatic), 1,610 (C═C, stretching), 1,291 (v P═O/δ^{π}POH, stretching), 1,184 (v as P—O(H), stretching), 1,164 (6 PO-H, bending), and 754 (C═C, bending). The Raman spectra of BPBPA has not been reported in the literature.

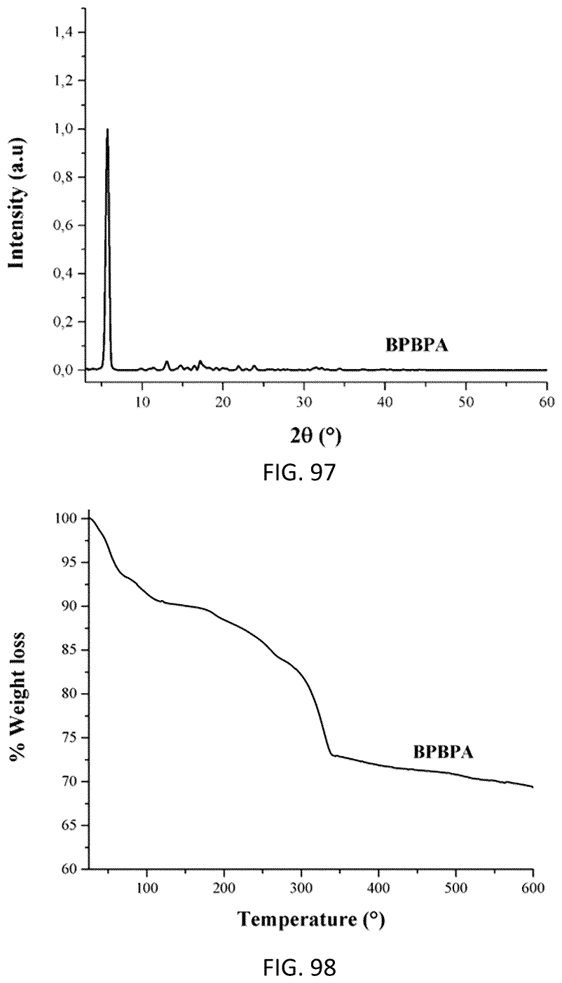

2.4. Powder X-ray diffraction (PXRD) for BPBPA. A Rigaku XtaLAB SuperNova X-ray diffractometer equipped with micro-focus Cu-Kα radiation (λ=1.5417 Å) source and a HyPix3000 X-ray detector was utilized to record the PXRD diffractogram for BPBPA. The experiment was performed in transmission mode at 50 kV and 1 mA. BPBPA crystals were gently grinded and powder BPBPA was mounted on MiTeGen micro-loops using paratone oil. The PXRD diffractogram for BPBPA was collected at 300 K, 20 range (6-60°), and in fast phi mode (90 s) employing an Oxford Cryosystem Cryostream 800 cooler. The CrysAlis^{PRO} software version 1.171.3920a was utilized to analyze the data displayed in FIG. 97. The PXRD diffractogram of BPBPA has not been previously reported in the literature.

2.5. Thermogravimetric analysis (TGA) for BPBPA. A TGA Q500 (TA Instruments Inc.) was employed to record the TGA thermograph of BPBPA. The experiment was carried out from 25 to 700° C., under N₂ (60 mL/min) at 5° C./min. For this, about 2-5 mg of a powered BPBPA was used for the experiment. The TA Universal Analysis software v 4.5 Å was utilized to collect and analyze the data. FIG. 98 illustrates the TGA thermograph of BPBPA. The TGA thermograph for BPBPA has not been previously reported in the literature.

2.6. Differential Scanning Calorimeter (DSC) for BPBPA. A DSC Q2000 (TA Instruments Inc.) was utilized to determine the melting point of BPBPA. An indium standard (Tm =156.6° C. and ΔH_{f}=28.54 J/g) was utilized to calibrate the instrument. Additionally, the instrument was equipped with a 50-position autosampler and a refrigerated cooling system (RCS40). The DSC thermograph for BPBPA was collected in a temperature range between 25-400° C. under an N₂ atmosphere (50 mL/min) at 5° C./min. For this, about 1-2 mg of powered BPBPA sample was employed to carry out the experiment, hermetically sealed aluminum pans were utilized to prepare the sample. The TA Universal Analysis software v 4.5 Å was utilized to collect and analyze the data. The melting point for BPBPA was identified as 219±2° C. (468 K).

### 3. Synthesis and Characterization of BPBPA-based BPCCs

### 3.1. Synthesis of BPBPA-based BPCCs

BPBPA-Ca: Solution of BPBPA (0.01 mmol) and Ca(NO₃)₂·4H₂O (0.01 mmol) were separately prepared. About 10.0 mg of BPBPA was dissolved in 10.0 mL of nano pure water. Subsequently, the metal salt solution was prepared by adding 4.20 mg of Ca(NO₃)₂·4H₂O in 10.0 mL of nano pure water. Then, in 20.0 mL vials were transferred 5.0 mL of the previously prepared solutions (BPBPA and Ca²⁺ salt solutions). This mixture was left undisturbed in a heating block for 1 d at 70° C. When crystals were visually detected, the vials were removed from the heating block and left undisturbed to reach room temperature and equilibrium. The crystals obtained through this procedure were collected by vacuum filtration and air-dried.

BPBPA-Zn: Solution of BPBPA (0.01 mmol) and Zn(NO₃)₂·6H₂O (0.01 mmol) were separately prepared. About 10.0 mg of BPBPA was dissolved in 10.0 mL of nano pure water. Subsequently, the metal salt solution was prepared by adding 6.0 mg of Zn(NO₃)₂·6H₂O in 10.0 mL of nano pure water. Then, in 20.0 mL vials were transferred 5.0 mL of the previously prepared solutions (BPBPA and Zn²⁺ salt solutions). This mixture was left undisturbed in a heating block for 1 d at 70° C. When crystals were visually detected, the vials were removed from the heating block and left undisturbed to reach room temperature and equilibrium. The crystals obtained through this procedure were collected by vacuum filtration and air-dried.

BPBPA-Mg: Solution of BPBPA (0.01 mmol) and Mg(NO₃)₂·6H₂O (0.01 mmol) were separately prepared. About 10.0 mg of BPBPA was dissolved in 10.0 mL of nano pure water. Subsequently, the metal salt solution was prepared by adding 4.85 mg of Mg(NO₃)₂·6H₂O in 10.0 mL of nano pure water. Then, in 20.0 mL vials were transferred 5.0 mL of the previously prepared solutions (BPBPA and Mg²⁺ salt solutions). This mixture was left undisturbed in a heating block for 1 d at 70° C. When crystals were visually detected, the vials were removed from the heating block and left undisturbed to reach room temperature and equilibrium. The crystals obtained through this procedure were collected by vacuum filtration and air-dried.

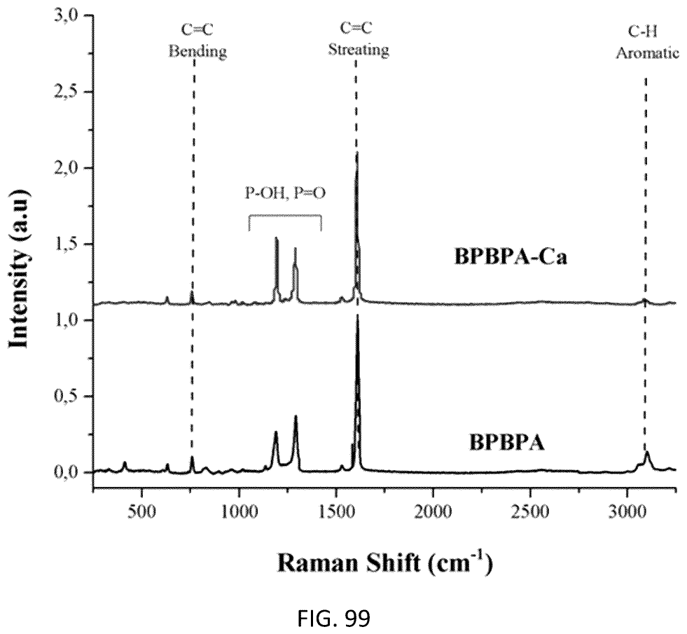

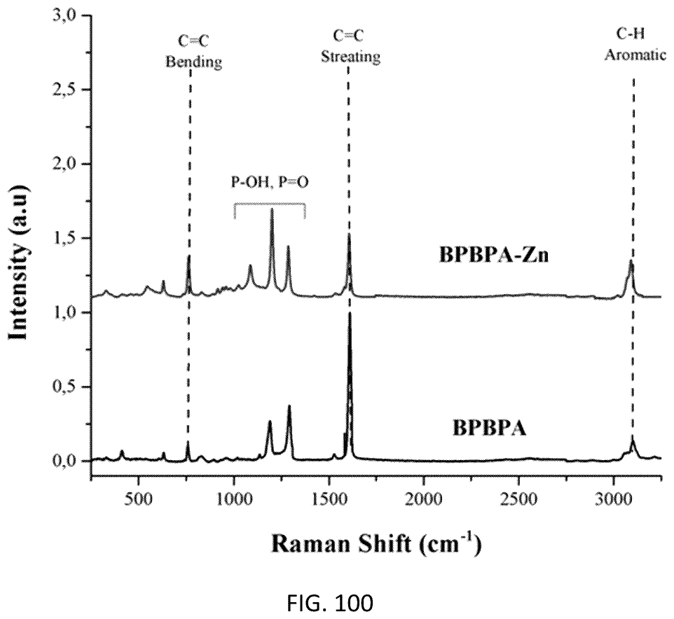

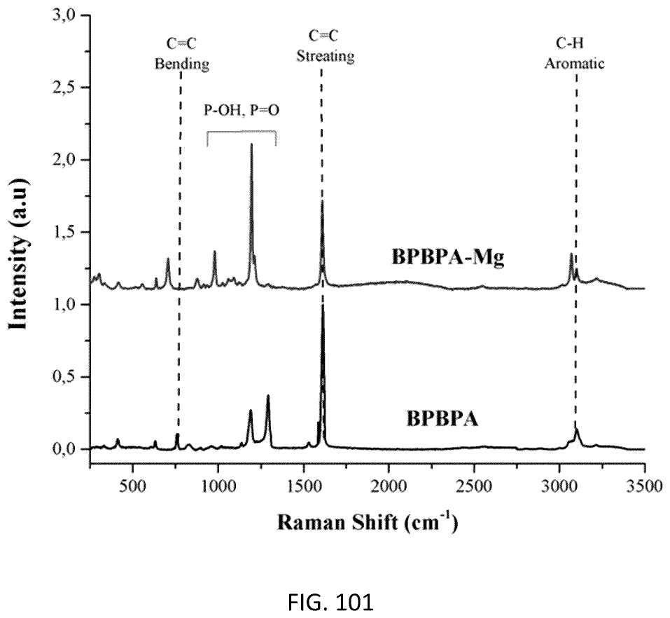

3.2. Raman Vibrational Spectroscopy for BPBPA-based BPCCs. The Raman spectra for BPBPA-Ca, BPBPA-Zn, and BPBPA-Mg were recorded employing a Thermo Scientific DXR Raman microscope. The data collection and analysis were performed as previously described for BPBPA (Section 2.3). The Raman spectra for BPBPA (black) compared with BPBPA-Ca (red), BPBPA-Zn (red), and BPBPA-Mg (red) are illustrated in FIGS. 99-101.

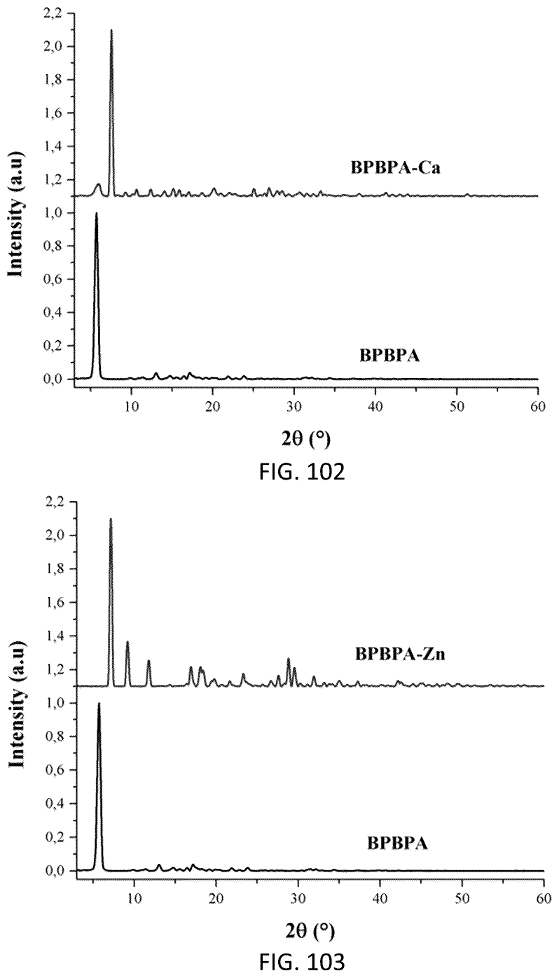

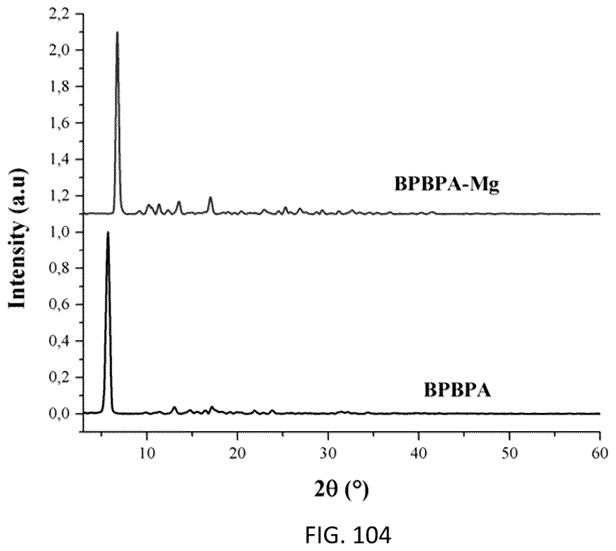

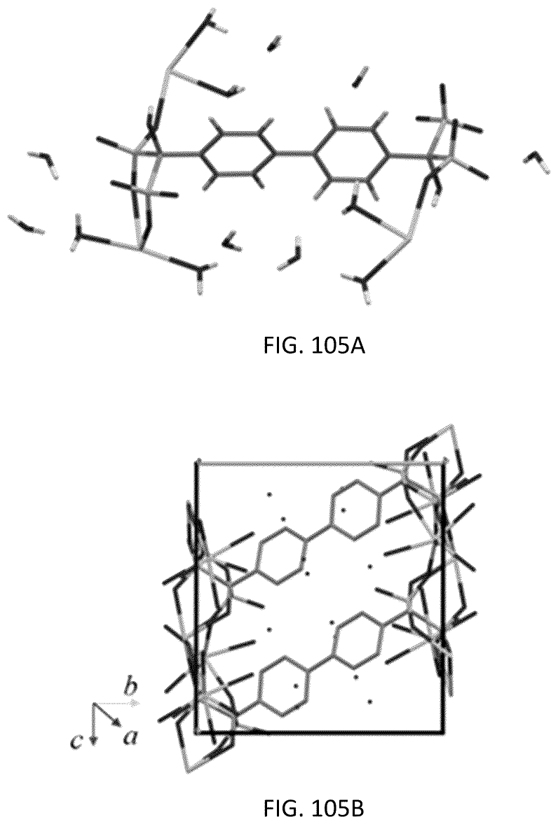

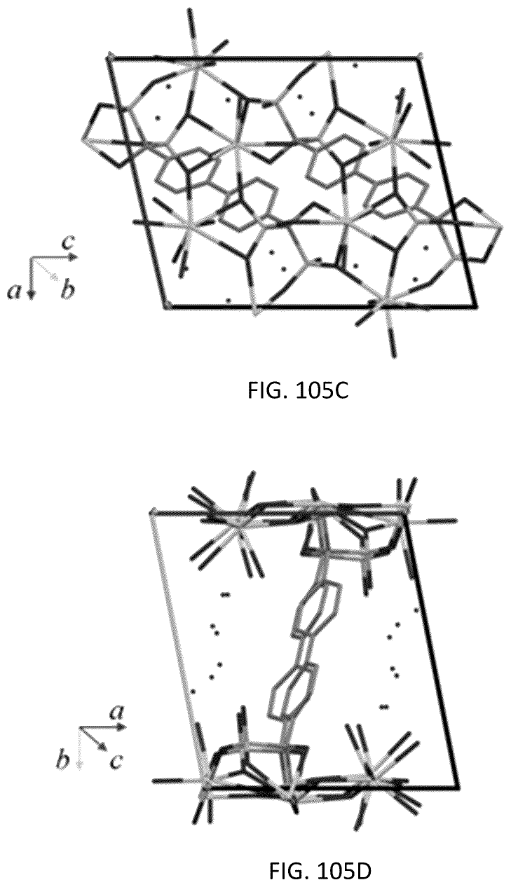

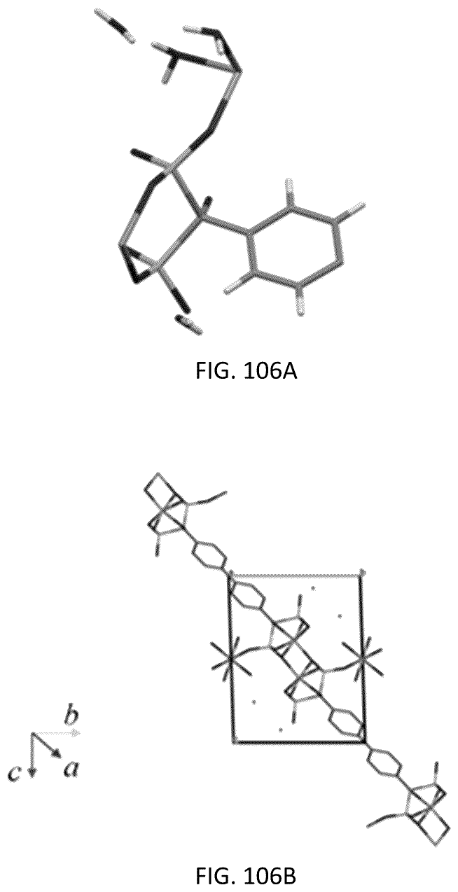

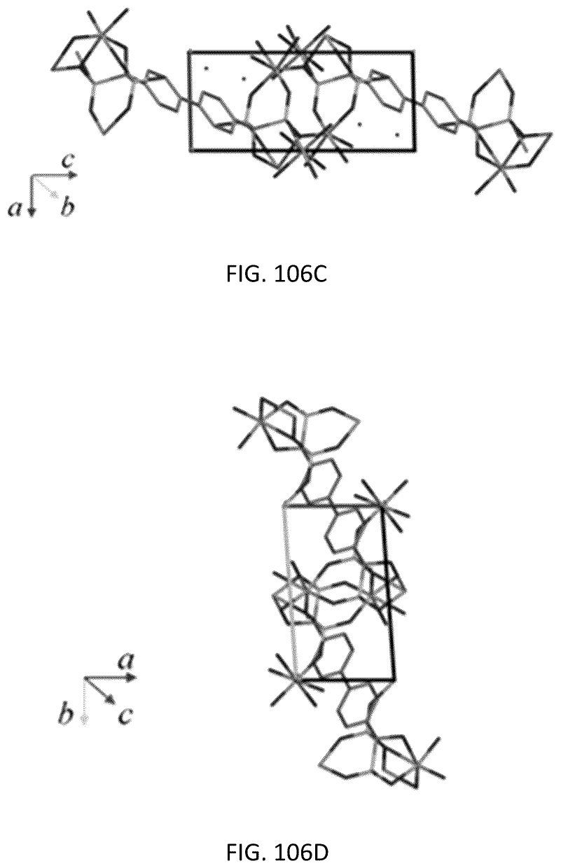

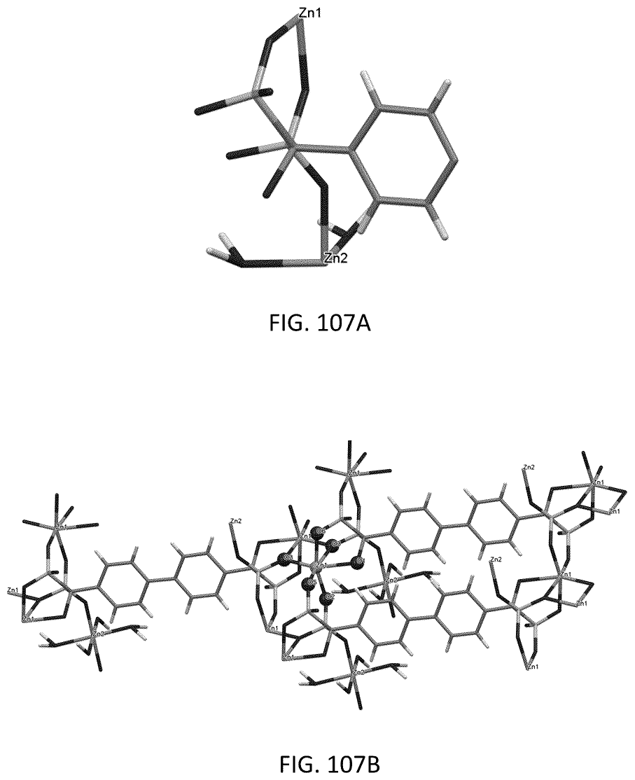

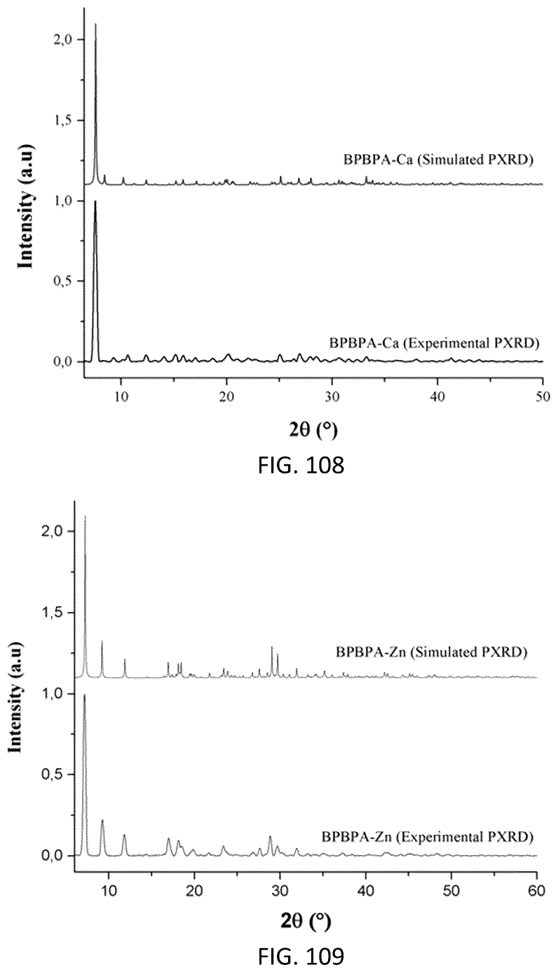

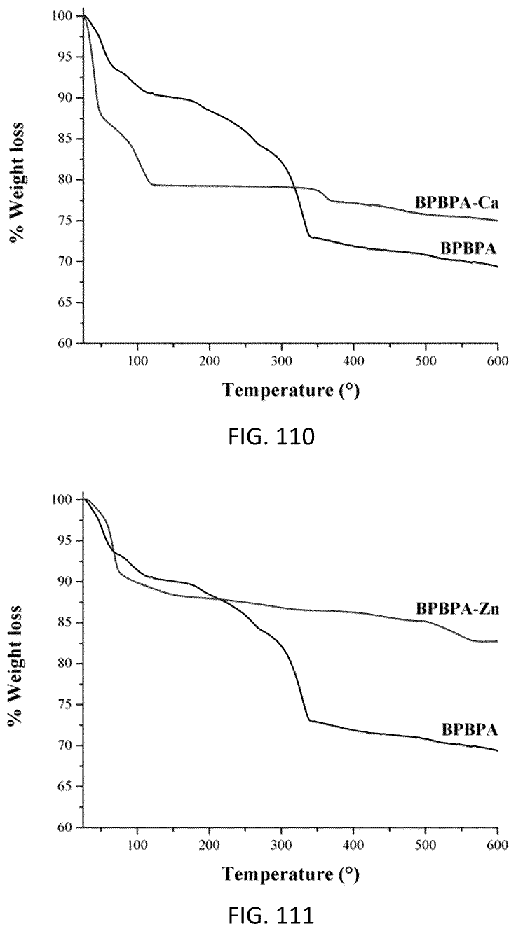

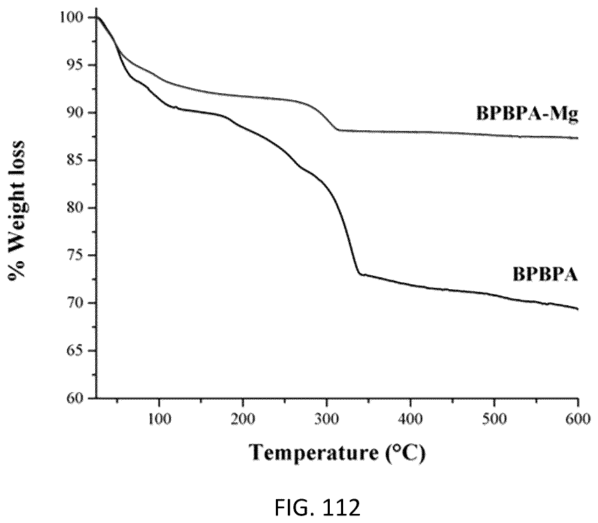

3.3. Powder X-ray diffraction (PXRD) for BPBPA-based BPCCs. The PXRD diffractograms for BPBPA-Ca, BPBPA-Zn, and BPBPA-Mg were collected using a Rigaku XtaLAB SuperNova X-ray diffractometer. The data collection and analysis were performed as previously described for BPBPA (Section 2.4). FIGS. 102-104 illustrate the PXRD diffractograms overlays of BPBPA (black) compared with the BPBPA-based metal complexes (red).

3.4. Single-crystal X-ray diffraction for BPBPA-based BPCCs. The crystal quality of single crystals of BPBPA-Ca, BPBPA-Zn, and BPBPA-Mg was assessed using a polarized microscope Nikon Eclipse Microscope LV100NPOL, equipped with a Nikon DS-Fi2 camera. Optical micrographs for all BPBPA-based BPCCs were recorded employing a NIS Elements BR software version 4.30.01. Suitable single crystals of BPBPA-based BPCCs were mounted in MiTeGen micro-loops for structure elucidation at 100 K. The experiments were accomplished in a Rigaku XtalLAB SuperNova single micro-focus Cu-Kα radiation (λ=1.5417 Å) source. The instrument was equipped with an Oxford Cryosystems Cryostream 800 and a HyPix3000 X-ray detector in transmission mode, working at 50 kV and 1 mA. The data was collected using the CrystAllis^{PRO} software v1.171.39.45c. All structures were solved using full-matrix least-squares (F² mode) and direct methods in Olex2 software vs 1.2.

3.5. Thermogravimetric analysis (TGA) for BPBPA-based BPCCs. The TGA Q500 (TA Instruments Inc.) was employed to collect the TGA thermographs of BPBPA-Ca, BPBPA-Zn, and BPBPA-Mg. The data collection and analysis were performed as previously described for BPBPA.

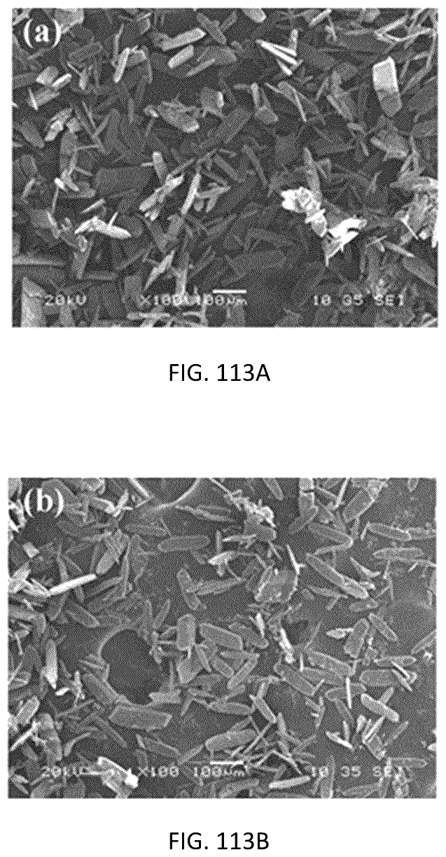

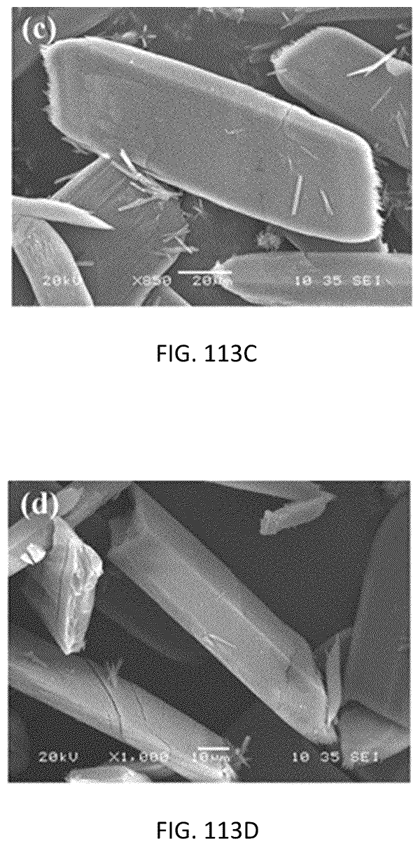

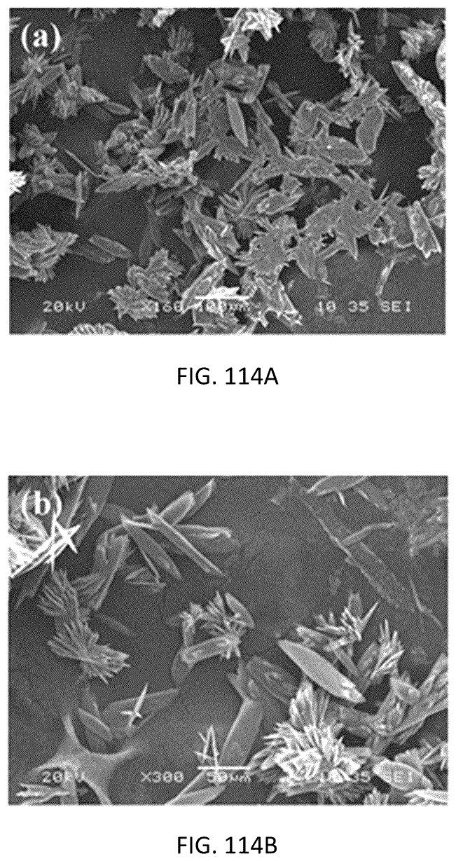

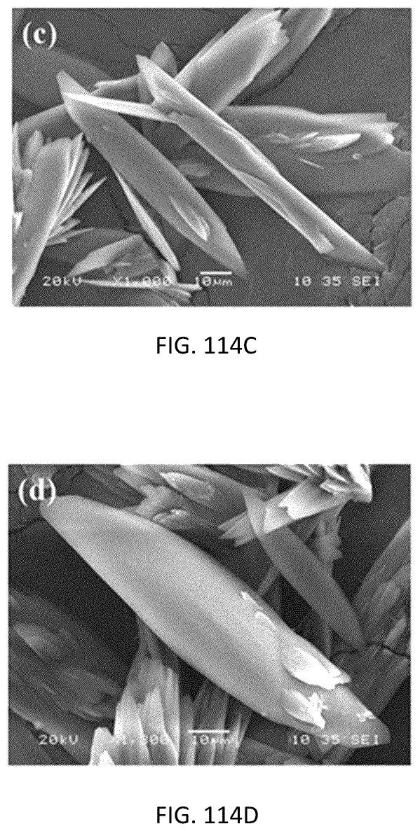

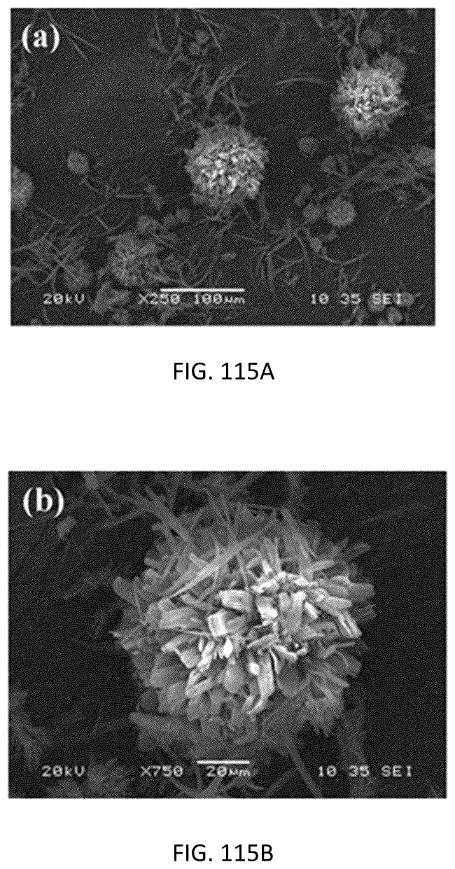

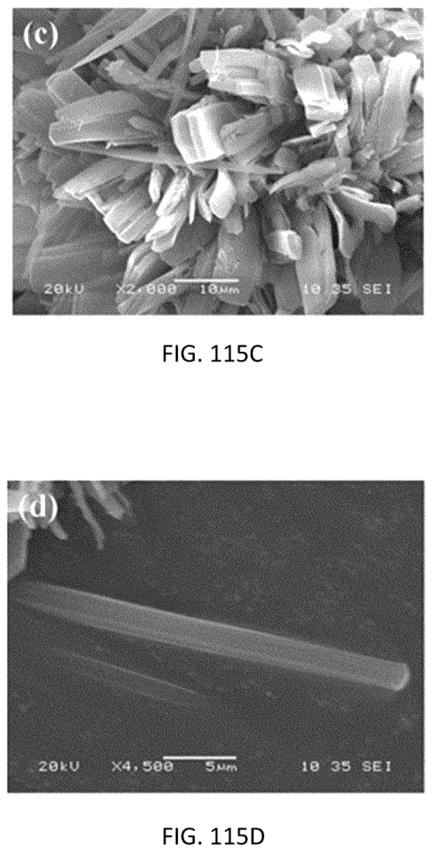

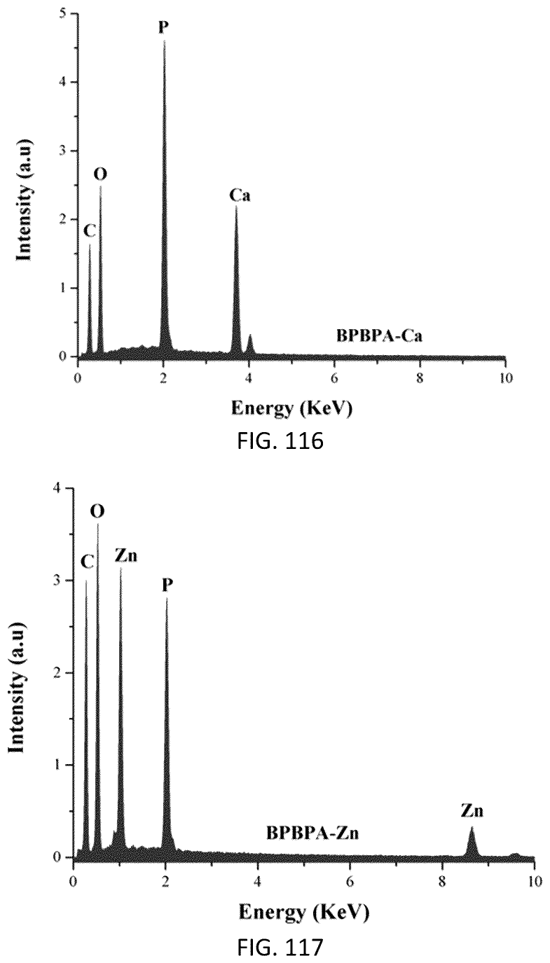

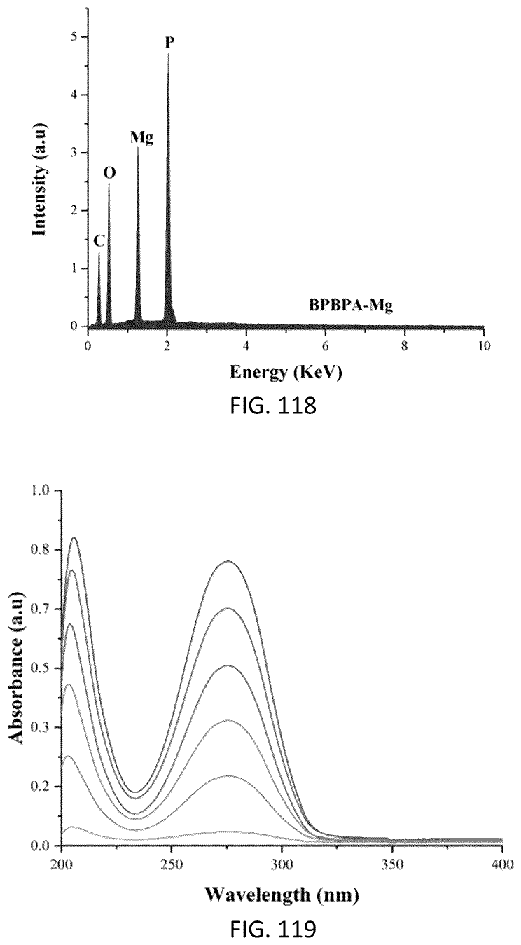

3.6. Scanning electron microscopy-energy dispersive spectroscopy (SEM-EDS) for BPBPA-based BPCCs. The SEM micrographs and the X-ray elemental analysis of BPBPA-Ca, BPBPA-Zn, and BPBPA-Mg were recorded using a JEOL JSM-6480LV scanning electron microscope. The instrument was equipped with an Everhart Thomley secondary electron imaging (SEI) and an energy dispersive X-ray analysis (EDAX) Genesis 2000 detectors. The SEM micrographs of the BPBPA-based metal complexes were collected employing an acceleration voltage of 20 kV, a spot size of 36, and an electron beam of 11 mm width in a high vacuum mode. The SEM micrographs for BPBPA-Ca, BPBPA-Zn, and BPBPA-Mg are depicted in FIGS. 113-115. The EDS spectra for the BPBPA-based BPCCs are shown in FIGS. 116-118.

3.7. Differential Scanning Calorimeter (DSC) for BPBPA-based BPCCs. A DSC Q2000 (TA Instruments Inc.) was utilized to record the melting points of BPBPA-Ca, BPBPA-Zn, and BPBPA-Mg. This experiment was performed employing the same parameters as for BPBPA. About 1-2 mg of powered BPBPA-based BPCCs sample was hermetically sealed using aluminum pans. The TA Universal Analysis software v 4.5 Å was utilized to collect and analyze the data. The melting points for all BPBPA-based BPCCs are shown in Table 17.

TABLE 17
Melting points determined for all BPBPA-based BPCCs

| BPBPA-based BPCCs | Melting point (° C.) | Melting point (K) |
|---|---|---|
| BPBPA-Ca | 220 | 493 |
| BPBPA-Zn | 217 | 490 |
| BPBPA-Mg | 218 | 491 |

### 4. Dissolution Curves in Physiological Conditions for BPBPA-Based BPCCs

4.1. Dissolution curves in phosphate-buffered saline for BPBPA-based BPCCs

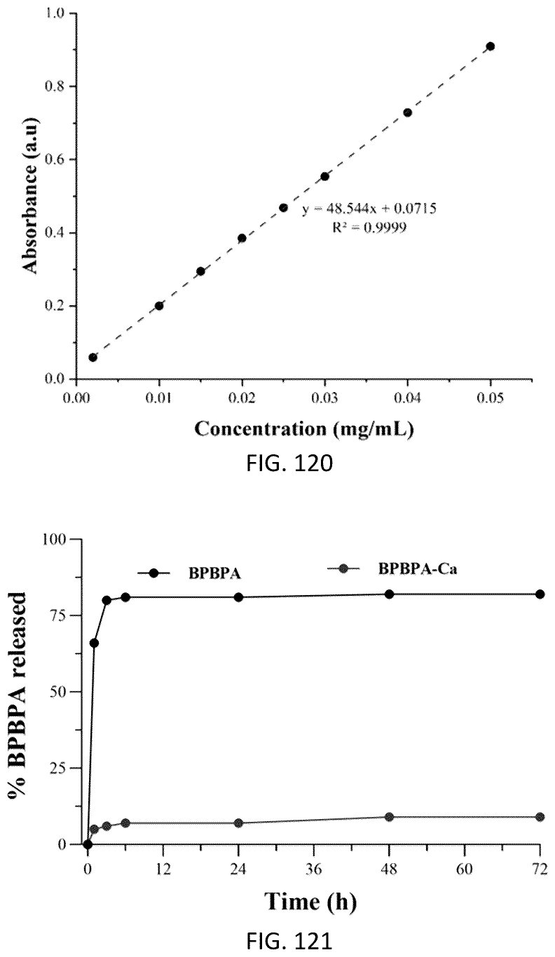

Calibration curve. A stock solution of 0.5 mg/mL of BPBPA was prepared; for this, 12.5 mg of BPBPA was dissolved in 25 mL of PBS. Then, serial dilutions were completed to obtain eight standard solutions in concentrations of 0.05, 0.04, 0.03, 0.025, 0.02, 0.015, 0.01, and 0.002 mg/mL. Finally, the absorbance was measured employing UV-Vis spectroscopy (200-400 nm), and PBS was used as a solvent blank. The maximum absorbance wavelength (k(max)) was detected at 275 nm. The absorption spectra (400-200 nm) for the BPBPA standard solutions in PBS are displayed in FIG. 119. The calibration curve of BPBPA in PBS is depicted in FIG. 120.

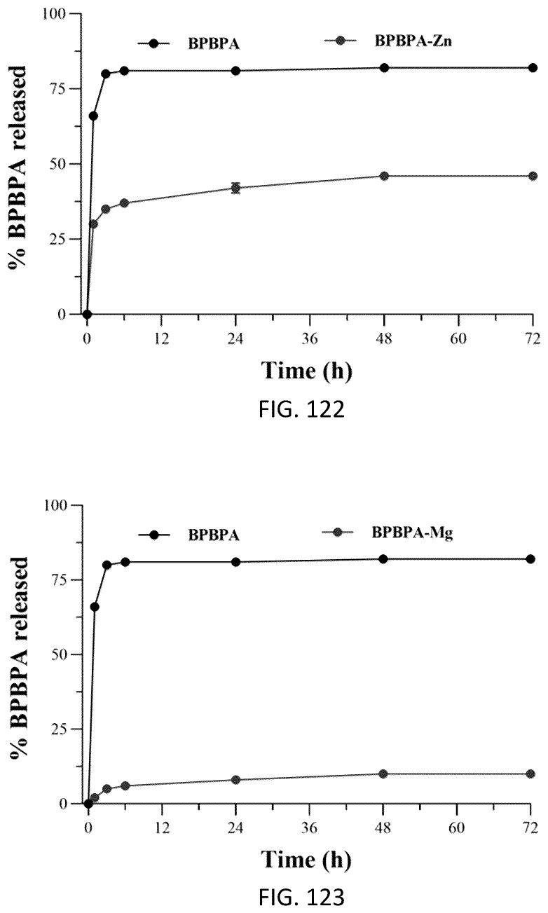

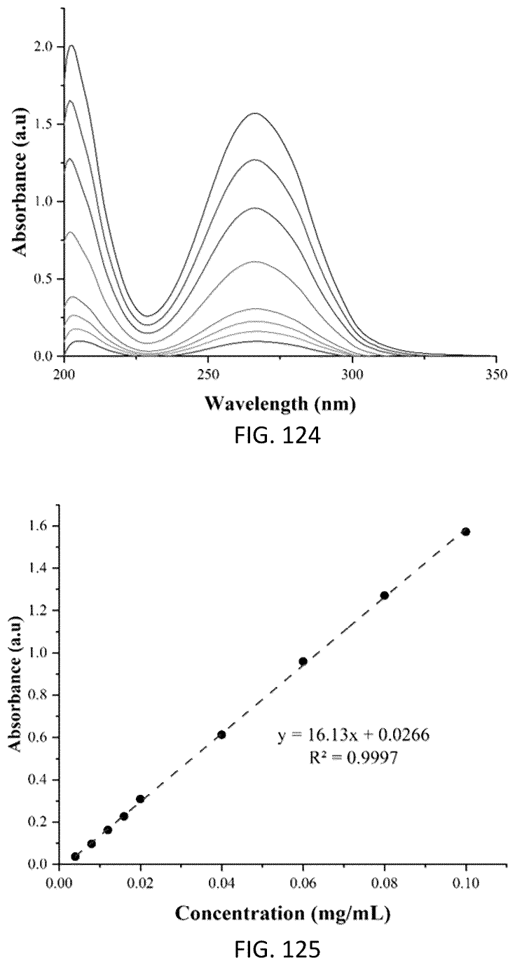

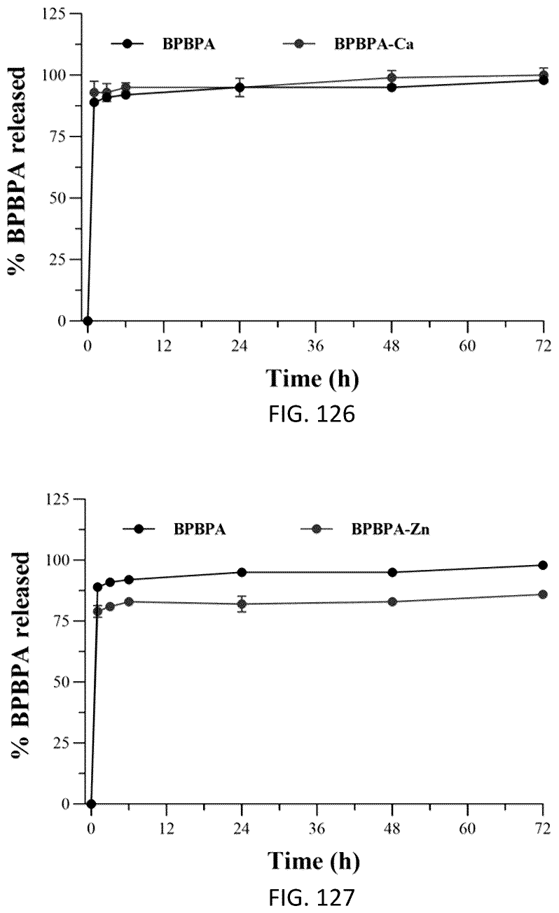

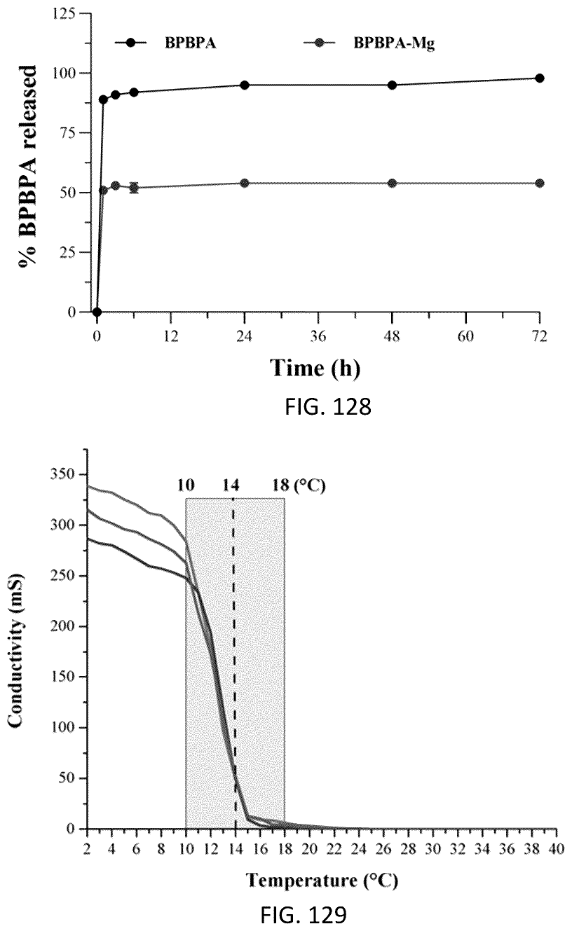

Dissolution experiment. About 100.0 mL of PBS was transferred to a 250 mL beaker; this solution was left under stirring at 37° C. (150 rpm). To record the first time point (0 h), an aliquot (1 mL) was extracted before adding the BPBPA-based BPCCs. Then, 15.0 mg of powered BPBPA-based BPCCs were added to the PBS solution. After selected time points (0, 1, 3, 6, 24, 48, and 72 h), aliquots of 1 mL were taken out and diluted in a 5 mL volumetric flask with PBS. Subsequently, the absorbance of BPBPA released from the coordination complexes was evaluated at 275 nm. The dissolution experiments were performed in duplicate for each BPBPA-based BPCCs. The percentage (%) of BPBPA release from the BPBPA-based BPCCs after the dissolution experiments in PBS is presented in Table 17. The dissolution profiles for BPBPA compared with BPBPA-Ca, BPBPA-Zn, and BPBPA-Mg in PBS are shown in FIGS. 121-123.

### 4.2. Dissolution Curve in Fasted-State Simulated Gastric Fluid for BPBPA-Based BBPCs.

Calibration curve. A stock solution of 0.1 mg/mL of BPBPA was prepared, for this, 2.5 mg of BPBPA were dissolved in 25 mL of FaSSGF. Then, serial dilutions were completed to obtain eight standard solutions in concentrations of 0.08, 0.06, 0.04, 0.02, 0.016, 0.012, 0.008, and 0.004 mg/mL. Finally, the absorbance was measured using UV-Vis spectroscopy (200-400 nm), FaSSGF was used as a solvent blank. The maximum absorbance wavelength (k(max)) was detected at 266 nm. The absorption spectra (400-200 nm) for the BPBPA standard solutions in FaSSGF are displayed in FIG. 119. The calibration curve of BPBPA in FaSSGF is depicted in FIG. 120.

Dissolution experiment. About 100.0 mL of FaSSGF was transferred to a 250 mL beaker; this solution was left under stirring at 37° C. (150 rpm). To record the first time point (0 h), an aliquot (1 mL) was extracted before adding the BPBPA-based BPCCs. Then, 15.0 mg of powered BPBPA-based metal complexes were added to the FaSSGF solution. After selected time points (0, 1, 3, 6, 24, 48, and 72 h), aliquots of 1 mL were taken out and diluted in a 5 mL volumetric flask with FaSSGF. Subsequently, the absorbance of BPBPA released from the BPBPA-based BPCCs was evaluated at 266 nm. The dissolution experiments were performed in duplicate for each coordination complex. The percentage (%) of BPBPA release from the BPBPA-based BPCCs after the dissolution experiments in FaSSGF are presented in Table 18. The dissolution profiles for BPBPA compared with BPBPA-Ca, BPBPA-Zn, and BPBPA-Mg in FaSSGF are shown in FIGS. 121-123.

TABLE 18
Percentage (%) of BPBPA released from the BPBPA-based BPCCs after
the dissolution experiment. The experiments were performed in duplicate (n = 2). The mean
percent released (% Released) and coefficient of variation (% CV) are reported.

| | BPBPA | | BPBPA-Ca | | BPBPA-Zn | | BPBPA-Mg | |
|---|---|---|---|---|---|---|---|---|
| Time | % | | % | | % | | % | |
| (h) | Released | % CV | Released | % CV | Released | % CV | Released | % CV |
| 0 | 0 | 0 | 0 | 0 | 0 | 0 | 0 | 0 |
| 1 | 89 | 2 | 93 | 5 | 79 | 3 | 51 | 1 |
| 3 | 91 | 1 | 93 | 4 | 81 | 2 | 53 | 3 |
| 6 | 92 | 3 | 95 | 2 | 83 | 2 | 52 | 4 |
| 24 | 95 | 2 | 95 | 4 | 82 | 4 | 54 | 2 |
| 48 | 95 | 3 | 99 | 3 | 83 | 1 | 54 | 3 |
| 72 | 98 | 1 | 100 | 3 | 86 | 2 | 54 | 1 |

### 5. Synthesis and Characterization of Nano-Ca@BPBPA

5.1 Phase Inversion Temperature Determination for BPBPA. The phase inversion temperature (PIT) was assessed for a micro-emulsion of BPBPA in heptane and Brij L4® (surfactant). About 11 mL of a 2.5 mg/mL BPBPA solution were mixed with 3.0 mL of heptane and 0.9 mL of Brij L4®. This mixture was completely homogenized before the experiment. The conductivity resulting from the previously homogenized micro-emulsion was measured in the temperature range from 2 to 40° C. at 1° C./min. FIG. 129 illustrates the PIT determination curves for the micro-emulsion of BPBPA in heptane utilizing Brij L4® as a surfactant.

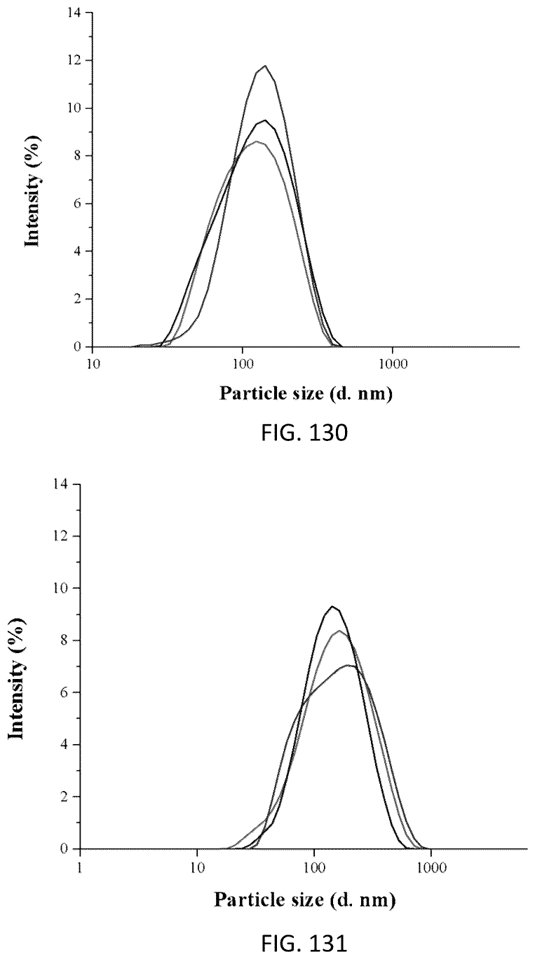

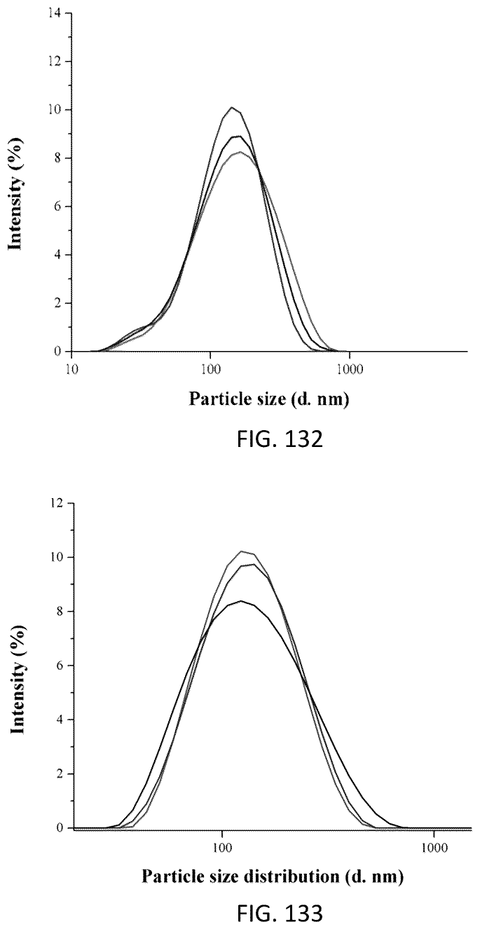

5.2. Synthesis of nano-Ca@BPBPA: The synthesis of nano-Ca@BPBPA was performed in a Crystalline (Technobis, Crystallization Systems, Alkmaar, Netherlands). Emulsions of BPBPA, heptane, and Brij L4® were prepared as previously described for the PIT determination method. These emulsions were utilized to obtain nano-Ca@BPBPA. About 3.5 mL of the previously homogenized emulsion were transferred to 8 mL reaction vials (with adequate stir bars and reflux caps) to perform the synthesis. The reaction vials were left in the Crystalline at 7° C. for 30 min. Then, the reaction was left at 60° C. for 30 min (in a second Crystalline reactor). Subsequently, the reaction was heated at 80° C., and 3.5 mL of the metal salt solution was added and left stirring for 1 h allowing the formation of nano-Ca@BPBPA. Finally, the reaction was left at room temperature (undisturbed) to reach equilibrium. Aliquots of the supernatant were measured in triplicate employing dynamic light scattering (DLS), to determine the particle size distribution for the nano-Ca@BPBPA (FIGS. 130-132).

5.3. Dynamic light scattering measurements for nano-Ca@BPBPA: DLS measurements were performed to determine the particle size distribution (supernatant) of the obtained nano-Ca@BPBPA. Aliquots (50 μL) were prepared (1:20 dilution ratio) in disposable polystyrol/polystyrene cuvettes (REF: 67.754 10×10×45 mm, Sarsted, Germany). FIGS. 130-132 presented the particle size distribution curves for the aqueous phase of the obtained nano-Ca@BPBPA.

TABLE 19
Particle size distribution parameters for nano-
Ca@BPBPA from synthesis 1 determined by DLS.
The measurements were recorded in triplicate.
The particle size distribution of nano-Ca@BBPA

| Run | Size (d · nm) | % Intensity | St. Dev. (d · nm) | PDI |
|---|---|---|---|---|
| 1 | 182.3 | 100.0 | 115.4 | 0.387 |
| | 0.000 | 0.0 | 0.000 | |
| | 0.000 | 0.0 | 0.000 | |
| 2 | 151.5 | 100.0 | 81.51 | 0.383 |
| | 0.000 | 0.0 | 0.000 | |
| | 0.000 | 0.0 | 0.000 | |
| 3 | 164.7 | 100.0 | 98.76 | 0.403 |
| | 0.000 | 0.0 | 0.000 | |
| | 0.000 | 0.0 | 0.000 | |
| Average | 166.2 | 100.0 | 100.3 | 0.391 |
| | 0.000 | 0.0 | 0.000 | |
| | 0.000 | 0.0 | 0.000 | |

TABLE 20
Particle size distribution parameters for nano-
Ca@BPBPA from synthesis 2 determined by DLS.
The measurements were recorded in triplicate.
The particle size distribution of nano-Ca@BBPA

| Run | Size (d · nm) | % Intensity | St. Dev. (d · nm) | PDI |
|---|---|---|---|---|
| 1 | 184.5 | 100.0 | 115.5 | 0.404 |
| | 0.000 | 0.0 | 0.000 | |
| | 0.000 | 0.0 | 0.000 | |
| 2 | 153.6 | 100.0 | 85.12 | 0.477 |
| | 0.000 | 0.0 | 0.000 | |
| | 0.000 | 0.0 | 0.000 | |
| 3 | 164.7 | 100.0 | 98.76 | 0.524 |
| | 0.000 | 0.0 | 0.000 | |
| | 0.000 | 0.0 | 0.000 | |
| Average | 177.8 | 100.0 | 114.0 | 0.408 |
| | 0.000 | 0.0 | 0.000 | |
| | 0.000 | 0.0 | 0.000 | |

TABLE 21
Particle size distribution parameters for nano-
Ca@BPBPA from synthesis 3 determined by DLS.
The measurements were recorded in triplicate.
The particle size distribution of nano-Ca@BBPA

| Run | Size (d · nm) | % Intensity | St. Dev. (d · nm) | PDI |
|---|---|---|---|---|
| 1 | 164.1 | 100.0 | 89.74 | 0.362 |
| | 0.000 | 0.0 | 0.000 | |
| | 0.000 | 0.0 | 0.000 | |
| 2 | 136.7 | 100.0 | 71.29 | 0.396 |
| | 0.000 | 0.0 | 0.000 | |
| | 0.000 | 0.0 | 0.000 | |
| 3 | 180.1 | 100.0 | 115.2 | 0.370 |
| | 0.000 | 0.0 | 0.000 | |
| | 0.000 | 0.0 | 0.000 | |
| Average | 159.0 | 100.0 | 95.28 | 0.385 |
| | 0.000 | 0.0 | 0.000 | |
| | 0.000 | 0.0 | 0.000 | |

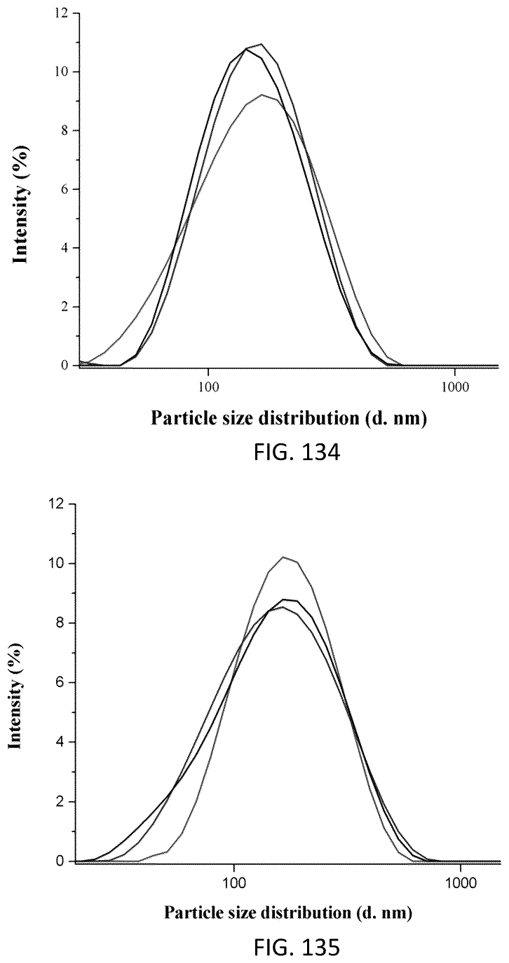

5.4. Aggregation measurements of the nano-Ca@BPBPA: Additional DLS measurements were performed to the previously obtained nano-Ca@BPBPA in 10% FBS in PBS. This experiment was carried out to determine the aggregation behavior of this nanomaterial in 10% FBS: PBS after 0, 24, and 48 h. Samples for DLS measurements were prepared as previously described in Section 5.3, samples were left undisturbed (30 min) before DLS assessment (in triplicate). FIGS. 133-135 represent the particle size distribution curves for the obtained nano-Ca@BPBPA in 10% FBS: PBS after 0, 24, and 48 h of being synthesized.

TABLE 22
Particle size distribution parameters for nano-Ca@BPBPA
determined by DLS in 10% FBS: PBS after 0 h.
The measurements were recorded in triplicate.
The particle size distribution of nano-Ca@BBPA

| | Size | | St. Dev. | |
|---|---|---|---|---|
| Run | (d · nm) | % Intensity | (d · nm) | PDI |
| 1 | 174.8 | 100.0 | 89.74 | 0.479 |
| | 0.000 | 0.0 | 0.000 | |
| | 0.000 | 0.0 | 0.000 | |
| 2 | 171.2 | 100.0 | 71.29 | 0.476 |
| | 0.000 | 0.0 | 0.000 | |
| | 0.000 | 0.0 | 0.000 | |
| 3 | 164.7 | 100.0 | 115.2 | 0.508 |
| | 0.000 | 0.0 | 0.000 | |
| | 0.000 | 0.0 | 0.000 | |
| Average | 170.23 | 100.0 | 95.28 | 0.488 |
| | 0.000 | 0.0 | 0.000 | |
| | 0.000 | 0.0 | 0.000 | |

TABLE 23
Particle size distribution parameters for nano-Ca@BPBPA
determined by DLS in 10% FBS:PBS after 24 h.
The measurements were recorded in triplicate.
The particle size distribution of nano-Ca@BBPA

| | Size | | St. Dev. | |
|---|---|---|---|---|
| Run | (d · nm) | % Intensity | (d · nm) | PDI |
| 1 | 186.8 | 100.0 | 89.74 | 0.513 |
| | 0.000 | 0.0 | 0.000 | |
| | 0.000 | 0.0 | 0.000 | |
| 2 | 179.1 | 100.0 | 71.29 | 0.491 |
| | 0.000 | 0.0 | 0.000 | |
| | 0.000 | 0.0 | 0.000 | |
| 3 | 181.0 | 100.0 | 115.2 | 0.498 |
| | 0.000 | 0.0 | 0.000 | |
| | 0.000 | 0.0 | 0.000 | |
| Average | 182.3 | 100.0 | 95.28 | 0.501 |
| | 0.000 | 0.0 | 0.000 | |
| | 0.000 | 0.0 | 0.000 | |

TABLE 24
Particle size distribution parameters for nano-Ca@BPBPA
determined by DLS in 10% FBS:PBS after 48 h.
The measurements were recorded in triplicate.
The particle size distribution of nano-Ca@BBPA

| | Size | | St. Dev | |
|---|---|---|---|---|
| Run | (d · nm) | % Intensity | (d · nm) | PDI |
| 1 | 179.4 | 100.0 | 110.2 | 0.458 |
| | 0.000 | 0.0 | 0.000 | |
| | 0.000 | 0.0 | 0.000 | |
| 2 | 181.0 | 100.0 | 110.9 | 0.517 |
| | 0.000 | 0.0 | 0.000 | |
| | 0.000 | 0.0 | 0.000 | |
| 3 | 177.1 | 100.0 | 109.1 | 0.463 |
| | 0.000 | 0.0 | 0.000 | |
| | 0.000 | 0.0 | 0.000 | |
| Average | 181.2 | 100.0 | 114.1 | 0.479 |
| | 0.000 | 0.0 | 0.000 | |
| | 0.000 | 0.0 | 0.000 | |

### 6. Binding Assays for Nano-Ca@BPBPA

Calibration curve. The calibration curve of BPBPA in PBS previously prepared (Section 4.1) was utilized to determine the concentration of BPBPA during the binding assay.

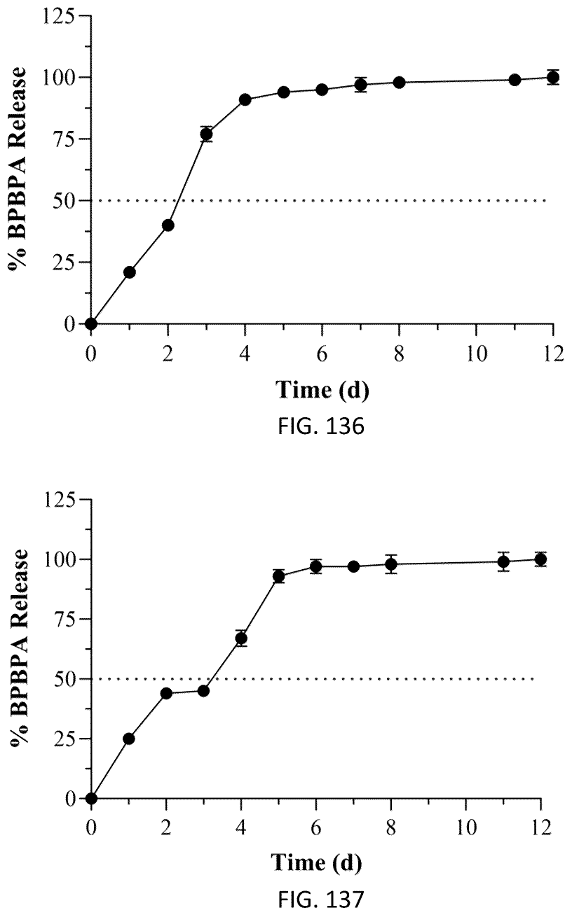

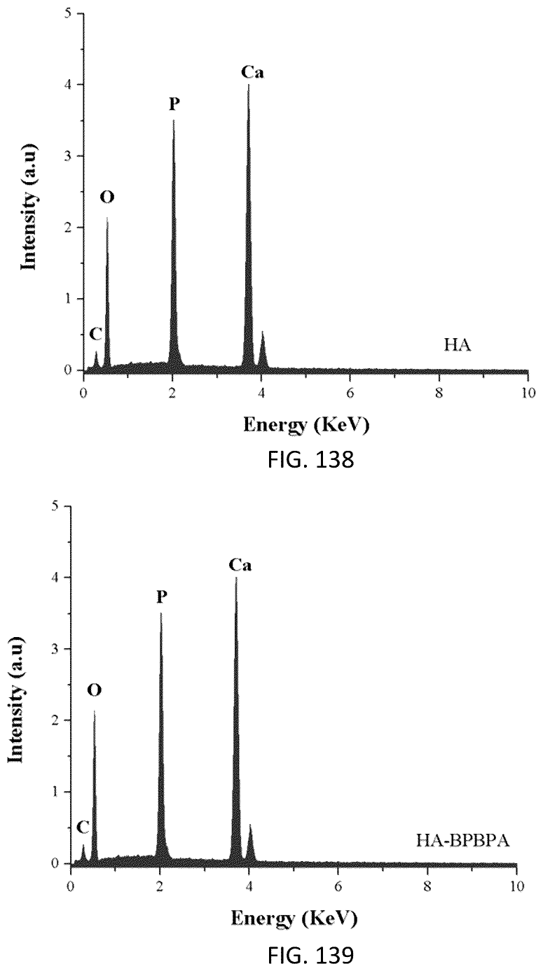

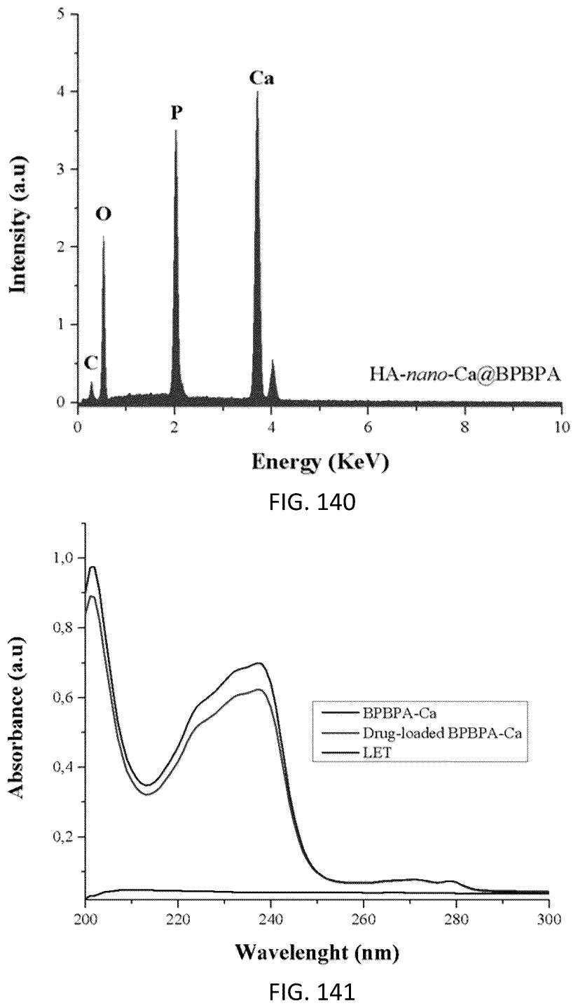

Binding assay with hydroxyapatite (HA). To determine the affinity of BPBPA and nano-Ca@BPBPA to the bone microenvironment was employed HA. For this, about 20 mg of powdered HA were exposed to nano-Ca@BPBPA (5 mL, 0.5 mg/mL). In addition, BPBPA (0.5 mg/mL) and HA (20 mg) were used as control groups. All experimental and control groups were left under constant stirring (150 rpm) for 0-12 d. The supernatant was collected, centrifuged (8 min, 1200 rpm), and the absorbance was measured (λₘₐₓ=275 nm) after each time point (1, 2, 3, 4, 7, 8, 9, 10, 11, 12 d) to quantify the amount (%) of BPBPA bound to HA. Moreover, HA, HA-BPBPA, and HA-nano-Ca@BPBPA were characterized by SEM-EDS and PXRD. Table S6.1 depicts the percentage (%) of BPBPA and nano-Ca@BPBPA bound to HA in PBS. Furthermore, FIGS. 136-137 illustrate the binding curves for BPBPA and nano-Ca@BPBPA. EDS spectra for HA, HA-BPBPA, and HA-nano-Ca@BPBPA are shown in FIGS. 138-140.

TABLE 25
Percentage (%) of BPBPA and nano-Ca@BPBPA bound to HA at a
concentration of 0.5 mg/mL. The experiment was carried
out in duplicate, the mean and % CV are reported.

| | BPBPA | | nano-Ca@BPBPA | |
|---|---|---|---|---|
| Time (d) | Mean | % CV | Mean | % CV |
| 1 | 21 | 3 | 25 | 3 |
| 2 | 40 | 3 | 44 | 2 |
| 3 | 77 | 4 | 45 | 3 |
| 4 | 91 | 2 | 67 | 5 |
| 5 | 94 | 1 | 93 | 3 |
| 6 | 95 | 2 | 97 | 3 |
| 7 | 97 | 3 | 97 | 1 |
| 8 | 98 | 2 | 98 | 4 |
| 11 | 99 | 1 | 99 | 4 |
| 12 | 100 | 3 | 100 | 3 |

7. Loading and Release of Letrozole (LET) into the BPBPA-Ca and Nano-Ca@BPBPA

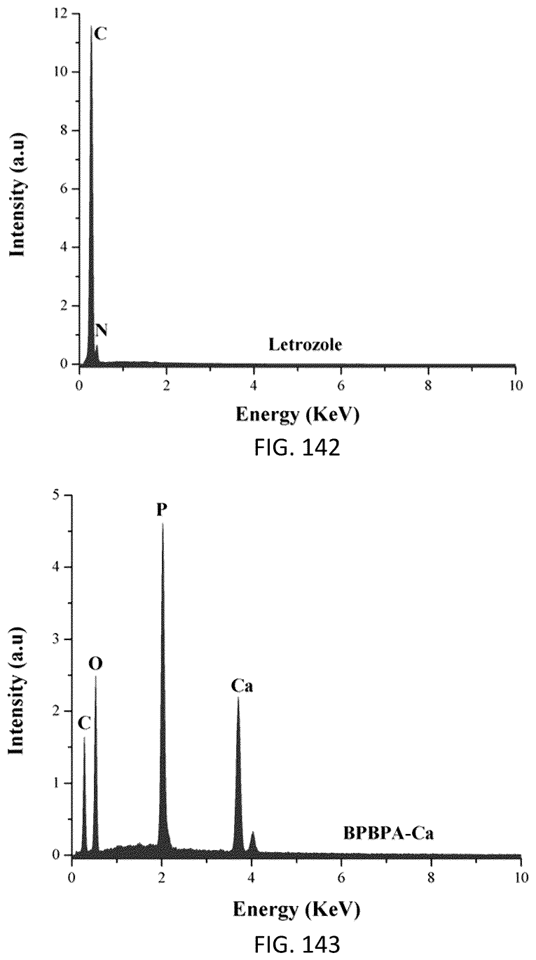

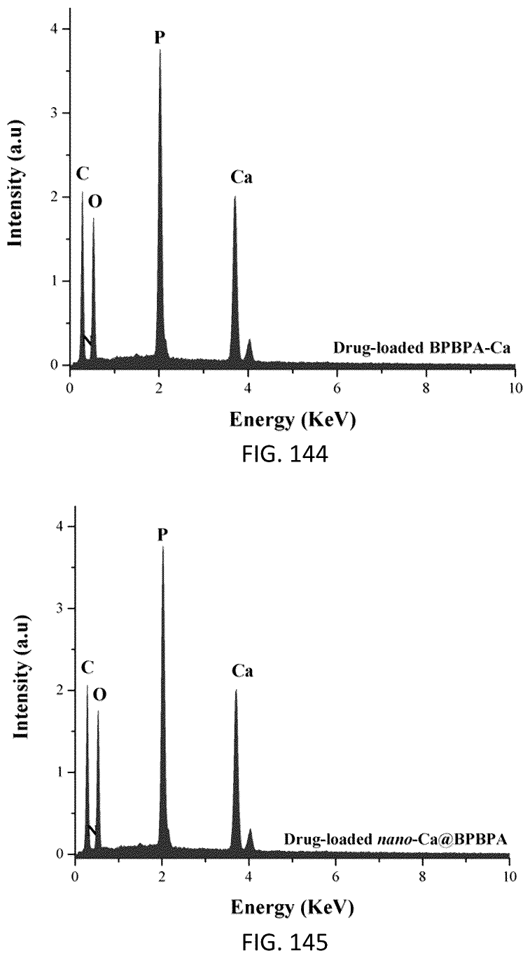

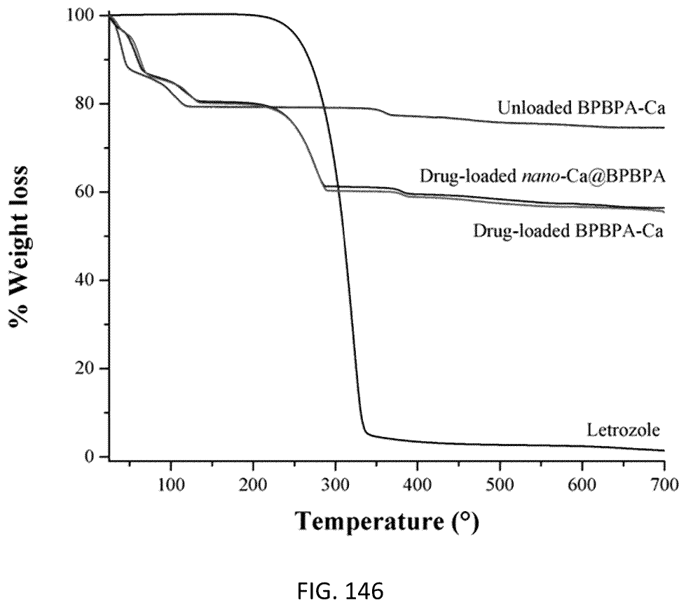

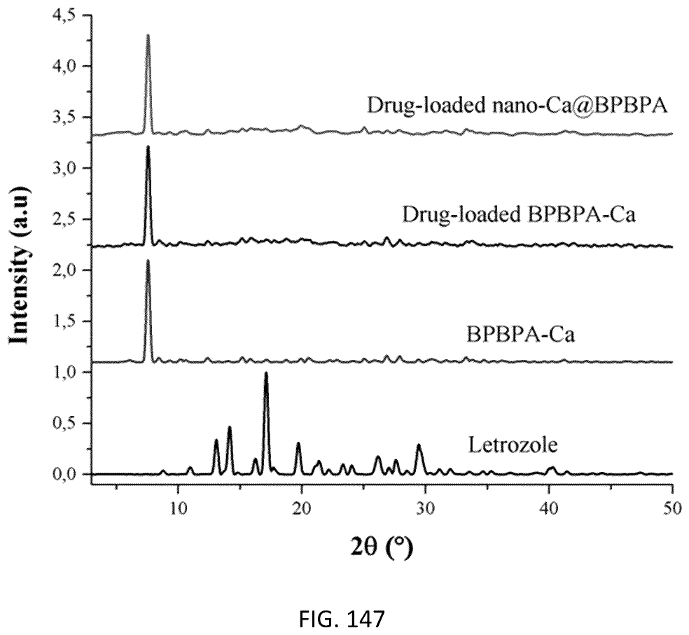

7.1. Loading of LET into BPBPA-Ca. Loading of LET into BPBPA-Ca was performed as follows, in a 1.5-mL vial were added BPBPA-Ca (20 mg), LET (7 mg), and ethanol (1 mL). This mixture was left undisturbed at 50° C. for 24 h. About 7 mg of LET were added to the vial to allow the complete loading of LET into the BPBPA-Ca channels. Two vials each with BPBPA-Ca (20 mg) and LET (7 mg) in ethanol (1 mL), respectively, were employed as control groups. Once the experiment was completed, the supernatant was collected, filtrated, and the absorbance was measured at 238 nm (FIG. 141). Lastly, the drug-loaded BPBPA-Ca (experimental), BPBPA-Ca (control), and LET (control) were characterized by SEM-EDS (FIGS. 142-144), TGA (FIG. 146), and PXRD (FIG. 147).

7.2. Loading of LET into nano-Ca@BPBPA. The PIT-nanoemulsion method was utilized to achieve the drug loading of LET into the nano-Ca@BPBPA. The synthesis of the nano-Ca@BPBPA was accomplished as previously described in Section 5.2, employing 2.5 mL of the emulsion (BPBPA, heptane, Brij L4®) and 2.5 mL of the Ca²⁺ salt (calcium nitrate) solution. Subsequently, about 2.5 mL of LET 0.36 mg/mL was added to the synthesized nano-Ca@BPBPA. This mixture was left under stirring for 1 h allowing the loading of LET into the nano-Ca@BBPA. The drug-loaded nano-Ca@BPBPA was characterized by EDS (FIG. 145), TGA (FIG. 146), and PXRD (FIG. 147).

7.3. Release of Letrozole in Fasted-State Simulated Gastric Fluid from BPBPA-Ca.

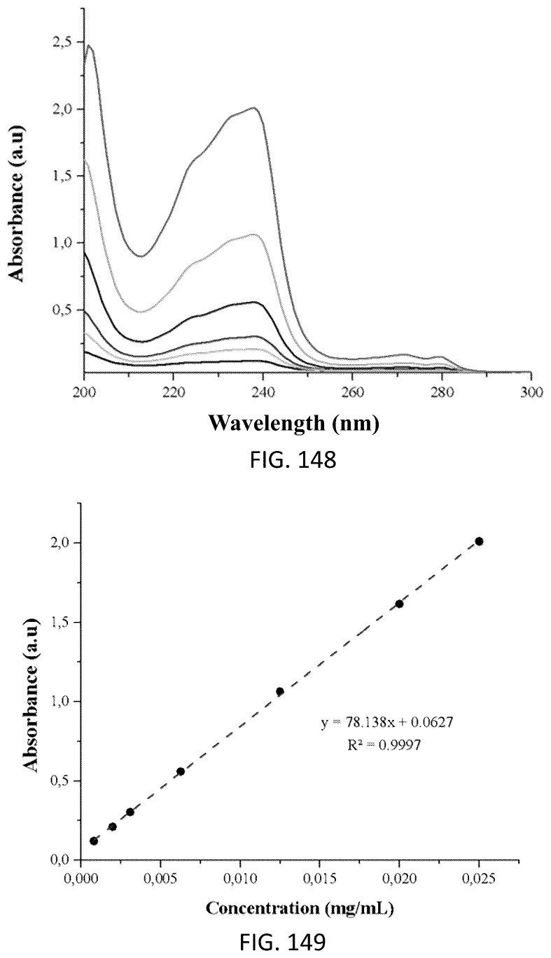

Calibration curve. A stock solution of 0.1 mg/mL of LET was prepared in FaSSGF. Then, two-fold serial dilutions were carried out to obtain concentrations of 0.025, 0.013, 0.063, 0.0031, 0.0016, 0.0008 mg/mL. The absorbance was measured (200-400 nm), and FaSSGF was employed as a solvent blank. The wavelength of maximum absorption (λₘₐₓ) was identified at 238 nm. FIG. 148 and FIG. 149 illustrate the absorption spectra and the calibration curve of LET in FaSSGF, respectively.

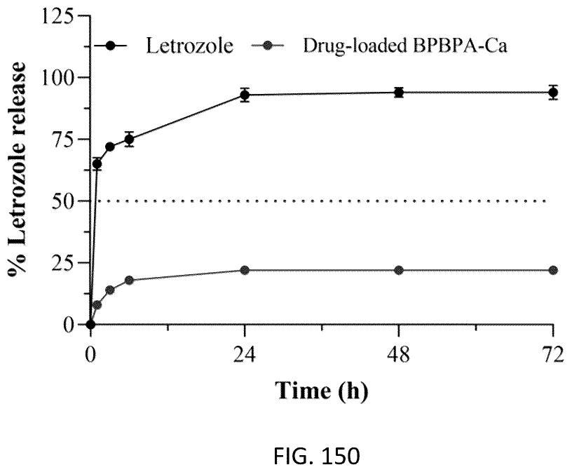

Release experiment. The release curve of LET from BPBPA-Ca was determined in FaSSGF. About 100 mL of FaSSGF were placed in a 250-mL beaker and left in constant stirring at 37° C. (150 rpm). To record the first time point (0 h), an aliquot (1 mL) was taken out before adding the drug-loaded BPBPA-Ca. Subsequently, about 20 mg of powdered drug-loaded BPBPA-Ca (experimental) were placed into the FaSSGF solution. After each time point (0, 1, 3, 6, 24, 48, and 72 h), an aliquot (1 mL) was taken out and diluted in a 5 mL volumetric flask. Once the experiment was completed, the absorbance was measured at 238 nm to determine the amount (%) of LET release from the BPBPA-Ca. The release curve of LET (control) in FaSSGF was determined for comparison. This experiment was performed in duplicate. FIG. 150 depicts the release curve of LET from the BPBPA-Ca channels.

TABLE 26
Percentage (%) of letrozole (LET) released from the BPBPA-Ca in
FaSSGF. The experiment was accomplished in duplicate;
the mean and % CV are reported.

| | Letrozole | | Drug-loaded BPBPA-Ca | |
|---|---|---|---|---|
| Time (h) | Mean | % CV | Mean | % CV |
| 1 | 65 | 4 | 8 | 3 |
| 3 | 72 | 2 | 14 | 5 |
| 6 | 75 | 4 | 18 | 4 |
| 24 | 93 | 3 | 22 | 3 |
| 48 | 94 | 2 | 22 | 4 |
| 72 | 94 | 3 | 22 | 5 |

### 8. Cytotoxicity Assays for Unloaded and Drug-Loaded Nano-Ca@BPBPA

Cell culture methods. MCF-7 and MDA-MB-231 were incubated employing DMEM media at 37° C. in 5% CO₂. The hFOB 1.19 cell lines were incubated using DMEM: F12 at 34° C. in 5% CO₂. Cell lines were supplemented using 10% FBS and 1% Pen-Strep. The media was exchanged twice per week. Cell passages were carried out at 80% confluency.

Seeding. Cell lines were seeded in 96 well plates at a density of 5×10′ cells/mL; cells were incubated for 24 h before each treatment.

Treatment. Cell lines were treated with 100 μL of BPBPA (0-400 μM), LET (0-200 μM), unloaded and loaded nano-Ca@BPBPA (0.5-50 μM). Control groups were treated with media (DMEM or DMEM: F12) supplemented with 1% Pen-Strep. All cell-based assays were performed after 24, 48, and 72 h of treatment and in triplicate.

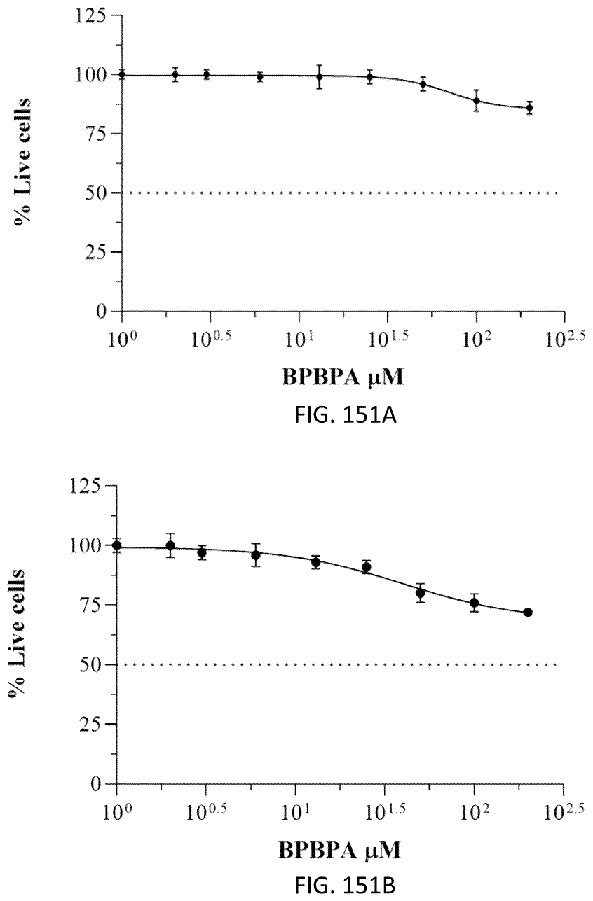

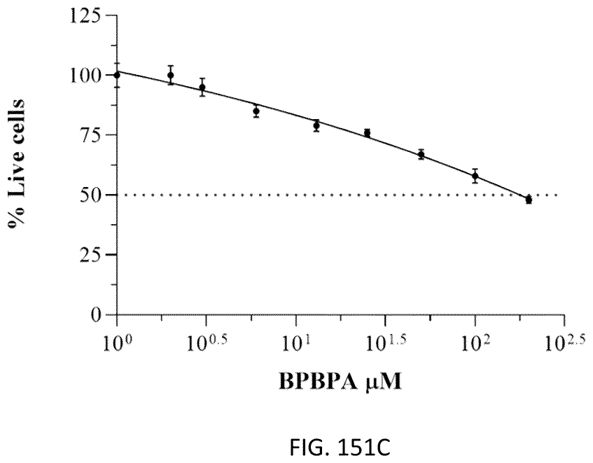

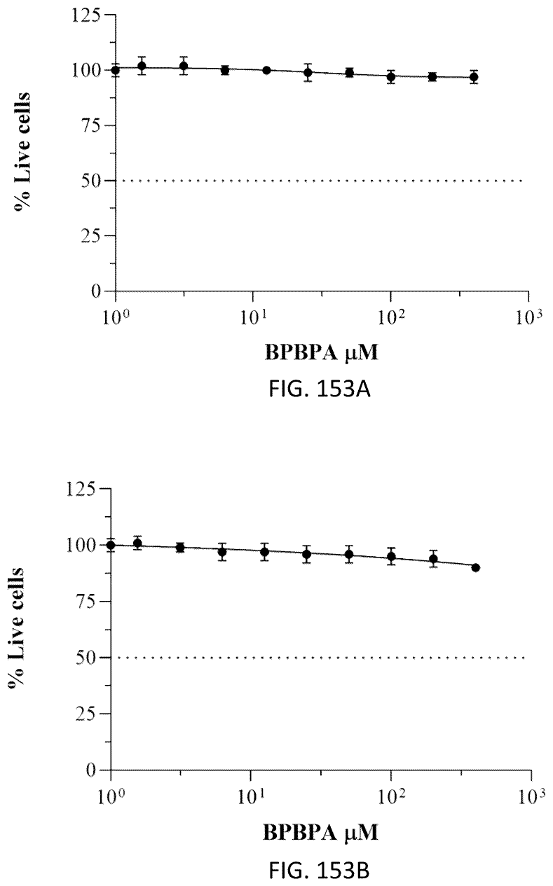

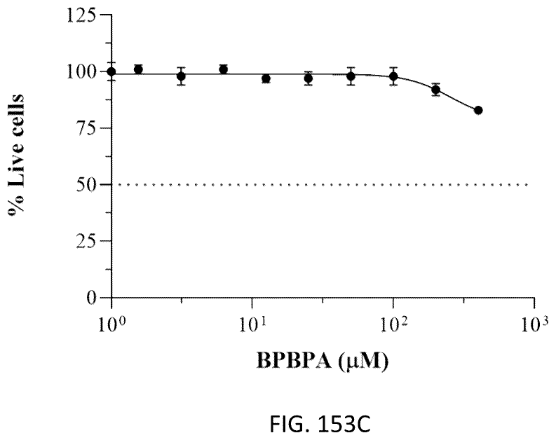

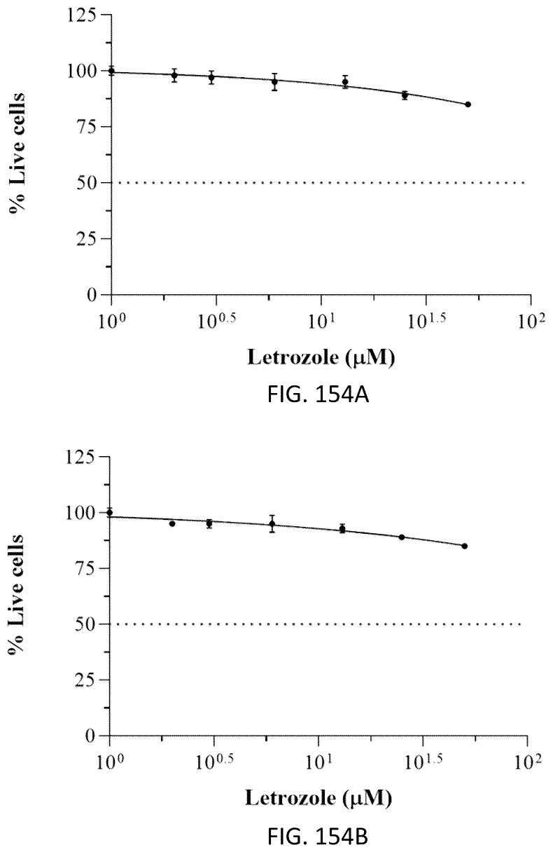

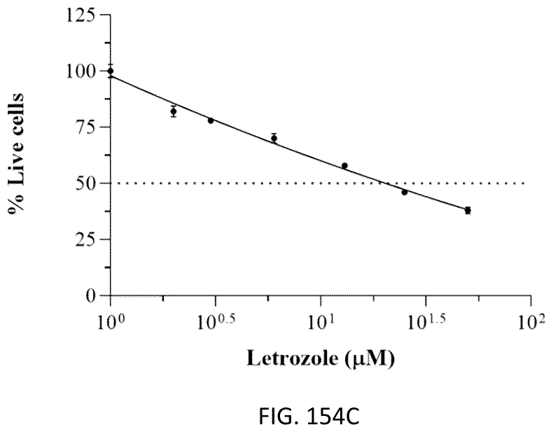

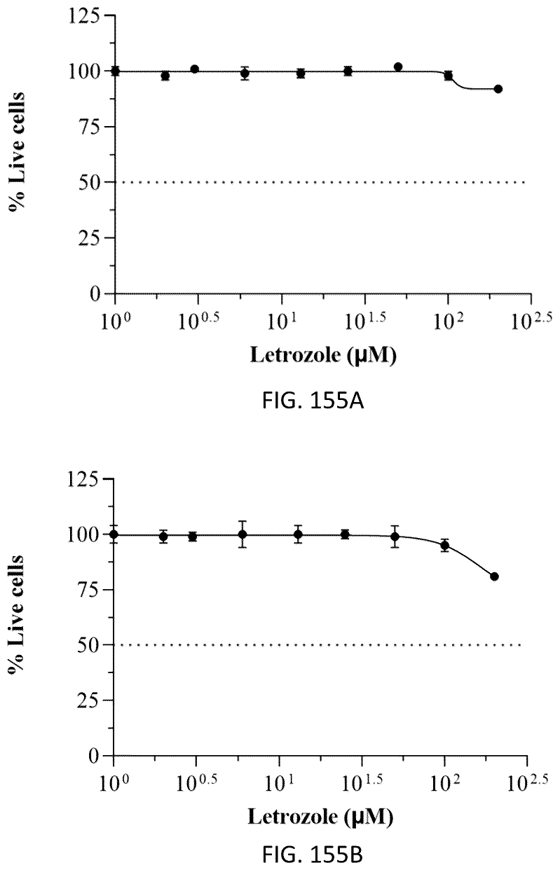

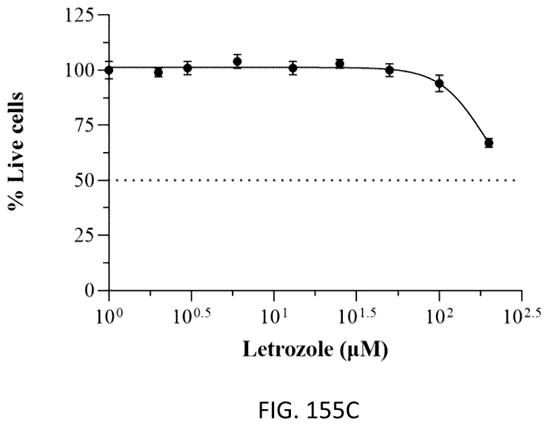

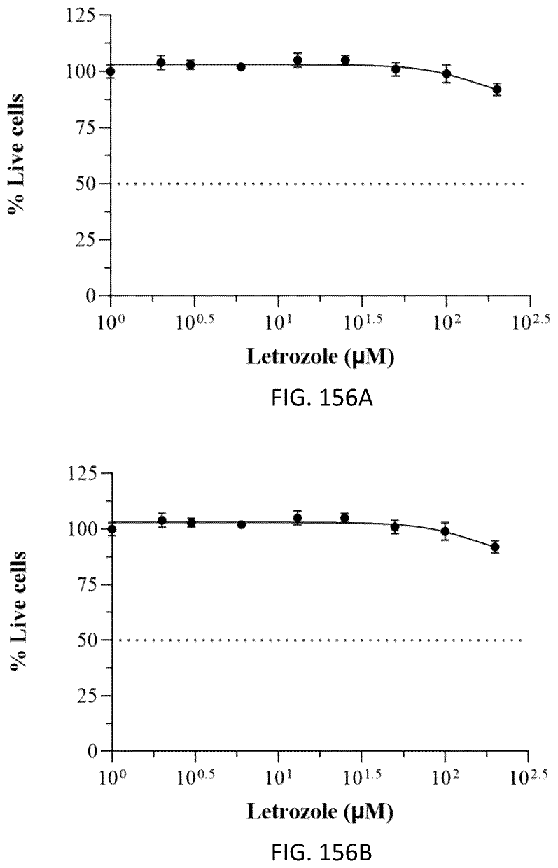

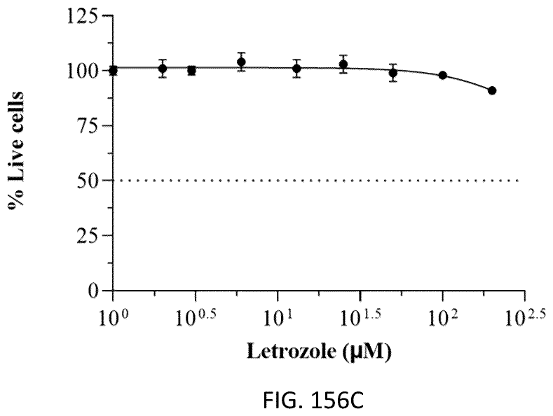

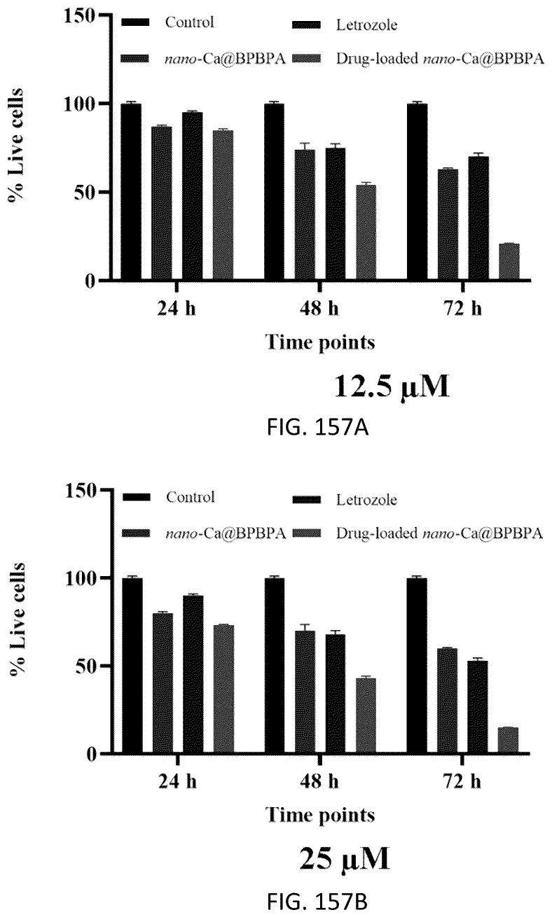

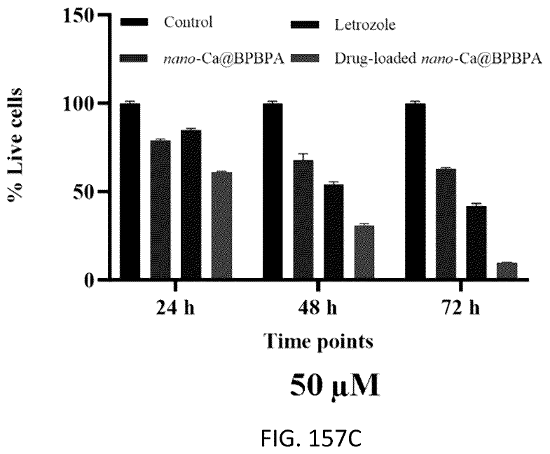

AlamarBlue@assay. To determine the cell viability, the media was removed and replaced with 100 μL of 10% AlamarBlue® solution. The 96 well plates were incubated for 4 h before measurements. Then, the fluorescence was assessed at 560 nm of excitation and λₘₐₓ 590 nm of emission. The IC₅₀ curves for MCF-7, MDA-MB-231, and hFOB 1.19 cell lines treated with BPBPA and LET are presented in FIGS. 151-156.

2,2′-bipyridine-5,5′-bisphosphonic acid (2,2′-BPBPA) as ligand

### Overview

The bisphosphonate analogue of 2,2′-bipyridine-5,5′-dicarboxylic acid (2,2′-BPDC) was employed to design extended bisphosphonate-based coordination complexes (BPCCs). The hydrothermal reaction of 2,2′-bipyridine-5,5′-bisphosphonic acid (2,2′-BPBPA) with bioactive (Ca²⁺, Zn²⁺, and Mg²⁺) metals allow the formation of three crystalline structures, namely; 2,2′-BPBPA-Ca, 2,2′-BPBPA-Zn, and 2,2′-BPBPA-Mg. Specifically, for 2,2′-BPBPA-Ca, channels adequate for drug loading (8×14 Å) were observed. Moreover, dissolution curves of these BPCCs in phosphate-buffered saline (PBS, pH=7.4) reveal that these complexes did not degrade in neutral conditions. While in fasted-state simulated gastric fluids (FaSSGF, pH=1.6), between 60 to 90% of 2,2′-BPBPA release was reached. These findings indicate a pH-dependent degradation for the 2,2′-BPBPA-based BPCCs. In addition, the PIT-nano-emulsion method was used to effectively decrease the particle size distribution of 2,2′-BPBPA-Ca to the nanoscale (-288 d. nm) range, obtaining the nano-Ca@2,2′-BPBPA. The affinity assay to hydroxyapatite (HA) demonstrates a higher binding of nano-Ca@2,2′-BPBPA (˜21%) to this mineral when compared with ZOLE (˜15%, commercial BP) after 24 h. Furthermore, about −20% of the antineoplastic drug letrozole (LET) was encapsulated into the 2,2′-BPBPA-Ca and nano-Ca@2,2′-BPBPA frameworks, then LET was completed released (˜20%) in FaSSGF. These results suggest that these BPCCs can successfully be encapsulated and then released their cargo in a pH-dependent manner. Collectively, these findings point towards the suitable characteristics offered by extended nano-BPCCs; in terms of stability, pH-dependent degradation, drug-loading capacity, drug-release ability, and cytotoxicity. These characteristics might enable the possible use of these materials as drug delivery systems (DDSs) to treat breast cancer-induced osteolytic metastases (OM).

### Materials

The 2,2′-bipyridine-5,5′-dicarboxylic acid (2,2′-BPDC, C₁₂O₄H₈N₂, 97% pure) was obtained from Sigma Aldrich (Milwaukee, WI). Tris(trimethylsilyl) phosphite ((CH₃)₃SiO]3P, 92% pure) was acquired from Fisher Scientific (Hampton, NH). Calcium nitrate tetrahydrate (Ca(NO₃)₂·4H₂O, 99% pure), zinc nitrate hexahydrate (Zn(NO₃)₂·6H₂O, 98% pure), magnesium nitrate hexahydrate (Mg(NO₃)₂·6H₂O, 99% pure), hydrochloric acid (HCl, 37% wt.), sodium hydroxide (NaOH, >98% pure), penicillin-streptomycin (Pen-Strep) and fetal bovine serum (FBS) were bought from Sigma-Aldrich (St. Louis, MO). Hydroxyapatite (Ca₅(OH)(PO₄)₃, synthetic powder), phosphate-buffered saline (PBS, tablets), and Dulbecco's Modified Eagle's Medium (DMEM) were purchased from Sigma-Aldrich (Milwaukee, WI). The 1:1 mixture of Ham's F-12 Medium/Dulbecco's Modified Eagle's Medium (1:1 DMEM: F-12) was purchased from Bioanalytical Instruments (San Juan, PR). Human breast cancer (MCF-7, MDA-MB-231) and normal osteoblast-like hFOB 1.19 cell lines were acquired from ATCC (Manassas, VA).

### Synthesis of 2,2′-BPBPA

The Lecouvey reaction was employed to obtain 2,2′-BPBPA.¹ The 2,2′-bipyridine-5,5′-dicarboxylic acid was employed as starting material to synthesize the 2,2′-bipyridine-5,5′-dicarbonyl dichloride (2,2′-BPDCl). Subsequently, -1.0 g of the corresponding acyl chloride (2,2′-BPDCl) was added to 7.0 mL of tris(trimethylsilyl) phosphite (TMSP). The TMSP was cool down at O° C. before adding the acyl chloride. Once the acyl chroide was added to the TMSP, the reaction was left undisturbed to reach room temperature. Then,the reaction was left for 3 d at 50° C. to allow the formation of an ester intermediate. The excess solvent was removed by rotoevaporation, and methanol was employed to hydrolyze the ester intermediate, obtaining 2,2′-BPBPA as a product. The product was characterized through nuclear magnetic resonance (NMR), Raman spectroscopy, powder X-ray diffraction (PXRD), thermogravimetric analysis (TGA), and differential scanning calorimetry (DSC) to confirm the structure and properties of 2,2′-BPBPA.

### Solid-State Characterization of 2,2′-BPBPA

Nuclear magnetic resonance (NMR)for BPBPA. ¹H NMR, ¹³C-APT NMR, and “P NMR were collected utilizing a Bruker Ascend Aeon 700 MHz NMR supplied with a multilinear, variable temperature, and cross-polarization magnetic angle spinning. The ¹H, ¹³C-APT, and “P NMR of 2,2′-BPBPA were recorded employing deuterium oxide (D₂O) as a solvent. The experiments were performed at room temperature. The Bruker TopSpin NMR software vs. 3.5 was employed to collect and analyzed the data.

Raman vibrational spectroscopy for BPBPA. A Thermo Scientific DXR Raman microscope was used to collect the Raman spectra of 2,2′-BPBPA. The instrument was supplied with a 532 nm laser. The spectra was collected from 250 to 3,250 cm⁻¹, employing a 50 μm slit, 400 lines/mm grating, and 32 scans for 5 s. The Raman data was collected and analyzed using the OMNIC for Dispersive Raman Software version 9.2.0.

Powder X-ray diffraction (PXRD) for BPBPA. A Rigaku XtaLAB SuperNova X-ray diffractometer was employed to collect the PXRD diffractogram for 2,2′-BPBPA. The instrument was supplied with a HyPix3000 X-ray detector, a micro-focus Cu-Kα radiation (λ=1.5417 Å) source, and an Oxford Cryosystem Cryostream 800 cooler. The diffractogram of 2,2′-BPBPA was recorded from 6-600 (20) in transmission mode at 50 kV and 1 mA. The experiment was carried out in fast Phi mode (90 s) at 300 K. A small amount of 2,2′-PBBPA was mounted on MiTeGen micro-loops using paratone oil. The CrysAlis^{PRO} software version 1.171.3920a was employed to collect and analyze the PXRD data.

Thermogravimetric analysis (TGA) for BPBPA. A TGA Q500 (TA Instruments Inc.) was utilized to collect the TGA thermograph of 2,2′-BPBPA. The experiment was performed between 25-700° C., under N₂ (60 mL/min) at 5° C./min. About 2-5 mg of 2,2′-BPBPA were weighed to perform thermal analysis. The TA Universal Analysis software v 4.5 Å was used to collect and analyze the TGA data.

Differential scanning calorimetric (DSC)for BPBPA. A DSC Q2000 outfitted with a 50-position autosampler and a refrigerated cooling system (RCS40) was used to determine the melting point of 2,2′-BPBPA. The instrument was calibrated employing an indium standard (Tm =156.6° C. and ΔH_{f}=28.54 J/g). The experiment was performed at a temperature from 25 to 390° C. under an N₂ atmosphere (50 mL/min) at 5° C./min. About 1-2 mg of 2,2′-BPBPA were hermetically sealed in aluminum pans to collect the DSC thermograph of this compound. The TA Universal Analysis software v 4.5 Å was used to analyze the DSC data collected.

### Synthesis of 2,2′-BPBPA-based BPCCs

The 2,2′-BPBPA-based BPCCs (2,2′-BPBPA-Ca, 2,2′-BPBPA-Zn, and 2,2′-BPBPA-Mg) were prepared by the hydrothermal method, using ˜10 mg of 2,2′-BPBPA dissolved in 10 mL of nano pure water. Separately, the metal salt solutions (Ca²⁺, Zn₂, and Mg²⁺) were prepared by dissolving 6.5 mg of Ca(NO₃)₂·4H₂O, 11.6 mg of Zn(NO₃)₂·4H₂O, and 20.6 mg of Mg(NO₃)₂·4H₂O in 10 mL nano pure water and transferred to individual 20 mL vials. The metal salt solutions (5 mL) were carefully added to 5 mL of 2,2′-BPBPA solution and kept at 80° C. (2,2′BPBPA-Ca), 85° C. (2,2′-BPBPA-Zn), and 180° C. (2,2′-BPBPA-Mg) for 1 to 8d. Once the 2,2′-BPBPA-based BPCCs precipitate was formed, the vials were allowed to cool to room temperature, and solids were collected by vacuum filtration.

### Solid-State Characterization of 2,2′-BPBPA-Based BPCCs

Raman Vibrational Spectroscopy and Powder X-ray diffraction (PXRD)for BPBPA-based BPCCs. The Raman spectra and the PXRD diffractograms of 2,2′-BPBPA-Ca, 2,2′-BPBPA-Zn, and 2,2′-BPBPA-Mg were collected as described for 2,2′-BPBPA (Section 3).

Single-crystal X-ray diffraction for BPBPA-based BPCCs. The quality of single crystals of 2,2′-BPBPA-Ca, 2,2′-BPBPA-Zn, and 2,2′-BPBPA-Mg was evaluated by a polarized microscope Nikon Eclipse Microscope LV100NPOL, with a Nikon DS-Fi2 camera. Crystal samples of these 2,2′-BPBPA-based BPCCs (10-15 mg) were sent to the NSF's ChemMatCARS, Sector 15 of the Advanced Photon Source, Argonne National Laboratory. Single-crystals synchrotron measurements of 2,2′-BPBPA-Ca and 2,2′-BPBPA-Mg were collected using a Huber 3-circle diffractometer (Huber diffraction, Lancaster, CA, USA) equipped with a Pilatus3X 2M detector (Dectris USA Inc., Philadelphia, PA, USA). In addition, appropriate single crystals of 2,2′-BPBPA-Zn were mounted in MiTeGen micro-loops for structure elucidation. The SC-XRD experiments for 2,2′-BPBPA-Zn were performed using a Rigaku XtalLAB SuperNova single micro-focus Cu-Kα radiation (λ=1.5417 Å) source, equipped with an Oxford Cryosystems Cryostream 800 and a HyPix3000 X-ray detector. The data was collected utilizing the CrysAlis^{PRO} software vs 1.171.39.45c. All structures were solved by applying full-matrix least-squares (F² mode) and direct methods in Olex2 software vs. 1.2.

Thermogravimetric analysis (TGA) for BPBPA-based BPCCs. A TGA Q500 (TA Instruments Inc.) was employed to collect the TGA thermographs of 2,2′-BPBPA-Ca, 2,2′-BPBPA-Zn, and 2,2′-BPBPA-Mg. The data collection was performed as described for 2,2′-BPBPA (Section 3).

Scanning electron microscopy-energy dispersive spectroscopy (SEM-EDS) for BPBPA-based BPCCs. The SEM micrographs and X-ray elemental analysis of 2,2′-BPBPA-Ca, 2,2′-BPBPA-Zn, and 2,2′-BPBPA-Mg were collected employing a JEOL JSM-6480LV scanning electron microscope. The instrument was equipped with an Everhart Thomley secondary electron imaging (SEI) and energy dispersive X-ray analysis (EDAX) Genesis 2000 detectors. The SEM micrographs of these materials were collected using an acceleration voltage of 20 kV, a spot size of 36, and an electron beam of 11 mm width in a high vacuum mode.

Dissolution profiles of BPBPA-based BPCCs

Calibration curve. A stock solution of 0.1 mg/mL of 2,2′-BPBPA was prepared in PBS and FaSSGF. Subsequently, 2-fold serial dilutions were completed in concentrations of 0.050, 0.025, 0.02, 0.013, 0.0063, 0.0033, and 0.0016 mg/mL. The absorbance was measured by UV-Vis spectroscopy (200-400 nm) employing PBS or FaSSGF as a solvent blank. The maximum absorbance wavelength (λₘₐₓ) was detected at 299 (PBS) and 318 (FaSSGF) nm.

Dissolution experiment. In a 250 mL beaker was tranfer 100 mL of PBS or FaSSGF.

Subsequently, this solution was allowed to reach 37° C. at 150 rpm. Then, individually ˜10.0 mg of powdered 2,2′-BPBPA-based BPCCs were added to the PBS or FaSSGF solution. Aliquots (1 mL) were taken out at different time points (0, 1, 3, 6, 24, 48, and 72 h) and diluted with PBS or FaSSGF in 5 mL volumetric flasks. An aliquot (1 mL) was taken out before adding the 2,2′-BPBPA-based BPCCs to record the first time point (0 h). The dissolution experiments were performed in duplicate for each 2,2′-BPBPA-based BPCC. The absorbance of the 2,2′-BPBPA released from these materials was assessed at 299 (PBS) and 318 (FaSSGF) nm.

Phase inversion temperature (PIT) and PIT-nano-emulsion synthesis of nano-Ca@2,2′-BPBPA

Phase inversion temperature (PIT) determination. The phase inversion temperature (PIT) was determined for a micro-emulsion of 2,2′-BPBPA in heptane employing Brij L4® as a surfactant. This micro-emulsion was prepared by homogenizing 11.0 mL of 2,2′-BPBPA (2.5 mg/mL), 3.0 mL of heptane, and 0.9 mL of Brij L4@. Successively, the conductivity was measured while the previously micro-emulsion was heated from 2 to 40° C. at 1° C./min.

Synthesis of nano-Ca@2,2′-BPBPA. A Crystalline (Technobis, Crystallization Systems, Alkmaar, Netherlands) was employed to synthesize nano-Ca@2,2′BPBPA. About 3.5 mL of this micro-emulsion prepared for the PIT determination was added to 8 mL reaction vials, along with stir bars and capped with reflux caps. These reaction vials were cooled in the Crystalline system at 7° C. for 30 min. After this period, the temperature was increased to 60° C. for 30 min (1,250 rpm) to ensure the complete phase inversion of the 2,2′-BPBPA micro-emulsion. Then, the vials were heated to 80° C., and 3.5 mL of 1.1 mg/mL Ca(NO₃)₂·6H₂O was added. The reaction was left for 1 h at 80° C. to allow the formation of nano-Ca@2,2′BPBPA. Aliquots of the supernatant were measured employing dynamic light scattering (DLS) to assess the particle size distribution of the nano-Ca@2,2′-BPBPA. A detailed description of the DLS experiment can be found in the Supporting Information.

Affinity assays to HA

Calibration curve. The calibration curve of 2,2′-BPBPA in PBS prepared in Section 6 was utilized to assess the concentration of 2,2′-BPBPA during the binding assays.

Affinity assays experiment. Synthetic HA was employed to explore the affinity of nano-Ca@2,2′-BPBPA to the bone microenvironment. HA (20 mg) was exposed to nano-Ca@2,2′-BPBPA (5 mL, 0.5 mg/mL). The 2,2′-BPBPA (0.5 mg/mL) and HA (20 mg) were used as control groups. All experimental and control groups were left under constant stirring (150 rpm) for 0-12 d. Finally, the supernatant was collected, centrifuged (5 min, 1500 rpm), and the absorbance was measured at λₘₐₓ=299 nm of maximum absorption (1, 2, 3, 4, 7, 8, 9, 10, 11, 12 d) to determine the amount (%) of 2,2′-BPBPA bound to HA after each period. The experiment was performed in duplicate. Once the experiment was completed, HA, HA-2,2′-BPBPA, and HA-nano-Ca@2,2′-BPBPA were characterized by SEM-EDS and PXRD.

Drug loading/release of letrozole

Drug loading of letrozole (LET) into 2,2′-BPBPA-Ca. LET was loaded into 2,2′-BPBPA-Ca in a 1.5-mL vial by transferring ˜20 mg of 2,2′-BPBPA-Ca, ˜7 mg of LET, and 1.0 mL of ethanol. This suspension was left at 50° C. for 24 h. Successively, −7 mg of LET were added to the vial to allow the complete loading of LET into the 2,2′-BPBPA-Ca. The 2,2′-BPBPA-Ca (20 mg) and LET (7 mg) in ethanol (1 mL), respectively, were employed as control groups in separate vials. Finally, the supernatant was collected, filtrated, and the absorbance was measured at the λₘₐₓ of 299 nm.

Drug loading of LET into nano-Ca@2,2′-BPBPA. The synthesis of the nano-Ca@2,2′-BPBPA was performed as described in Section 7. The PIT-nanoemulsion method was employed to facilitate the loading of LET into the nano-Ca@2,2′-BPBPA Subsequently, about 2.5 mL of LET at a concentration of 0.30 mg/mL was added to 2.5 mL of the synthesized nano-Ca@2,2′-BPBPA. This mixture was left under stirring for 1 h to load LET into the nano-Ca@2,2′-BPBPA.

LET release curve from 2,2′-BPBPA-Ca. The release curve of LET from 2,2′-BPBPA-Ca was assessed in FaSSGF. A calibration curve for LET in FaSSGF was previously prepared; the lambda max (λₘₐₓ) was detected at 238 nm (Supporting Information). About 100 mL of FaSSGF were placed in a 250-mL beaker and left in constant stirring at 37° C. (150 rpm).

Subsequently, −20 mg of powdered drug-loaded 2,2′-BPBPA-Ca (experimental) were placed into the FaSSGF solution. After each time point (0, 1, 3, 6, 24, 48, and 72 h), an aliquot (1 mL) was taken out and diluted in a 5 mL volumetric flask. An aliquot was taken out before adding the drug-loaded material to record the first time point (0 h). Then, the absorbance was measured at 238 nm to determine the amount (%) of LET release from the 2,2′-BPBPA-Ca.

Cytotoxicity assays

Cell culture methods. MCF-7 and MDA-MB-231 were incubated using DMEM at 37° C. in 5% CO₂. The hFOB 1.19 cell lines were incubated with DMEM: F12 at 34° C. in 5% CO₂.

Cell lines were supplemented using 10% FBS and 1% Pen-Strep. The media was replaced twice per week. Cell passages were carried out at 80% confluency.

Cell-based assays. Cell lines were seeded in 96 well plates at a density of 5x 103 cells/mL and incubated for 24 h before treatment. Cells were treated with 100 μL of 2,2′-BPBPA (0-400 μM), unloaded and loaded nano-Ca@2,2′-BPBPA (6.3-50 μM) for 24, 48, and 72 h.

Control groups were treated with media (DMEM or DMEM: F12) supplemented with 1% Pen-Strep. Cell viability was determined by employing AlamarBLue@. The media was replaced with 100 μL of 10% AlamarBlue® solution. After 24 h of incubation, the fluorescence was assessed at )max of 560 nm for excitation and 590 nm for emission.

### Results and Discussion

Synthesis and solid-state characterization of 2,2′-BPBPA

The BP analogue (2,2′-BPBPA) of 2,2′-bipyridine-5,5′-dicarboxylic acid (2,2′-BPDCA) was synthesized employing the Lecouvey reaction. First, the starting material, 2,2′-BPDCA, was converted to the acyl chloride (2,2′-BPDCl) required to carry out the Lecouvey reaction (FIG. 2A). Then, the 2,2′-BPDCl was left under constant stirring in tris(trimethylsilyl) phosphite, followed by hydrolysis with methanol to yield the 2,2′-BPBPA (80.0%, FIG. 2B). The synthesis of 2,2′-BPBPA using the Lecouvey reaction was reported previously in the literature.¹ The product was characterized by TGA, DSC, ¹H NMR, ¹³C NMR, and Raman spectroscopy. The results confirmed the presence and purity of the synthesized 2,2′-BPBPA within this work

### (Supporting Information).

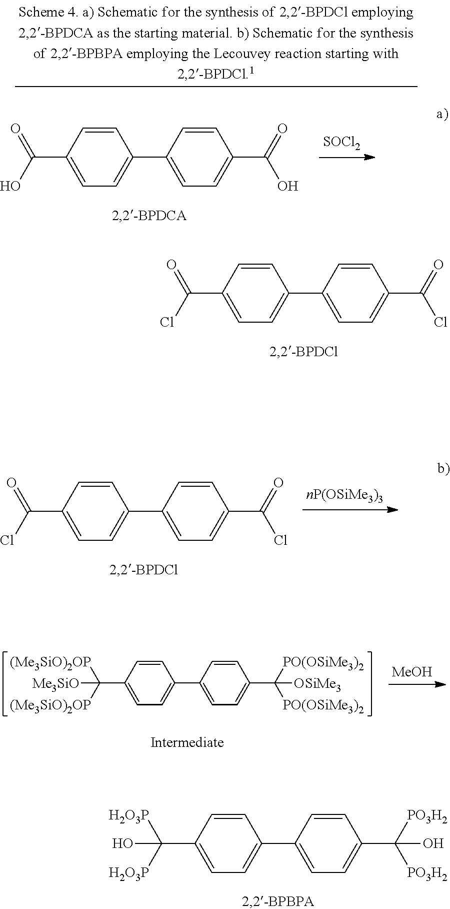

Synthesis and solid-state characterization of 2,2′-BPBPA-based BPCCs PGP₆3,c3

The 2,2′-BPBPA have been previously employed as an organic ligand to obtain 2,2′-BPBPA-based MOFs with cooper; these materials were explored as catalysts for the electrochemical reduction of carbon dioxide.¹ However, bioactive metals such as Ca²⁺, Zn²⁺, and Mg²⁺ have not been previously considered to obtain 2,2′-BPBPA-based BPCCs. Information about the solid-state characterization (TGA, DSC, SEM-EDS, or Raman spectroscopy), BET surface areas, and drug-loading capacity of these 2,2′-BPBPA-based MOFs have not been reported in the literature. This work involves the hydrothermal synthesis of 2,2′-BPBPA-based BPCCs (2,2′-BPBPA-Ca, 2,2′-BPBPA-Zn, and 2,2′-BPBPA-Mg) employing a 1:1 M²⁺/2,2′-BPBPA molar ratio, neutral pH of 7.0, at a temperature range between 80 andl80° C. The solid-state characterization, structure, binding affinity, loading capacity, and cytotoxicity of these materials were assessed to determine their capacity as viable drug delivery systems with high bone affinity.

Scanning electron microscopy-energy dispersive X-ray spectroscopy (SEM-EDS) of 2,2′-BPBPA-based BPCCs

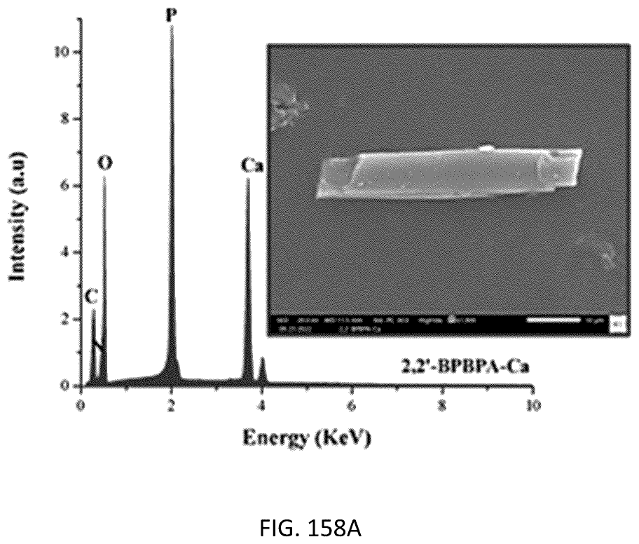

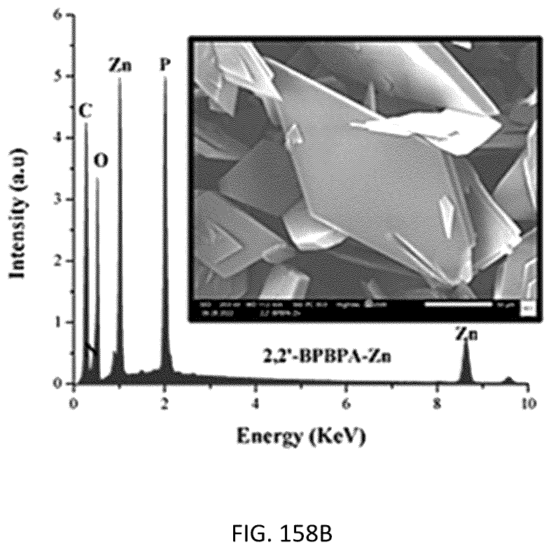

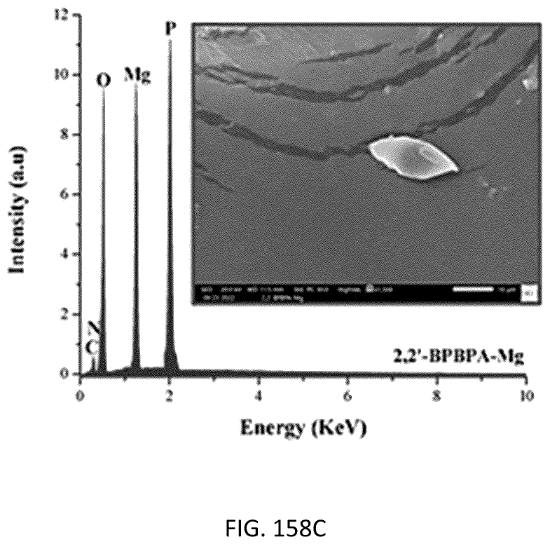

SEM-EDS analysis was performed to assess the morphology and elemental composition of 2,2′-BPBPA-Ca, 2,2′-BPBPA-Zn, and 2,2′-BPBPA-Mg. The SEM micrographs of these 2,2′BPBPA-based BPCCs demonstrate well-defined prism morphologies (FIGS. 158A-158C). In addition, it was observed that the diameter of these materials varied from 5 to 100 μm.

The EDS elemental analysis reveals the detection of the metal (Ca²⁺, Zn²⁺, and Mg²⁺) and elements corresponding to the 2,2-BPBPA chemical structure (carbon, oxygen, phosphorous, and nitrogen).

These results provide evidence of the formation of each 2,2′-BPBPA-based BPCC through the specific hydrothermal synthesis conditions employed (FIGS. 158A-158C).

Powder X-ray diffraction analysis of 2,2′-BPBPA-based BPCCs

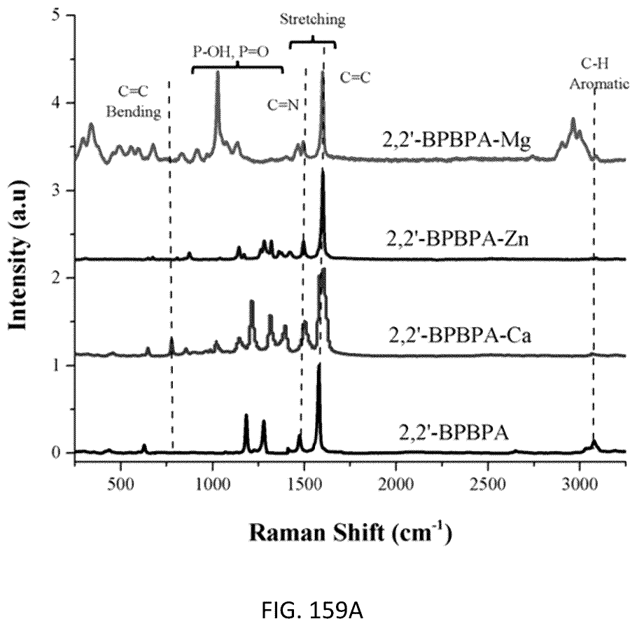

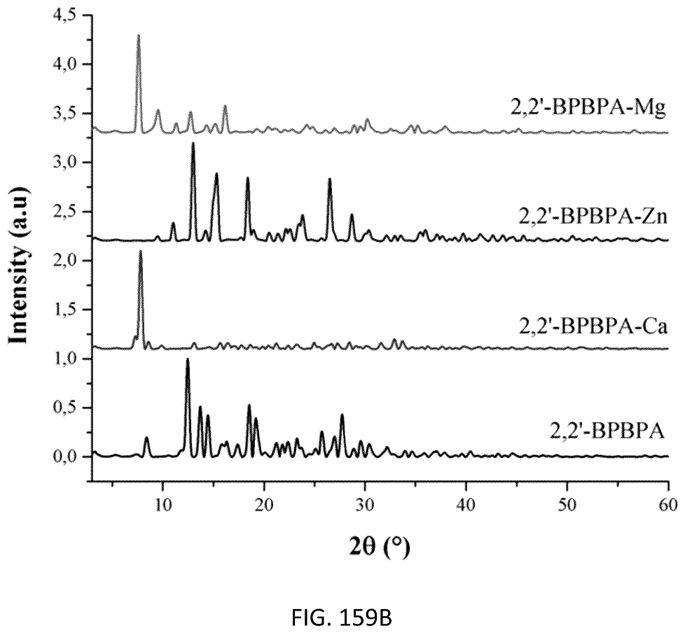

The PXRD diffraction analysis for the 2,2′-BPBPA-based BPCCs demonstrates a high degree of crystallinity with a small amorphous background for 2,2′-BPBPA-Ca, 2,2′-BPBPA-Zn, and 2,2′-BPBPA-Mg (FIG. 159B). It was observed that the ligand and the coordination complexes exhibit unique crystal phases, presenting characteristic reflections on each one. Additionally, the PXRD diffractograms for all 2,2′-BPBPA-based BPCCs did not display reflections corresponding to the ligand or the metal salts employed in the hydrothermal synthesis. These results discarded the possible recrystallization of the 2,2′-BPBPA and the metal salts.

Single crystal X-ray diffraction analysis of 2,2′-BPBPA-based BPCCs

The single-crystal structures of 2,2′-BPBPA-Ca and 2,2′-BPBPA-Mg were elucidated by synchrotron measurement at NSF's ChemMatCARS, while the 2,2′-BPBPA-Zn crystal structure was elucidated by SC-XRD. All crystalline phases were solved using direct methods applying full-matrix least-squares mode in Olex2 (Table 1). Asymmetric units and packing along with the a, b, and c-axis for these 2,2′-BPBPA-based BPCCs can be found in the Supporting Information. In addition, the experimental PXRDs of these BPCCs were contrasted with the simulated PXRDs obtained from the solved crystal structures (Supporting Information).

Results demonstrate equal reflection for PXRD diffractograms (experimental) when compared with the simulated PXRD in each BPCC, indicating that representative solutions were determined for these crystalline materials. Specifically, for the 2,2′-BPBPA-Ca crystal packing were observed channels (8×14 Å) that might potentiate this material as a viable DDS by investigating its drug-loading and release capacity of antineoplastic drugs such as letrozole into its channels.

TABLE 27
Summary of the crystallographic parameters of
the structure refinements for 2,2′-BPBPA-Ca

| Compound | 2,2′-BPBPA-Ca |
|---|---|
| Empirical formula | |
| FW (g/mol) | |
| Space group | P1̅ |
| Temperature (K) | 100 |
| λ (Å) | |
| a (Å) | 10.9848(6) |
| b (Å) | 11.5911(6) |
| c (Å) | 12.9535(7) |
| α (°) | 90.3380(10) |
| β (°) | 103.8540(10) |
| γ (°) | 104.6930(10) |
| V (Å³) | 1545.07 |
| Z | 2 |
| ρ_{calc} (g/cm³) | |
| R_{wp} | |
| Rₚ | |

Dissolution curve of 2,2′-BPBPA-based BPCCs

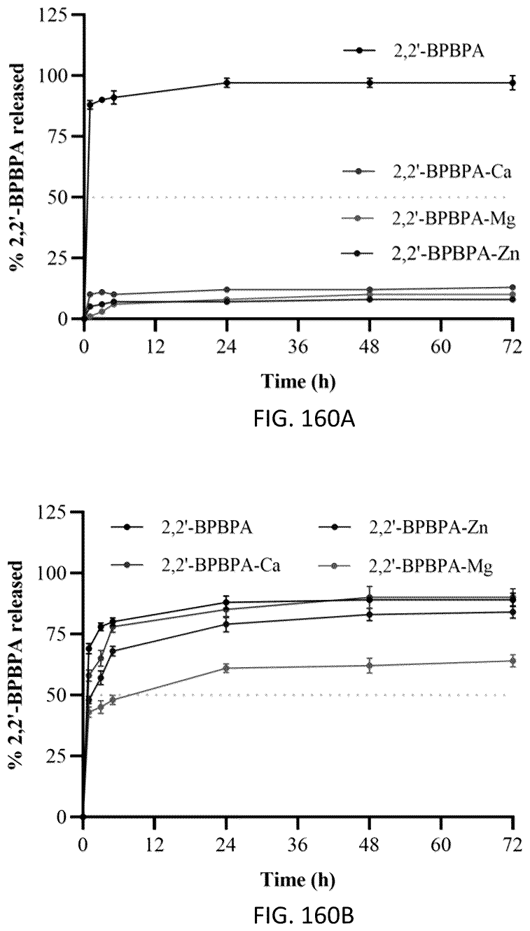

The release of 2,2′-BPBPA from the coordination complexes was assessed in physiological conditions (PBS, pH=7.40 and FaSSGF, pH=1.60). The absorbance of the supernatant was measured at the lambda of maximum absorption to determine the quantity of 2,2′-BPBPA release over time in PBS (λₘₐₓ=299 nm) and FaSSGF (λₘₐₓ=318 nm) at 37° C. It was observed that the 2,2′-BPBPA-based BPCCs release from 8 to 13% of 2,2′-BPBPA in neutral conditions (FIG. 160A). These findings reveal that these materials do not collapse significantly in PBS, retaining their crystalline structures in this neutral environment. In acidic conditions, these 2,2′-BPBPA-based BPCCs release from 64 to 90% of 2,2′-BPBPA. The 2,2′-BPBPA-Ca (90%) and 2,2′-BPBPA-Zn (84%) presented the highest release of the ligand contrasted with 2,2′-BPBPA-Mg (64%) in FaSSGF (FIG. 160B). In particular, the 2,2′-BPBPA-Ca collapsed almost completely, indicating the possible ability of this material to degrade once in the acid environment of metastatic cancerous cells and be able to release potential cargo drugs.

Phase inversion temperature (PIT) and PIT-nano-emulsion synthesis of nano-Ca@2,2′-BPBPA

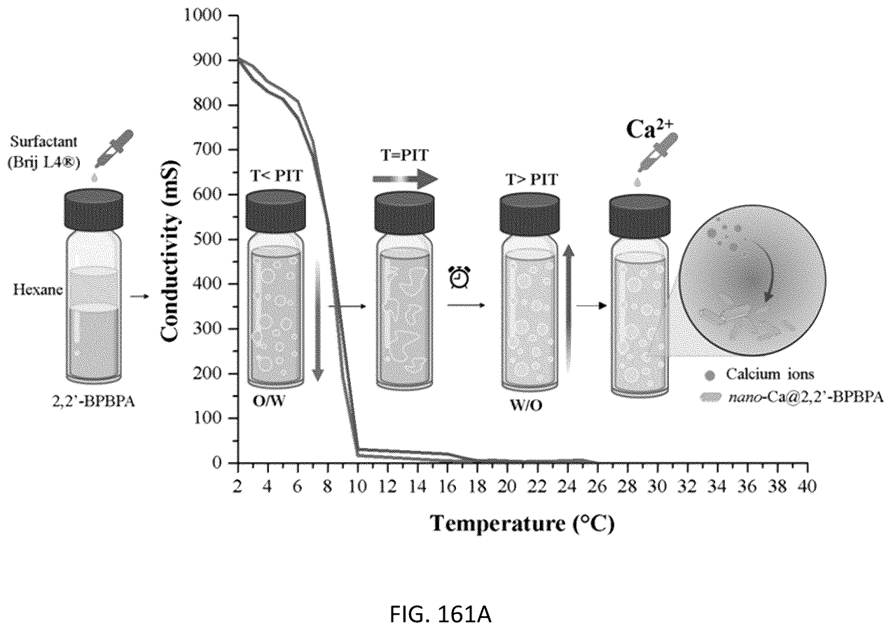

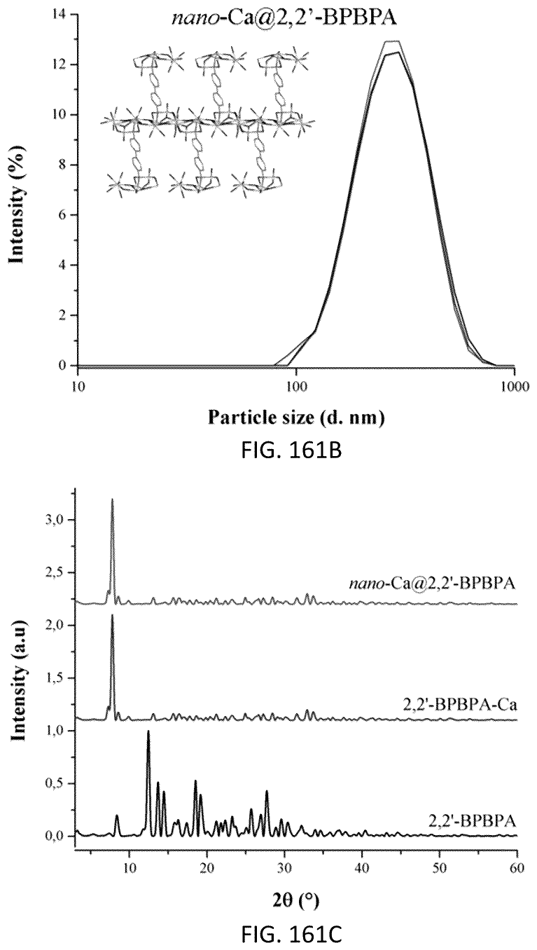

The 2,2′-BPBPA-Ca framework was selected for further analysis because of its thermal stability, ability to maintain its crystal phase in neutral pH while degraded in acidic pH, and the present channels (10×11 Å) that enable its use as a viable DDS. The PIT-nano-emulsion method was combined with the hydrothermal synthesis of 2,2′-BPBPA-Ca to decrease the particle size of this material to the nanoscale range,^{2,3} obtaining nano-Ca@2,2′-BPBPA. First, a water-in-oil (W/O) nano-emulsion is prepared through the PIT method. The 2,2′-BPBPA is entrapped in aqueous nanospheres, reducing the reaction space when the metal salt solution is added to the W/O nano-emulsion (FIG. 161A). The DLS results revealed particle size distribution values in the nanoscale range (˜288 d.nm) for the obtained nano-Ca@2,2′-BPBPA. The polydispersity indexes (PDI) varied from 0.434 to 0.498, demonstrating the monodispersity of the acquired nanomaterial (FIG. 161B). In addition, an agglomerate of nano-Ca@2,2′-BPBPA was employed to assess the PXRD diffractograms of this nanomaterial. It was demonstrated that the nano-Ca@2,2′-BPBPA synthesized by the PIT-nano-emulsion method was isostructural to 2,2′-BPBPA-Ca (FIG. 161C).

These results indicate that the PIT-nano-emulsion method coupled with the hydrothermal conditions led to the particle size reduction of 2,2′-BPBPA (microscale, ˜100 μm) to the nano-Ca@2,2′-BPBPA (nanoscale, -288 d.nm).

Furthermore, aggregation measurements for the nano-Ca@2,2′-BPBPA were conducted under biologically relevant conditions after 0, 24, and 48 h in 10% FBS:PBS. This analysis is required to find insights into the ability of nano-Ca@2,2′-BPBPA to maintain its particle size distribution (<500 nm) in this serum-like dispersant. The DLS results demonstrate that the previously synthesized nanomaterial, after O(257 d. nm), 24 (266 d. nm), and 48 (290 d. nm) h, retains a homogeneous particle size distribution in 10% FBS:PBS. Additionally, nano-Ca@2,2′-BPBPA particles were maintained monodispersed over time with PDI values of O (0.414), 24 (0.578), and 48 (0.344) h (Supporting Information). These findings suggest that this nanomaterial presents a low aggregation tendency in this biologically relevant condition.

Affinity assays for nano-Ca@2,2′-BPBPA

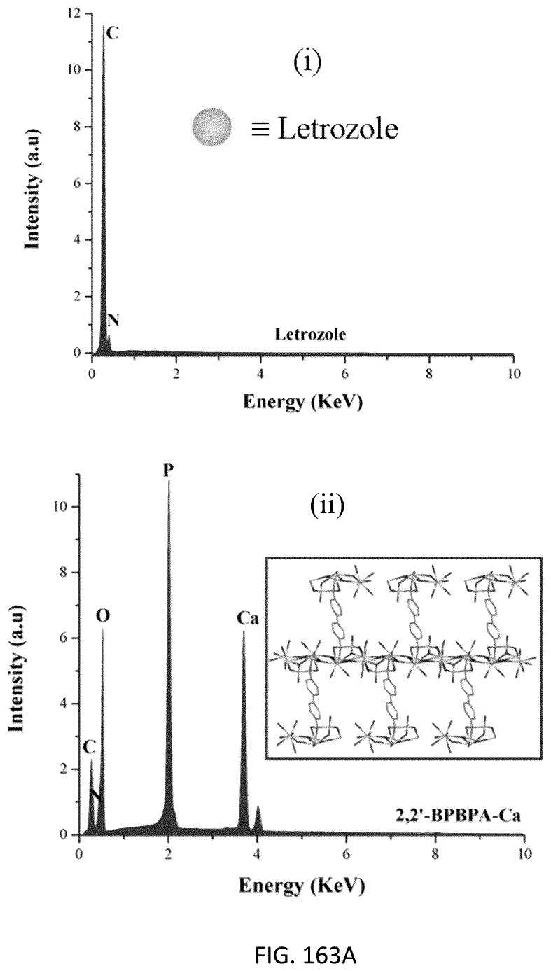

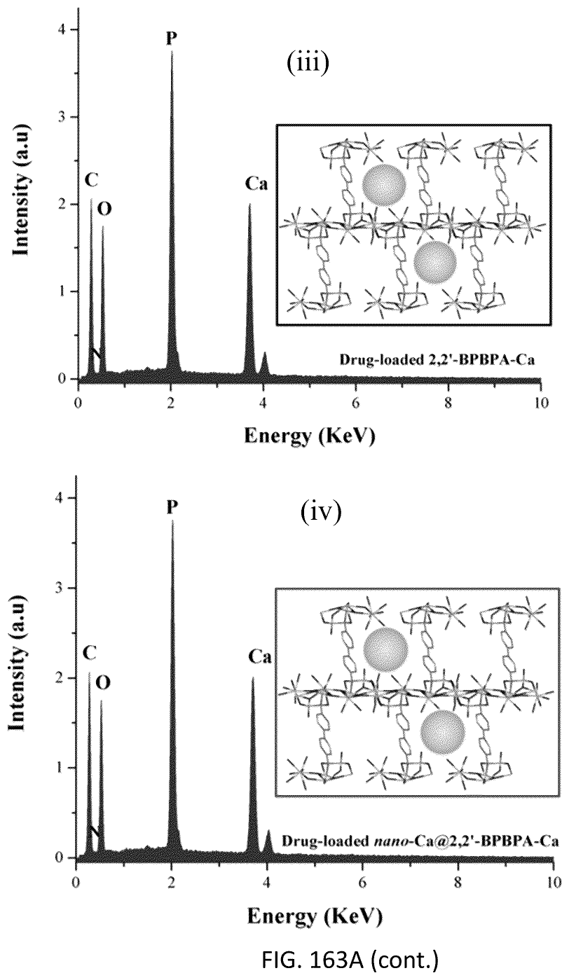

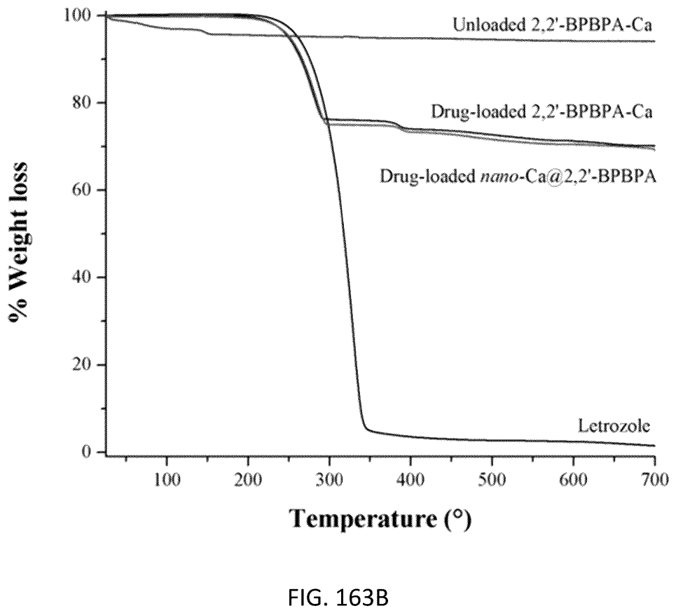

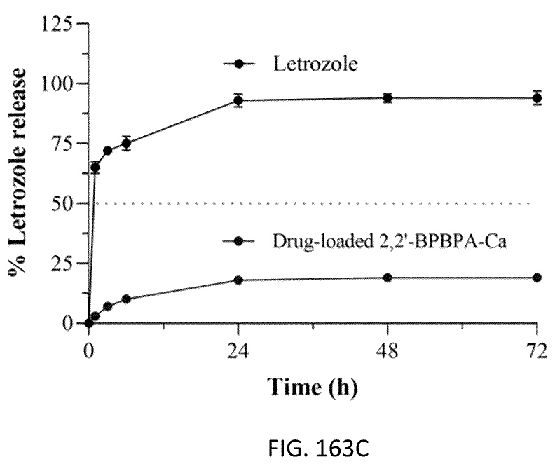

The affinity of nano-Ca@22′-BPBPA to the bone was investigated using hydroxyapatite (HA). The HA is the main constituent of the bone microenvironment; this mineral represents an ideal target when treating bone-related diseases.⁴⁵ The binding assay of the nano-Ca@2,2′-BPBPA to HA was performed in PBS at 37° C., the HA as a received reagent was exposed to this nano-BPCCs for 0-12 d. The binding assay for 2,2′-BPBPA to HA was determined as a control experiment. The affinity of these materials to HA was assessed by measuring the absorbance of the supernatant at the lambda max (λₘₐₓ=299 nm) to quantify the decrease in the 2,2′-BPBPA concentration over time. Binding curves (FIG. 163A) reveal that 2,2′-BPBPA and the nano-Ca@2,2′-BPBPA presented between 32 to 37% binding to HA after 2 d. The ligand reaches about 90% of binding to HA after 7 d while the nano-Ca@2,2′-BPBPA offers a 93% of binding to this mineral after 8 d. These results demonstrate that the nanomaterial can bind to HA in phisological conditions, suggesting that the uncoordinated BPs groups from the nano-Ca@2,2′-BPBPA surface might be responsible for its affinity to HA.

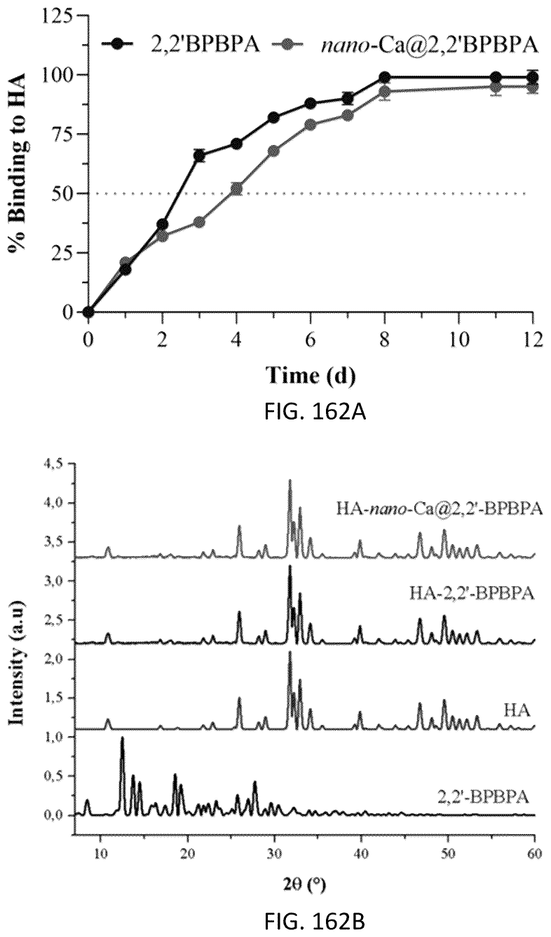

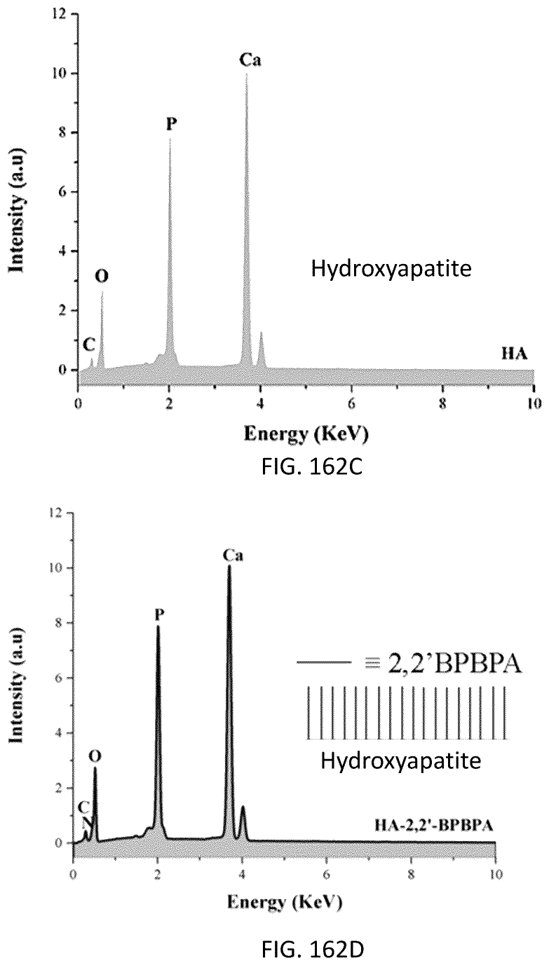

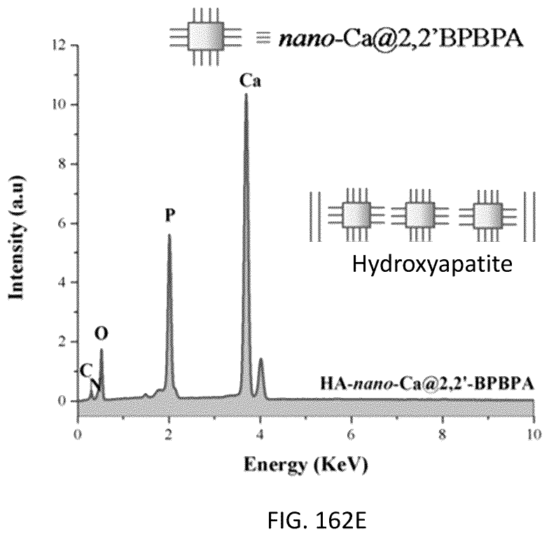

Furthermore, PXRD diffractograms for HA (control), HA-2,2′-BPBPA (experimental), and the HA-nano-Ca@2,2′-BPBPA (experimental) (FIG. 162B) presented similar reflections after the binding assay. These results indicate that the instrument might not identify (LOD <5 wt. %) enough quantity of signals corresponding to 2,2′-BPBPA or nano-Ca@2,2′-BPBPA in the control and experimental groups to support the recrystallization of the ligand or the nanomaterial on the HA surface. These results suggest that the binding of 2,2′-BPBPA and nano-Ca@2,2′-BPBPA did not alter the HA crystal phase.

TABLE 28
EDS elemental analysis of HA (control), HA-2,2′-BPBPA (control), and
nano-Ca@2,2′-BPBPA (control) after the binding assay.
The EDS analysis was collected at a 3000x magnification for all samples.

| | | | HA-nano- |
|---|---|---|---|
| Elements | HA^{a} | HA-2,2′BPBPA^{b} | Ca@2,2′BPBPA^{c} |
| Calcium | 48.49 | 39.89 | 40.00 |
| Nitrogen | — | 0.65 | 0.78 |
| Carbon | — | 3.14 | 5.49 |
| Oxygen | 36.30 | 37.75 | 36.88 |
| Phosphorous | 15.21 | 18.57 | 16.85 |

ªHA [Ca₅(OH)(PO₄)₃],
^{b}2,2′-BPBPA [C₁₂H₁₆O₁₄P₄N₂],
^{c}nano-Ca@2,2′-BPBPA [Ca₃(C₁₂H₁₀O₁₄P₂N₂)(6H₂O)]7H₂O]

EDS elemental analysis and PXRD diffractograms for HA (control), HA-2,2′-BPBPA (control), and HA-nano-Ca@2,2′-BPBPA (experimental) were collected to corroborate the affinity of these materials to HA. The EDS elemental composition of HA, HA-2,2′-BPBPA, and HA-nano-Ca@2,2′-BPBPA was compared using the weight percentage (wt. %) listed in Table 2. The EDS analysis shows that the relative concentration of calcium decreases for HA-2,2′-BPBPA (39.89 wt. %) and nano-Ca@2,2′-BPBPA (40.00 wt. %) when compared with HA (48.49 wt. %, FIG. 162B). These findings indicate that 2,2′-BPBPA (0 calcium per formula unit, FIG. 162C) and nano-Ca@2,2′-BPBPA (3 calciums per asymmetric unit, FIG. 162D) might shield the detection of calcium ions in HA because of the formation of monolayers in the HA surface.

Furthermore, a slight increment in the relative concentration of oxygen and phosphorous signals was observed for HA-2,2′-BPBPA (37.75 and 18.57 wt. %, respectively) and nano-Ca@2,2′-BPBPA (36.88 and 16.85 wt. %, respectively) when compared with HA (36.30 and 15.21 wt. %, correspondingly). These results agree with the relative composition of these elements in these materials, with 13-15 oxygens and 2-4 phosphorous per formula or asymmetric unit. Signals corresponding to carbon and nitrogen were detected for HA-2,2′-BPBPA (3.14 and 0.65 wt. %, respectively) and nano-Ca@2,2′-BPBPA (5.49 and 0.78 wt. %, respectively); these elements were not detected for HA due to their absence in this mineral (0 atoms per formula unit). Collectively, these results support the effective binding of these materials to the HA surface.

Loading and release of letrozole into the 2,2′-BPBPA-Ca and nano-Ca@2,2′BPBPA

The 2,2′-BPBPA-Ca (bulk) and nano-Ca@2,2′-BPBPA (nanocrystals) were loaded with letrozole (LET) to assess their drug-loading and release. LET was selected because this drug represents a type II aromatase inhibitor commonly used to treat breast cancer.^{5,6} The drug-loading of 2,2′-BPBPA-Ca bulk crystals was performed in ethanol (Supporting Information).

The PIT-nano-emulsion method was applied to obtain the drug-loaded nano-Ca@2,2′-BPBPA (Supporting Information). After the drug-loading experiments, the LET (control), 2,2′-BPBPA-Ca (control), drug-loaded 2,2′-BPBPA-Ca (experimental), and drug-loaded nano-Ca@2,2-BPBPA (experimental) were characterized by EDS (Table 3, FIG. 163A) to verify the effective loading of LET into these BPCCs frameworks.

TABLE 29
EDS elemental analysis of LET (control), 2,2′-BPBPA-Ca (control),
drug-loaded 2,2′-BPBPA-Ca (experimental), and drug-loaded
nano-Ca@BPBPA(experimental) after the drug-loading experiment.
The EDS analysis was collected at a 3000x magnification for
all the samples.

| | | | | Drug-loaded |
|---|---|---|---|---|
| | | | Drug-loaded 2,2′- | nano-Ca@2,2′- |
| Elements | LETª | 2,2′-BPBPA-Ca^{b} | BPBPA-Ca | BPBPA^{c} |
| Carbon | 67.89 | 22.72 | 24.94 | 27.81 |
| Nitrogen | 32.11 | 0.73 | 3.77 | 3.37 |
| Oxygen | — | 46.19 | 39.65 | 39.72 |
| Phosphorous | — | 15.00 | 15.84 | 15.11 |
| Calcium | — | 15.36 | 15.79 | 14.00 |

ªLET [C₁₇H₁₁N₅],
^{b}2,2′-BPBPA-Ca[C₁₂H₁₆O₁₄P₄N₂] and
^{c}nano-Ca@2,2′-BPBPA [Ca₃(C₁₂H₁₀O₁₄P₂N₂)(6H₂O)]7H₂O]

The elemental analysis of LET, 2,2′-BPBPA-Ca, drug-loaded 2,2′-BPBPA-Ca, and drug-loaded nano-Ca@2,2-BPBPA was contrasted by employing the weight percentage (wt. %) of all elements identified in these materials through EDS. The LET (graph (i) in FIG. 163A) and 2,2′-BPBPA-Ca (graph (ii) in FIG. 163A) were used as control groups. The EDS elemental analysis reveals an increase in the relative concentration of carbon and nitrogen for drug-loaded 2,2′-BPBPA-Ca (24.94 and 3.77 wt. %, respectively, graph (iii) in FIG. 163A) and drug-loaded nano-Ca@2,2′-BPBPA (27.81 and 3.37 wt. %, respectively, graph (iv) in FIG. 163A) compared with 2,2′-BPBPA-Ca (22.77 and 0.73 wt. %, respectively). These findings can be attributed because these elements are part of the LET molecular structure (17 carbons and 5 nitrogens per formula unit). In addition, it was observed that the relative concentration of nitrogen in these drug-loaded crystalline materials decreased in comparison with the drug LET alone (32.11 wt. %). This result indicates that the encapsulation of LET into these BPCCs might shield the detection of nitrogen when LET is loaded. Furthermore, a similar relative concentration of oxygen, phosphorous, and calcium was detected for the drug-loaded 2,2′-BPBPA-Ca (39.65, 15.84, and 15.79 wt. %, respectively) and nano-Ca@2,2′-BPBPA (39.72, 15.11, and 14.00 wt. %, respectively) when compared with 2,2′-BPBPA-Ca (46.19, 15.00, and 15.36 wt. %, respectively).

These findings might be due to the absence of these elements in the LET molecular structure, containing O atoms (oxygen, phosphorous, and calcium) per formula unit.

TGA thermographs for these drug-loaded materials were collected to determine the amount of LET loaded into the channels of 2,2′-BPBPA and nano-Ca@2,2′-BPBPA (20-21%, FIG. 8B). Furthermore, the release capacity of these drug-loaded BPCCs was assessed in physiological conditions (FaSSGF, pH=1.60) at 37° C. The LET release from 2,2′-BPBPA-Ca was determined by measuring the absorption of the supernatant at the lambda max (λₘₐₓ=318 nm) and quantifying the increase in the LET concentration over time. Results demonstrate that the drug-loaded 2,2′-BPBPA-Ca reaches a 19% maximum release of LET after 24 h (FIG. 163C), which is in agreement with the amount of LET loaded into these BPCCs found by the TGA results.

These findings suggested that these BPCCs might be degraded in FaSSGF (acid environment) with the ability to release their LET content.

Cell-based assays for nano-Ca@2,2′-BPBPA

Human breast cancer (MCF-7 and MDA-MB-231) and human osteoblast (hFOB 1.19) cell lines were utilized to assess the cytotoxicity of 2,2′-BPBPA (control), LET (control), nano-Ca@2,2′-BPBPA (control), and drug-loaded nano-Ca@2,2′-BPBPA (experimental). The MCF-7 cell line was selected because it represents an ER-positive breast cancer model.⁷ The MDA-MB-231 cell line is an ER-negative breast cancer (triple negative) type.⁸ These cell cancer models can be involved in the progression of breast cancer-induced OM.^{8,9} The osteoblast-like hFOB 1.19 cells were chosen as a homogeneous non-cancerous cell model, frequently employed to evaluate osteoblast differentiation.¹⁰ The cytotoxicity of 2,2′-BPBPA, letrozole, and the unloaded and drug-loaded BPCCs was investigated by the assessment of the IC₅₀ and % RCL after 24, 48, and 72 h of cell treatment. It was observed lower cytotoxicity effects for MCF-7 (IC₅₀=134 ±2 μM at 72 h), MDA-MB-231 (IC₅₀ >200 μM), and hFOB 1.19 (IC₅₀ >188±4 μM at 72 h) cell lines treated with 2,2′-BPBPA after 24, 48, and 72 h, resulting in IC₅₀ >200 μM or all selected time points (Supporting Information). The IC₅₀ for LET has been previously reported in the literature for MCF-7 (2θ±3 μM), MDA-MB-231 (IC₅₀>200 μM), and hFOB 1.19 (IC₅₀>200 [M).

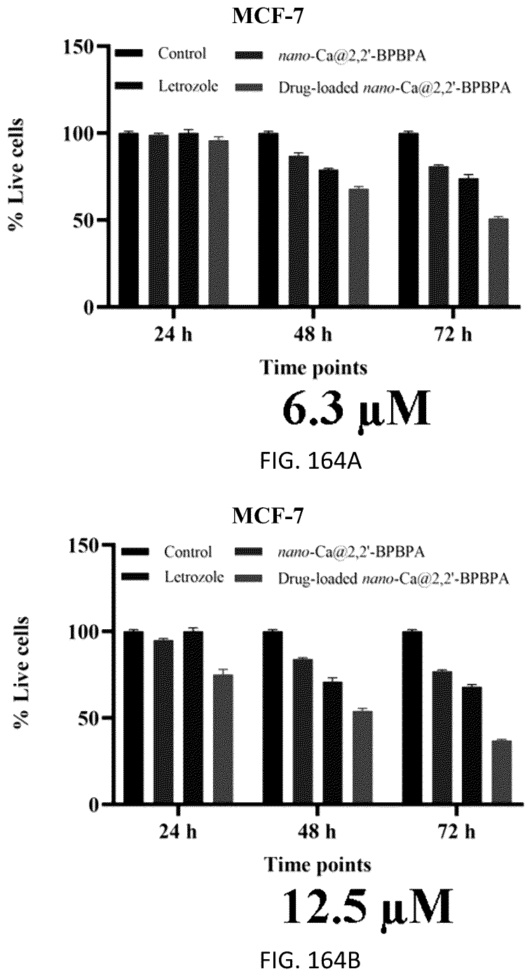

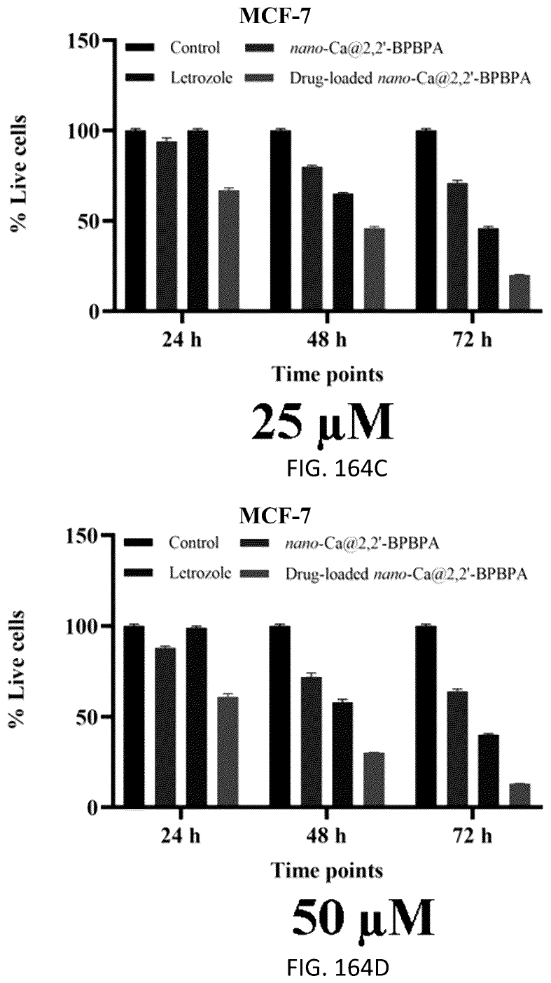

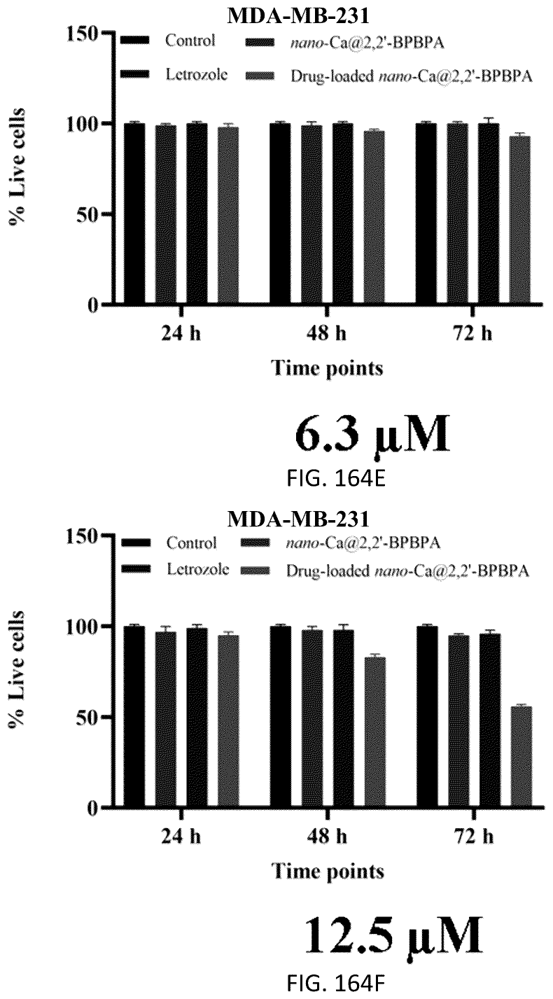

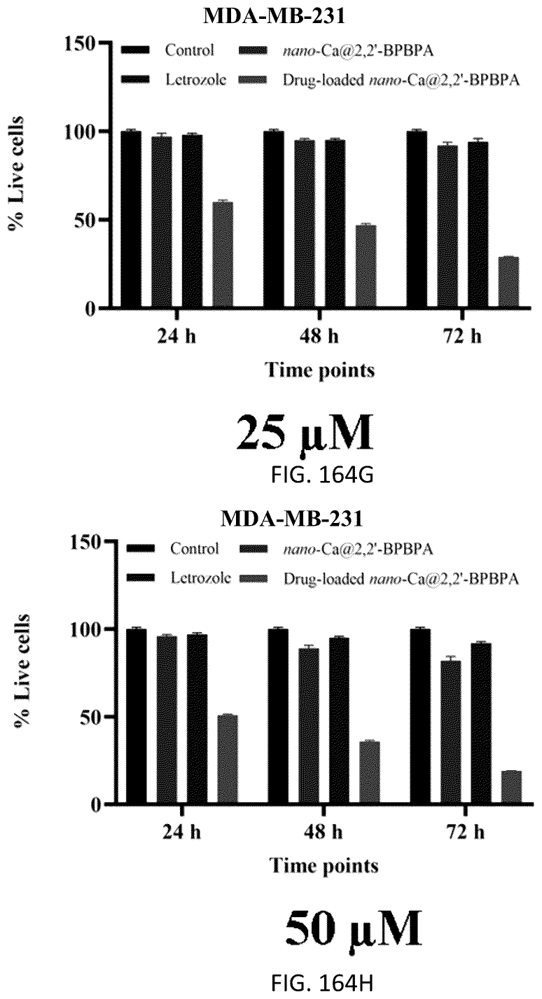

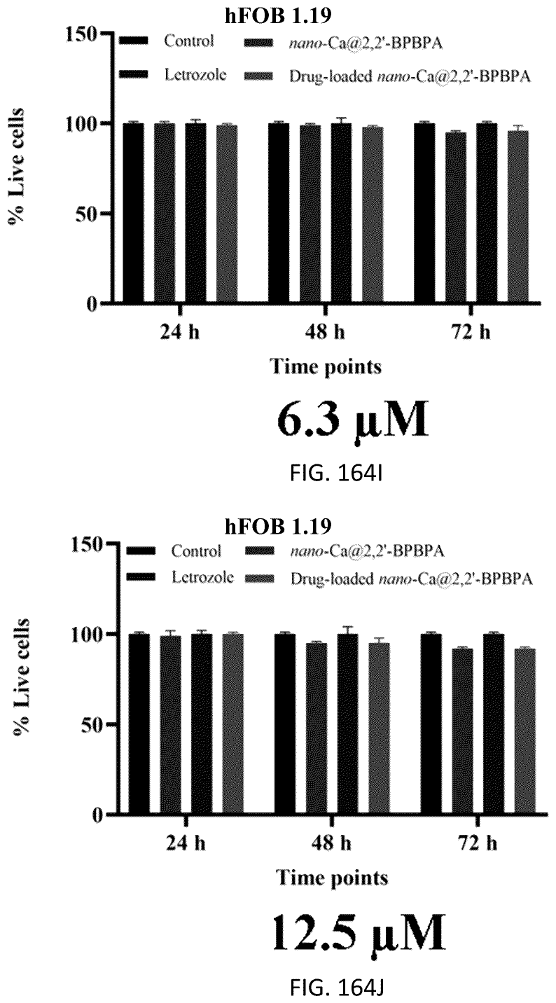

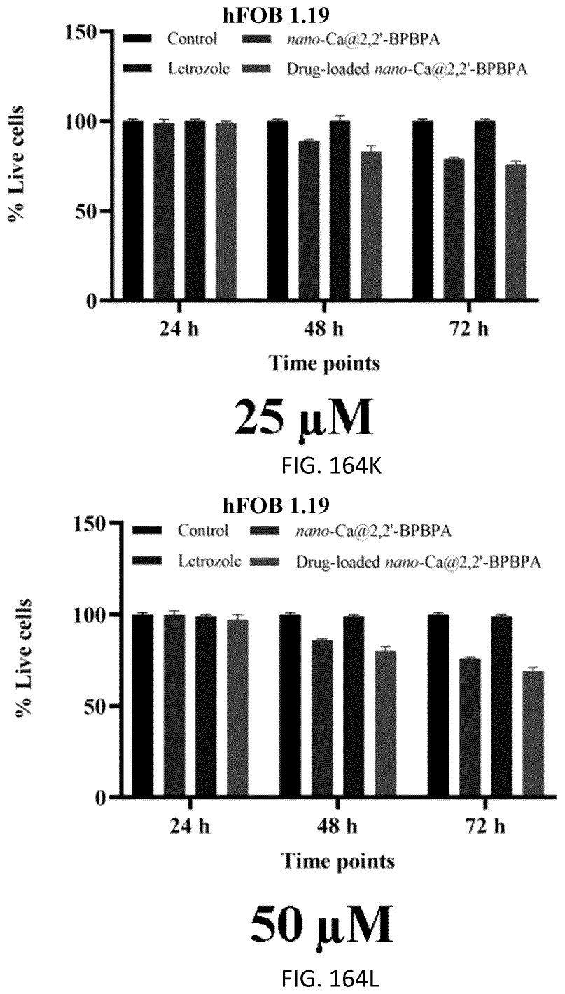

The MCF-7 cell line was treated with these unloaded and drug-loaded BPCCs in concentrations from 6.3 to 50 μM (FIGS. 164A-164D). At 6.3 μM, the % RCL results show that the nano-Ca@2,2′-BPBPA did not lead to a significant decrease in cell viability for MCF-7 cells after 24 (% RCL=99±1%), 48(% RCL=87±2%), and 72 (% RCL=81±1%) h of been treated. For LET, was observed a similar result, with % RCL values of about 100±2% (24 h), 79 ±1% (48 h), and 74±3% (72 h). A decrease in cell viability was observed for MCF-7 cells treated with the drug-loaded nano-Ca@2,2′-BPBPA from 24 (% RCL=96±2%) to 48 (% RCL =68±2%) and 72 (% RCL=51±2%) h (FIG. 164A). At a concentration of 12.5 μM, results demonstrate that this unloaded BPCC maintains the MCF-7 cell viability up to 70% during the treatment, resulting in % RCL values of 95±1% (24 h), 84±1% (48 h), and 77±1% (72 h). At this concentration, LET shows % RCL values up to 60% for MCF-7 after treatment, leading to % RCL values of 100±2% (24 h), 71±3% (48 h), and 68±2% (72 h). A higher decrease in cell viability was observed for MCF-7 cells treated with drug-loaded nano-Ca@2,2′-BPBPA after 24 (% RCL=75±1%), 48(% RCL=54±2%), and 72 (% RCL=34±1%) h (FIG. 164B). At concentrations of 25 and 50 μM, a slight decrease in cell viability was observed for MCF-7 cells treated with unloaded nano-Ca@2,2′-BPBPA, with % RCL values from 94±2% (24 h) to 71±2 % at 25 μM, and from 88±1% (24 h) to 64±2% at 50 μM. For LET, results demonstrate a decrease in the cell viability from 100±1% (24 h) to 46±2% (72 h) at 25 μM and from 99±1 % (24 h) to 40±1% (72 h) at 50 μM. A higher decrease in cell viability was observed for MCF-7 cells treated with the drug-loaded nano-Ca@2,2′-BPBPA, leading to lower % RCL values from 67±2% (24 h) to 20±2% (72 h) at 25 μM and 61±3% (24 h) to 13±1% (72 h) (FIGS. 164C-164D). These findings demonstrate higher cytotoxicity effects in the MCF-7 cells when treated with the drug-loaded nano-Ca@2,2′-BPBPA than the drug alone (LET), even at a low concentration of 6.3 μM.

Furthermore, the osteoblast hFOB 1.19 cell line was treated using the same conditions as the MCF-7 and MDA-MB-231 cell lines. Low cytotoxicity effects against the hFOB 1.19 cell were expected, suggesting that these BPCCs will not generate damage to the normal tissue. Results show that LET did not cause a considerable decrease in cell viability (% RCL ˜99 %) at a concentration range of 6.3-50 μM after 24, 48, and 72 h of treatment. For nano-Ca@2,2′-BPBPA, it was observed that % RCL values were up to -92% in all-time points at a concentration between 6.3 to 12.5 μM (FIGS. 164I-164J). A slight decrease in cell viability of hFOB 1.19 cells was determined at higher concentrations of 25 and 50 μM, resulting in % RCL from 99±2% (24 h) to 79±1% (72) at 25 μM and 100±2% (24 h) to 76±1% (72 h) at 50 μM (FIGS. 164K-164L). Additionally, it was observed that at concentrations of 6.3 and 12.5 μM, the drug-loaded nano-Ca@2,2′-BPBPA did not cause a decrease in cell viability (% RCL >90%) for the osteoblast hFOB 1.19 cells. However, at higher concentrations of 25 and 50 μM, this drug-loaded BPCC generates a slight decrease in cell viability from 24 (% RCL >90%) to 48 (% RCL ˜80%), and 72 h (% RCL ˜70%). These findings point toward designing a drug-loaded nano-Ca@BPCC in a concentration range of 6.3-12.5 μM that might decrease cell viability in cancerous cells (MCF-7 and MDA-MB-231) without causing cell damage to the normal cells (hFOB 1.19) at the metastatic site.

### Conclusions

The hydrothermal reaction of 2,2′-BPBPA with bioactive metals (Ca²⁺, Zn²⁺, and Mg²⁺) leads to the formation of three crystalline phases, namely, 2,2′-BPBPA-Ca, 2,2′-BPBPA-Zn, and 2,2′-BPBPA-Mg. Out of these three structures, for 2,2′-BPBPA-Ca were observed channels (9×13 Å); these channels facilitate the application of this crystal structure as a potential DDS. The particle size of 2,2′-BPBPA was successfully decreased by the PIT-nano-emulsion method, resulting in the nano-Ca@2,2′-BPBPA (˜288 d.nm). In addition, low aggregation tendency was observed for nano-Ca@2,2′-BPBPA after 0, 24, and 48 h in 10% FBS:PBS, maintaining a homogeneous particle size (<300 d. nm). These findings suggest that this material might be capable of maintaining its particle size distribution in this physiological serum-like dispersant. The affinity assays reveal a higher binding of nano-Ca@2,2′-BPBPA (21%) to hydroxyapatite (HA) when contrasted with ZOLE (15%, commercial BP) after 24 h. Furthermore, the antineoplastic drug letrozole (LET) was encapsulated and released from the 2,2′-BPBPA-Ca and nano-Ca@2,2′-BPBPA frameworks (˜20%), showing the capability of this material to load and release its cargo (LET) in a pH-dependent manner. The results attained within this work provide evidence about the design of nano-Ca@BPCCs with suitable characteristics to be used as possible DDSs to treat breast cancer-induced OM.

### 2,2′-BPBPA Supporting Information

### 1. Materials

The 2,2′-bipyridine-5,5′-dicarboxylic acid (2,2′-BPDC) C₁₂O₄H₈N₂, 97% pure) was obtained from Sigma Aldrich (Milwaukee, WI). Tris(trimethylsilyl) phosphite ((CH₃)₃SiO]3P, 92% pure) was acquired from Fisher Scientific (Hampton, NH). Calcium nitrate tetrahydrate (Ca(NO₃)₂·4H₂O, 99% pure), zinc nitrate hexahydrate (Zn(NO₃)₂·6H₂O, 98% pure), magnesium nitrate hexahydrate (Mg(NO₃)₂·6H₂O, 99% pure), hydrochloric acid (HCl, 37% wt.), sodium hydroxide (NaOH, >98% pure), penicillin-streptomycin (Pen-Strep) and fetal bovine serum (FBS) were bought from Sigma-Aldrich (St. Louis, MO). Hydroxyapatite (Ca₅(OH)(PO₄)₃, synthetic powder), phosphate-buffered saline (PBS, tablets), and Dulbecco's Modified Eagle's Medium (DMEM) were purchased from Sigma-Aldrich (Milwaukee, WI). The 1:1 mixture of Ham's F-12 Medium/Dulbecco's Modified Eagle's Medium (1:1 DMEM: F-12) was purchased from Bioanalytical Instruments (San Juan, PR). Human breast cancer (MCF-7, MDA-MB-231) and normal osteoblast-like hFOB 1.19 cell lines were acquired from ATCC (Manassas, VA).

### 2. Synthesis and Characterization of 2,2′-BPBPA

2.1. Synthesis of 2,2′-bipyridine-5,5′-bisphosphonic acid (2,2′-BPBPA). The Lecouvey reaction was employed to obtain the 2,2′-BPBPA.^{1,2,3,4} The 2,2′-bipyridine-5,5′-dicarboxylic acid was employed as starting material to synthesize the 2,2′-bipyridine-5,5′-dicarbonyl dichloride (2,2′-BPDCl). Subsequently, -1.0 g of the corresponding acyl chloride (2,2′-BPDCl) was added to 7.0 mL of tris(trimethylsilyl) phosphite. The tris(trimethylsilyl) phosphite was at O° C. before adding the acyl chloride. The reaction was allowed to cool down to room temperature and left for 3 d at 50° C. to allow the formation of an ester intermediate. The excess solvent was removed by rotoevaporation, and methanol was employed to hydrolyze the ester intermediate, obtaining the 2,2′-BPBPA product. The 2,2′-BPBPA was characterized through nuclear magnetic resonance (NMR), Raman spectroscopy, powder X-ray diffraction (PXRD), thermogravimetric analysis (TGA), and differential scanning calorimetry (DSC).

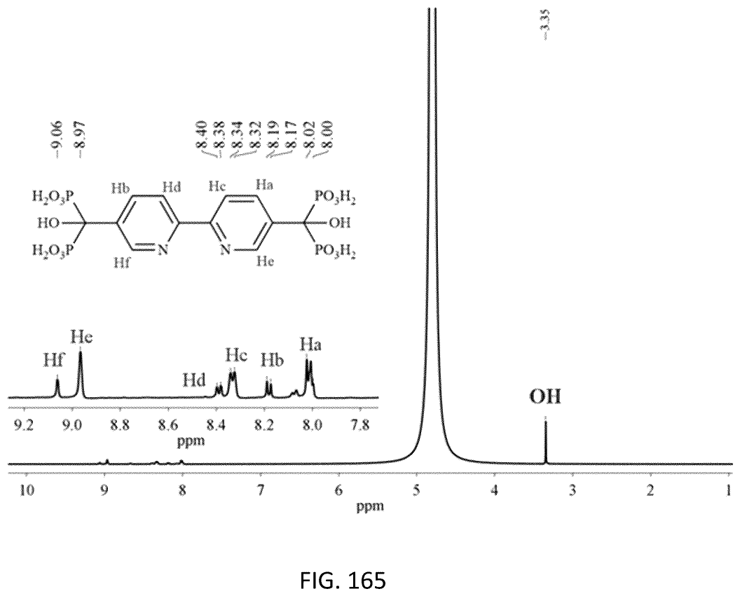

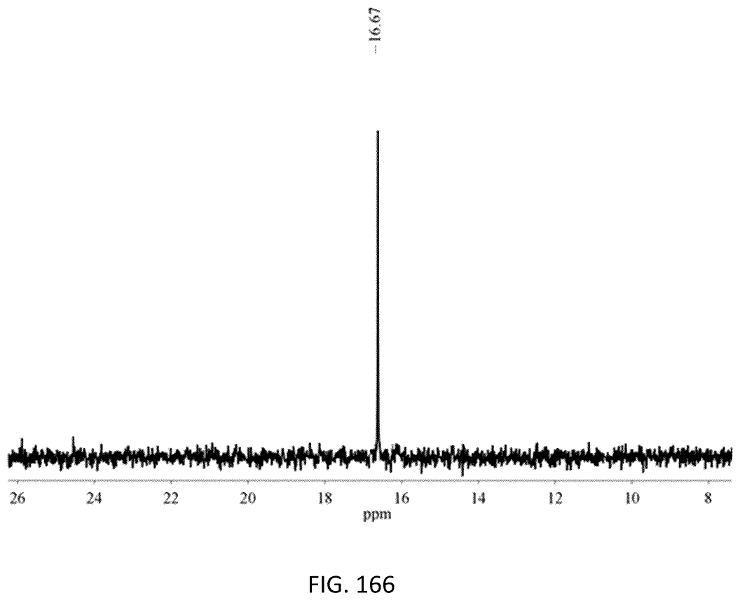

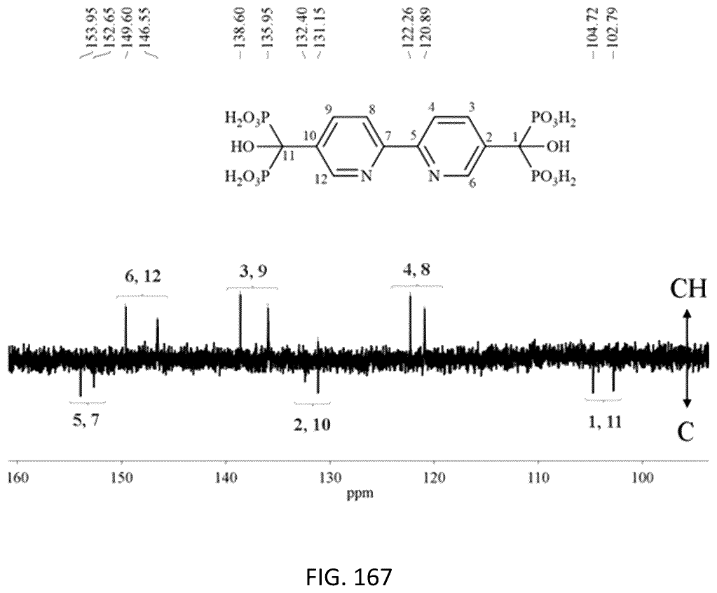

2.2. Nuclear magnetic resonance (NMR) for 2,2′-BPBPA. 1H NMR, 13C-APT NMR, and 31P NMR were collected utilizing a Bruker Ascend Aeon 700 MHz NMR supplied with a multilinear, variable temperature, and cross-polarization magnetic angle spinning. The 1H, 13C-APT, and 31P NMR of 2,2′-BPBPA were recorded employing deuterium oxide (D₂O) as a solvent. The experiments were performed at room temperature. FIGS. 165-167 depicts the 1H, 31P, and 13C-APT NMR for the 2,2′-BPBPA. The main chemical shifts (6) for 2,2′-BPBPA are listen as follows: ¹H NMR (700 MHz, D₂O): δ(ppm)=3.35 (s, OH), 8.00, 8.02 (dd, Ha), 8.17, 8.19 (dd, Hb), 8.32, 8.34 (dd, Hc), 8.38, 8.40 (dd, Hd), 8.97 (s, He), and 9.06 (s, H_{f}). ³¹P NMR (700 MHz, D₂O): δ(ppm)=16.67 (s, 4P). ¹³C-APT NMR (700 MHz, D₂O): δ(ppm)=102.79, 104.72 (s, C1, C11), 120.89, 122.26 (s, C4, C8), 131.15, 132.40 (s, C2, C10), 135.95, 138.60 (s, C3, C9), 146.55, 149.60 (s, C6, C12), and 152.65, 153.95 (s, C5, C7).

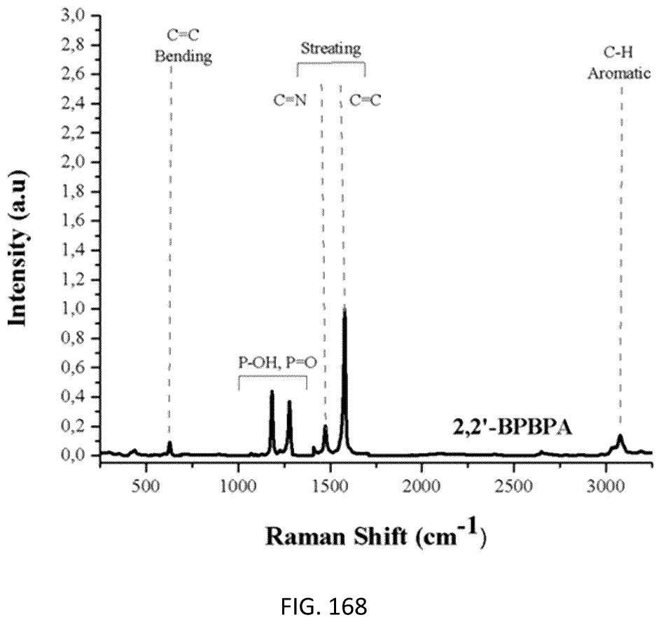

2.3. Raman Vibrational Spectroscopy for 2,2′-BPBPA. A Thermo Scientific DXR Raman microscope was used to collect the Raman spectra of 2,2′-BPBPA. The instrument was supplied with a 532 nm laser. The spectra was collected from 250 to 3,250 cm⁻¹, employing a 50 μm slit, 400 lines/mm grating, and 32 scans for 5 s. The data was collected and analyzed using the OMNIC for Dispersive Raman Software version 9.2.0. FIG. 168 shows the Raman spectra of 2,2′-BPBPA.

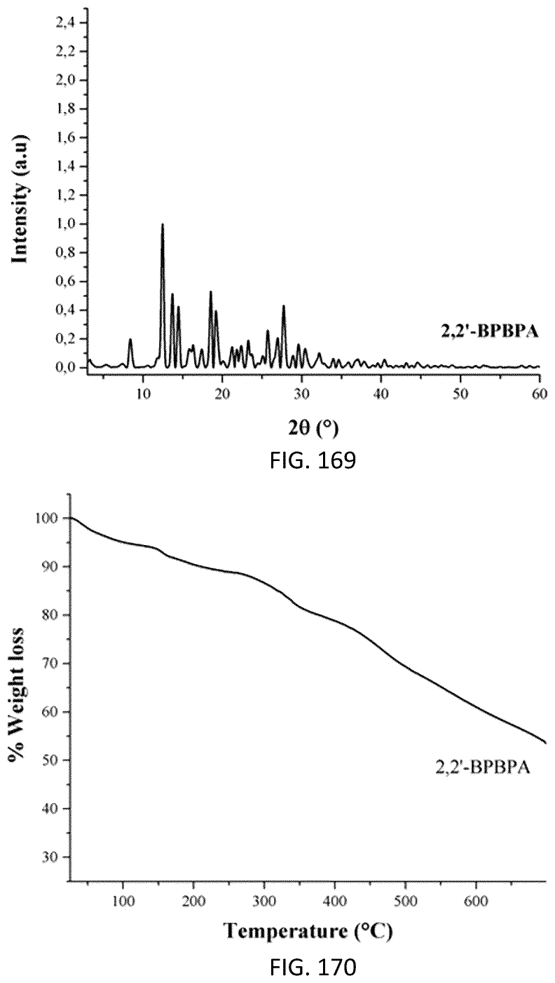

2.4. Powder X-ray diffraction (PXRD) for 2,2′-BPBPA. A Rigaku XtaLAB SuperNova X-ray diffractometer was employed to collect the PXRD diffractogram for 2,2′-BPBPA. The instrument was supplied with a HyPix3000 X-ray detector, a micro-focus Cu-Kα radiation (λ=1.5417 Å) source, and an Oxford Cryosystem Cryostream 800 cooler. The diffractogram of 2,2′-BPBPA was recorded at 300 K from 6-600 (20) using a transmission mode at 50 kV, 1 mA, and fast Phi mode (90 s). A small amount of 2,2′-PBBPA was mounted on MiTeGen micro-loops using paratone oil. To collect and analyze the data illustrated in FIG. 169. the CrysAlisPRO software version 1.171.3920a was employed.

2.5. Thermogravimetric analysis (TGA) for 2,2′-BPBPA. A TGA Q500 (TA Instruments Inc.) was utilized to collect the TGA thermograph of 2,2′-BPBPA. The experiment was performed between 25-700° C., under N₂ (60 mL/min) at 5° C./min. About 2-5 mg of 2,2′-BPBPA were weighed to perform the thermal analysis. The TA Universal Analysis software v 4.5 Å was used to collect and analyze the data. FIG. 170 shows the TGA thermograph of 2,2′-BPBPA.

2.6. Differential Scanning Calorimeter (DSC) for 2,2′-BPBPA. A DSC Q2000 outfitted with a 50-position autosampler, and a refrigerated cooling system (RCS40) was used to determine the melting point of 2,2′-BPBPA. The instrument was calibrated employing an indium standard (Tₘ=156.6° C. and ΔH_{f}=28.54 J/g). The experiment was performed at a temperature from 25 to 390° C. under an N₂ atmosphere (50 mL/min) at 5° C./min. About 1-2 mg of 2,2′-BPBPA were hermetically sealed in aluminum pans to collect the DSC thermograph of this compound. The TA Universal Analysis software v 4.5 Å was used to analyze the data collected. The melting point of 2,2′-BPBPA was determined as 245±3° C. (518.15 K).

### 3. Synthesis and Characterization of 2,2′-BPBPA-based BPCCs

### 3.1. Synthesis of 2,2′-BPBPA-based BPCCs

2,2′-BPBPA-Ca: The 2,2′-BPBPA-Ca was prepared by the hydrothermal method, using ˜10 mg of 2,2′-BPBPA dissolved in 10 mL of nano pure water. Separately, the metal salt solution was prepared in a 20 mL vial by dissolving 6.5 mg of Ca(NO₃)₂·4H₂O in 10 mL nano pure water. The metal salt solution was carefully added to the 2,2′-BPBPA solution and kept at 80° C. for Id. Once the 2,2′-BPBPA-Ca crystals were formed, the vials were allowed to cool down until room temperature, and crystals were collected by vacuum filtration.

2,2′-BPBPA-Zn: The 2,2′-BPBPA-Zn was prepared by the hydrothermal method, using ˜10 mg of 2,2′-BPBPA dissolved in 10 mL of nano pure water. Separately, the metal salt solution was prepared in a 20 mL vial by dissolving 11.6 mg of Zn(NO₃)₂·6H₂O in 10 mL nano pure water. The metal salt solution was carefully added to the 2,2′-BPBPA solution and kept at 85° C. for 2d. Once the 2,2′-BPBPA-Zn crystals were formed, the vials were allowed to cool down until room temperature, and crystals were collected by vacuum filtration.

2,2′-BPBPA-Mg: The 2,2′-BPBPA-Mg was prepared by the hydrothermal method, using ˜20 mg of 2,2′-BPBPA dissolved in 20 mL of nano pure water. Separately, the metal salt solution was prepared in a 20 mL vial by dissolving 20.6 mg of Mg(NO₃)₂·6H₂O in 10 mL nano pure water. The metal salt solution was carefully added to the 2,2′-BPBPA solution and kept at 180° C. for 8d. Once the 2,2′-BPBPA-Mg crystals were formed, the vials were allowed to cool down until room temperature, and crystals were collected by vacuum filtration.

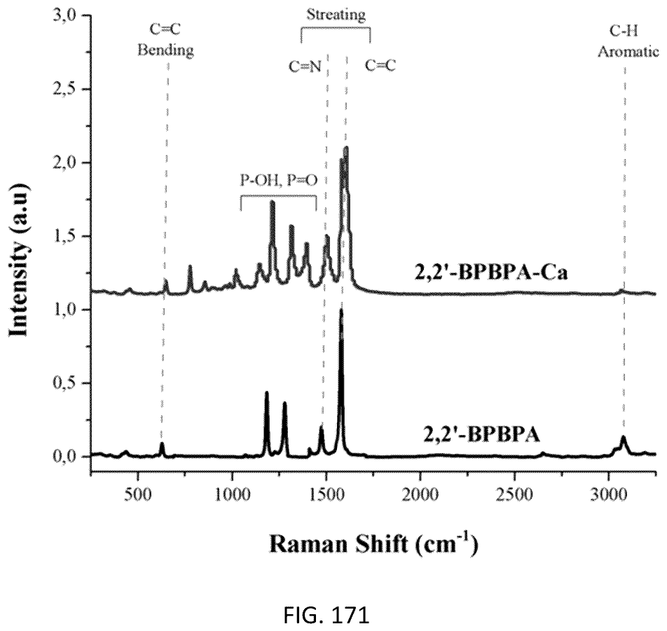

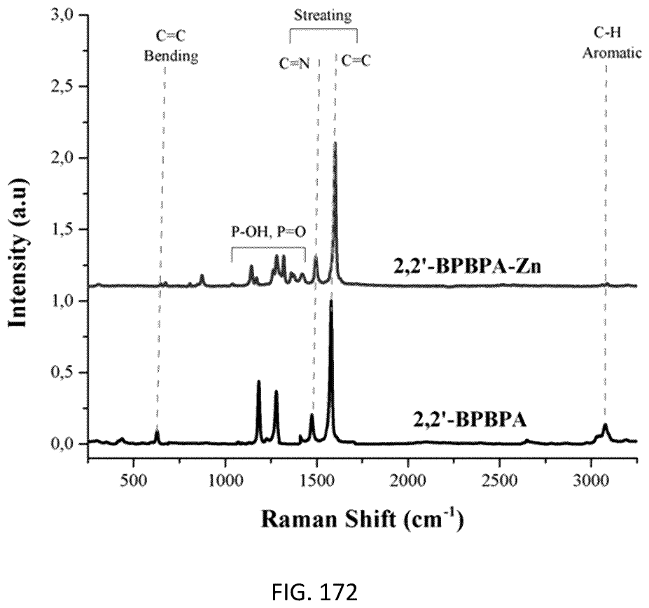

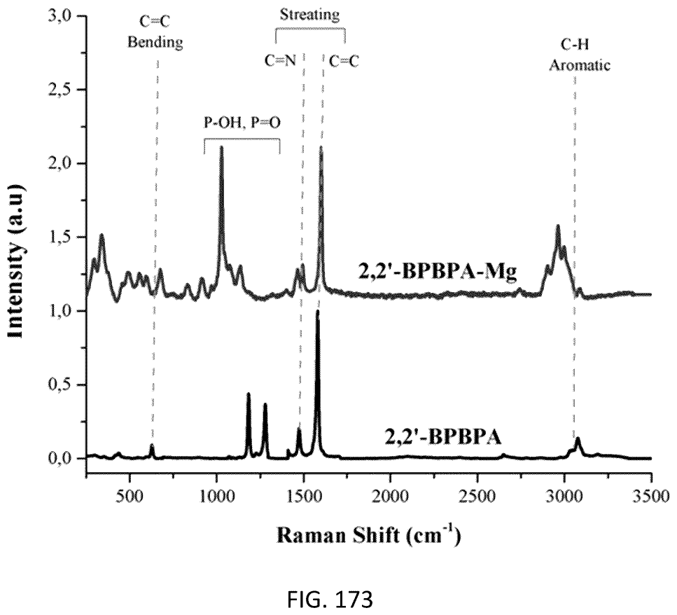

3.2. Raman Vibrational Spectroscopy for 2,2′-BPBPA-based BPCCs. The Raman spectra of 2,2′-BPBPA-Ca, 2,2′-BPBPA-Zn, and 2,2′-BPBPA-Mg were collected using a Thermo Scientific DXR Raman microscope as previously described for 2,2′-BPBPA (Section 2.3). The Raman spectra for 2,2′-BPBPA (black) compared with 2,2′-BPBPA-Ca (red), 2,2′-BPBPA-Zn (red), and 2,2′-BPBPA-Mg (red) are illustrated in FIGS. 171-173.

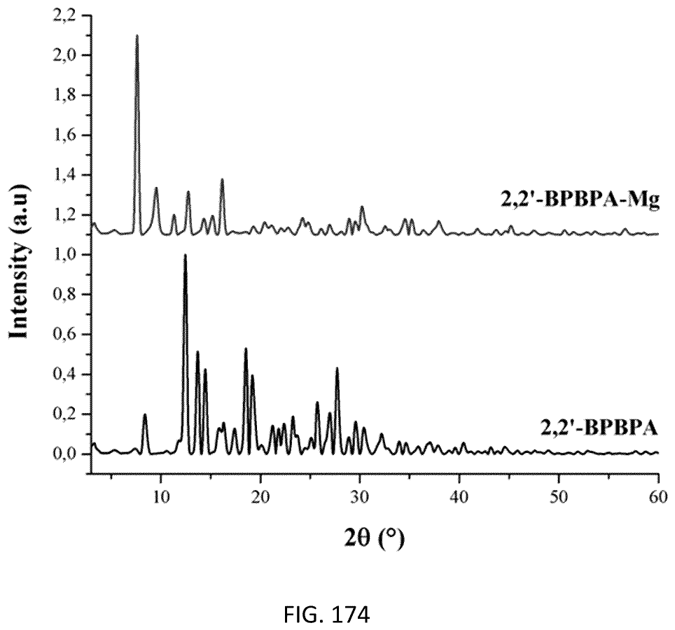

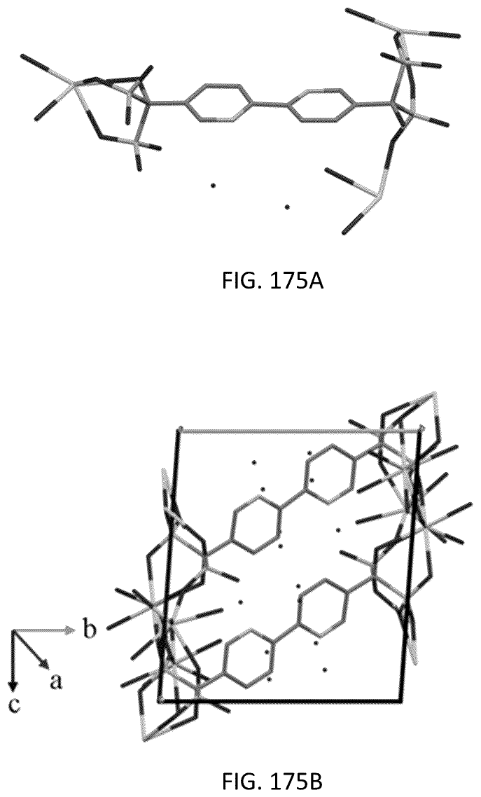

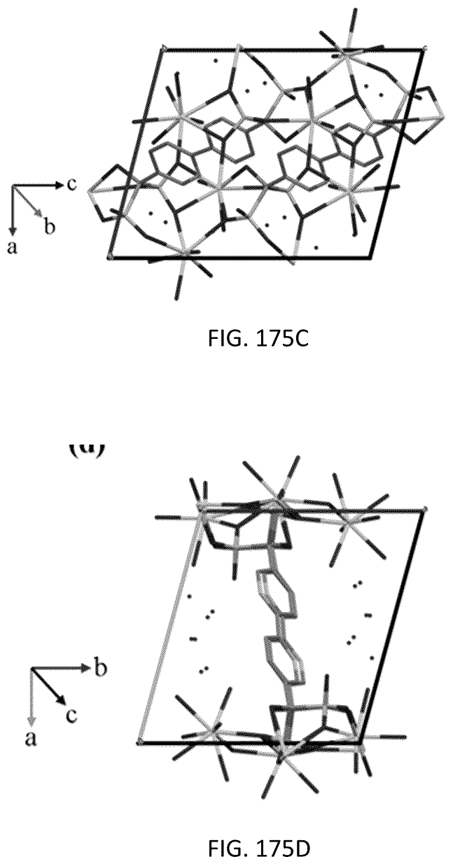

3.3. Powder X-ray diffraction (PXRD) for 2,2′-BPBPA-based BPCCs. The diffractograms of 2,2′-BPBPA-Ca, 2,2′-BPBPA-Zn, and 2,2′-BPBPA-Mg were recorded utilizing a Rigaku XtaLAB SuperNova X-ray diffractometer as previously described for 2,2′-BPBPA (Section 2.4). FIG. 174 shows the diffractograms of 2,2′-BPBPA (black) contrasted with the 2,2′-BPBPA-based metal complexes (red).

3.4. Single-crystal X-ray diffraction for 2,2′-BPBPA-based BPCCs. The quality of single crystals of 2,2′-BPBPA-Ca, 2,2′-BPBPA-Zn, and 2,2′-BPBPA-Mg was evaluated by polarized microscope Nikon Eclipse Microscope LV100NPOL, supplied with a Nikon DS-Fi2 camera. Appropriate single crystals of 2,2′-BPBPA-based BPCCs were mounted in MiTeGen micro-loops for structure elucidation. The SC-XRD experiments were performed using a Rigaku XtalLAB SuperNova single micro-focus Cu-Kα radiation (λ=1.5417 Å) source, equipped with an Oxford Cryosystems Cryostream 800 and a HyPix3000 X-ray detector. The data was collected utilizing the CrysAlis^{PRO} software vs 1.171.39.45c. All structures were solved applying full-matrix least-squares (F² mode) and direct methods in Olex2 software vs 1.2.

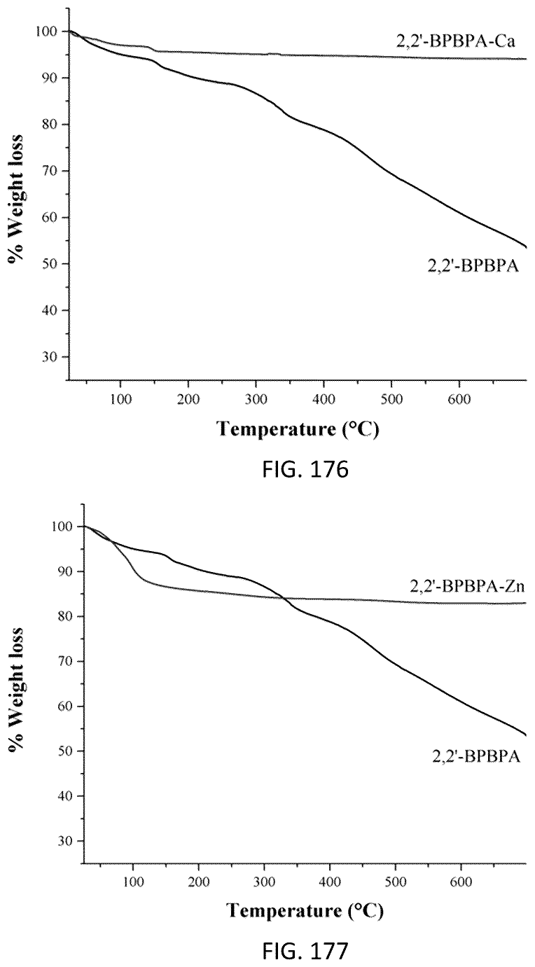

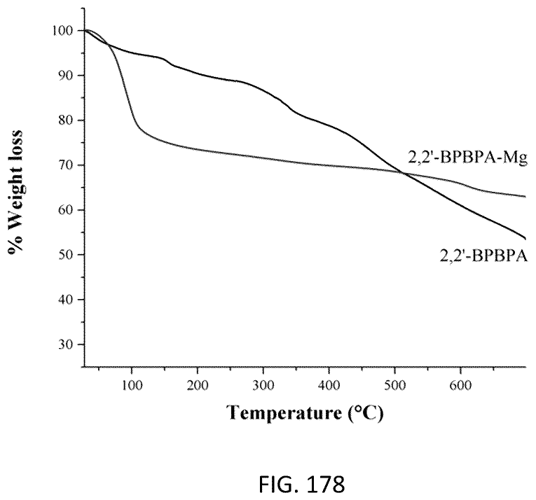

3.5. Thermogravimetric analysis (TGA) for 2,2′-BPBPA-based BPCCs. A TGA Q500 (TA Instruments Inc.) was employed to collect the TGA thermographs of 2,2′-BPBPA-Ca, 2,2′-BPBPA-Zn, and 2,2′-BPBPA-Mg. The data collection was performed as earlier described for 2,2′-BPBPA (Section 2.5). The TGA thermographs of 2,2′-BPBPA (black) compared with 2,2′-BPBPA-Ca (red), 2,2′-BPBPA-Zn(red), and 2,2′-BPBPA-Mg(red) are depicted in FIGS. 176-178.

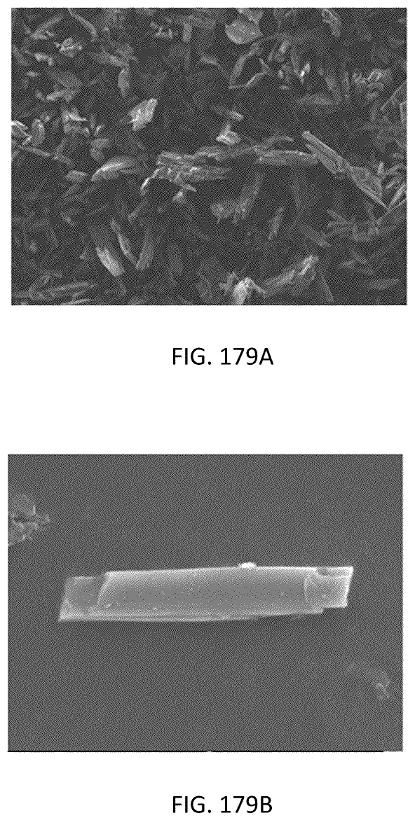

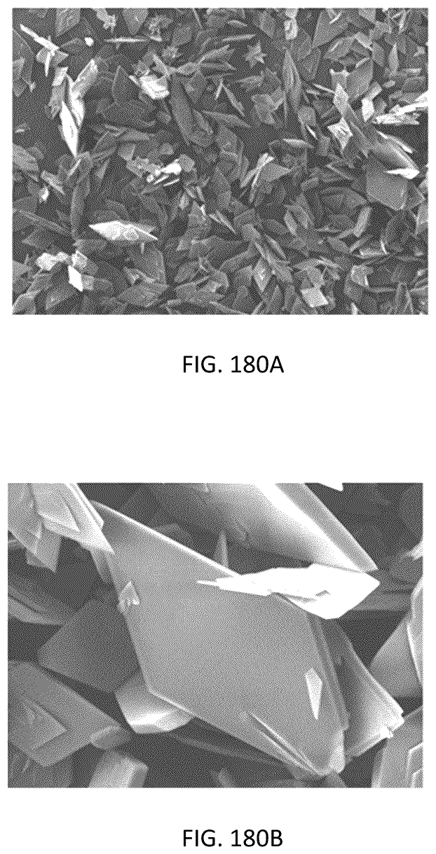

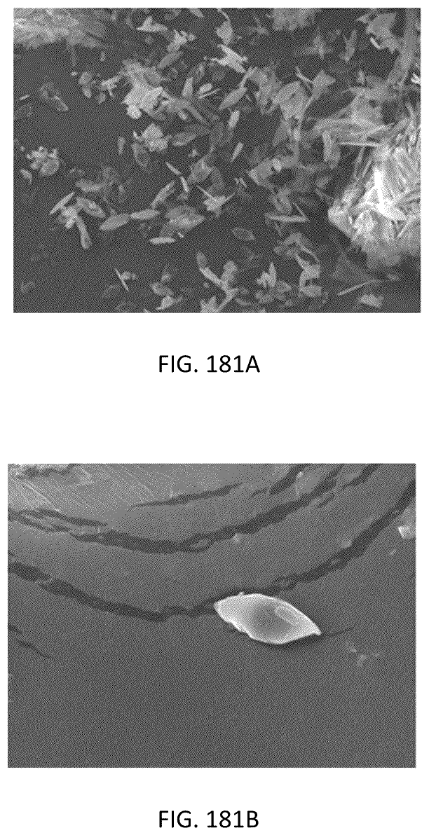

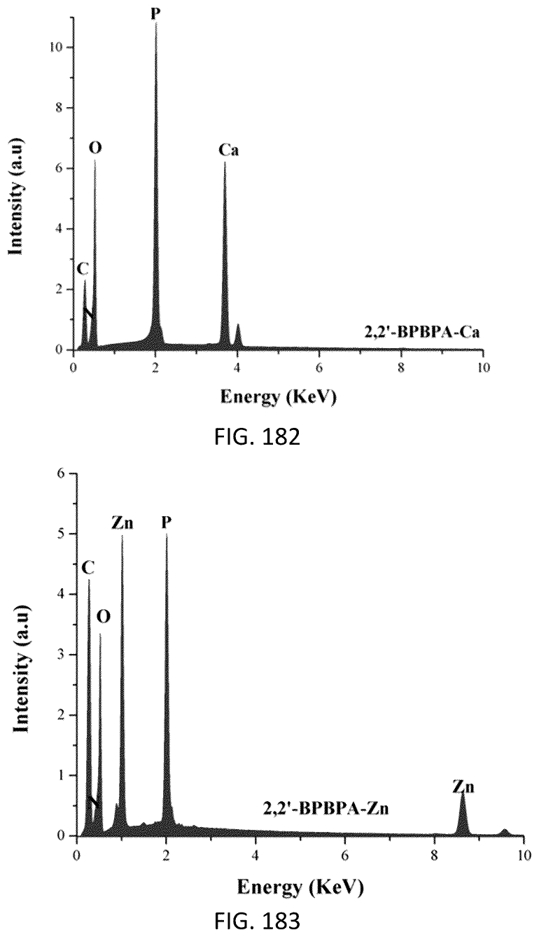

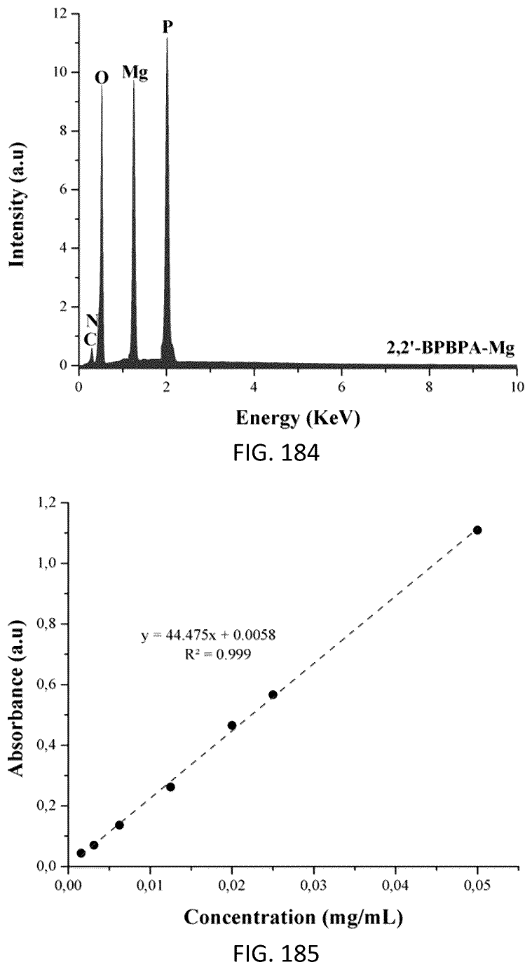

3.6. Scanning electron microscopy-energy dispersive spectroscopy (SEM-EDS) for 2,2′-BPBPA-based BPCCs. The SEM micrographs and X-ray elemental analysis of 2,2′-BPBPA-Ca, 2,2′-BPBPA-Zn, and 2,2′-BPBPA-Mg were collected employing a JEOL JSM-6480LV scanning electron microscope. The instrument was equipped with an Everhart Thomley secondary electron imaging (SEI) and an energy dispersive X-ray analysis (EDAX) Genesis 2000 detectors. The SEM micrographs of these materials were collected using an acceleration voltage of 20 kV, a spot size of 36, and an electron beam of 11 mm width in a high vacuum mode. The SEM micrographs for 2,2′-BPBPA-Ca, 2,2′-BPBPA-Zn, and 2,2′-BPBPA-Mg are illustrated in FIGS. 179-183. The EDS spectra for the 2,2′-BPBPA-based BPCCs are displayed in FIGS. 182-184.

3.7. Differential Scanning Calorimetry (DSC) for 2,2′-BPBPA-based BPCCs. A DSC Q2000 (TA Instruments Inc.) was utilized to determine the melting points of 2,2′-BPBPA-Ca, 2,2′-BPBPA-Zn, and 2,2′-BPBPA-Mg as previously described for 2,2-BPBPA (Section 2.6). The TA Universal Analysis software vs 4.5 Å was employed for the data collection and analysis. The melting points for all 2,2′-BPBPA-based BPCCs are listed in Table 3.7.1.

4. Dissolution curves in physiological conditions for 2,2′-BPBPA-based BPCCs

4.1. Dissolution curves in phosphate-buffered saline for 2,2′-BPBPA-based BPCCs Calibration curve. A stock solution of 0.1 mg/mL of 2,2′-BPBPA was prepared in PBS. Subsequently, 2-fold serial dilutions were completed in concentrations of 0.050, 0.025, 0.02, 0.013, 0.0063, 0.0033, and 0.0016 mg/mL. The absorbance was measured by UV-Vis spectroscopy (200-400 nm) employing PBS as a solvent blank. The maximum absorbance wavelength (λₘₐₓ) was detected at 299 nm. The calibration curve of 2,-BPBPA in PBS is illustrated in FIG. 185.

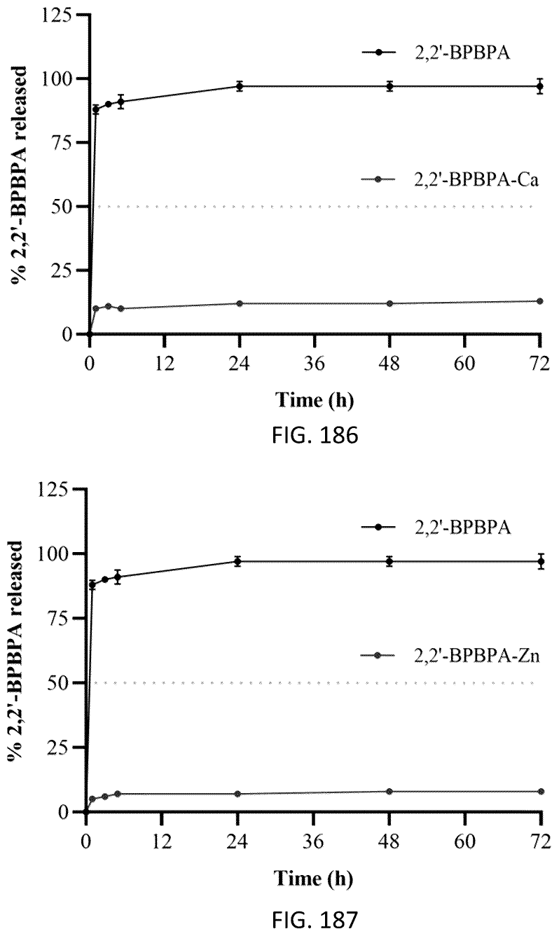

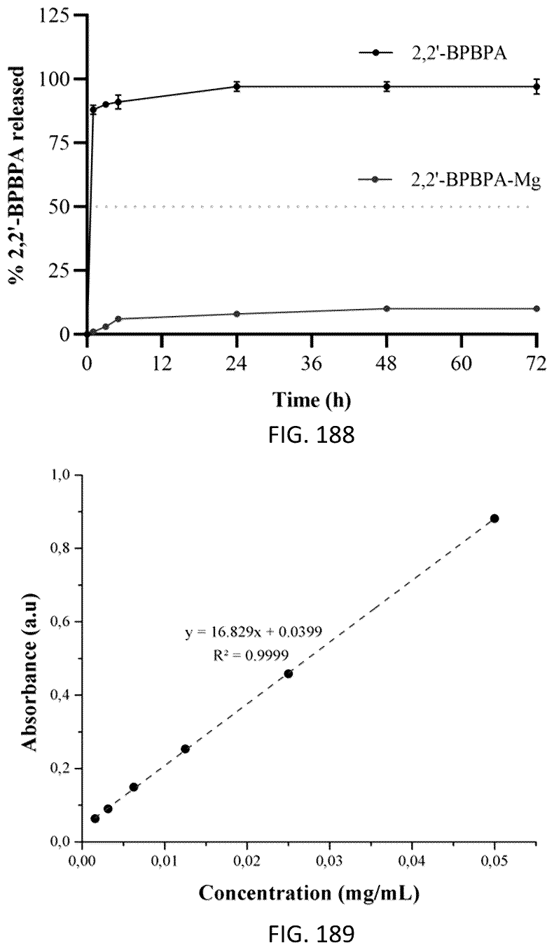

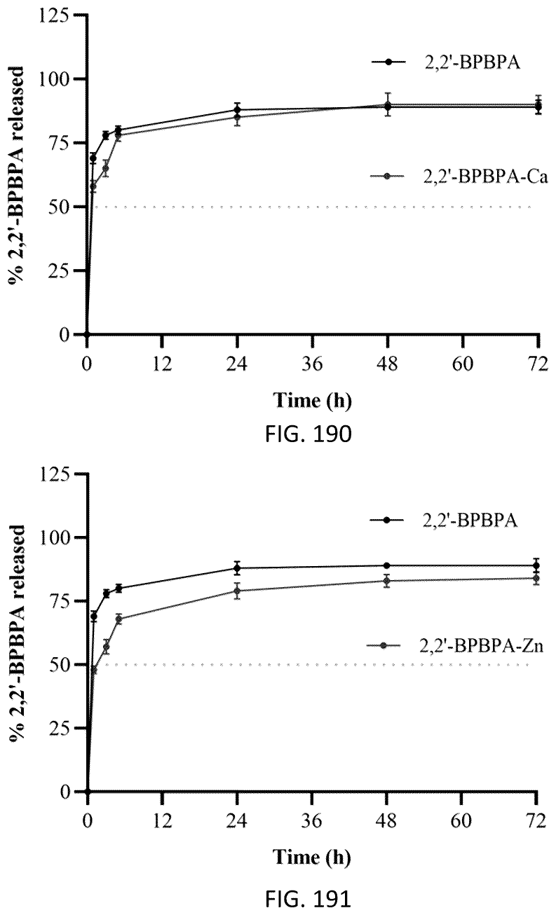

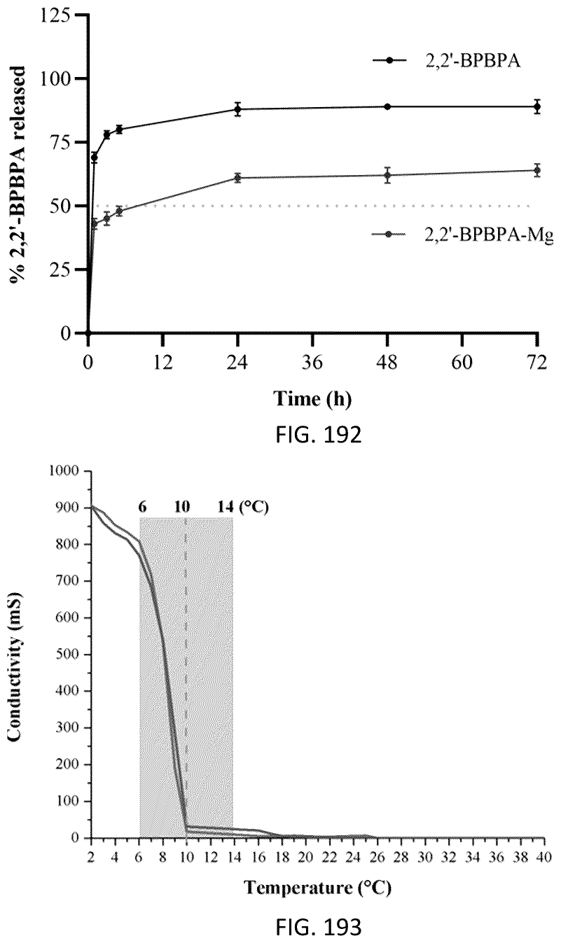

Dissolution experiment. In a 250 mL beaker was tranfer 100 mL of PBS. Subsequently, this solution was allowed to reach 37° C. at 150 rpm. Then, individually ˜10.0 mg of powdered 2,2′-BPBPA-based BPCCs were added to the PBS solution. Aliquots (1 mL) were taken out at different time points (0, 1, 3, 6, 24, 48, and 72 h) and diluted with PBS in 5 mL volumetric flasks. An aliquot (1 mL) was taken out before adding the 2,2′-BPBPA-based BPCCs to record the first time point (0 h). The absorbance of the 2,2′-BPBPA released from these materials was assessed at 299 nm. The dissolution experiments were performed in duplicate for each 2,2′-BPBPA-based BPCC. The percentage (%) of 2,2′-BPBPA released in PBS from these complexes is illustrated in Table 30. The dissolution curves for 2,2′-BPBPA compared to 2,2′-BPBPA-Ca, 2,2′-BPBPA-Zn, and 2,2′-BPBPA-Mg in PBS are displayed in FIGS. 186-188.

TABLE 30
Amount (%) of 2,2′-BPBPA released from the 2,2'-BPBPA-based
BPCCs in PBS. The experiments were performed in duplicate (n = 2). The mean percent released
(% Released) and coefficient of variation (% CV) are reported.

| | 2,2′-BPBPA | | 2,2′-BPBPA-Ca | | 2,2′-BPBPA-Zn | | 2,2′-BPBPA-Mg | |
|---|---|---|---|---|---|---|---|---|
| Time | % | | % | | % | | % | |
| (h) | Released | % CV | Released | % CV | Released | CV % | Released | % CV |
| 0 | 0 | 0 | 0 | 0 | 0 | 0 | 0 | 0 |
| 1 | 88 | 2 | 10 | 5 | 5 | 4 | 1 | 5 |
| 3 | 90 | 1 | 11 | 3 | 6 | 3 | 3 | 3 |
| 6 | 91 | 3 | 10 | 2 | 7 | 2 | 6 | 5 |
| 24 | 97 | 2 | 12 | 4 | 7 | 4 | 8 | 6 |
| 48 | 97 | 2 | 12 | 5 | 8 | 5 | 10 | 3 |
| 72 | 97 | 3 | 13 | 4 | 8 | 4 | 10 | 4 |

### 5. Synthesis and Characterization of nano-Ca@2,2′-BPBPA

5.1 Phase Inversion Temperature Determination for 2,2′-BPBPA. The phase inversion temperature (PIT) was determined for a micro-emulsion of 2,2′-BPBPA in heptane employing Brij L4® as a surfactant. This micro-emulsion was prepared by homogenizing 11.0 mL of 2,2′-BPBPA (2.5 mg/mL), 3.0 mL of heptane, and 0.9 mL of Brij L4®. Successively, the conductivity was measured while the previously micro-emulsion was heated from 2 to 40° C. at 1° C./min. FIG. 193 shows the PIT curves for the micro-emulsion of 2,2′-BPBPA in heptane using Brij L4® as a surfactant. The experiment was performed in duplicate.

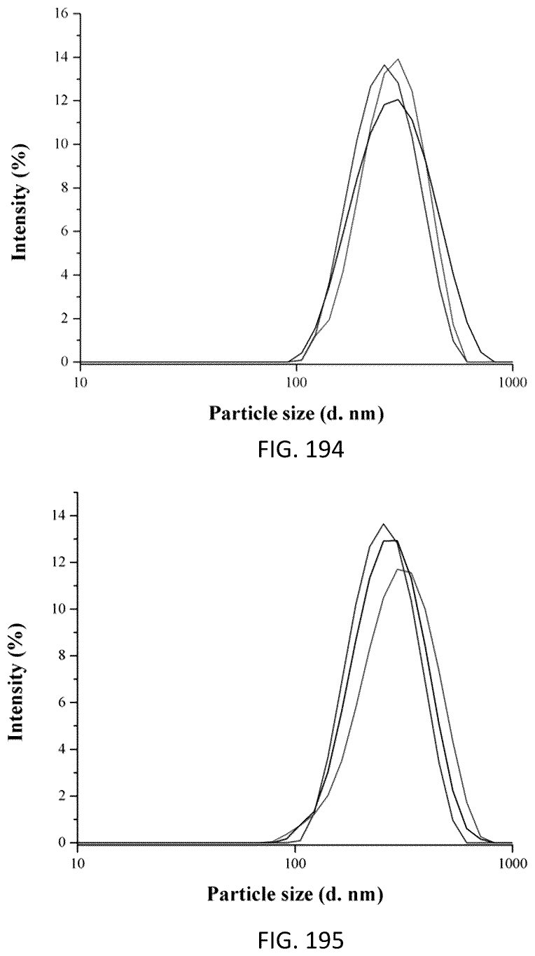

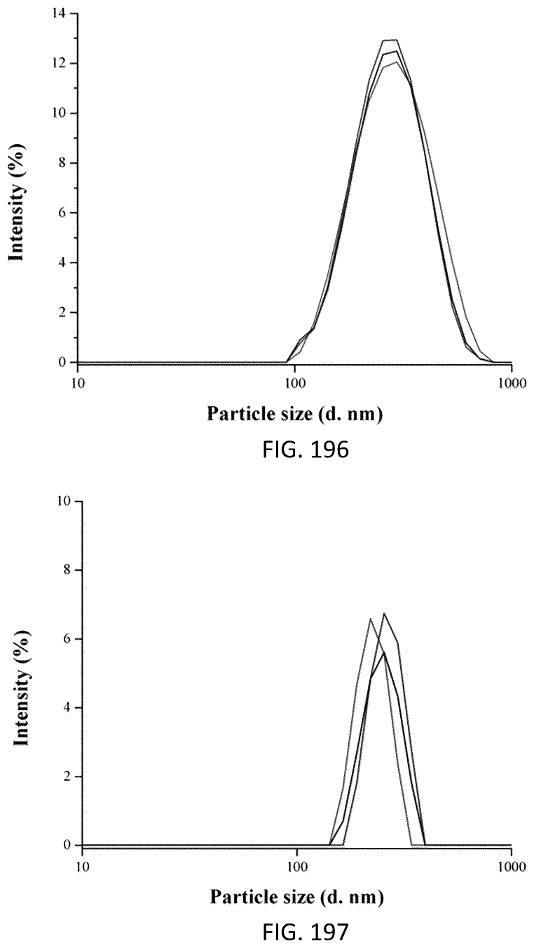

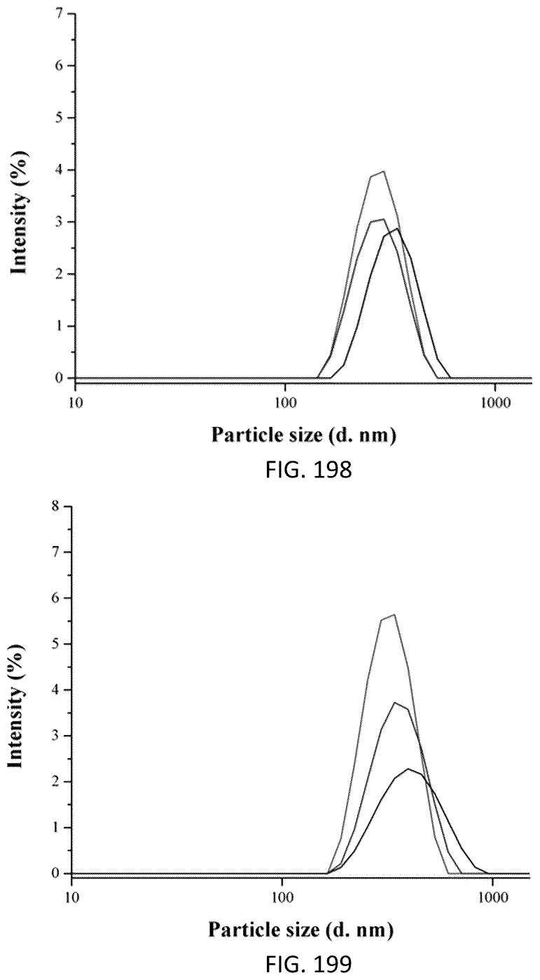

5.2. Synthesis of nano-Ca@2,2′-BPBPA: A Crystalline (Technobis, Crystallization Systems, Alkmaar, Netherlands) was employed to synthesize nano-Ca@2,2′BPBPA. The micro-emulsions earlier prepared for the PIT determination were used for these experiments. About 3.5 mL of this micro-emulsion was added to 8 mL reaction vials, along with stir bars and capped with reflux caps. These reaction vials were left in the Crystalline system at 7° C. for 30 min. After this period, the temperature was increased to 60° C. for 30 min to ensure the complete phase inversion of the 2,2′-BPBPA micro-emulsion. Then, the vials were heated to 80° C., and 3.5 mL of 1.1 mg/mL Ca(NO₃)₂·6H₂O was added. The reaction was left for 1 h at 80° C. to allow the formation of nano-Ca@2,2′BPBPA. Aliquots of the supernatant were measured employing dynamic light scattering (DLS) to assess the particle size distribution of the nano-Ca@2,2′-BPBPA (FIGS. 194-196).

5.3. Dynamic light scattering (DLS) measurements for nano-Ca@2,2′-BPBPA: DLS measurements were completed to explore the particle size distribution (supernatant) of the obtained nano-Ca@2,2′-BPBPA. Aliquots (50 μL) were prepared (1:20 dilution ratio) in disposable polystyrol/polystyrene cuvettes (REF: 67.754 10×10×45 mm, Sarsted, Germany). FIGS. 194-196 represents the particle size distribution curves for the aqueous phase of nano-Ca@2,2′-BPBPA.

TABLE 31
Particle size distribution parameters for nano-Ca@2,2′-BPBPA
from synthesis 2 determined by DLS. The measurements
were recorded in triplicate.
The particle size distribution of nano-Ca@2,2′-BPBPA

| | Size | | St. Dev. | |
|---|---|---|---|---|
| Run | (d · nm) | % Intensity | (d · nm) | PDI |
| 1 | 317.5 | 100.0 | 106.7 | 0.545 |
| 2 | 267.5 | 100.0 | 129.4 | 0.466 |
| 3 | 285.0 | 100.0 | 99.08 | 0.484 |
| Average | 288.1 | 100.0 | 111.73 | 0.498 |

TABLE 32
Particle size distribution parameters for nano-Ca@2,2′-BPBPA from
synthesis 3 determined by DLS. The measurements were
recorded in triplicate.
Particle size distribution of nano-Ca@2,2′-BPBPA

| | Size | | St. Dev. | |
|---|---|---|---|---|
| Run | (d · nm) | % Intensity | (d · nm) | PDI |
| 1 | 300.5 | 100.0 | 183.01 | 0.416 |
| 2 | 286.0 | 100.0 | 115.36 | 0.445 |
| 3 | 288.1 | 100.0 | 105.9 | 0.482 |
| Average | 291.5 | 100.0 | 134.75 | 0.448 |

TABLE 33
Particle size distribution parameters for nano-Ca@2,2′-BPBPA
determined by DLS in 10% FBS:PBS after 24 h.
The measurements were recorded in triplicate.
The particle size distribution of nano-Ca@2,2′-BPBPA

| | Size | | St. Dev. | |
|---|---|---|---|---|
| Run | (d · nm) | % Intensity | (d · nm) | PDI |
| 1 | 251.0 | 100.0 | 100.1 | 0.599 |
| 2 | 256.0 | 100.0 | 99.9 | 0.574 |
| 3 | 290.0 | 100.0 | 106.8 | 0.562 |
| Average | 266.0 | 100.0 | 102.3 | 0.578 |

TABLE 34
Particle size distribution parameters for nano-Ca@2,2′-BPBPA
determined by DLS in 10% FBS:PBS after 48 h.
The measurements were recorded in triplicate.
Particle size distribution of nano-Ca@2,2′-BPBPA

| | Size | | St. Dev | |
|---|---|---|---|---|
| Run | (d · nm) | % Intensity | (d · nm) | PDI |
| 1 | 282.0 | 100.0 | 105.2 | 0.318 |
| 2 | 305.0 | 100.0 | 98.3 | 0.316 |
| 3 | 284.0 | 100.0 | 89.6 | 0.397 |
| Average | 290.0 | 100.0 | 97.7 | 0.344 |

6. Binding assays for nano-Ca@2,2′-BPBPA

Calibration curve. The calibration curve of 2,2′-BPBPA in PBS earlier prepared (Section 4.1) was utilized to assess the concentration of 2,2′-BPBPA during the binding assay.

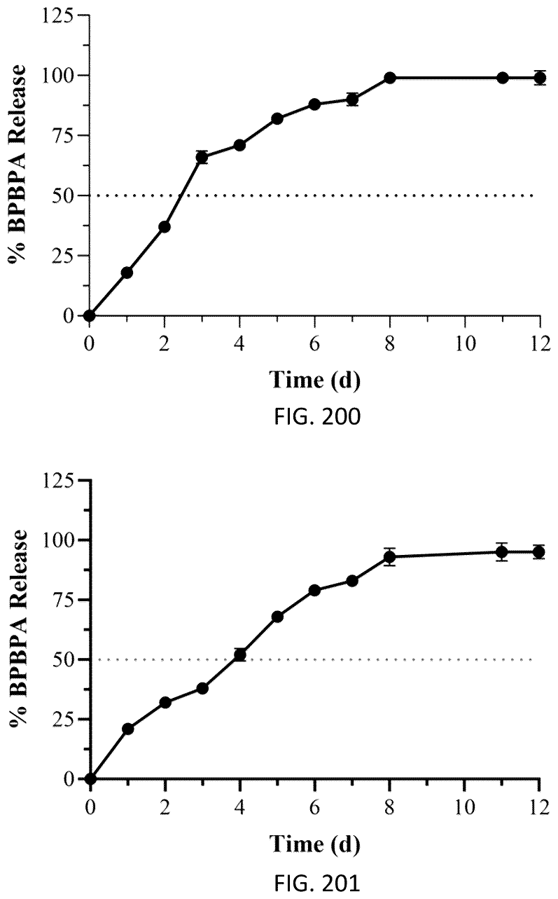

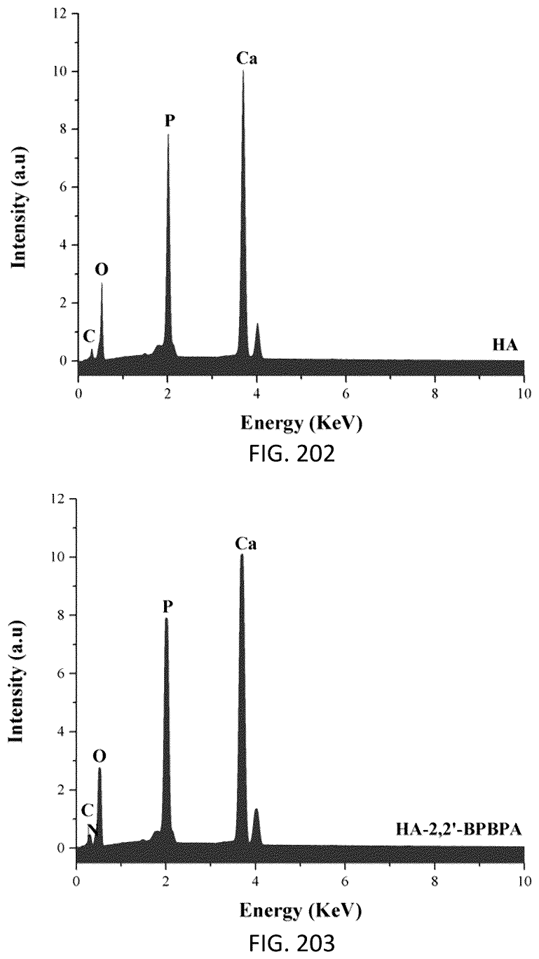

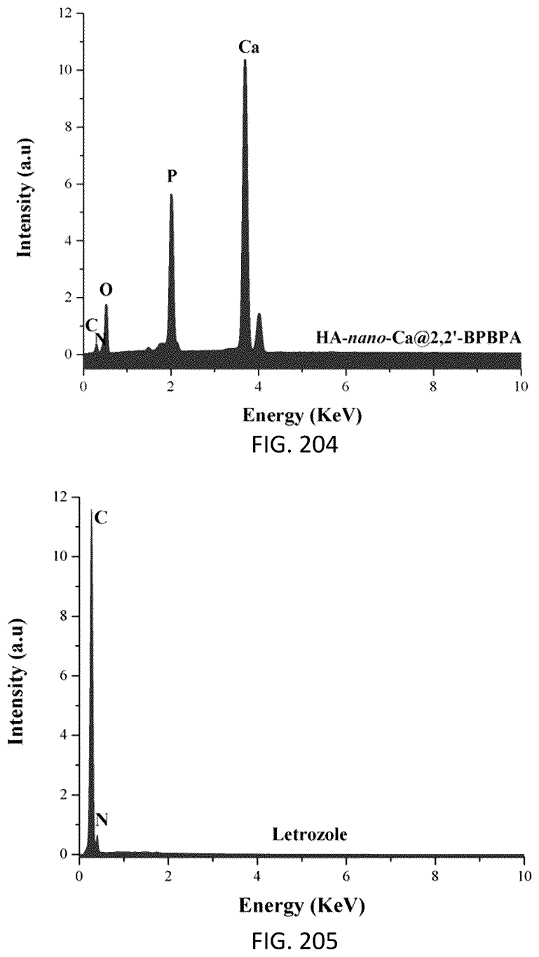

Binding assay with hydroxyapatite (HA). Synthetic HA was employed to explore the affinity of nano-Ca@2,2′-BPBPA to the bone microenvironment. HA (20 mg) was exposed to nano-Ca@2,2′-BPBPA (5 mL, 0.5 mg/mL). The 2,2′-BPBPA (0.5 mg/mL) and HA (20 mg) were used as control groups. All experimental and control groups were left under constant stirring (150 rpm) for 0-12 d. Finally, the supernatant was collected, centrifuged (5 min, 1500 rpm), and the absorbance was measured at λₘₐₓ=299 nm of maximum absorption (1, 2, 3, 4, 7, 8, 9, 10, 11, 12 d) to determine the amount (%) of 2,2′-BPBPA bound to HA after each period. Experiment was performed in duplicate. Once the experiment was completed, HA, HA-2,2′-BPBPA, and HA-nano-Ca@2,2′-BPBPA were characterized by SEM-EDS and PXRD. Table 35 present the percentage (%) of 2,2′-BPBPA and nano-Ca@2,2′-BPBPA bound to HA in PBS. FIGS. 200-201 show the binding curves for 2,2′-BPBPA and nano-Ca@2,2′-BPBPA. The EDS spectra for HA, HA-2,2′-BPBPA, and HA-nano-Ca@2,2′-BPBPA are displayed in FIGS. 202-204.

TABLE 35
Amount (%) of 2,2′-BPBPA and nano-Ca@2,2′-BPBPA bound to HA
at a concentration of 0.5 mg/mL. The mean and % CV are reported;
the experiment was performed in duplicate.

| | 2,2′-BPBPA | | nano-Ca@2,2′-BPBPA | |
|---|---|---|---|---|
| Time (d) | Mean | % CV | Mean | % CV |
| 1 | 18 | 3 | 21 | 3 |
| 2 | 37 | 3 | 32 | 2 |
| 3 | 66 | 4 | 38 | 3 |
| 4 | 71 | 2 | 52 | 5 |
| 5 | 82 | 1 | 68 | 3 |
| 6 | 88 | 2 | 79 | 3 |
| 7 | 90 | 3 | 83 | 1 |
| 8 | 99 | 2 | 93 | 4 |
| 11 | 99 | 1 | 95 | 4 |
| 12 | 99 | 3 | 95 | 3 |

7. Loading and Release of Letrozole (LET) into the 2,2′-BPBPA-Ca and nano-Ca@2,2′-BPBPA

7.1. Loading of LET into 2,2′BPBPA-Ca. LET was loaded into 2,2′-BPBPA-Ca in a 1.5-mL vial by transferring ˜20 mg of 2,2′-BPBPA-Ca, ˜7 mg of LET, and 1.0 mL of ethanol.

This suspension was left at 50° C. for 24 h. Successively, −7 mg of LET were added to the vial to allow the complete loading of LET into the 2,2′-BPBPA-Ca. The 2,2′-BPBPA-Ca (20 mg) and LET (7 mg) in ethanol (1 mL), respectively, were employed as control groups in separate vials.

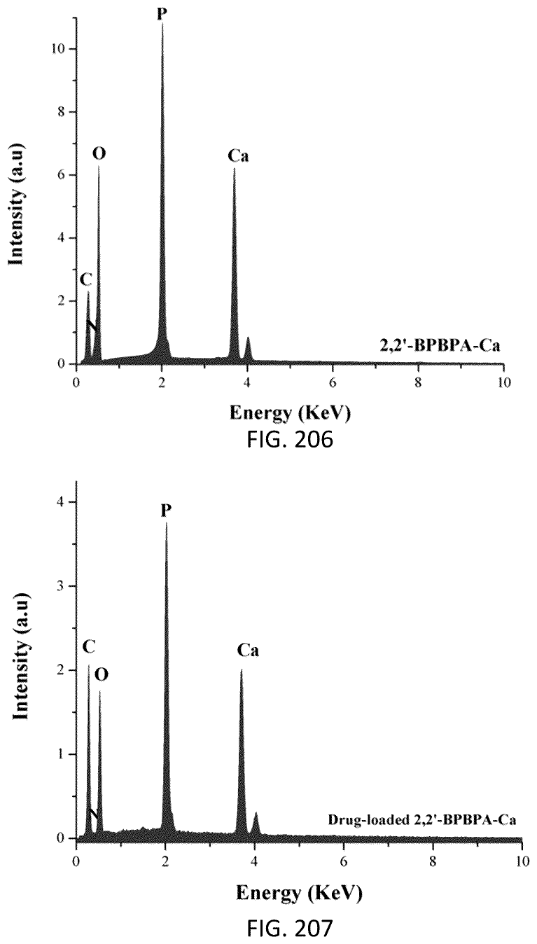

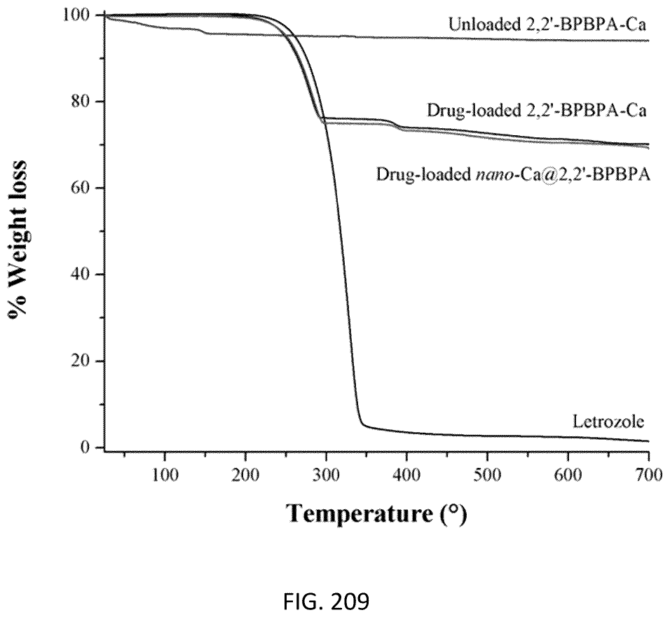

Finally, the supernatant was collected, filtrated, and the absorbance was measured at the λₘₐₓ of 299 nm (FIG. 205). The drug-loaded 2,2′-BPBPA-Ca (experimental), 2,2′-BPBPA-Ca (control), and LET (control) were characterized by SEM-EDS (FIGS. 205-207) and TGA (FIG. 209).

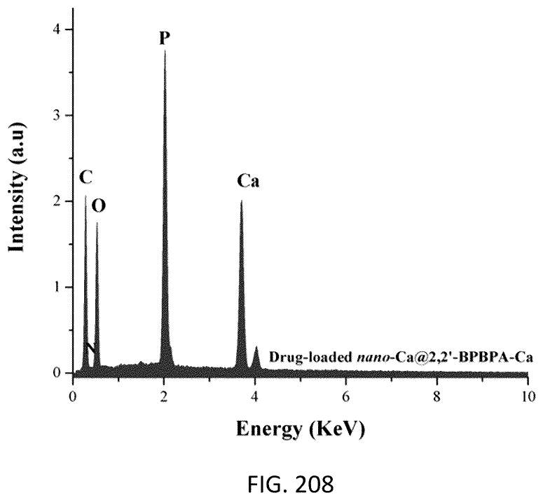

7.2. Loading of LET into nano-Ca@2,2′-BPBPA. The PIT-nanoemulsion method was employed to facilitate the loading of LET into the nano-Ca@2,2′-BPBPA. The synthesis of the nano-Ca@2,2′-BPBPA was performed as described in Section 5.2. Subsequently, about 2.5 mL of LET at a concentration of 0.30 mg/mL was added to 2.5 mL of the synthesized nano-Ca@2,2′-BPBPA. This mixture was left under stirring for 1 h allowing the loading of LET into the nano-Ca@2,2′-BPBPA. The drug-loaded nano-Ca@2,2′-BPBPA was characterized by EDS (FIG. 208) and TGA (FIG. 209).

7.3. Release of letrozole in fasted-state simulated gastric fluid from 2,2′-BPBPA-Ca.

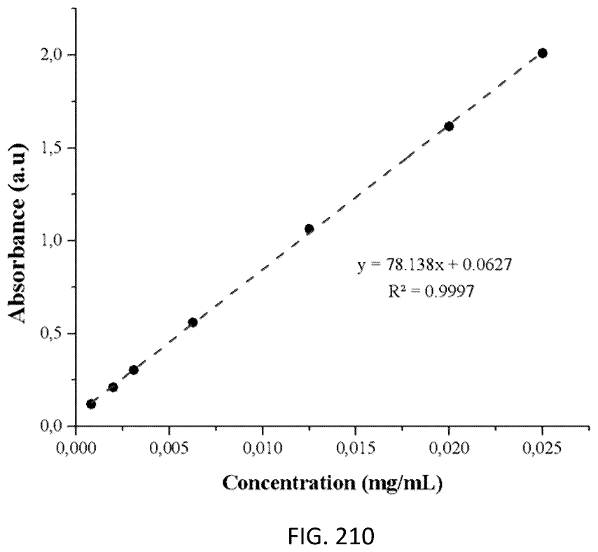

Calibration curve. A stock solution of 0.1 mg/mL of LET was prepared in FaSSGF. Then, two-fold serial dilutions were carried out to obtain concentrations of 0.025, 0.013, 0.063, 0.0031, 0.0016, 0.0008 mg/mL. The absorbance was measured (200-400 nm), and FaSSGF was employed as a solvent blank. The wavelength of maximum absorption (λₘₐₓ) was identified at 238 nm. FIG. 210 illustrates the calibration curve of LET in FaSSGF.

Release experiment. The release curve of LET from 2,2′-BPBPA-Ca was achieved in FaSSGF. About 100 mL of FaSSGF were placed in a 250-mL beaker and left in constant stirring at 37° C. (150 rpm). Subsequently, −20 mg of powdered drug-loaded 2,2′-BPBPA-Ca (experimental) were placed into the FaSSGF solution. After each time point (0, 1, 3, 6, 24, 48, and 72 h), an aliquot (1 mL) was taken out and diluted in a 5 mL volumetric flask. An aliquot was taken out before adding the drug-loaded material to record the first time point (0 h). Then, the absorbance was measured at 238 nm to determine the amount (%) of LET release from the 2,2′-BPBPA-Ca. The release curve of LET (control) in FaSSGF was used for comparison.

TABLE 36
Percentage (%) of letrozole (LET) released from the
2,2′-BPBPA-Ca in FaSSGF. The experiment was
accomplished in duplicate; the mean and % CV are reported.

| | Letrozole | | Drug-loaded 2,2′-BPBPA-Ca | |
|---|---|---|---|---|
| Time (h) | Mean | % CV | Mean | % CV |
| 1 | 65 | 4 | 0 | 0 |
| 3 | 72 | 2 | 3 | 2 |
| 6 | 75 | 4 | 7 | 3 |
| 24 | 93 | 3 | 10 | 4 |
| 48 | 94 | 2 | 18 | 2 |
| 72 | 94 | 3 | 19 | 3 |

8. Cytotoxicity assays for unloaded and drug-loaded nano-Ca@2,2′-BPBPA

Cell culture methods. MCF-7 and MDA-MB-231 were incubated using DMEM at 37° C. in 5% CO₂. The hFOB 1.19 cell lines were incubated with DMEM: F12 at 34° C. in 5% CO₂. Cell lines were supplemented using 10% FBS and 1% Pen-Strep. The media was replaced twice times per week. Cell passages were carried out at 80% confluency.

Seeding. Cell lines were seeded in 96 well plates at a density of 5×103 cells/mL; cells were incubated for 24 h before each treatment.

Treatment. Cell lines were treated with 100 μL of 2,2′-BPBPA (0-400 μM), unloaded and loaded nano-Ca@2,2′-BPBPA (6.3-50 μM). Control groups were treated with media (DMEM or DMEM: F12) supplemented with 1% Pen-Strep. All cell-based assays were conducted for 24, 48, and 72 h of treatment. Experiments were performed in triplicate.

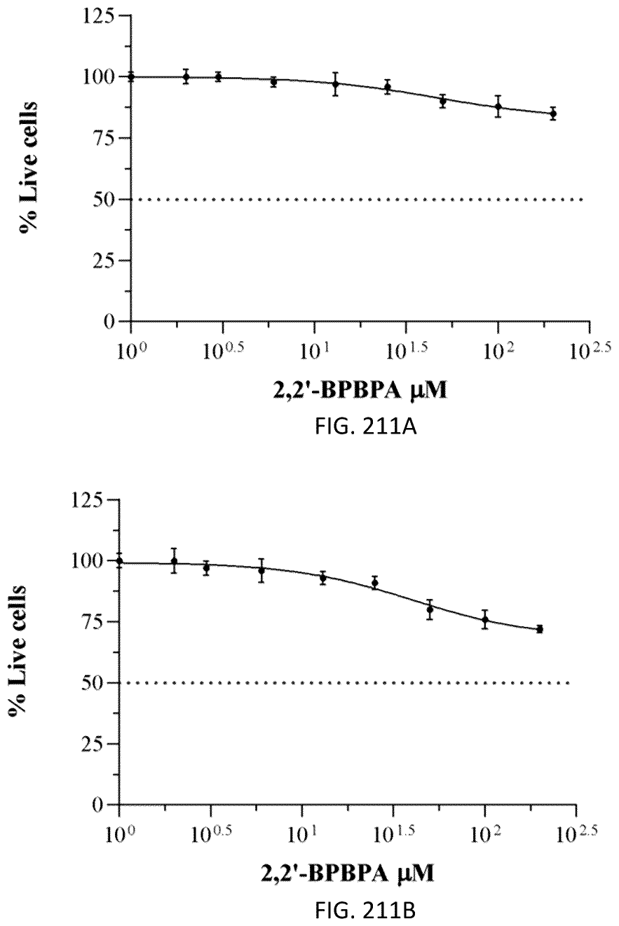

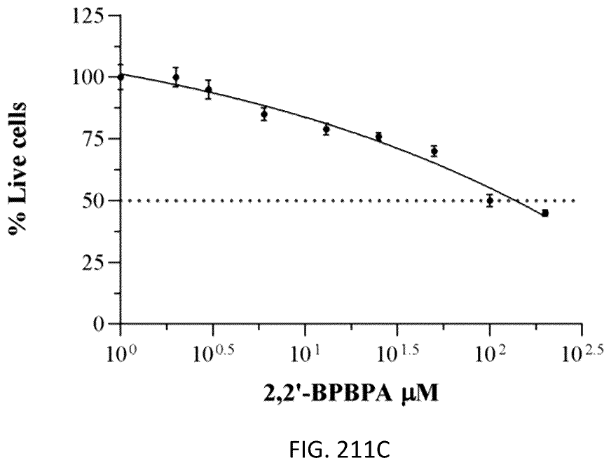

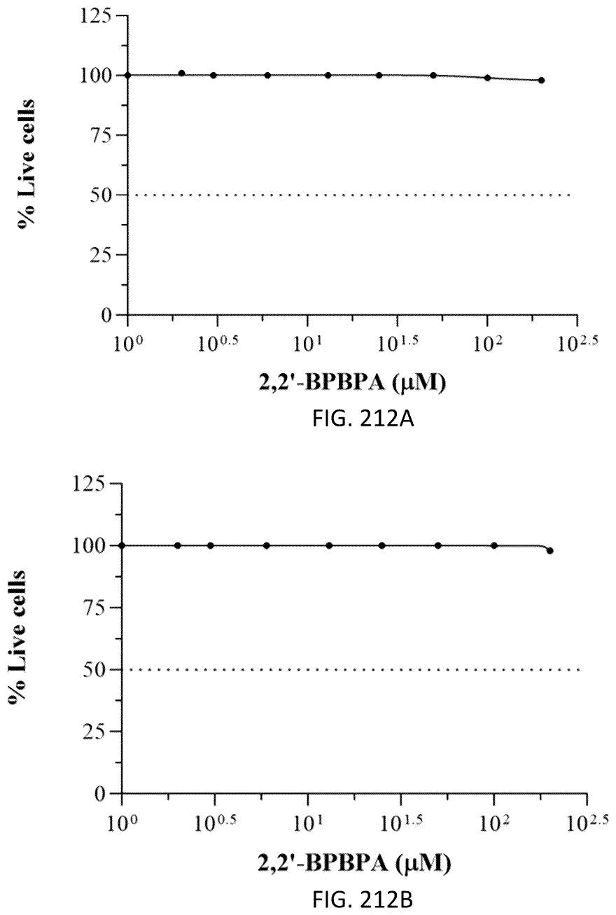

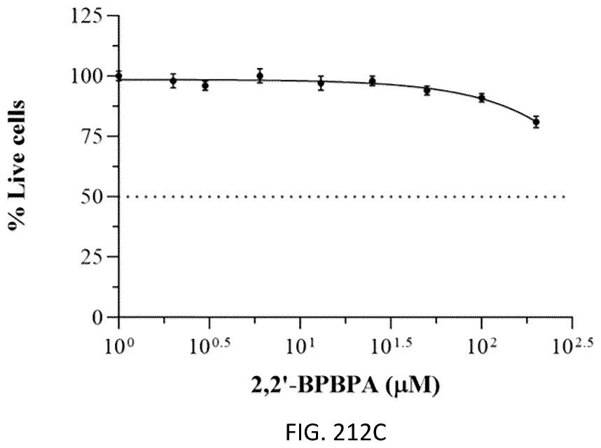

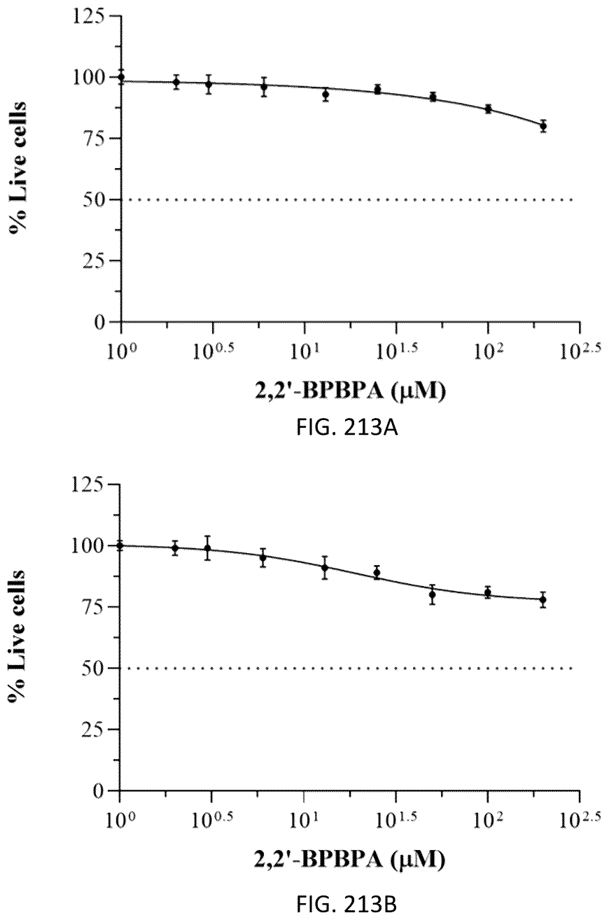

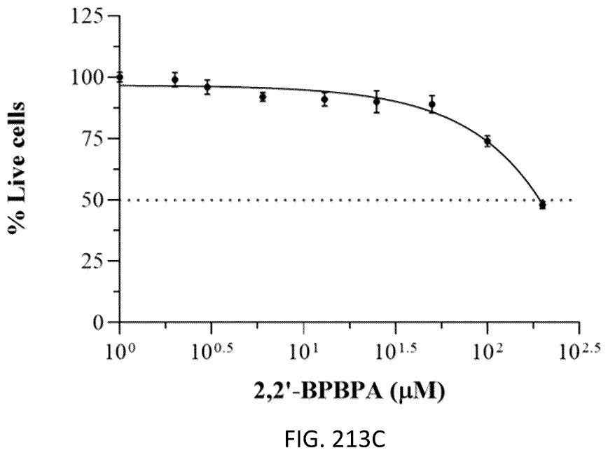

AlamarBlue@assay. To determine the cell viability, the media was removed and replaced with 100 μL of 10% AlamarBlue® solution. The 96 well plates were incubated for 4 h before the measurements. Then, the fluorescence was assessed at 560 nm of excitation and λₘₐₓ 590 nm of emission. The IC₅₀ curves for MCF-7, MDA-MB-231, and hFOB 1.19 cell lines treated with 2,2′-BPBPA are presented in FIGS. 211A-211C, 212A-212C, and 213A-213C.

### Zoledronate-based Compounds References

(1) Ferlay, J.; Colombet, M.; Soerjomataram, I.; Mathers, C.; Parkin, D. M.; Pineros, M.; Znaor, A.; Bray, F. Estimating the Global Cancer Incidence and Mortality in 2018: GLOBOCAN Sources and Methods. International Journal of Cancer. Wiley-Liss Inc. Apr. 15, 2019, pp 1941-1953. https://doi.org/10.1002/ijc.31937.
(2) Siegel, R. L.; Miller, K. D.; Jemal, A. Cancer Statistics, 2019. CA. Cancer J. Clin. 2019, 69 (1), 7-34. https://doi.org/10.3322/caac.21551.
(3) Welsh, J. E. Animal Models for Studying Prevention and Treatment of Breast Cancer. In Animal Models for the Study of Human Disease; Elsevier Inc., 2013; pp 997-1018. https://doi.org/10.1016/B978—O-12-415894-8.00040-3.
(4) Hart, N. H.; Galvao, D. A.; Saunders, C.; Taaffe, D. R.; Feeney, K. T.; Spry, N. A.; Tsoi, D.; Martin, H.; Chee, R.; Clay, T.; et al. Mechanical Suppression of Osteolytic Bone Metastases in Advanced Breast Cancer Patients: A Randomised Controlled Study Protocol Evaluating Safety, Feasibility and Preliminary Efficacy of Exercise as a Targeted Medicine. Trials. BioMed Central Ltd. Dec. 20, 2018. https://doi.org/10.1186/s13063-018-3091-8.
(5) Mundy, G. R. Metastasis to Bone: Causes, Consequences and Therapeutic Opportunities. Nature Reviews Cancer. August 2002, pp 584-593. https://doi.org/10.1038/nrc867.
(6) Diba, M.; Camargo, W. A.; Zinkevich, T.; Grunewald, A.; Detsch, R.; Kabiri, Y.; Kentgens, A. P. M.; Boccaccini, A. R.; Van Den Beucken, J. J. J. P.; Leeuwenburgh, S. C. G. Hybrid Particles Derived from Alendronate and Bioactive Glass for Treatment of Osteoporotic Bone Defects. J. Mater. Chem. B 2019, 7 (5), 796-808. https://doi.org/10.1039/c8tb03062f.
(7) Paolino, D.; Licciardi, M.; Celia, C.; Giammona, G.; Fresta, M.; Cavallaro, G. Bisphosphonate-Polyaspartamide Conjugates as Bone Targeted Drug Delivery Systems. J. Mater. Chem. B 2015, 3 (2), 250-259. https://doi.org/10.1039/c4tb00955j.
(8) Guenin, E.; Ledoux, D.; Oudar, O.; Lecouvey, M.; Kraemer, M. Structure-Activity Relationships of a New Class of Aromatic Bisphosphonates That Inhibit Tumor Cell Proliferation in Vitro. Anticancer Res 2005, 25 (2 Å), 1139-1145.
(9) Giger, E. V.; Castagner, B.; Leroux, J. C. Biomedical Applications of Bisphosphonates. J. Control. Release 2013, 167 (2), 175-188. https://doi.org/10.1016/j.jconrel.2013.01.032.
(10) Clezardin, P.; Ebetino, F. H.; Fournier, P. G. Bisphosphonates and Cancer-Induced Bone Disease: Beyond Their Antiresorptive Activity. J. Cancer Res. 2005, 65 (12), 4971-4974.
(11) Alasmari, A.; Lin, S. C.; Dibart, S.; Salih, E. Bone Microenvironment-Mediated Resistance of Cancer Cells to Bisphosphonates and Impact on Bone Osteocytes/Stem Cells. Clin. Exp. Metastasis 2016, 33 (6), 563-588. https://doi.org/10.1007/s10585-016-9798-6.
(12) Lin, J. H. Bisphosphonates: A Review of Their Pharmacokinetic Properties. Bone. Elsevier Inc. 1996, pp 75-85. https://doi.org/10.1016/8756-3282(95)00445-9.
(13) Khosla, S.; Bilezikian, J. P.; Dempster, D. W.; Lewiecki, E. M.; Miller, P. D.; Neer, R. M.; Recker, R. R.; Shane, E.; Shoback, D.; Potts, J. T. Benefits and Risks of Bisphosphonate Therapy for Osteoporosis. Journal of Clinical Endocrinology andMetabolism. July 2012, pp 2272-2282. https://doi.org/10.1210/jc.2012-1027.
(14) Grey, A. Intravenous Zoledronate for Osteoporosis: Less Might Be More. Therapeutic Advances inMusculoskeletalDisease. SAGE Publications Ltd Aug. 1, 2016, pp 119-123. https://doi.org/10.1177/1759720X16650866.
(15) Majkowska, A.; Neves, M.; Antunes, I.; Bilewicz, A. Complexes of Low Energy Beta Emitters 47Sc and 177Lu with Zoledronic Acid for Bone Pain Therapy. Appl. Radiat. Isot. 2009, 67 (1), 11-13. https://doi.org/10.1016/j.apradiso.2008.08.014.
(16) Grey, A.; Bolland, M.; Mihov, B.; Wong, S.; Horne, A.; Gamble, G.; Reid, I. R. Duration of Antiresorptive Effects of Low-Dose Zoledronate in Osteopenic Postmenopausal Women: A Randomized, Placebo-Controlled Trial. J. Bone Miner. Res. 2014, 29 (1), 166-172. https://doi.org/i0.1002/jbmr.2009.
(17) Grey, A.; Bolland, M.; Wong, S.; Horne, A.; Gamble, G.; Reid, I. R. Low-Dose Zoledronate in Osteopenic Postmenopausal Women: A Randomized Controlled Trial. J. Clin. Endocrinol. Metab. 2012, 97 (1), 286-292. https://doi.org/10.1210/jc.2011-2081.
(18) Au, K. M.; Satterlee, A.; Min, Y.; Tian, X.; Kim, Y. S.; Caster, J. M.; Zhang, L.; Zhang, T.; Huang, L.; Wang, A. Z. Folate-Targeted PH-Responsive Calcium Zoledronate Nanoscale Metal-Organic Frameworks: Turning a Bone Antiresorptive Agent into an Anticancer Therapeutic. Biomaterials 2016, 82, 178-193. https://doi.org/10.1016/j.biomaterials.2015.12.018.
(19) Nikzad, M.; Jalilian, A. R.; Shirvani-Arani, S.; Bahrami-Samani, A.; Golchoubian, H. Production, Quality Control and Pharmacokinetic Studies of 177Lu-Zoledronate for Bone Pain Palliation Therapy. J. Radioanal. Nucl. Chem. 2013, 298 (2), 1273-1281. https://doi.org/10.1007/s10967-013-2490-2.
(20) Nikzad, M.; Jalilian, A. R.; Shirvani-Arani, S.; Arabieh, M.; Shanesazzadeh, S.; Golchoobian, H. Development and Assessment of 153Sm-Zoledronate Complex As a Possible Bone Pain Palliative Agent. Iran. J. Nucl. Med. 2017, 25 (249), 81-91.
(21) Nikzad, M.; Jalilian, A. R.; Shirvani-Arani, S.; Bahrami Samani, A.; Golchobian, H. Development of 166Ho-Zoledronate as a Bone Marrow Ablative Agent. Pharm. Biomed. Res. 2016, 2 (1), 14-22. https://doi.org/10.18869/acadpub.pbr.2.1.14.
(22) Li, W.; Xin, X.; Jing, S.; Zhang, X.; Chen, K.; Chen, D.; Hu, H. Organic Metal Complexes Based on Zoledronate-Calcium: A Potential PDNA Delivery System. J. Mater. Chem. B 2017, 5 (8), 1601-1610. https://doi.org/10.1039/c6tb03041f.
(23) Liu, D.; Kramer, S. A.; Huxford-phillips, R. C.; Wang, S.; Rocca, J. Della; Lin, W. Coercing Bisphosphonates to Kill Cancer Cells with Nanoscale Coordination Polymers. Chem Commun 2012, 48, 2668-2670. https://doi.org/10.1039/c2cc17635a.
(24) Quinones Velez, G.; Carmona-Sarabia, L.; Rodriguez-Silva, W. A.; Rivera Raices, A. A.; Feliciano-Cruz, L.; Hu, C. T.; Peterson, E. A.; Lopez-Mejias, V. Potentiating Bisphosphonate-Based Coordination Complexes to Treat Osteolytic Metastases. J. Mater. Chem. B 2020, 8 (10), 2155-2168.
(25) Freire, E.; Vega, D. R. Aquabis[1-Hydroxy-2-(Imidazol-3-Ium-1-Yl)-1,1′-Ethylidenediphophonato-K2 O,O′] Zinc(II) Dihydrate. Acta Crystallogr. Sect. E Struct. Reports Online 2009, 65 (11). https://doi.org/10.107/δ160053680904286X.
(26) Freire, E.; Vega, D. R.; Baggio, R. Zoledronate Complexes. III. Two Zoledronate Complexes with Alkaline Earth Metals: [Mg(C5H9N2O7P 2)2(H₂O)₂] and [Ca(C 5H₈N2O7P2)(H 20)]N. Acta Crystallogr. Sect. C Cryst. Struct. Commun. 2010, 66 (6). https://doi.org/10.1107/δ0108270110017634.
(27) Freire, E.; Vega, D. R. Diaqua-Bis[1-Hydroxy-2-(Imidazol-3-Ium-1-Yl)-1,1′-Ethyl-Idenediphophonato-K2 O,O′] Zinc(II). Acta Crystallogr. Sect. E Struct. Reports Online 2009, 65 (11). https://doi.org/10.1107/51600536809042858.
(28) Zhang, Z. C.; Li, R. Q.; Zhang, Y. Diaquabis{[1-Hydr-Oxy-2-(1H-Imidazol-3-Ium-1-Yl)Ethane-1,1-Di-Yl] Bis-(Hydrogen Phospho-Nato)}manganese(II). Acta Crystallogr. Sect. EStruct. Reports Online 2009, 65 (12). https://doi.org/10.1107/δ160053680905065X.
(29) Cao, D. K.; Li, Y. Z.; Zheng, L. M. Layered Cobalt(II) and Nickel(II) Diphosphonates Showing Canted Antiferromagnetism and Slow Relaxation Behavior. Inorg. Chem. 2007, 46 (18), 7571-7578. https://doi.org/10.1021/ic701098t.
(30) Kato, Y.; Ozawa, S.; Miyamoto, C.; Maehata, Y.; Suzuki, A.; Maeda, T.; Baba, Y. Acidic Extracellular Microenvironment and Cancer. Cancer Cell Int. 2013, 13 (1), 1-8. https://doi.org/10.1186/1475-2867-13-89.
(31) Coleman, R.; Body, J. J.; Aapro, M.; Hadji, P.; Herrstedt, J. Bone Health in Cancer Patients: ESMO Clinical Practice Guidelines. Ann. Oncol. 2014, 25, 124-137. https://doi.org/10.1093/annonc/mdu103.
(32) Tsuzuki, S.; Park, S. H.; Eber, M. R.; Peters, C. M.; Shiozawa, Y. Skeletal Complications in Cancer Patients with Bone Metastases. International Journal of Urology. Blackwell Publishing Oct. 1, 2016, pp 825-832. https://doi.org/10.1111/iju.13170.
(33) Pugazhendhi, A.; Edison, T. N. J. I.; Karuppusamy, I.; Kathirvel, B. Inorganic Nanoparticles: A Potential Cancer Therapy for Human Welfare. International Journal of Pharmaceutics. Elsevier B.V. Mar. 25, 2018, pp 104-111. https://doi.org/10.1016/j.ijpharm.2018.01.034.
(34) Croset, M.; Clezardin, P. MicroRNA-Mediated Regulation of Bone Metastasis Formation: From Primary Tumors to Skeleton. In Bone Cancer: Primary Bone Cancers and Bone Metastases: Second Edition; Elsevier Inc., 2014; pp 479-489. https://doi.org/10.1016/B978—O-12-416721-6.00041-8.
(35) Harris, S. A.; Enger, R. J.; Riggs, L. B.; Spelsberg, T. C. Development and Characterization of a Conditionally Immortalized Human Fetal Osteoblastic Cell Line. J. Bone Miner. Res. 1995, 10 (2), 178-186.

### Risedronate-Based Compounds References

(1) Lipton, A. Bisphosphonates and Metastatic Breast Carcinoma. Cancer 2003, 97 (3 SUPPL.), 848-853. https://doi.org/10.1002/cncr.11123.
(2) Goldvaser, H.; Amir, E. Role of Bisphosphonates in Breast Cancer Therapy. Curr. Treat. Options Oncol. 2019, 20 (4). https://doi.org/10.1007/s11864-019-0623-8.
(3) Hart, N. H.; Galvao, D. A.; Saunders, C.; Taaffe, D. R.; Feeney, K. T.; Spry, N. A.; Tsoi, D.; Martin, H.; Chee, R.; Clay, T.; et al. Mechanical Suppression of Osteolytic Bone Metastases in Advanced Breast Cancer Patients: A Randomised Controlled Study Protocol Evaluating Safety, Feasibility and Preliminary Efficacy of Exercise as a Targeted Medicine. Trials. BioMed Central Ltd. Dec. 20, 2018. https://doi.org/10.1186/s13063-018-3091-8.
(4) Diba, M.; Camargo, W. A.; Zinkevich, T.; Grunewald, A.; Detsch, R.; Kabiri, Y.; Kentgens, A. P. M.; Boccaccini, A. R.; Van Den Beucken, J. J. J. P.; Leeuwenburgh, S. C. G. Hybrid Particles Derived from Alendronate and Bioactive Glass for Treatment of Osteoporotic Bone Defects. J. Mater. Chem. B 2019, 7 (5), 796-808. https://doi.org/10.1039/c8tb03062f.
(5) Mundy, G. R. Metastasis to Bone: Causes, Consequences and Therapeutic Opportunities. Nature Reviews Cancer. August 2002, pp 584-593. https://doi.org/10.1038/nrc867.
(6) Paolino, D.; Licciardi, M.; Celia, C.; Giammona, G.; Fresta, M.; Cavallaro, G. Bisphosphonate-Polyaspartamide Conjugates as Bone Targeted Drug Delivery Systems. J. Mater. Chem. B 2015, 3 (2), 250-259. https://doi.org/10.1039/c4tb00955j.
(7) Welsh, J. E. Animal Models for Studying Prevention and Treatment of Breast Cancer. In Animal Models for the Study of Human Disease; Elsevier Inc., 2013; pp 997-1018. https://doi.org/10.1016/B978—O-12-415894-8.00040-3.
(8) Roelofs, A. J.; Thompson, K.; Gordon, S.; Rogers, M. J.; Boyce; Roodman; Suva; Coleman; Weilbaecher; Bruland; et al. Molecular Mechanisms of Action of Bisphosphonates: Current Status. Clin. Cancer Res. 2006, 12 (20 PART 2). https://doi.org/10.1158/1078-0432.CCR-06-0843.
(9) Guenin, E.; Ledoux, D.; Oudar, O.; Lecouvey, M.; Kraemer, M. Structure-Activity Relationships of a New Class of Aromatic Bisphosphonates That Inhibit Tumor Cell Proliferation in Vitro. Anticancer Res 2005, 25 (2 Å), 1139-1145.
(10) Giger, E. V.; Castagner, B.; Leroux, J. C. Biomedical Applications of Bisphosphonates. J. Control. Release 2013, 167 (2), 175-188. https://doi.org/10.1016/j.jconrel.2013.01.032.
(11) Clezardin, P.; Ebetino, F. H.; Fournier, P. G. Bisphosphonates and Cancer-Induced Bone Disease: Beyond Their Antiresorptive Activity. J. Cancer Res. 2005, 65 (12), 4971-4974.
(12) Lin, J. H. Bisphosphonates: A Review of Their Pharmacokinetic Properties. Bone. Elsevier Inc. 1996, pp 75-85. https://doi.org/10.1016/8756-3282(95)00445-9.
(13) Khosla, S.; Bilezikian, J. P.; Dempster, D. W.; Lewiecki, E. M.; Miller, P. D.; Neer, R. M.; Recker, R. R.; Shane, E.; Shoback, D.; Potts, J. T. Benefits and Risks of Bisphosphonate Therapy for Osteoporosis. Journal of Clinical Endocrinology andMetabolism. July 2012, pp 2272-2282. https://doi.org/10.1210/jc.2012-1027.
(14) Au, K. M.; Satterlee, A.; Min, Y.; Tian, X.; Kim, Y. S.; Caster, J. M.; Zhang, L.; Zhang, T.; Huang, L.; Wang, A. Z. Folate-Targeted PH-Responsive Calcium Zoledronate Nanoscale Metal-Organic Frameworks: Turning a Bone Antiresorptive Agent into an Anticancer Therapeutic. Biomaterials 2016, 82 (2016), 178-193. https://doi.org/10.1016/j.biomaterials.2015.12.018.
(15) Li, W.; Xin, X.; Jing, S.; Zhang, X.; Chen, K.; Chen, D.; Hu, H. Organic Metal Complexes Based on Zoledronate-Calcium: A Potential PDNA Delivery System. J. Mater. Chem. B 2017, 5 (8), 1601-1610. https://doi.org/10.1039/c6tb03041f.
(16) Liu, D.; Kramer, S. A.; Huxford-phillips, R. C.; Wang, S.; Rocca, J. Della; Lin, W. Coercing Bisphosphonates to Kill Cancer Cells with Nanoscale Coordination Polymers. Chem Commun 2012, 48, 2668-2670. https://doi.org/10.1039/c2cc17635a.
(17) Mitchell, D. Y.; Barr, W. H.; Eusebio, R. A.; Pallone Stevens, K. A.; Duke, F. P.; Russell, D. A.; Nesbitt, J. D.; Powell, J. H.; Thompson, G. A. Risedronate Pharmacokinetics and Intra- and Inter-Subject Variability upon Single-Dose Intravenous and Oral Administration. Pharm. Res. 2001, 18 (2), 166-170. https://doi.org/10.1023/A:1011024200280.
(18) Demoro, B.; Caruso, F.; Rossi, M.; Benitez, D.; Gonzalez, M.; Cerecetto, H.; Paraj6n-Costa, B.; Castiglioni, J.; Galizzi, M.; Docampo, R.; et al. Risedronate Metal Complexes Potentially Active against Chagas Disease. J. Inorg. Biochem. 2010, 104 (12), 1252-1258. https://doi.org/10.1016/j.jinorgbio.2010.08.004.
(19) Quinones Velez, G.; Carmona-Sarabia, L.; Rodriguez-Silva, W. A.; Rivera Raices, A. A.; Feliciano-Cruz, L.; Hu, C. T.; Peterson, E. A.; Lopez-Mejias, V. Potentiating Bisphosphonate-Based Coordination Complexes to Treat Osteolytic Metastases. J. Mater. Chem. B 2020, 8 (10), 2155-2168.
(20) Hu, J.; Zhao, J.; Hou, H.; Fan, Y. Syntheses, Structures and Fluorescence Studies of Two New Cadmium(II) Pyridyl-Diphosphonates. Inorg. Chem. Commun. 2008, 11 (10), 1110-1112. https://doi.org/10.1016/j.inoche.2008.06.013.
(21) Bretti, C.; De Stefano, C.; Cardiano, P.; Cataldo, S.; Pettignano, A.; Arena, G.; Sgarlata, C.; Ida Grasso, G.; Lando, G.; Sammartano, S. Risedronate Complexes with Mg²⁺, Zn²⁺, Pb²⁺, and Cu²⁺: Species Thermodynamics and Sequestering Ability in NaCl(Aq) at Different Ionic Strengths and at T=298.15 K. J. Mol. Liq. 2021, 343. https://doi.org/10.1016/j.molliq.2021.117699.
(22) Barbey, C.; Lecouvey, M. Crystal Structure of (1-Hydroxy-1-Phosphono-2-Pyridin-3-Yl-Ethyl)-Phos-Phonic Acid (Risedronate), C₇H₁₁NO₇P₂·H₂O, an Antiresorptive Bones Drug. Zeitschrift fur Krist.—New Cryst. Struct. 2002, 217 (JG), 137-138. https://doi.org/10.1524/ncrs.2002.217.jg.137.
(23) Walker, A. D.; Adachi, J. D. In Vitro Disintegration Studies of Weekly Generic and Branded Risedronate Sodium Formulations Available in Canada. Curr. Med. Res. Opin. 2011, 27(9), 1749-1754. https://doi.org/10.1185/03007995.2011.604309.
(24) Reid, D. M.; Hosking, D.; Kendler, D.; Brandi, M. L.; Wark, J. D.; Marques-Neto, J. F.; Weryha, G.; Verbruggen, N.; Hustad, C. M.; Mahlis, E. M.; et al. A Comparison of the Effect of Alendronate and Risedronate on Bone Mineral Density in Postmenopausal Women with Osteoporosis: 24-Month Results from FACTS-International. Int. J. Clin. Pract. 2008, 62 (4), 575-584. https://doi.org/10.1111/j.1742-1241.2008.01704.x.
(25) Kato, Y.; Ozawa, S.; Miyamoto, C.; Maehata, Y.; Suzuki, A.; Maeda, T.; Baba, Y. Acidic Extracellular Microenvironment and Cancer. Cancer Cell Int. 2013, 13 (1), 1-8. https://doi.org/10.1186/1475-2867-13-89.
(26) Coleman, R.; Body, J. J.; Aapro, M.; Hadji, P.; Herrstedt, J. Bone Health in Cancer Patients: ESMO Clinical Practice Guidelines. Ann. Oncol. 2014, 25, 124-137. https://doi.org/10.1093/annonc/mdu103.
(27) Tsuzuki, S.; Park, S. H.; Eber, M. R.; Peters, C. M.; Shiozawa, Y. Skeletal Complications in Cancer Patients with Bone Metastases. International Journal of Urology. Blackwell Publishing Oct. 1, 2016, pp 825-832. https://doi.org/10.1111/iju.13170.
(28) Pugazhendhi, A.; Edison, T. N. J. I.; Karuppusamy, I.; Kathirvel, B. Inorganic Nanoparticles: A Potential Cancer Therapy for Human Welfare. International Journal of Pharmaceutics. Elsevier B.V. Mar. 25, 2018, pp 104-111. https://doi.org/10.1016/j.ijpharm.2018.01.034.
(29) Croset, M.; Clezardin, P. MicroRNA-Mediated Regulation of Bone Metastasis Formation: From Primary Tumors to Skeleton. In Bone Cancer: Primary Bone Cancers and Bone Metastases: Second Edition; Elsevier Inc., 2014; pp 479-489. https://doi.org/10.1016/B978—O-12-416721-6.00041-8. (30) Harris, S. A.; Enger, R. J.; Riggs, L. B.; Spelsberg, T. C. Development and Characterization of a Conditionally Immortalized Human Fetal Osteoblastic Cell Line. J. Bone Miner. Res. 1995, 10 (2), 178-186.

### Supporting Information References

(1) Barbey, C.; Lecouvey, M. Crystal Structure of (1-Hydroxy-1-Phosphono-2-Pyridin-3-Yl-Ethyl)-Phos-Phonic Acid (Risedronate), C₇H₁₁NO₇P₂·H₂O, an Antiresorptive Bones Drug. Zeitschrift fur Krist.—New Cryst. Struct. 2002, 217 (JG), 137-138. https://doi.org/10.1524/ncrs.2002.217.jg.137.
(2) Hu, J.; Zhao, J.; Hou, H.; Fan, Y. Syntheses, Structures and Fluorescence Studies of Two New Cadmium(II) Pyridyl-Diphosphonates. Inorg. Chem. Commun. 2008, 11 (10), 1110-1112. https://doi.org/10.1016/j.inoche.2008.06.013.
(3) Demoro, B.; Caruso, F.; Rossi, M.; Benitez, D.; Gonzalez, M.; Cerecetto, H.; Paraj6n-Costa, B.; Castiglioni, J.; Galizzi, M.; Docampo, R.; et al. Risedronate Metal Complexes Potentially Active against Chagas Disease. J. Inorg. Biochem. 2010, 104 (12), 1252-1258. https://doi.org/10.1016/j.jinorgbio.2010.08.004.

### BPBPA-Based Compounds References

(1) Rucci, N.; Ricevuto, E.; Ficorella, C.; Longo, M.; Perez, M.; Di Giacinto, C.; Funari, A.; Teti, A.; Migliaccio, S. In Vivo Bone Metastases, Osteoclastogenic Ability, and Phenotypic Characterization of Human Breast Cancer Cells. Bone 2004, 34 (4), 697-709.
(2) Spinello, A.; Martini, S.; Berti, F.; Pennati, M.; Pavlin, M.; Sgrignani, J.; Grazioso, G.; Colombo, G.; Zaffaroni, N.; Magistrato, A. Rational Design of Allosteric Modulators of the Aromatase Enzyme: An Unprecedented Therapeutic Strategy to Fight Breast Cancer. Eur. J. Med. Chem. 2019, 168, 253-262.
(3) Siegel, R. L.; Miller, K. D.; Fuchs, H. E.; Jemal, A. Cancer Statistics, 2022. CA. Cancer J. Clin. 2022, 72 (1), 7-33.
(4) Harborg, S.; Zachariae, R.; Olsen, J.; Johannsen, M.; Cronin-Fenton, D.; Boggild, H.; Borgquist, S. Overweight and Prognosis in Triple-Negative Breast Cancer Patients: A Systematic Review and Meta-Analysis. npjBreast Cancer 2021, 7 (1).
(5) Chen, Y. C.; Sosnoski, D. M.; Mastro, A. M. Breast Cancer Metastasis to the Bone: Mechanisms of Bone Loss. Breast Cancer Res. 2010, 12 (6).
(6) Holen, I.; Coleman, R. E. Bisphosphonates as Treatment of Bone Metastases. 2010, 16, 1262-1271.
(7) Marazzi, F.; Orlandi, A.; Manfrida, S.; Masiello, V.; Di Leone, A.; Massaccesi, M.; Moschella, F.; Franceschini, G.; Bria, E.; Gambacorta, M. A.; et al. Diagnosis and Treatment of Bone Metastases in Breast Cancer: Radiotherapy, Local Approach and Systemic Therapy in a Guide for Clinicians. Cancers (Basel). 2020, 12 (9), 1-20.
(8) Lin, Y.; Villacanas, M. G.; Zou, H.; Liu, H.; Carcedo, I. G.; Wu, Y.; Sun, B.; Wu, X.; Prasadam, I.; Monteiro, M. J.; et al. Calcium-Bisphosphonate Nanoparticle Platform as a Prolonged Nanodrug and Bone-Targeted Delivery System for Bone Diseases and Cancers. ACS Appl. Bio Mater. 2021, 4 (3), 2490-2501.
(9) Ma, S.; Goh, E. L.; Jin, A.; Bhattacharya, R.; Boughton, O. R.; Patel, B.; Karunaratne, A.; Vo, N. T.; Atwood, R.; Cobb, J. P.; et al. Long-Term Effects of Bisphosphonate Therapy: Perforations, Microcracks and Mechanical Properties. Sci. Rep. 2017, 7 (January), 1-10.
(10) Nogues, X.; Martinez-Laguna, D. Update on Osteoporosis Treatment. Med. Clin. (Barc). 2018, 150 (12), 479-486. https://doi.org/10.1016/j.medcli.2017.10.019.
(11) Orellana-Tavra, C.; Koppen, M.; Li, A.; Stock, N.; Fairen-Jimenez, D. Biocompatible, Crystalline, and Amorphous Bismuth-Based Metal-Organic Frameworks for Drug Delivery. ACSAppl. Mater. Interfaces 2020, 12 (5), 5633-5641.
(12) Rojas, S.; Horcajada, P. Understanding the Incorporation and Release of Salicylic Acid in Metal-Organic Frameworks for Topical Administration. Eur. J. Inorg. Chem. 2021, 2021 (14), 1325-1331.
(13) Sun, Y.; Zheng, L.; Yang, Y.; Qian, X.; Fu, T.; Li, X.; Yang, Z.; Yan, H.; Cui, C.; Tan, W. Metal-Organic Framework Nanocarriers for Drug Delivery in Biomedical Applications. Nano-Micro Lett. 2020, 12 (1).
(14) Wang, Y.; Yan, J.; Wen, N.; Xiong, H.; Cai, S.; He, Q.; Hu, Y.; Peng, D.; Liu, Z.; Liu, Y. Metal-Organic Frameworks for Stimuli-Responsive Drug Delivery. Biomaterials 2020, 230, 119619.
(15) Rodrigues, N. M.; Martins, J. B. L. Theoretical Evaluation of the Performance of IRMOFs and M-MOF-74 in the Formation of 5-Fluorouracil@MOF. RSCAdv. 2021, 11 (49), 31090-31097.
(16) Liu, W.; Pan, Y.; Zhong, Y.; Li, B.; Ding, Q.; Xu, H.; Qiu, Y.; Ren, F.; Li, B.; Muddassir, M.; et al. A Multifunctional Aminated UiO-67 Metal-Organic Framework for Enhancing Antitumor Cytotoxicity through Bimodal Drug Delivery. Chem. Eng. J. 2021, 412. https://doi.org/10.1016/j.cej.2020.127899.
(17) Quinones Velez, G.; Carmona-Sarabia, L.; Rodriguez-Silva, W. A.; Rivera Raices, A. A.; Feliciano-Cruz, L.; Hu, C. T.; Peterson, E. A.; Lopez-Mejias, V. Potentiating Bisphosphonate-Based Coordination Complexes to Treat Osteolytic Metastases. J. Mater. Chem. B 2020, 8 (10), 2155-2168.
(18) Quinones Velez, G.; Carmona-Sarabia, L.; Rivera Raices, A. A.; Hu, T.; Peterson-Peguero, E. A.; L6pez-Mejias, V. High Affinity Zoledronate-Based Metal Complex Nanocrystals to Potentially Treat Osteolytic Metastases. Mater. Adv. 2022, 3 (7), 3251-3266.
(19) Kennel, K. A.; Drake, M. T. Adverse Effects of Bisphosphonates: Implications for Osteoporosis Management. Mayo Clin. Proc. 2009, 84 (7), 632-638.
(20) Yamaguchi, M. Role of Nutritional Zinc in the Prevention of Osteoporosis. Mol. Cell. Biochem. 2010, 338 (1-2), 241-254.
(21) Castiglioni, S.; Cazzaniga, A.; Albisetti, W.; Maier, J. A. M. Magnesium and Osteoporosis: Current State of Knowledge and Future Research Directions. Nutrients 2013, 5 (8), 3022-3033.
(22) Lecouvey, M.; Mallard, I.; Bailly, T.; Burgada, R.; Leroux, Y. A Mild and Efficient One-Pot Synthesis of 1-Hydroxymethylene-1,1-Bisphosphonic Acids. Preparation of New Tripod Ligands. Tetrahedron Lett. 2001, 42 (48), 8475-8478.
(23) Guenin, E.; Degache, E.; Liquier, J.; Lecouvey, M. Synthesis of 1-Hydroxymethylene-1,1-Bis(Phosphonic Acids) from Acid Anhydrides: Preparation of a New Cyclic 1-Acyloxymethylene-1,1-Bis(Phosphonic Acid). European J. Org. Chem. 2004, 14, 2983-2987.
(24) Guenin, E.; Ledoux, D.; Oudar, O.; Lecouvey, M.; Kraemer, M. Structure-Activity Relationships of a New Class of Aromatic Bisphosphonates That Inhibit Tumor Cell Proliferation in Vitro. Anticancer Res 2005, 25 (2 Å), 1139-1145.
(25) Egorov, M.; Aoun, S.; Padrines, M.; Redini, F.; Heymann, D.; Lebreton, J.; Mathe-Allainmat, M. A One-Pot Synthesis of 1-Hydroxy-1,1-Bis(Phosphonic Acid)s Starting from the Corresponding Carboxylic Acids. European J. Org. Chem. 2011, 35, 7148-7154.
(26) Burdett, J. K.; Hoffmann, R.; Fay, R. C. Eight-Coordination. Inorg. Chem. 1978, 17 (9), 2553-2568. https://doi.org/10.1021/ic50187a041.
(27) Firor, R. L.; Seff, K. Seven-Coordinate Distorted C3v-Capped Trigonal-Prismatic Europium(II). Crystal Structure of Hydrated Europium(II)-Exchanged Sodium Zeolite A, Eu5Na2-A. Inorg. Chem. 1978, 17 (8), 2144-2148. https://doi.org/10.1021/ic50186a021.
(28) Uchtman, V. A. Implications for Polynuclear. J. Phys. Chem. 1971, 1262 (1969), 1304-1310.
(29) Stavgianoudaki, N.; Papathanasiou, K. E.; Colodrero, R. M. P.; Choquesillo-Lazarte, D.; Garcia-Ruiz, J. M.; Cabeza, A.; Aranda, M. A. G.; Demadis, K. D. Crystal Engineering in Confined Spaces. A Novel Method to Grow Crystalline Metal Phosphonates in Alginate Gel Systems. CrystEngComm 2012, 14 (17), 5385-5389.
(30) Liu, D.; Kramer, S. A.; Huxford-Phillips, R. C.; Wang, S.; Rocca, J. Della; Lin, W. Coercing Bisphosphonates to Kill Cancer Cells with Nanoscale Coordination Polymers. Chem. Commun. 2012, 48 (21), 2668-2670.
(31) Vassaki, M.; Papathanasiou, K. E.; Hadjicharalambous, C.; Chandrinou, D.; Turhanen, P.; Choquesillo-Lazarte, D.; Demadis, K. D. Self-Sacrificial MOFs for Ultra-Long Controlled Release of Bisphosphonate Anti-Osteoporotic Drugs. Chem. Commun. 2020, 56(38), 5166-5169.
(32) Patel, K.; Kumar, A.; Durani, S. Analysis of the Structural Consensus of the Zinc Coordination Centers of Metalloprotein Structures. Biochim. Biophys. Acta —Proteins Proteomics 2007, 1774 (10), 1247-1253.
(33) Fu, R.; Hu, S.; Wu, X. Luminescent Zinc Phosphonates for Ratiometric Sensing of 2,4,6-Trinitrophenol and Temperature. Cryst. Growth Des. 2016, 16 (9), 5074-5083. https://doi.org/10.1021/acs.cgd.6b00669.
(34) Zhang, X. L.; Cheng, K.; Wang, F.; Zhang, J. Chiral and Achiral Imidazole-Linked Tetrahedral Zinc Phosphonate Frameworks with Photoluminescent Properties. J. Chem. Soc. Dalt. Trans. 2014, 43 (1), 285-289. https://doi.org/10.1039/c3dt52159a.
(35) Jiang, Z.; Wang, T.; Yuan, S.; Wang, M.; Qi, W.; Su, R.; He, Z. A Tumor-Sensitive Biological Metal-Organic Complex for Drug Delivery and Cancer Therapy. J. Mater. Chem. B 2020, 8 (32), 7189-7196.
(36) Giger, E. V.; Castagner, B.; Leroux, J. C. Biomedical Applications of Bisphosphonates. J. Control. Release 2013, 167 (2), 175-188.
(37) Stapleton, M.; Sawamoto, K.; Almeciga-Diaz, C. J.; Mackenzie, W. G.; Mason, R. W.; Orii, T.; Tomatsu, S. Development of Bone Targeting Drugs. Int. J. Mol. Sci. 2017, 18 (7), 1345-1359.
(38) Shah, A.; Bloomquist, E.; Tang, S.; Fu, W.; Bi, Y.; Liu, Q.; Yu, J.; Zhao, P.; Palmby, T. R.; Goldberg, K. B.; et al. FDA Approval: Ribociclib for the Treatment of Postmenopausal Women with Hormone Receptor-Positive, HER2-Negative Advanced or Metastatic Breast Cancer. Clin. Cancer Res. 2018, 24 (13), 2981-2983.
(39) Sun, J.; Wei, Q.; Zhou, Y.; Wang, J.; Liu, Q.; Xu, H. A Systematic Analysis of FDA-Approved Anticancer Drugs. BMC Syst. Biol. 2017, 11, 27-102.
(40) Croset, M.; Clezardin, P. MicroRNA-Mediated Regulation of Bone Metastasis Formation: From Primary Tumors to Skeleton. Bone Cancer 2015, 479-490.
(41) Welsh, J. E. Animal Models for Studying Prevention and Treatment of Breast Cancer. Anim. Model. Study Hum. Dis. 2013, 997-1018.
(42) Harris, S. A.; Enger, R. J.; Riggs, L. B.; Spelsberg, T. C. Development and Characterization of a Conditionally Immortalized Human Fetal Osteoblastic Cell Line. J. Bone Miner. Res. 1995, 10 (2), 178-186.

### Supporting Information References

(1) Lecouvey, M.; Mallard, I.; Bailly, T.; Burgada, R.; Leroux, Y. A Mild and Efficient One-Pot Synthesis of 1-Hydroxymethylene-1,1-Bisphosphonic Acids. Preparation of New Tripod Ligands. Tetrahedron Lett. 2001, 42 (48), 8475-8478.
(2) Guenin, E.; Degache, E.; Liquier, J.; Lecouvey, M. Synthesis of 1-Hydroxymethylene-1,1-Bis(Phosphonic Acids) from Acid Anhydrides: Preparation of a New Cyclic 1-Acyloxymethylene-1,1-Bis(Phosphonic Acid). European J. Org. Chem. 2004, 14, 2983-2987.
(3) Egorov, M.; Aoun, S.; Padrines, M.; Redini, F.; Heymann, D.; Lebreton, J.; Mathe-Allainmat, M. A One-Pot Synthesis of 1-Hydroxy-1,1-Bis(Phosphonic Acid)s Starting from the Corresponding Carboxylic Acids. European J. Org. Chem. 2011, 35, 7148-7154.
(4) Mazur, A.; Nedelec, J.; Cachet, C.; Padmanilayam, M.; Liebens, A. Preparation of Copper Bisphosphonate Complex Catalyst for the Electrochemical Reduction of Carbon Dioxide, 2013.

### 2,2′-BPBPA-based Compounds References

(1) Mazur, A.; Nedelec, J.; Cachet, C.; Padmanilayam, M.; Liebens, A. Preparation of Copper Bisphosphonate Complex Catalyst for the Electrochemical Reduction of Carbon Dioxide, 2013.
(2) Quinones Velez, G.; Carmona-Sarabia, L.; Rodriguez-Silva, W. A.; Rivera Raices, A. A.; Feliciano-Cruz, L.; Hu, C. T.; Peterson, E. A.; Lopez-Mejias, V. Potentiating Bisphosphonate-Based Coordination Complexes to Treat Osteolytic Metastases. J. Mater. Chem. B 2020, 8 (10), 2155-2168.
(3) Quinones Velez, G.; Carmona-Sarabia, L.; Rivera Raices, A. A.; Hu, T.; Peterson-Peguero, E. A.; L6pez-Mejias, V. High Affinity Zoledronate-Based Metal Complex Nanocrystals to Potentially Treat Osteolytic Metastases. Mater. Adv. 2022, 3 (7), 3251-3266.
(4) Giger, E. V.; Castagner, B.; Leroux, J. C. Biomedical Applications of Bisphosphonates. J. Control. Release 2013, 167 (2), 175-188.
(5) Stapleton, M.; Sawamoto, K.; Almeciga-Diaz, C. J.; Mackenzie, W. G.; Mason, R. W.; Orii, T.; Tomatsu, S. Development of Bone Targeting Drugs. Int. J. Mol. Sci. 2017, 18 (7), 1345-1359.
(6) Shah, A.; Bloomquist, E.; Tang, S.; Fu, W.; Bi, Y.; Liu, Q.; Yu, J.; Zhao, P.; Palmby, T. R.; Goldberg, K. B.; et al. FDA Approval: Ribociclib for the Treatment of Postmenopausal Women with Hormone Receptor-Positive, HER2-Negative Advanced or Metastatic Breast Cancer. Clin. Cancer Res. 2018, 24 (13), 2981-2983.
(7) Rucci, N.; Ricevuto, E.; Ficorella, C.; Longo, M.; Perez, M.; Di Giacinto, C.; Funari, A.; Teti, A.; Migliaccio, S. In Vivo Bone Metastases, Osteoclastogenic Ability, and Phenotypic Characterization of Human Breast Cancer Cells. Bone 2004, 34 (4), 697-709.
(8) Welsh, J. E. Animal Models for Studying Prevention and Treatment of Breast Cancer. Anim. Model. Study Hum. Dis. 2013, 997-1018.
(9) Croset, M.; Clezardin, P. MicroRNA-Mediated Regulation of Bone Metastasis Formation: From Primary Tumors to Skeleton. Bone Cancer 2015, 479-490.
(10) Harris, S. A.; Enger, R. J.; Riggs, L. B.; Spelsberg, T. C. Development and Characterization of a Conditionally Immortalized Human Fetal Osteoblastic Cell Line. J. Bone Miner. Res. 1995, 10 (2), 178-186.

### Supporting Information

(1) Lecouvey, M.; Mallard, I.; Bailly, T.; Burgada, R.; Leroux, Y. A Mild and Efficient One-Pot Synthesis of 1-Hydroxymethylene-1,1-Bisphosphonic Acids. Preparation of New Tripod Ligands. Tetrahedron Lett. 2001, 42 (48), 8475-8478.
(2) Guenin, E.; Degache, E.; Liquier, J.; Lecouvey, M. Synthesis of 1-Hydroxymethylene-1,1-Bis(Phosphonic Acids) from Acid Anhydrides: Preparation of a New Cyclic 1-Acyloxymethylene-1,1-Bis(Phosphonic Acid). European J. Org. Chem. 2004, 14, 2983-2987.
(3) Egorov, M.; Aoun, S.; Padrines, M.; Redini, F.; Heymann, D.; Lebreton, J.; Mathe-Allainmat, M. A One-Pot Synthesis of 1-Hydroxy-1,1-Bis(Phosphonic Acid)s Starting from the Corresponding Carboxylic Acids. European J. Org. Chem. 2011, 35, 7148-7154.
(4) Mazur, A.; Nedelec, J.; Cachet, C.; Padmanilayam, M.; Liebens, A. Preparation of Copper Bisphosphonate Complex Catalyst for the Electrochemical Reduction of Carbon Dioxide, 2013.

While particular aspects and embodiments are disclosed herein, other aspects and embodiments will be apparent to those skilled in the art in view of the foregoing teaching. The various aspects and embodiments disclosed herein are for illustration purposes only and are not intended to be limiting, with the true scope and spirit being indicated by the following claims.

1-60. (canceled)

61. A compound comprising:
one or more bioactive metal ions, wherein the one or more bioactive metal ions are Mg², Ca²⁺, or Zn²⁺ ions; and
one or more ligand molecules coordinating to the one or more bioactive metal ions, wherein the one or more ligand molecules are:
zoledronate;
risedronate; 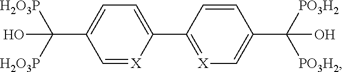
wherein X is N or C(H); or
an anionic derivative thereof.

62. The compound of claim 61, wherein each of the one or more ligand molecules coordinates to each of the one or more bioactive metal ions through at least one phosphonate group thereof.

63. The compound of claim 61, wherein the compound is a one-dimensional, two-dimensional, or three-dimensional chain structure.

64. The compound of claim 61, wherein the one or more bioactive metal ions and the one or more ligand molecules are in a stoichiometric ratio of 1:1, 1:2, 1:3, or 2:1.

65. The compound of claim 61, wherein each of the one or more ligand molecules coordinates to each of the one or more bioactive metal ions in a monodentate, bidentate, or tridentate manner.

66. The compound of claim 61, wherein each of the one or more bioactive metal ions is coordinated by at least one water molecule.

67. The compound of claim 61, wherein each of the one or more bioactive metal ions are surrounded by at least one lattice water molecule, and wherein the at least one lattice water molecule does not coordinate to the one or more bioactive metal ions.

68. The compound of claim 61, wherein the one or more ligand molecules are zoledronate, and wherein the compound forms a crystal polymorph characterized in that it provides a powder X-ray diffraction pattern comprising four or more peaks selected from one of the following sets (2θ±0.1 degrees):
(a) 12.4, 13.1, 14.7, 17.5, 20.9, 23.5, 31.5, 36.3;
(b) 8.2, 9.3, 11.6, 19.5, 23.2, 26.7;
(c) 12.5, 15.4, 17.3, 17.4, 17.7, 20.8, 22.6, 24.7, 28.7, 31.4, 38.1;
(d) 8.6, 10.8, 12.4, 19.2, 25.3, 28.8;
(e) 12.4, 15.1, 17.3, 20.8, 24.5, 28.4, 31.4; and
(f) 8.5, 10.8, 12.4, 18.6, 25.0, 28.8.

69. The compound of claim 61, wherein the one or more ligand molecules are risedronate, and wherein the compound forms a crystal polymorph characterized in that it provides a powder X-ray diffraction pattern comprising four or more peaks selected from one of the following sets (2θ±0.1 degrees):
(g) 7.9, 10.6, 11.7, 18.7, 28.7, 31.5;
(h) 9.6, 14.3, 15.5, 17.5, 20.9, 22.7, 29.2, 31.1, 34.2; and
(i) 6.3, 10.9, 12.6, 14.4, 19.5, 20.4, 24.9, 27.5, 29.4, 30.6.

70. The compound of claim 61, wherein the one or more ligand molecules are zoledronate, and wherein the compound is provided in a crystal having a unit cell selected from one of the following sequences:

| | (i) | (ii) | (iii) | (iv) | (v) | (vi) |
|---|---|---|---|---|---|---|
| a (Å, ± 0.1) | 7.4 | 10.2 | 7.4 | 5.0 | 7.4 | 5.0 |
| b (Å, ± 0.1) | 9.0 | 20.9 | 8.4 | 16.4 | 8.4 | 16.4 |
| c (Å, ± 0.1) | 9.5 | 22.5 | 9.7 | 14.4 | 9.7 | 14.4 |
| α (°, ± 0.1) | 105.7 | 90 | 105.2 | 90 | 105.3 | 90 |
| β (°, ± 0.1) | 108.7 | 90 | 111.4 | 93.2 | 111.2 | 93.5 |
| γ (°, ± 0.1) | 97.9 | 90 | 97.1 | 90 | 97.4 | 90 |

71. The compound of claim 61, wherein the one or more ligand molecules are risedronate, and wherein the compound is provided in a crystal having a unit cell selected from one of the following sequences:

| | (vii) | (viii) | (ix) |
|---|---|---|---|
| a (Å, ± 0.1) | 5.1 | 13.2 | 8.2 |
| b (Å, ± 0.1) | 16.6 | 5.2 | 28.3 |
| c (Å, ± 0.1) | 15.2 | 19.0 | 10.1 |
| α (°, ± 0.1) | 90 | 90 | 90 |
| β (°, ± 0.1) | 95.0 | 104.5 | 149.0 |
| γ (°, ± 0.1) | 90 | 90 | 90 |

72. The compound of claim 61, wherein the one or more ligand molecules are

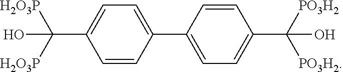

73. The compound of claim 61, wherein the one or more ligand molecules are

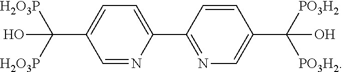

74. A drug-loaded composition comprising the compound of claim 61 and a drug composition, wherein the compound of claim 61 is provided in a crystal comprising a plurality of channels, and wherein the drug composition is disposed within the plurality of channels.

75. The drug-loaded composition of claim 74, wherein each of the plurality of channels has a width of at least 5 Å and a height of at least 5 Å.

76. The drug-loaded composition of claim 74, wherein the crystal has an average diameter of at least 20 nm.

77. The drug-loaded composition of claim 74, wherein the drug composition comprises a drug that treats breast cancer or a bone disease.

78. A method for treating a disease in a subject in need thereof, the method comprising administering to the subject a therapeutically effective amount of the compound of claim 61.

79. The method of claim 78, wherein the disease is breast cancer or a bone disease.

80. The method of claim 78, wherein the therapeutically effective amount of the compound is in a range of 0.1 mg/kg to 400 mg/kg.
